(19) United States
(12) Patent Application Publication
(10) Pub. No.: US 2012/0185172 A1
(43) Pub. Date: Jul. 19, 2012

(54) METHOD, SYSTEM AND APPARATUS FOR DATA PROCESSING

(76) Inventors: Joseph BARASH, Toronto (CA); Brendan J. FREY, Toronto (CA); Benjamin J. BLENCOWE, Toronto (CA)

(21) Appl. No.: 13/098,222

(22) Filed: Apr. 29, 2011

Related U.S. Application Data
(60) Provisional application No. 61/433,627, filed on Jan. 18, 2011.

(51) Int. Cl. G06F 19/18

(52) U.S. Cl. 702/19

(57) ABSTRACT

A method, system and apparatus for processing requests is provided. The method comprises storing, in a memory, splicing code data comprising a plurality of features, the splicing code data further comprising, in association with each feature, at least one parameter defining the activity of the feature in splicing regulation; receiving a request at a processor, the request identifying at least a first portion of a genomic sequence; receiving, at the processor, at least a second portion of the genomic sequence that is relevant to the first portion; generating, at the processor, a feature set comprising at least one feature from the second portion of the genomic sequence; generating, based on the splicing code data and the feature set, a response to the request, the response comprising at least one of predicted changes in inclusion levels and a predicted feature map for at least one condition; and transmitting the response.

### FIELD

The specification relates generally to data processing, and specifically to a method, system and apparatus for processing genomic data and requests relating to said data.

### BACKGROUND

The proper function of a living cell depends on constant regulation of its biomolecular content, both spatially and temporally. One important regulated process is splicing, where exonic segments of the transcribed pre-mRNA are spliced together while intronic segments are removed. In some cases, different exons of the pre-mRNA may be retained, leading to different transcripts called isoforms, a process known as alternative splicing (AS). There are several known types of AS, with the most common one in humans being cassette AS (Wang et al., 2008), illustrated in FIG. 26. AS plays a critical role in shaping how genetic information is expressed in cells of metazoan species. Moreover, it is estimated that 15-50% of human disease mutations affect splice site selection (Wang and Cooper, 2007).

Recent high-throughput sequencing studies estimate that transcripts from about 95% of multiexon human genes undergo AS, with the majority of AS exons displaying differential expression across different tissues (Pan et al., 2008; Wang et al., 2008). Such high-throughput studies can be probed to identify condition-specific splicing changes that subsequently can be linked to genetic disease (Scheper et al., 2004). Alternatively, groups of exons identified by these studies as exhibiting concerted changes across functionally related conditions (e.g. muscle tissues) can be used to look for a common regulatory program. For example, several works (Castle et al., 2008; Fagnani et al., 2007; Wang et al., 2008) correlated splicing changes with potential binding motifs.

Due to our limited understanding of the living cell, the volume of potential regulating factors involved in alternative splicing combined with finite computational and experimental resources and technologies available, processing data describing alternative splicing events and generating predictions based on such data remains a challenge.

### BRIEF DESCRIPTIONS OF THE DRAWINGS

Embodiments are described with reference to the following figures, in which:

FIG. 1 depicts a system for processing data and handling requests, according to a non-limiting embodiment;

FIG. 2 depicts a method of handling requests, according to a non-limiting embodiment;

FIG. 2A depicts a method of handling requests, according to another non-limiting embodiment;

FIG. 3 depicts a performance of block 205 of the method of FIG. 2, according to a non-limiting embodiment;

FIG. 4 depicts a performance of the method of FIG. 2 or FIG. 2a, according to a non-limiting embodiment (part A); a code quality measurement as features are recursively added to the splicing code data, according to a non-limiting embodiment (part B); the preference of different feature types as features are recursively added to the splicing code data, according to a non-limiting embodiment (part C); and a comparison of the splicing code data of FIG. 1 with simpler splicing codes, according to a non-limiting embodiment; error bars represent 1 s.d. (part D);

FIG. 5 depicts classification rates for the assembled splicing code data and simpler splicing codes, assessed using microarray data (n=28,920), according to a non-limiting embodiment (part A); accuracy of splicing code data in predicting microarray- and RT-PCR-measured changes in exon inclusion levels between paris of tissues (n=346 and n=208), according to a non-limiting embodiment; error bars represent 1 s.d. (part B); for each exon and pair of tissues, the RT-PCT-measured change in the percentage inclusion plotted against the splicing code-predicted change in the probability of exon inclusion, according to a non-limiting embodiment; dashed lines indicate RT-PCT differences exceeding 1 s.d. in measurement error (part C); RT-PCR data for four exons, plus splicing code predictions indicating relative increases (dark shading) or decreases (light shading) in the exon inclusion level, according to a non-limiting embodiment (part D);

FIG. 6 depicts the region-specific activity of each feature in increased exon inclusion (white bar 600) or exclusion (shaded bar 604) for CNS (“C”), muscle (“M”), embryo (“E”) and digestive (“D”) tissues, plus a tissue-independent mixture (“I”), according to a non-limiting embodiment; a bar with/without a black hat 608 indicates activity due to feature depletion/enrichment; bar size conveys enrichment P-value; P<0.005 in all cases; potential feature binding proteins are shown in parentheses;

FIG. 6A depicts feature interaction networks for identified unexpectedly frequent feature pairs in CNS (part B), muscle (part C) and embryonic (part D) tissues, according to a non-limiting embodiment; the edges in aras 612 correspond to increased exclusion, while remaining edges correspond to increased inclusion; and edge thickness conveys interaction P-value (false discovery rate-corrected Fisher test); P<0.05 in all cases; a thick/thin node boundary, as at 616, indicates activity due to feature depletion/enrichment;

FIG. 7 depicts the validation of a regulatory feature map of regulatory elements in the intron upstream of exon 16 in Daam1 predicted to be associated with CNS-specific increased exon inclusion, according to a non-limiting embodiment. Part A shows putative features (grey blocks 700), along with code-selected features from the compendium (white blocks 704) and the unbiased motif set (shaded blocks 708). Twelve segments were selected for testing (shaded blocks 712), including one not overlapping with predictions, and 15 minigene reporters with single- or combined-segment substitutions were constructed and transfected into neuroblastoma (N2A) and epithelial (NIH-3T3) cells. FIG. 7, part B shows RT-PCR results for the wild type and 15 mutants. FIG. 7, part C shows mutations of several nPTB-like elements support code-predicted synergistic interactions. FIG. 7, part D, shows mutations of several CU and CUG elements between 55 and 90 nucleotides support code-predicted antagonistic interactions. Symbol size indicates the percentage exon inclusion (0-83.7%);

FIG. 8, part A depicts a class of PTC-introducing exons identifed by the splicing code and predicted to activate NMD when included in adult tissues, but to allow mRNA expression when skipped in embryonic tissues, according to a non-limiting embodiment;

FIG. 8, part B depicts RT-PCR data monitoring splicing and mRNA expression levels of transcripts from Xpo4, which contains a code-predicted PTC-introducing exon, in four adult tissues (cortex, cerebellum, kidney and liver) and three embryonic samples (embryonic day (E)9.5, E12.5 and E15), according to a non-limiting embodiment;

FIG. 8, part C depicts RT-PCR data monitoring mRNA levels of the NMD factor Upf1 and the PTC-containing Xpo4 isoform in neuroblastoma (N2A) cells transfected with control siRNAs or Upf1 siRNAs, according to a non-limiting embodiment. The Xpo4 PTC-containing isoform was selectively amplified using an exon-specific primer. Gapdh mRNA levels represent a loading control;

FIG. 9 depicts five components identified by the performance of blocks 305 and 310 of the method of FIG. 3, according to a non-limiting embodiment; black bars denote the variance of the components over 15 random subsets of 80% of original dataset, demonstrating the robustness of the extracted components;

FIG. 10 depicts a motif map for differential splicing in CNS, upstream intron of Src N1 exon, according to a non-limiting embodiment;

FIG. 11 depicts a motif map for differential splicing in CNS, downstream intron of Src N1 exon, according to a non-limiting embodiment;

FIG. 12 depicts a motif map for differential splicing in CNS, downstream intron of Caspase-2 exon 9, according to a non-limiting embodiment;

FIG. 13 depicts a motif map for differential splicing in muscle, downstream intron of Caspase-2 exon 9, according to a non-limiting embodiment;

FIG. 14 depicts a motif map for differential splicing in CNS, downstream intron of Agrin Y exon, according to a non-limiting embodiment;

FIG. 15 depicts a motif map for differential splicing in CNS, upstream intron of Slo K⁺ channel STREX exon, according to a non-limiting embodiment;

FIGS. 16 and 16A depict a graphical depiction of splicing code data, according to a non-limiting embodiment;

FIGS. 17 and 17A depict a graphical depiction of the short motifs in the splicing code data of FIGS. 16 and 16A, according to a non-limiting embodiment;

FIG. 18 depicts histograms for the number of features per exon, for each of the four tissue-specific splice patterns, for only cis elements without 1-3mer count (part A), when adding other genomic features (part B) and for only 1-3mer count features (part C), according to a non-limiting embodiment;

FIG. 19 depicts an analysis of features encoding transcript structure, according to a non-limiting embodiment. The distributions of features encoding transcript structure are compared for alternative exons exhibiting tissue-specific regulation, alternative exons not exhibiting that tissue-specific regulation and exons that are not alternatively spliced (constitutive exons). The 5′ junction score is weaker in alternative exons and weaker still in exons included more frequently in muscle tissues (p<10⁻⁵) (part A). Shorter exons are more frequently included in CNS tissues compared to other tissues (p<10⁻⁹) (part B). Distance to the first AG in the upstream intron is indicative of increased inclusion in CNS tissues (p<10⁻¹⁵) (part C). Introduction of a premature termination codon (PTC) in the inclusion isoform is a highly enriched feature in exons exhibiting differential exclusion embryo tissues (p<10⁻¹⁴) (part D);

FIG. 20 depicts prediction accuracy of the inferred code for differences in splicing levels when compared against microarray-assessed direction of change in % inclusion (up or down) between pairs of tissues, according to a non-limiting embodiment. The x-axis gives the accuracy as a function of the gene expression level used to screen the data for high confidence measurements;

FIG. 21 depicts prediction accuracy for constitutive vs. tissue regulated exons, using 5 fold cross validation; in particular, FIG. 21A is a ROC curve for the entire range, with an area under the curve (AUC)>0.94; dashed line represents random guessing. FIG. 21B is the same ROC, but zoomed to the range of 0-1% FPR, where sensitivity of 60% is achieved;

FIG. 22 depicts RT-PCR assays verifying predicted neural-specific alternative exons in genes with disease associations, according to a non-limiting embodiment; grey-scale coded predictions as in FIG. 5 and gene names are indicated on the right of each gel, and icons representing each splice isoform are shown on the left of each gel. Tissues and whole embryo stages are indicated above the gels;

FIG. 23 depicts the effect of mutated intron upstream of Daam1 exon 16 on the predictions of the splicing code for changes in inclusion levels in CNS tissues, according to a non-limiting embodiment;

FIG. 24 depicts two addtional sets of RT-PCR results and their quantifications for the wild type and 15 mutants presented in FIG. 7b, according to a non-limiting embodiment;

FIG. 25 depicts additional examples of developmentally regulated genes with transcript isoforms targeted by NMD pathway, according to a non-limiting embodiment; in particular, part A shows RT-PCR assays monitoring alternative splicing and overall mRNA expression levels of four transcripts (from Gstcd, Nup155, Kif2c, and Ndc80 genes) in three adult tissues (cortex, kidney, liver) and three stages of embryonic development (E 9.5, E 12.5, and E 15). Gapdh mRNA levels are displayed as a loading control (bottom panel). Part B shows semi-quantitative RT-PCR assays measuring abundances of PTC-containing isoforms corresponding to transcripts from part A in Neuro2a cells transfected with control siRNAs (lane1) or Upf1 siRNAs (lane2). The fold change of transcript abundances in Upf1 siRNA-transfected cells relative to control siRNA-transfected cells are listed below each image. Upf1 mRNA levels (top panel) and gapdh mRNA levels (bottom panel) are also shown.

FIG. 26, part A depicts the quantification of isoforms including and excluding a cassette exon using a single number, representing the percent of isoforms that include the exon, according to a non-limiting embodiment;

FIG. 26, part B depicts high-throughput alternative splicing data (also referred to as expression data herein) as a matrix of percent inclusion values for different exons (rows) under different conditions (columns), according to a non-limiting embodiment;

FIG. 26, part C depicts the matrix of FIG. 26, part B for a real dataset (Fagnani et al., 2007), after agglomerative clustering, according to a non-limiting embodiment. Inclusion levels are displayed as a heat-map, with the subset of CNS tissues visible on the left;

FIG. 26A, part D depicts four examples of exons exhibiting condition-specific splicing changes in CNS, muscle and embryo tissues, according to a non-limiting embodiment. Arrows show the position of each exon in the clustergram;

FIG. 26A, part E depicts five underlying alternative splicing signals identified by a performance of blocks 305 and 310 of FIG. 3, according to a non-limiting embodiment;

FIG. 26A, part F depicts how each of the signals of FIG. 26E is associated with the four exon examples, according to a non-limiting embodiment;

FIG. 27 depicts a Bayesian network representation of the model used in the performance of blocks 305 and 310 of FIG. 3, according to a non-limiting embodiment. Observed variables are shaded and dependencies are denoted with directed edges. The dashed frame denotes elements shared with standard FA;

FIG. 28 depicts comparisons of the performance of blocks 305 and 310 of FIG. 3 with alternative approaches, according to a non-limiting embodiment. In particular, parts A-C show SVD analysis, including the singular values (part A), examples of the first five condition specific eigen-exons (part B), and a heat map (part C) of the pair-wise correlation between the first five eigen-exons identified from ten random subsets of the data; part D is a comparison of the feature information index (FII) for ASFA (blocks 305 and 310), SVD and a manual approach;

FIG. 29 depicts the effect of varying the number of condition-specific AS signals between two and six, according to a non-limiting embodiment; in particular, part A shows the number of iterations until convergence; part B shows the free energy (average bits per instance) for the train set; part C shows free energy for the test set;

FIG. 30 depicts the effect of different model settings on the identified AS signals, according to a non-limiting embodiment; in particular, parts A-C show heat maps of the pairwise correlation between all AS signals identified in 10 random subsets of the data when learning five AS signals (part A), learning four signals (part B), and learning four signals with three signal initialized to CNS, muscle and embryo tissues (part C); part D shows examples of the AS signals identified;

FIG. 31, part A depicts histograms of the estimated log-abundance of genes, according to a non-limiting embodiment. The histogram 3104 on the right represents the actual experimental data, derived from measurements of the genes corresponding to all exons in the experiment. The histogram 3108 on the left was derived from a set of negative probes, measuring genes that are presumably not expressed, according to a non-limiting embodiment;

FIG. 31, part B depicts, in dashed line, the relation between expression level (x-axis) and the fraction of measurements in the data (histogram 3104 of part A) that exceed it (y-axis), according to a non-limiting embodiment. A threshold that corresponds to the 95^{th} percentile of the negative probes (histogram 3108 of part A) is plotted as a vertical dashed line. The solid line plots the posterior signal model probability as a function of the observed expression level;

FIG. 31, part C depicts the plot of part B, derived from a noisier data set, according to a non-limiting embodiment. In this case, the alternative approach of removing data based on a hard threshold corresponding to the 95^{th} percentile of the negative probes would result in removing over 70% of the data;

FIGS. 32 to 78, also referred to herein as Table S1, depict the feature compendium of FIG. 1, according to a non-limiting embodiment;

FIGS. 79 to 97, also referred to herein as Table S2, depict the splicing code data of FIG. 1, according to a non-limiting embodiment;

FIGS. 98 to 103, also referred to herein as Table S3, depict predictions for previously-verified CNS- and/or muscle-regulated exons, according to a non-limiting embodiment;

FIGS. 104 to 107, also referred to herein as Table S4, depict the exploration of CNS-regulated exons in widely expressed genes that are associated with neurological diseases, according to a non-limiting embodiment; and

FIGS. 108 to 110, also referred to herein as Table S5, depict the feature compendium of FIG. 1, according to another non-limiting embodiment;

### DETAILED DESCRIPTION OF THE EMBODIMENTS

According to an aspect of the specification, a method of processing requests is provided, the method comprising: storing, in a memory, splicing code data comprising a plurality of features, the splicing code data further comprising, in association with each feature, at least one parameter defining the activity of the feature in splicing regulation; receiving a request at a processor, the request identifying at least a first portion of a genomic sequence; receiving, at the processor, at least a second portion of the genomic sequence that is relevant to the first portion; receiving, at the processor, a feature set comprising at least one feature from the second portion of the genomic sequence; generating, based on the splicing code data and the feature set, a response to the request, the response comprising at least one of a numerical value and a graphical depiction for at least one condition; and transmitting the response.

According to another aspect of the specification, a non-transitory computer readable medium is provided for storing computer readable instructions executable by a processor for configuring the processor to implement the above method.

According to another aspect of the specification, a server is provided, comprising: a memory for storing splicing code data comprising a plurality of features, the splicing code data further comprising, in association with each feature, at least one parameter defining the activity of the feature in splicing regulation; processor configured to receive a request, the request identifying at least a first portion of a genomic sequence; the processor further configured to receive at least a second portion of the genomic sequence that is relevant to the first portion; the processor further configured to receive a feature set comprising at least one feature from the second portion of the genomic sequence; the processor further configured to generate, based on the splicing code data and the feature set, a response to the request, the response comprising at least one of at least one of a numerical value and a graphical depiction for at least one condition; and the processor further configured to transmit the response.

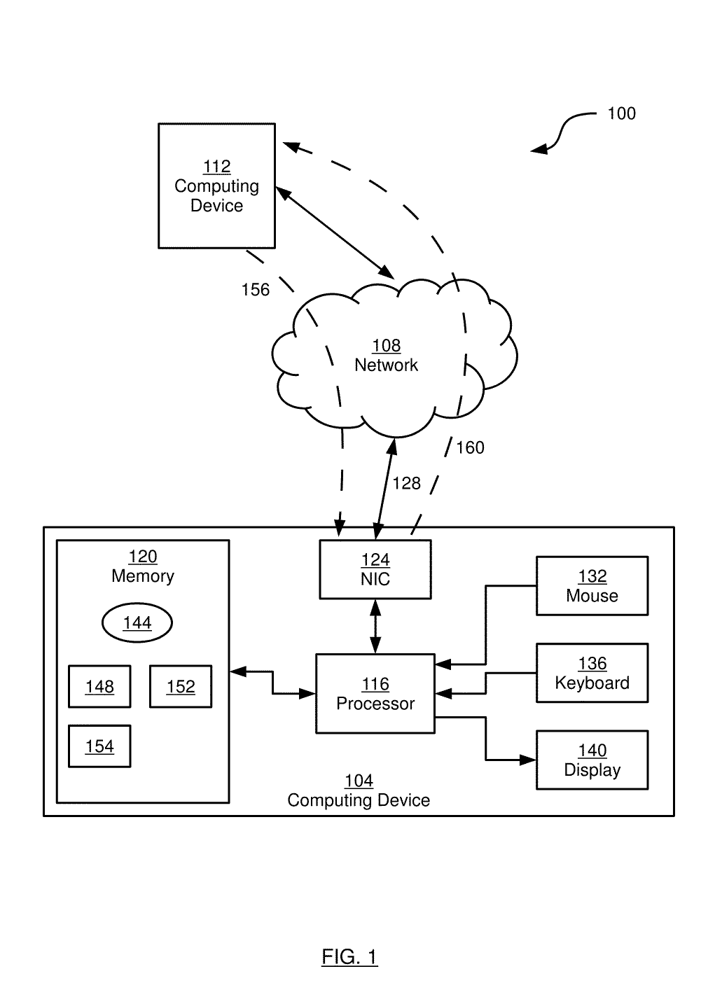

Referring to FIG. 1, a system 100 is depicted, comprising a first computing device 104, a network 108 and a second computing device 112. In the present embodiment, computing device 104 is based on the computing environment and functionality of a server, and computing device 104 is therefore also referred to herein as “server 104”. It is contemplated, however, that computing device 104 is not limited to a server environment and can be implemented, in other embodiments, in computing environments such as that of a desktop computer, a laptop computer, a tablet computer and the like.

Computing device 112, in the present embodiment, is a desktop computer comprising a processor, a memory and input and output devices (e.g. a mouse, a keyboard and a display). In other embodiments, however, computing device 112 can be any one of a variety of computing devices, including a laptop computer, a tablet computer, a smart phone and the like.

Network 108 can include any suitable combination of wired networks, wireless networks or both. Network 108 can thus include, but is not limited to, a Wide Area Network (WAN) such as the Internet, a Local Area Network (LAN), mobile networks, WiFi networks and the like. In general, network 108 enables communication between computing devices, as will be discussed in greater detail below.

Certain internal components of server 104 are shown in FIG. 1. In particular, server 104 includes an enclosure housing one or more processors such as processor 116. Processor 116 is interconnected with a non-transitory computer-readable medium such as a memory 120. Memory 120 can be any suitable combination of volatile (e.g. Random Access Memory (“RAM”)) and non-volatile (e.g. read only memory (“ROM”), Electrically Erasable Programmable Read Only Memory (“EEPROM”), flash memory, magnetic computer storage device, or optical disc) memory.

Server 104 also includes a communications interface, such as a network interface controller (NIC) 124, interconnected with processor 116. NIC 124 allows server 104 to connect to network 108 via a link 128 and thereby communicate with other computing devices (such as computing device 112) via link 128 and network 108. In the present example embodiment, link 128 is a wired link, though it is contemplated that in other embodiments, link 128 can include a wireless link (such as a link based on any one or more of Global System for Mobile communications (GSM), General Packet Radio Service (GPRS), Enhanced Data rates for GSM Evolution (EDGE), and the third-generation mobile communication system (3G), Institute of Electrical and Electronics Engineers (IEEE) 802.11 (WiFi) or other wireless protocols). Link 128 can also include any backhaul links necessary to connect server 104 to network 108. NIC 124 is therefore selected for compatibility with link 128 as well as with network 108.

Server 104 also includes input devices such as a mouse 321 and a keyboard 136 interconnected with processor 116. Such input devices accept input (for example, in the form of key depressions for keyboard 136) and transmit input data to processor 116 representative of such input. Additional input devices, such as a microphone (not shown) can also be provided in some embodiments.

Server 104 further includes output devices such as a display 140. Display 140 can include any suitable combination of includes flat panel displays (e.g. Liquid Crystal Display (LCD), plasma display, Organic Light Emitting Diode (OLED) display) and Cathode Ray Tube (CRT) displays, and thus includes circuitry comprising any suitable combination of display buffers, transistors, LCD cells, plasma cells, phosphors, and the like. In general, display 140 is controllable by processor 116 to generate visual representations of data.

The various components of server 104 are interconnected, for example via a communication bus. Server 104 is powered by an electrical supply (not shown) derived from any suitable source (e.g. mains electricity, batteries and the like.

As can also be seen in FIG. 1, server 104 maintains, in memory 120, one or more applications. Each application comprises computer-readable instructions for execution by processor 116. In general, execution of the computer-readable instructions of an application configures processor 116 to implement certain functionality. It is contemplated that a plurality of applications can be maintained in memory 120, however, for the sake of simplicity, one application 144 is shown in memory 120. The functionality implemented by processor 116 via execution of the instructions of application 144 relates to the processing of data and requests, and will be discussed in greater detail below.

Additional data is also stored in memory 120. In particular, memory 120 contains splicing code data 148, which will be discussed in further detail below. Memory 120 also contains expression data 152 and a feature compendium 154, which will also be discussed below.

Also shown in FIG. 1 are a request 156 from computing device 112, and a response 160, from server 104, to request 156. Request 156 and response 160 will be discussed in greater detail below.

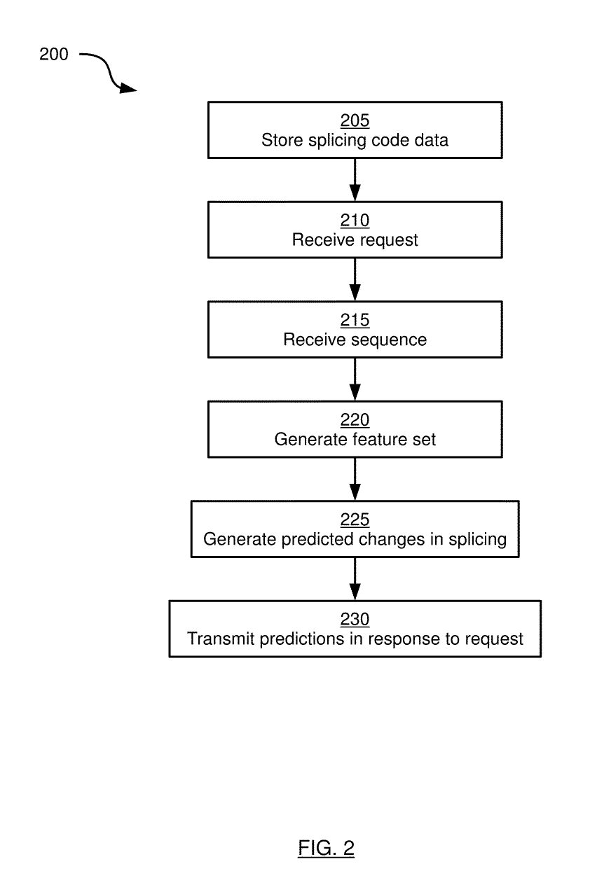

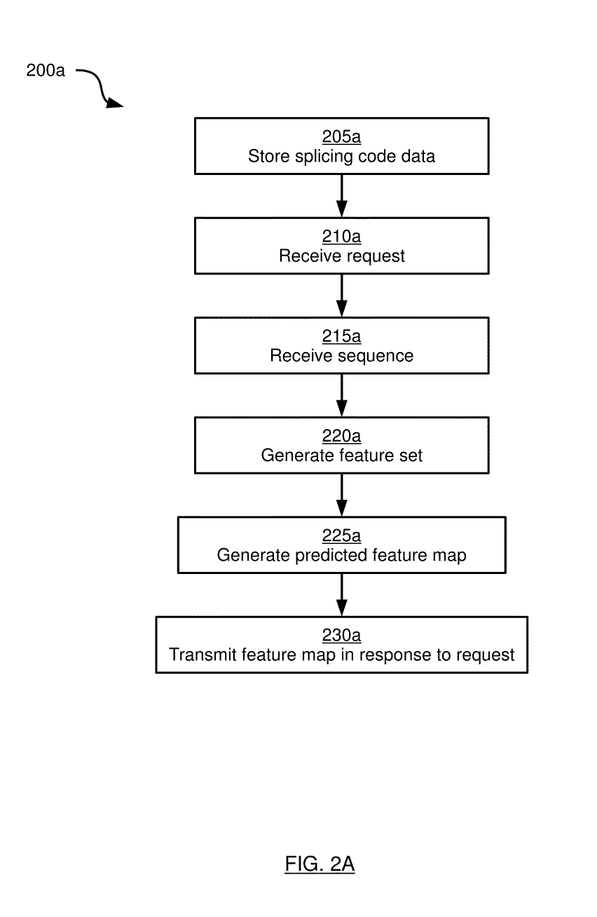

Turning to FIG. 2, a flowchart of a method 200 of handling requests is depicted. The blocks of method 200 are performed by processor 116, as configured via execution of application 144 and in conjunction with the remaining components of server 104.

At block 205 of method 200, processor 116 is configured to store, in memory 120, splicing code data 148. Splicing code data 148 comprises a plurality of features. The term “features” is used herein to refer to various types of motifs, including one-dimensional motifs (e.g. a particular sequences of nucleotides), two-dimensional and three-dimensional motifs as well as epigenetic modifications, features relating to the organization of DNA and the like. Features can also include attributes such as the length (in nucleotides) of an exon or of neighbouring introns and exons, and the like. In general, features can describe any measurable aspect of genomic structures, including RNA and DNA, and their interactions. Certain examples of features are provided below in the section titled Selection of Regulatory Features. Further detail concerning those example features is provided in Supplementary Information section 2 (Compendium of Putative Regulatory Features), below. It will now be apparent that the features discussed herein are non-limiting examples, and a variety of other types of features will also now occur to those skilled in the art.

It will now be apparent to those skilled in the art that splicing code data 148 can comprise data identifying each of the plurality of features in addition to, or instead of, a full description of the feature. For example, a feature consisting of a particular sequence of nucleotides can be identified in splicing code data 148 by the identifier tag “feature 1” or any other tag, rather than by the actual sequence. It will therefore be understood that when splicing code data 148 is described herein as comprising features, such a description is intended to cover embodiments in which splicing code data 148 includes tags only, embodiments in which splicing code data 148 includes tags and full descriptions, and embodiments in which both tags and full descriptions are included.

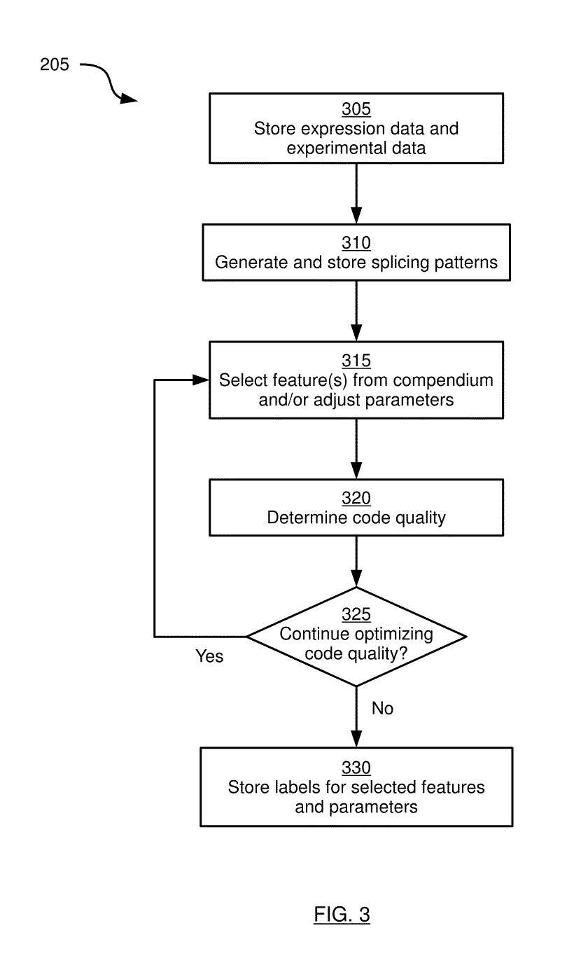

Splicing code data 148 also includes, in association with each feature, at least one parameter defining the activity of the feature in splicing regulation. Parameters include indications of which tissue types or other cellular conditions the feature is active in, weighting factors indicating the magnitude and direction of the feature's activity (for example, the presence of some features is predictive of increased inclusion of an exon in resulting mRNA sequences, while the presence of other features is predictive of increased exclusion of the exon) and the like. An example embodiment of splicing code data 148 is shown in Supplementary Table S2. Splicing code data 148 can be generated by server 104, as will be discussed below in connection with FIG. 3. In other embodiments, splicing code data 148 can be generated by a different computing device (not shown) and provided to server 104 for storage, for example via network 108.

Proceeding to block 210, processor 116 is configured to receive request 156 from computing device 112. As seen in FIG. 1, request 156 originates from computing device 112 and reaches NIC 124 via network 108 and link 128. NIC 124 is configured to transmit incoming requests to processor 116, and thus processor 116 receives request 156. A variety of request types are contemplated. IFor example, in the present embodiment, request 156 is a Hypertext Transport Protocol (HTTP) request from computing device 112. Such an HTTP request can originate from a web browser application on computing device 112, accessing a web page hosted by server 104, such as the web page “http://genes.toronto.edu/wasp” discussed below. It will now be apparent that the HTTP request mentioned above is a non-limiting example of a request, and that a wide variety of requests can be accomodated by server 104. In some embodiments, by way of another non-limiting example, request 156 can comprise input data received from keyboard 136 and mouse 132. Still other forms of request will now occur to those skilled in the art.

In general, request 156 identifies at least a first portion of a genomic sequence. The term “genomic sequence” as used herein is not particularly limiting, and is directed to any nucleotide structure, including a sequence of RNA, a sequence of DNA, and the like. Such sequences can be existing sequences drawn from the genome or any suitable organism, or synthetic sequences not associated with any genome or organism. To that end, request 156 can include the sequence of the first portion, or genomic coordinates pointing to the first portion, or a combination thereof. In the present example performance of method 200, the first portion of the genomic sequence is an exon. It will now be apparent to those skilled in the art that a given exon can have various different 3′ and 5′ splice sites, as well as various definitions of UTR—the first portion can encompass any of the possible variations of an exon resulting from the selection of different ones of such splice sites and UTRs. Thus, request 156 can include, for example, genomic coordinates pointing to the exon. Request 156 can also include, in addition to or instead of the coordinates, the full sequence of the exon. In other embodiments, request 156 can include a portion of the sequence of the exon of sufficient length or uniqueness to permit identification of the exon (that is, request 156 can include a recognizable portion of the exon). It will now be apparent that although the discussions below make reference to an exon, the nature of the first portion identified in request 156 is not particularly limited. Non-limiting examples of a first portion of a genomic sequence identified in request 156 include a portion of an exon, an exon, an intron, a combination of one or more exons and one or more introns, an untranslated region, an untranslated 3′ region and an untranslated 5′ region.

Returning to FIG. 2, following receipt of request 156 at block 210, the performance of method 200 proceeds to block 215. At block 215, processor 116 is configured to receive at least a second portion of the genomic sequence that is relevant to the first portion. In the present embodiment, it will now be understood that the second portion is relevant to the first portion in the context of alternative splicing. The second portion received at block 215 can take a variety of forms in various embodiments. In the present example embodiment, in which the first portion is an exon, the second portion defines the exon identified in request 156, as well as one or more regions of RNA proximal to the exon. Thus, in the present example embodiment the second portion includes the first portion. In other embodiments, the second portion can be substantially the same, or the same, as the first portion (for example, in embodiments where request 156 includes a sequence for an exon as well as surrounding introns and exons). In embodiments in which the first and second portions are the same, blocks 210 and 215 are performed simultaneously, as request 156 already includes the second portion. In other words, blocks 210 and 215 are collapsed into a single step. It is contemplated that such embodiments can be used where, for example, a previously unknown sequence (e.g. a synthetic sequence) is submitted with request 156. In other embodiments, such as those in which request 156 includes genomic coordinates but no sequence (or a sequence of only part of the first portion which allows identification of the first portion), processor 116 can be configured to retrieve the second portion from sequence data (not shown in FIG. 1) stored in memory 120 using the genomic coordinates.

Proceeding to block 220, processor 116 is configured, after receiving the sequence at block 215, to generate a feature set relating to the exon identified in request 156. In general, the feature set generated at block 220 represents a set of features present in the sequence received at block 215 that potentially affect alternative splicing of the exon identified in request 156. More specifically, in some embodiments the generation of the feature set at block 220 comprises identifying features present in the sequence from block 215 that are also present in splicing code data 148. As a further example, in the present embodiment, the generation of the feature set at block 220 comprises identifying features that are present in the sequence from block 215 that are also present in feature compendium 154. As will be discussed in greater detail below, feature compendium 154 contains a super-set of the features present in splicing code data 148. Thus, the performance of block 220 results in the generation of a set of features from the exon and surrounding areas (i.e. the second portion of the genomic sequence) identified as potentially having a regulatory role in the alternative splicing of the exon identified in request 156. It is contemplated that the generation of the feature set at block 220 can include various intermediate operations, including computing the secondary structure of the second portion and determining the frequency with which certain nucleotide sequences appear in the second portion in certain regions of the second portion. Other computations necessary to generate the feature set at block 220 will now occur to those skilled in the art. Once the generation of the feature set is complete, the performance of method 200 proceeds to block 225.

It is contemplated that in some embodiments, the performance of block 220 can comprise receiving a feature set via network 108 and NIC 124. For example, the feature set can be received from a further computing device (not shown), or from computing device 112. When the feature set is received from computing device 112, it can be received with request 156, or as a separate request. It will now be apparent to those skilled in the art that the feature set received at block 220 can be generated at computing device 112 is based on the first portion of the sequence identified in the request 156.

At block 225, processor 116 is configured to generate predicted changes in the inclusion level of the exon (or, more generally, of the first portion) for at least one cellular condition. In the present example embodiment, the performance of block 225 involves the generation of three predicted probabilities for each cellular condition: a predicted probability of increased exon inclusion, a predicted probability of increased exon exclusion, and a predicted probability of no change in exon inclusion. In general, the predictions generated at block 225 indicate a level of confidence that significant changes in inclusion levels will occur under certain cellular conditions.

The above predictions can be generated for any number of cellular conditions. In the present example embodiment, a set of three probabilities is generated for each of the following four conditions: CNS tissue, muscle tissue, embryo tissue and digestive tissue. It is contemplated that although the above-recited conditions are tissue types, the conditions are not limited to tissue types. It is also contemplated that in some embodiments, request 156 can identify a particular condition or plurality of conditions (e.g. CNS tissue). In such embodiments, processor 116 is configured to generate predictions for only the condition or conditions specified in request 156.

Certain ways to generate predictions during the performance of block 225, according to non-limiting embodiments, are discussed in greater detail below, in the sections Assembling a high-information code and Predicting alternative splicing. The validation of predictions is discussed in the section Prediction Performance Evaluation.

Following the generation of predictions at block 225, the performance of method 200 proceeds to block 230, at which processor 116 is configured to generate and transmit a response to request 156. Referring again to FIG. 1, response 160 is shown transmitted from NIC 124 (under the control of processor 116), via link 128 and network 160, to computing device 112. When request 156 is an HTTP request, as mentioned above, response 160 can also be an HTTP response received by the browser application of computing device 112.

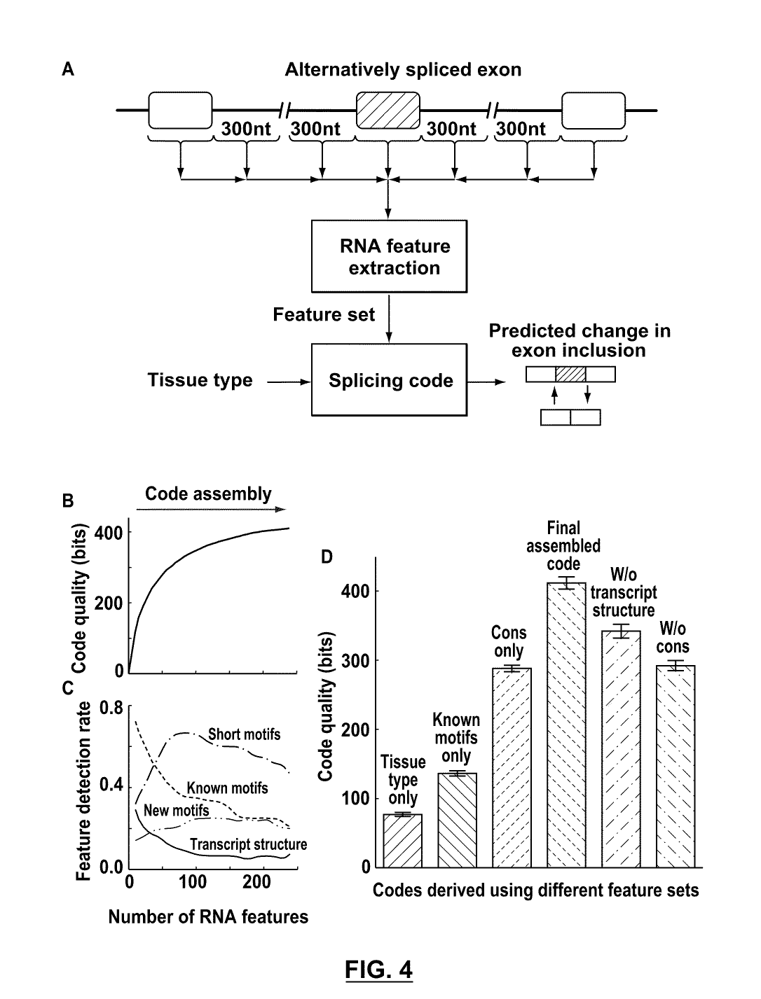

Referring briefly to FIG. 4, part A, a graphical depiction of the performance of method 200 is shown, in which a tissue type and feature set (derived from the sequence shown at the top of part A of FIG. 4) are used as inputs to generate predictions based on splicing code data 148.

Turning now to FIG. 2A, an additional method 200a is depicted. As with method 200, method 200a can be implemented by processor 116 via the execution of application 144. Blocks 205a, 210a, 215a and 220a of method 200a are substantially as described above in connection with blocks 205, 210, 215 and 220 of method 200, respectively. At block 225a, processor 116 is configured to generate a predicted feature map for a given condition (such as a tissue type). A predicted feature map (also referred to herein simply as a “feature map”) includes an identification of features in all or part of the second portion of the genomic sequence (for example, in an intron neighbouring the exon identified in request 156) which splicing code data 148 indicates are, or may be, involved in the regulation of alternative splicing. In other words, the feature map highlights areas of the second portion that are, or may be, of interest in the context of alternative splicing of the exon.

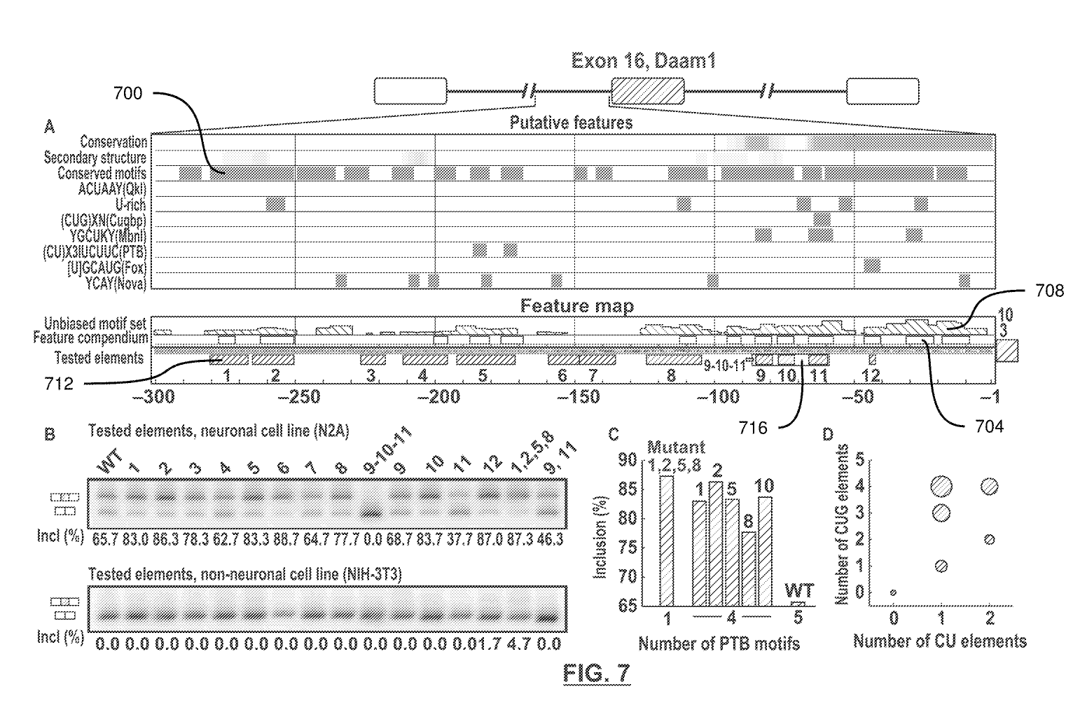

In the present example embodiment, the feature map is a graphical representation of the above-mentioned features of interest. Non-limiting examples of feature maps are provided in FIGS. 7a and 10-15 and discussed below in the sections “Predicting regulatory feature maps” and “Exon-Specific Feature Maps”. In the non-limiting example feature maps of FIGS. 7a and 10-15, each feature map includes a “putative features” portion and a “motif map” portion. The “putative features” portion indicates areas of the second portion in which selected features from feature compendium 154 (to be discussed further below) are present. The “motif map” portion indicates areas in which features from splicing code data 148 are present, as well as areas which have been the subject of experimental testing and areas which contain features located as part of an unbiased motif search, also discussed below. It will now be apparent to those skilled in the art that the above-mentioned feature maps are provided for example purposes only, and that the various portions thereof can be combined, omitted and added to in various ways that will now occur to those skilled in the art. In other embodiments, the feature map generated at block 225a can be in a machine-readable format other than a graphical format, such as text. In such embodiments, the transmission at block 230a can include transmission to an experimental apparatus (not shown) configured to mutate selected areas of a genomic sequence based on the feature map. In other embodiments, the output of methods 200 and 200a can be provided to an experimental apparatus or system which manufactures, tests or otherwise evaluates compounds for treating various diseases. For example, the experimental apparatus or system can be configured to produce a compound which targets a certain region of a sequence in or derived from an individual's genome. The output of the above methods can therefore be provided to the apparatus or system as feedback data describing the predicted effects of the compound on the isoforms produced in the individual. Still other applications of the results of blocks 225 and 225a will now occur to those skilled in the art. As a further example, predictions as to the susceptibility of an individual to a disease can be generated based on the results of block 225 or 225a.

It is contemplated that the performances of methods 200 and 200a can be combined in some embodiments. For example, the performance of block 225a can be combined with the performance of block 225, such that both predictions and a predicted feature map are generated for transmission to computing device 112. As a further example, in some embodiments predictions can be generated as in block 225, and if the predictions meet a predetermined confidence threshold (that is, if the probabilities generated at block 220 are high enough) then processor 116 can also generate a feature map.

It is also contemplated that the outputs of methods 200 and 200a need not be constrained to predictions and feature maps as discussed above. More generally, processor 116 can be configured to generate one or more of a numerical value and a graphical depiction. In the embodiments discussed above, the numerical value comprises the predictions generated at block 225, while the graphical depiction comprises the feature map generated at block 225a. An example of output generated at block 225 or 225a is one or more histograms representing sites in a given sequence at which proteins (such as splicing factors) are likely to bind. Other examples of numerical values and graphical depictions generated by processor 116 will now also occur to those skilled in the art.

Turning now to FIG. 3, a more detailed discussion of the performance of block 205 of method 200 will be provided. FIG. 3 depicts a method of performing block 205 (i.e. storing the splicing code data), according to a non-limiting embodiment. The performance of the blocks of FIG. 3 is carried out by processor 116 via execution of application 144. It is contemplated, however, that certain portions of the method of FIG. 3 can be performed via execution of separate applications, including separate applications at different computing devices.

Beginning at block 305, processor 116 is configured to store expression data 152 (as shown in FIG. 1) relating to a plurality of exons. Expression data 152 can be received prior to storage, for example from another computing device or in the form of input data from keyboard 136 and mouse 132. In general, expression data 152 comprises experimental data describing levels of inclusion of each of the plurality of exons in each of a plurality of samples. In some embodiments, expression data 152 can include, for each of a plurality of short sequences, an experimentally-obtained count of the number of reads of the short sequence detected in one or more samples of tissue (for example, a count can be obtained for samples of cerebellum tissue, samples of liver tissue and the like). In other embodiments, expression data 152 can include a processed form of such experimental data according to any suitable method that will now occur to those skilled in the art.

For example, in some embodiments the above counts can be processed such that expression data 152 is stored in the form of a matrix in which each row is associated with an exon and each column is associated with a sample or tissue. Thus, each cell of the matrix corresponds to a particular exon-sample pair. Each cell of the matrix holds an inclusion level, which indicates a fraction of transcripts from the sample of the pair in which the exon of the pair is included. Thus, an exon “EX 1” may have an inclusion level of 30% in sample “SAM1”. Exon EX 1 may have a difference inclusion level in a different sample “SAM 2”. The collection of inclusion values across the plurality of samples for a given exon is referred to as the exon's tissue profile. In other embodiments, the above counts, or any other suitable experimental data, can be processed such that expression data 152 includes data describing a statistical distribution of an inclusion level for each exon rather than a discrete percentage.

Expression data 152, in some embodiments, can also include data describing the abundance of the gene containing the exon or of the transcript which can include or exclude the exon (in other words, data describing the level of expression of the relevant genes or transcripts). The inclusion of such data in a second matrix, according to a non-limiting embodiment, is described in the “Introduction” section below. It will now be apparent to those skilled in the art that abundance data can be stored in a variety of formats in expression data 152.

Various types of expression data will now occur to those skilled in the art. Non-limiting examples of expression data 152 are discussed below in the sections Isoform Quantifications and RNA Features, Supplementary Information 1 (Extracting Splicing Patterns from mRNA Expression Data) and Model-based Detection of Alternative Splicing Signals.

Processor 116 is also configured to store other experimental data at block 305. Such experimental data is not particularly limited and can include a wide variety of data obtained from previous experiments relating to RNA features, exons (both present in expression data 152 and absent from expression data 152). Various uses of such experimental data will become apparent through the discussion herein.

The performance of block 205 continues at block 310, at which processor 116 is configured to generate, for each exon in the expression data, at least one splicing pattern comprising a probability for each of increased exon inclusion, increased exon exclusion, and no change in exon transcription in connection with at least one cellular condition, such as tissue type. In the present example embodiment, a plurality of splicing patterns are generated, one for each of the above-mentioned tissue types. As mentioned earlier, other cellular conditions than the four tissue types discussed herein can be used. Each splicing pattern comprises a set of probabilities, including one probability each for increased inclusion of the exon, increased exclusion of the exon, and no change in inclusion of the exon in resulting transcripts. A detailed discussion of selected ways of generating splicing patterns according to non-limiting embodiments is provided below in the sections Extracting Splicing Patterns from mRNA Expression Data, as well as Model-based Detection of Alternative Splicing Signals and Supplementary Materials. In the sections referred to above, generating splicing patterns comprises determining a plurality of alternative splicing (AS) signals—for example, one signal for each condition and an condition-independent signal—and assigning the signals to the exons in expression data 152 in a three-way multinomial distribution. It will now be apparent to those skilled in the art that various modifications can be made to the above-referenced ways of generating splicing patterns.

The generation of splicing patterns at block 310 can be influenced to varying degrees by way of input data received at processor 116 from, for example, keyboard 136 and mouse 132. For example, in some embodiments processor 116 can receive input data specifying a fixed number of conditions for which to generate splicing patterns. In other embodiments, such data can be omitted and processor 116 can be configured to vary the number of splicing patterns generated and to select the set of splicing patterns which best matches the observed inclusion levels in expression date 152.

The performance of block 205 as shown in FIG. 3 then proceeds to block 315. At this point, it is noted that blocks 305 and 310 can be performed by a computing device other than server 104 in some embodiments, and the results (i.e. the splicing patterns) can be transmitted to server 104 for processing according to blocks 315-330. In other embodiments, server 104 can perform blocks 305 and 310 and transmit the results to a different computing device for further processing.

At block 315, processor 116 is configured to select at least one feature from feature compendium 154 (shown in FIG. 1). Feature compendium 154, and selected ways to build the feature compendium according to non-limiting embodiments, is described below in the sections Selection of Regulatory Features and Supplementary Information 2 (Compendium of Putative Regulatory Features). Additional ways of building feature compendium 154 will now occur to those skilled in the art. In general, the features contained in feature compendium 154 can be assembled from previous experimental data. Such experimental data can be maintained in memory 120 as described above at block 305. Feature compendium 154 can also include features (referred to herein as “unbiased motifs”) in the sequences of the exons identified in expression data 152 which are potentially involved in splicing regulation but not present in previous experimental data. Unbiased motifs can also be maintained separately from feature compendium 154 in memory 120.

In some embodiments, the performance of block 315 can include the generation (i.e. building) of feature compendium 154 prior to the selection of features and adjustment of parameters. In building feature compendium 154, processor 116 is configured to receive input data identifying features derived from previous experimental data, or to search the previous experimental data for features, or both. Processor 116 can also be configured to search expression data 152 for features which occur among various exons in connection with splicing changes in certain conditions. For example, this unbiased motif search may select a feature for the compendium if the feature occurs with a certain frequency in exons which all show increased levels of inclusion in digestive tissue. Other examples will also occur to those skilled in the art. Exemplary non-limiting embodiments of the unbiased search are discussed below in the section, “De Novo Search: The Unbiased Motif Set”.

At block 315, processor 116 can also be configured to set parameters associated with selected features and relating to the generation of splicing code data 148. Such parameters can be received from, for example, keyboard 136, or can be determined automatically, or a combination thereof. It is contemplated that the performance of block 315 can involve at least one of feature selection and parameter adjustment, but need not involve both. For example, in a particular performance of block 315, a weight parameter indicating the magnitude of a feature's effect on alternative splicing under a certain condition can be adjusted, but additional features may not be selected.

Proceeding to block 320, processor 116 is configured to determine a code quality based on the selected features and parameters from block 315. In general, the code quality is an indication of how closely a prediction generated based on the features and parameters from block 315 matches the actual splicing patterns generated at block 310 from experimental expression data. In other words, the code quality indicates how much of the splicing activity shown in the expression data can be explained by examining only the features and parameters from block 315. If the code quality is high, then the selected features and parameters can be used as splicing code data to generate accurate predictions (as described in method 200) for exons in the expression data as well as exons not described in the expression data. If the code quality is low, then the selected features and parameters, if used as splicing code data to generate predictions, do not result in accurate predictions. A detailed discussion of certain ways of measuring code quality according to non-limiting embodiments is provided below in the sections Assembling a High-Information Code and Supplementary Information 4 (Inferring the Regulatory Code).

At block 325, processor 116 is configured to determine whether to continue optimizing code quality. In general, blocks 315-325 can be performed iteratively to generate splicing code data 148. The nature of the determination at block 325 is therefore no particularly limited. In some embodiments, block 325 can involve a determination of whether a predetermined code quality has not yet been reached. The predetermined code quality can be specified in a variety of ways. For example, the predetermined code quality can be set as an absolute threshold. In other embodiments, the predetermined code quality can be set as an increase above a previous code quality. For example, once the increase over the immediately preceeding code quality is lower than a certain level, it can be assumed that the code quality is reaching a maximum. Combinations of these predetermined code quality measures can also be used. In other embodiments, blocks 315-325 can be repeated a specified number of times (such as five thousand times, or two hundred times, or any other suitable number of repetitions). In such cases, the determination at block 325 will be a determination of whether the specified number of iterations has not yet been completed.

When the determination at block 325 is affirmative, processor 116 is configured to repeat the performances of blocks 315-325 until a negative determination is reached. Thus, the selected features can grow in number and the parameters can be adjusted with repeated performances of blocks 315-325.

When the determination at block 325 is affirmative (i.e. when the features selected and adjusted parameters obtained through multiple performances of block 315 are sufficient to explain a certain level of splicing activity in expression data 152) processor 116 is configured to store the adjusted parameters and the selected features in memory 120 as splicing code data 148. A detailed discussion of the above repetition and storage of resulting splicing code data, according to an exemplary non-limiting embodiment, is provided in Supplementary Information 4.

In some embodiments, a plurality of versions of splicing code data 148 can be generated by performing blocks 315-325 (repeatedly, when necessary) and block 330 for different sets of expression data. For example, expression data 152 can be divided randomly into multiple subsets of expression data (not shown). Each subset can then be used, according to the method of FIG. 3, to generate splicing code data.

Following the generation of multiple sets of splicing code data, processor 116 can be configured to determine, for each selected feature from among the totality of features selected across all sets of splicing code data, the fraction of the sets of splicing code data in which the selected feature is present. That is, processor 116 can be configured to determine how frequently a particular feature was selected across the multiple splicing codes. When the determined frequency exceeds a predetermined threshold, processor 116 can be configured to store the feature in a set of splicing code data termed the “robust splicing code” or “robust regulatory code”. When the determined frequency does not exceed the predetermined threshold, processor 116 can be configured to discard the selected feature, such that it will not be identified in the robust splicing code data. The robust splicing code data can be stored in memory 120 as splicing code data 148, to be used in responding to requests 156. The extraction of such a robust splicing code, according to an exemplary, non-limiting embodiment, is discussed below in Supplementary Information 4.2 (“Extracting the Robust Regulatory Code”).

Returning briefly to FIG. 2, it is contemplated that multiple performances of method 200 can therefore be based on a single performance of block 205 as discussed above. That is, each request need not be responded to be generating new splicing code data. Additionally, in some embodiments “online learning” can be employed, in which some or all of the method shown in FIG. 3 can be conducted with each new request, such that splicing code data 148 is successively refined with each request 156.

In the sections below, additional discussion of selected non-limiting embodiments of the above systems, methods and apparatus will be provided. In particular, we describe a method for inferring a splicing regulatory code that addresses the challenges noted in the Background (see FIG. 1). We evaluate the code using a variety of criteria, describe and verify predictions made by the code, and demonstrate the usefulness of the code in scientific exploration.

Various references are referred to in the text below. Where not indicated by name, references are identified as “reference x”, where x is a number identifying the reference. All references are listed before the claims, and are incorporated herein by reference.

### Deciphering the Splicing Code

Isoform quantification and RNA features

Generation of Splicing Patterns

Our method takes as an input a collection of exons and surrounding intron sequences and data profiling how those exons are spliced in different tissues. The method assembles a code that can predict how a transcript will be spliced in different tissues.

We used data profiling 3,665 cassette-type alternative exons across 27 diverse mouse tissues, including whole-embryo stages and a variety of adult tissues (reference 10). For each exon and each tissue, this data set provides a percentage inclusion value, which is an estimate of the fraction of transcripts that include the exon (reference 11). Tissues were grouped to form four tissue types: central nervous system (CNS) tissues, muscle tissues, digestive system tissues, and whole embryos, with embryonic stem cells added to the latter group (see Supplementary Information 1 and FIG. 4). To correct for tissue-independent baseline exon inclusion levels and measurement noise, we converted the percentage inclusion value for each data point (exon and tissue type) to three probabilities, q^{inc}, q^{exc} and q^{nc}, of increased exon inclusion (‘inc’), increased exon exclusion, that is, skipping (‘exc’), and no change (‘nc’). q denotes the set of three probabilities and we refer to it as a ‘splicing pattern’. Of all exons exhibiting a high probability of increased inclusion (q^{inc}≧0.99) or exclusion (q^{exc}≧0.99), 51%, 23%, 32% and 25% showed changes in CNS, muscle, embryonic and digestive tissues, respectively, whereas 24% were regulated in more than one tissue type.

Selection of Regulatory Features

Code assembly requires a set of relevant features derived from exonic and intronic sequences. We constructed a compendium of 1,014 features of four types: known motifs, new motifs, short motifs and features describing transcript structure (see below, as well as Supplementary Information 2). Motif features correspond to consensus sequences, sequence clusters, or position-specific score matrices, and may be associated with specific RNA regions (see FIG. 4, part A).

A literature survey yielded 171 known motifs' found near tissue-regulated exons (references 10, 12-14) or associated with splicing factor binding preferences, including [U]GCAUG (bound by A 2bp1 and A2bp2, referred to here as Fox proteins (references 15, 16)), YCAY clusters (bound by Nova1 and Nova2, referred to as Nova (references 17, 18), CU-rich sequences (bound by Ptbp1 and its neuronal variant Ptbp2, referred to as PTB and nPTB (references 19, 20)), YGCUYK-like CUG- and UG-rich sequences (bound by Mbnl, Cugbp and related CELF-like factors (reference 21)), ACUAAY (bound by Quaking-like Qk and Star 22 factors, later referred to as Qkl), U-rich sequences (bound by Tia1 and Tial1, later referred to as Tia1/Tiar), and elements associated with serine/arginine-rich (SR) and heterogenous nuclear ribonucleoprotein factors. As interspecies conservation of intronic sequences is associated with alternative splicing (references 1, 12, 23), we included interval-averaged conservation levels as features and also region-specific motif scores weighted by conservation. Note that although a motif may be known, its regulatory activity in the context of other features is usually not.

The compendium includes 326 ‘new motifs’ that have weak or no known evidence for roles in tissue-dependent splicing, including 12 clusters of validated or putative exonic and intronic splicing enhancers (ESEs and ISEs) and silencers (ESSs and ISSs), which are 6-8 nucleotides long and were identified without regard to possible tissue-dependent roles (references 24-26), and 314 5-7-nucleotide-long motifs that are conserved in intronic sequences neighbouring alternative exons (reference 27). There are also 460 region-specific counts of 1-3-nucleotide ‘short motifs’, because such features were previously associated with alternative splicing (reference 28). We included 57 ‘transcript structure’ features implicated in determining spliced transcript levels, such as exon/intron lengths, regional probabilities of secondary structures (reference 29), and whether exon inclusion/exclusion introduces a premature termination codon (PTC).

In addition to the feature compendium, we constructed a set of, 1,800 ‘unbiased motifs’ by performing a de novo search (reference 10) for each tissue type and direction of splicing change (Supplementary Information 3). Later, we report results obtained with and without using these features.

### Assembling a High-Information Code

Our method seeks a code that is able to predict the splicing patterns of all exons as accurately as possible, based solely on the tissue type and proximal RNA features. The putative features for a particular exon are appended to make a feature vector r, and the corresponding prediction in tissue type c is denoted p(c,r). Like q, p(c,r) consists of probabilities of increased inclusion or exclusion, or no change. The code is combinatorial and accounts for how features cooperate or compete in a given tissue type, by specifying a subset of important features, thresholds on feature values and softmax parameters 30 relating active feature combinations to the prediction p(c,r) (Supplementary Information 4).

We use a measure of ‘code quality’ that is based on information theory (reference 31) (see Methods Summary). It can be viewed as the amount of information about genome-wide tissue-dependent splicing accounted for by the code. A code quality of zero indicates that the predictions are no better than guessing, whereas a higher code quality indicates improved prediction capability.

To assemble a code, our method recursively selects features from the compendium, while optimizing their thresholds and softmax parameters to maximize code quality (Supplementary Information 5). The code quality increased monotonically during assembly, but diminished gains were observed after 200 features were included (see FIG. 4, parts B, C, based on fivefold cross-validation). The final assembled code contained approximately 200 features. When a code was assembled using the compendium plus the unbiased motifs, the increase in code quality did not exceed 1 standard deviation (s.d.) in error (data not shown), but, interestingly, some of the unbiased motifs that did not correspond to any corn pendium features were selected and subsequently experimentally verified, as discussed in later sections.

To quantify the contributions of its different components, we compared our final assembled code to partial codes whose only inputs were the tissue type, previously described motifs, conservation levels, or the compendium with transcript structure features or conservation levels removed (see FIG. 4, part D).

### Predicting Alternative Splicing

On the task of distinguishing alternatively spliced exons from constitutively spliced exons, our method achieves a true positive rate of more than 60% at a false positive rate of 1% (Supplementary Information 6). To address the more difficult challenge of predicting tissue-dependent regulation, we applied the code to various sets of unique test exons (exons not similar to those used during code assembly) and verified the predictions using microarray data, polymerase chain reaction with reverse transcription (RT-PCR) and focused studies (as discussed below and in Supplementary Information 5).

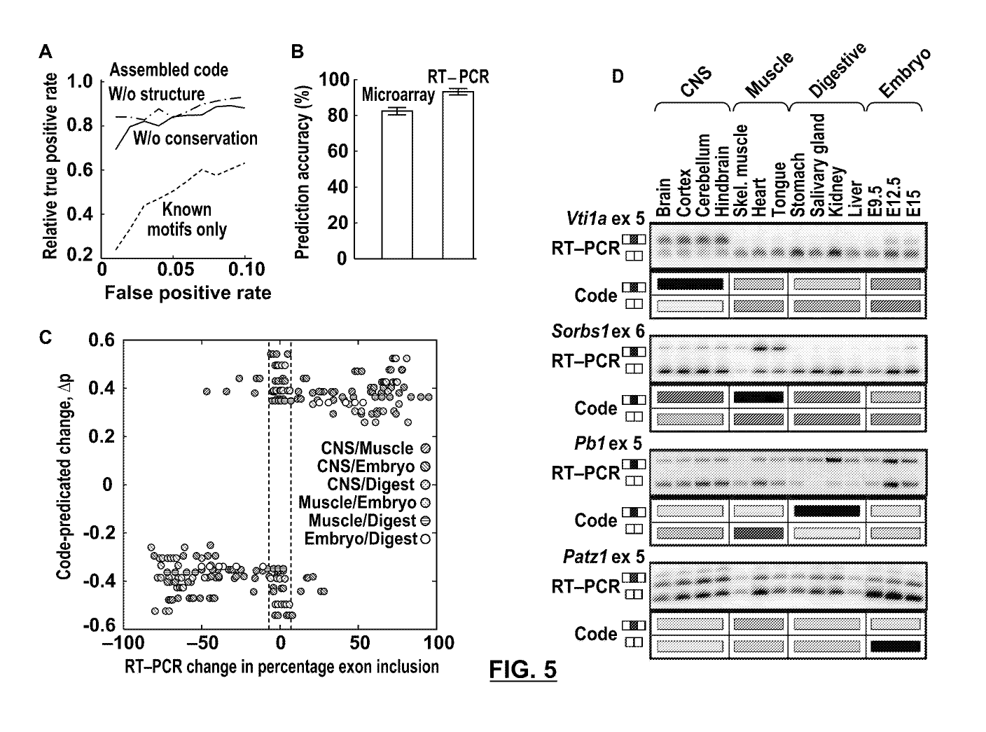

We first asked whether the theoretical ranking of the different codes shown in FIG. 4, part D corresponds well to their relative abilities to predict microarray-assessed tissue-dependent regulation (see Methods Summary). Indeed, the final assembled code achieved significantly higher accuracy than the partial codes (see FIG. 5, part A). For exons in genes with median expression in the top 20th percentile, at a false positive rate of 1%, a true positive rate of 21% was achieved, and this rose to 51% for a false positive rate of 10%.

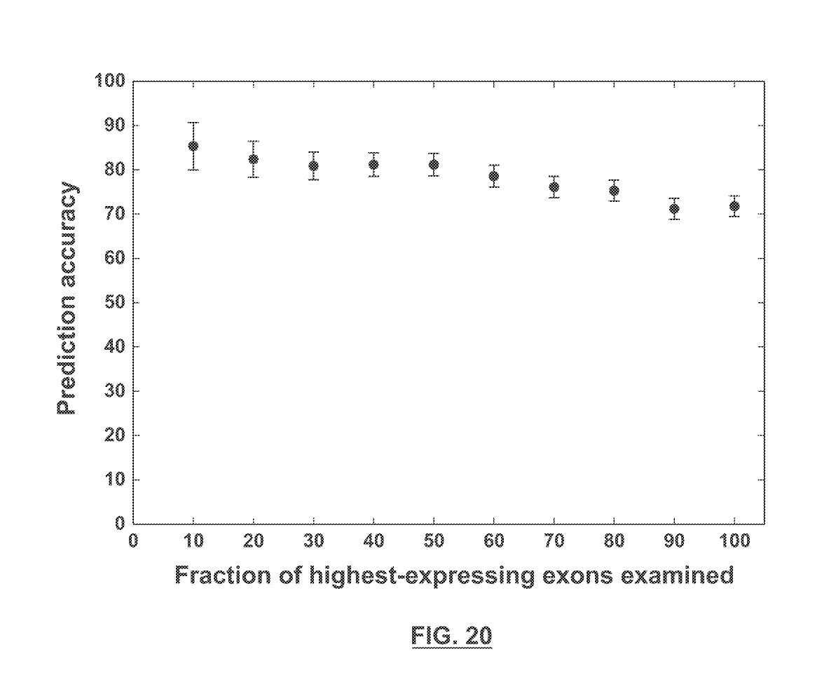

We next asked how well the splicing code predicts significant differences in the percentage exon inclusion between pairs of tissues, for cases where the predicted difference is large (see FIG. 5, part B and FIG. 20). For microarray data, the splicing code correctly predicted the direction of change (positive or negative) in 82.4% of cases (P<1×10 ⁻³⁰, Binomial test; see Methods Summary). For RT-PCR evaluation, 14 exons that the splicing code predicted would exhibit significant tissue-dependent splicing were profiled in 14 diverse tissues. The splicing code correctly predicted the direction of change in 93.3% of cases (P<1×10⁻¹⁰, Binomial test). A scatter-plot comparing predictions and measurements (see FIG. 5, part C) illustrates that the code is able to predict an exon's direction of regulation better than its percentage inclusion level. FIG. 5, part D shows RT-PCR data and predictions for four representative exons.

To assess whether the code recapitulates results from experimental studies of individual exons and tissue-specific splicing factors, we surveyed 97 CNS- and/or muscle-regulated exons targeted by Nova, Fox, PTB, nPTB and/or unknown factors (references 18, 19, 32-39). For each test exon, we extracted its features, applied the code and examined whether or not it correctly predicts splicing patterns in CNS or muscle tissues (Supplementary Table 3). The code's predictions were correct for 74% of the combined set of 97 exons (P<1×10⁻⁴¹, Bernoulli test), 65% of the Nova targets (P<1×10⁻²⁰), 95% of the Fox targets (P<1×10⁻¹⁵) and 91% of the PTB/nPTB targets (P<1×10⁻⁸).

To our knowledge, this is the first time tissue-dependent splicing changes have been predicted from sequence information alone and the prediction accuracy has been quantitatively evaluated.

### Interpretation of the Splicing Code

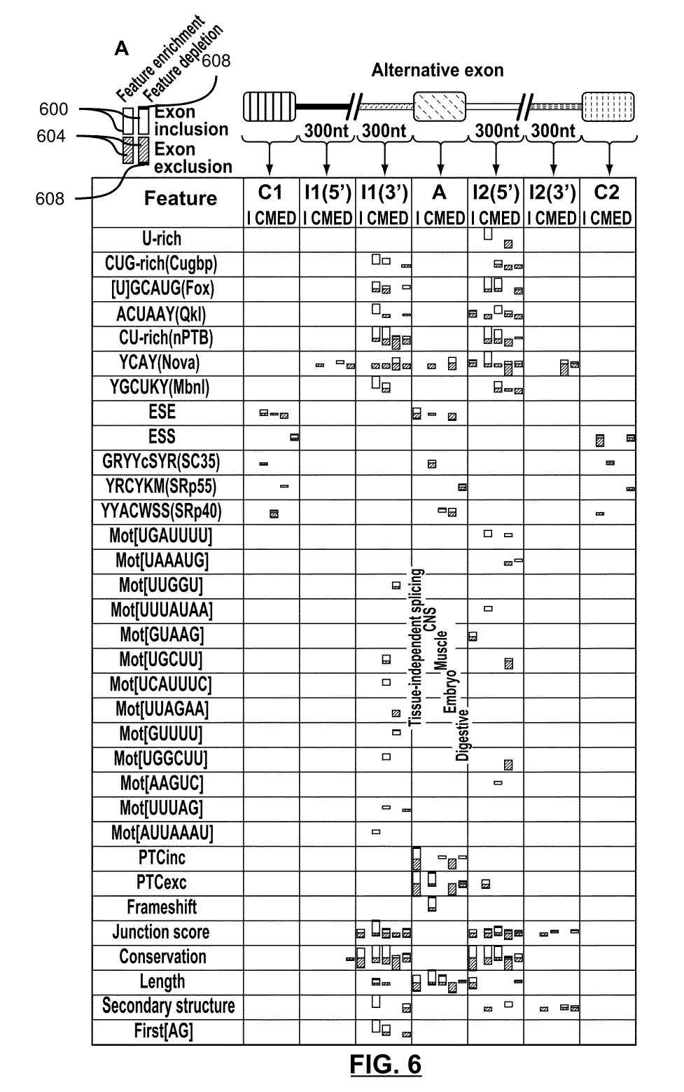

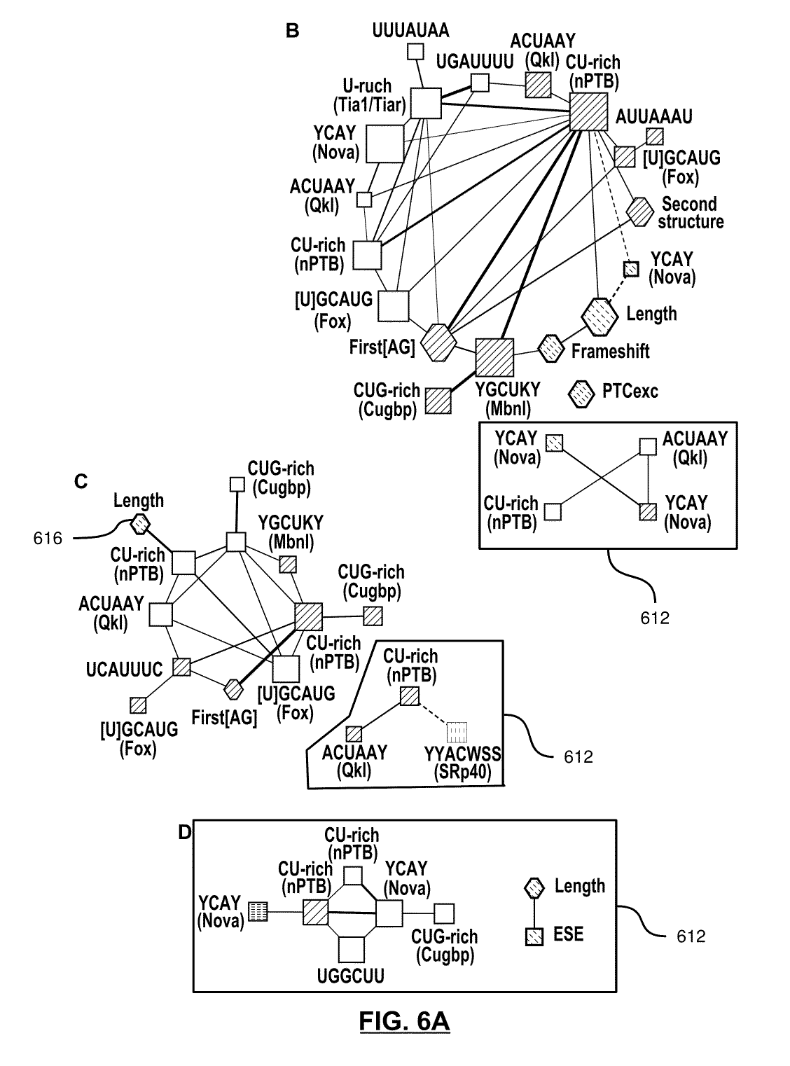

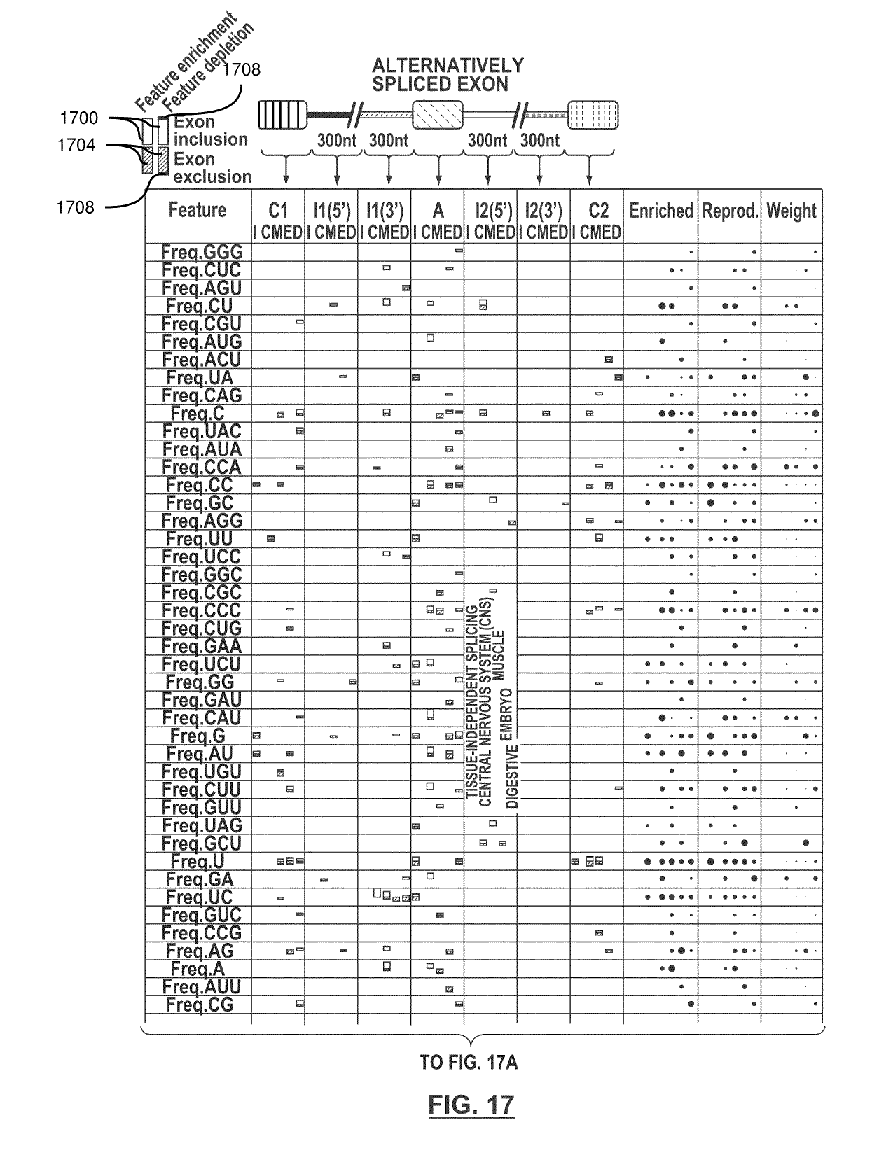

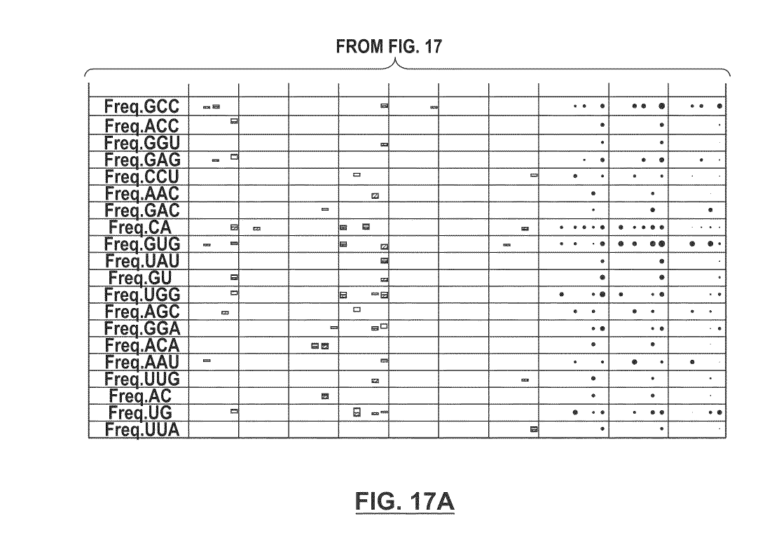

FIG. 6, part A shows components of the code that have strongest regulatory evidence (also see Supplementary Information 7-9). The consensus sequences for motif features are accompanied (in parentheses) by names of potential binding proteins, but it should be kept in mind that a different or unknown factor could bind instead. The direction of a feature's regulatory activity (increased inclusion or exclusion) is indicated by white bars 600 or shaded bars 604 respectively, and if a feature has an effect in both directions (for example, because it works in combination with another factor) both types of bar are shown. Short motifs are not included, but are shown in FIGS. 17 and 17A.

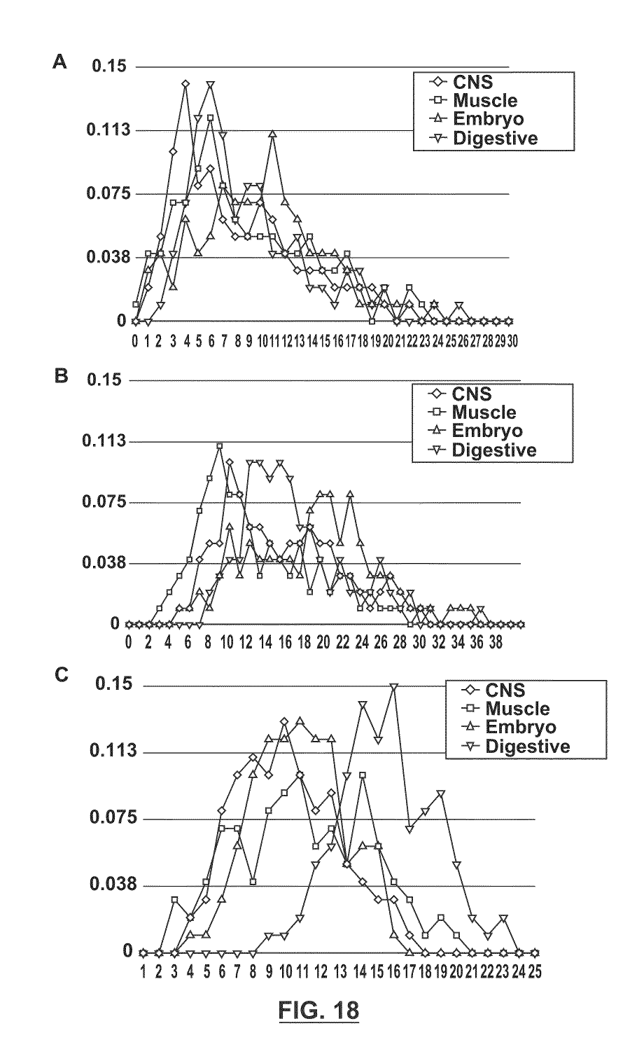

The complexity of the code is reflected by the number of tissue-specific features per exon, the median of which varies from 12 (CNS) to 19 (embryo) when excluding short motifs (FIG. 18). The code reveals tissue-specific combinations of features that are potentially synergistic (the number of features must exceed a threshold for regulation) or antagonistic (the direction of the regulatory effects of two features is opposite). Other features are associated with several tissues or are predicted to act in a tissue-independent manner. Many aspects of the code compare well with known results, whereas others are new, and others challenge known results, as explained later.

Position- and tissue-specific effects of elements that match the known binding motifs for Fox, Nova, Mbnl, Cugbp, Tia1/Tiar, PTB, nPTB and Qkl proteins are mostly consistent with previous results, but interesting differences arise. The code predicts regulatory elements that are deeper into introns than previously appreciated; PTB/nPTB-like CU-rich elements were found to often reside 250 to 300 nucleotides upstream of CNS-regulated exons, which is considerably farther than previously reported (references 10, 14) (see FIG. 7 and below). Mbnl sites were found mostly in upstream introns of exons upregulated in CNS, but were also found in the downstream introns of muscle-regulated exons. Consistent with previous computational analyses (reference 17) and in vivo cross-linking and immunoprecipitation (CLIP) assays (reference 18), in adult CNS tissues, Nova elements in upstream introns and alternative exons were associated with exon exclusion, whereas elements in the 5′ region of downstream in trons were primarily associated with exon inclusion. However, contrasting effects were observed in embryonic tissues (see FIG. 6), where Nova elements in the 5′ region of downstream introns were primarily associated with exon exclusion. Although the position of the first AG upstream of the alternative exon was previously associated with alternative splicing (reference 40), our code associates it with tissue-specific (predominantly CNS) regulation. The motif ACUAAC was previously associated with Qkl factors and reported as enriched downstream of exons upregulated in muscle (references 1, 13). Our code identifies this feature, but also predicts that its presence in the upstream intron regulates CNS-specific splicing, which is consistent with studies implicating its trans-factor as a regulator in human brain tissue (reference 41).

To determine interactions between regulatory features, we identified pairs of features that are unexpectedly frequent in the code and generate d feature interaction networks (see FIG. 6A and Supplementary Information 8). Although some combinations arise primarily from feature similarity (for example, Mbnl and Cugbp binding sites), others correspond to bona fide mechanisms, some of which have been verified. FIG. 6A, part B shows that nPTB, Mbnl and Cugbp binding sites jointly occur in the 3′ region of introns upstream of exons upregulated in CNS tissues; later, this interaction is examined using mutated minigene reporters. The combination of nPTB binding sites in upstream introns, nPTB binding sites in downstream introns, and short alternative exons shows the general utility of a previously proposed mechanism in which PTB facilitates RNA looping resulting in exon exclusion (reference 42). Our code indicates that this mechanism may be disabled in CNS tissues, causing increased exon inclusion.

The code shows that combinations of several features act more frequently than previously appreciated. In a few isolated cases, short exons, weak splice sites and low ESE counts were previously found to result in an ‘exclusion by default’ mechanism that can be reversed by other features (reference 9). As seen in FIGS. 6 and 6A, short exons, weak 3′ splice sites and low ESE counts are frequently associated with CNS-specific exon inclusion. Over six times more CNS-regulated exons have low values (lowest 20th percentile) for these features than non-CNS-regulated exons (P<1×10⁻⁸, Binomial test). The code also reveals elements near flanking exons (for example, ESEs and ESSs) that participate in regulation.

Transcript structure features were found to have strong effects in the code, with interesting and potentially important biological implications. For example, the code predicts a class of exons that insert a PTC after inclusion in transcripts and that are skipped in embryonic tissues but included in adult tissues. Later, we describe experiments indicating that these exons have an important role in the regulation of developmental stage-specific gene expression.

### Predicting Regulatory Feature Maps

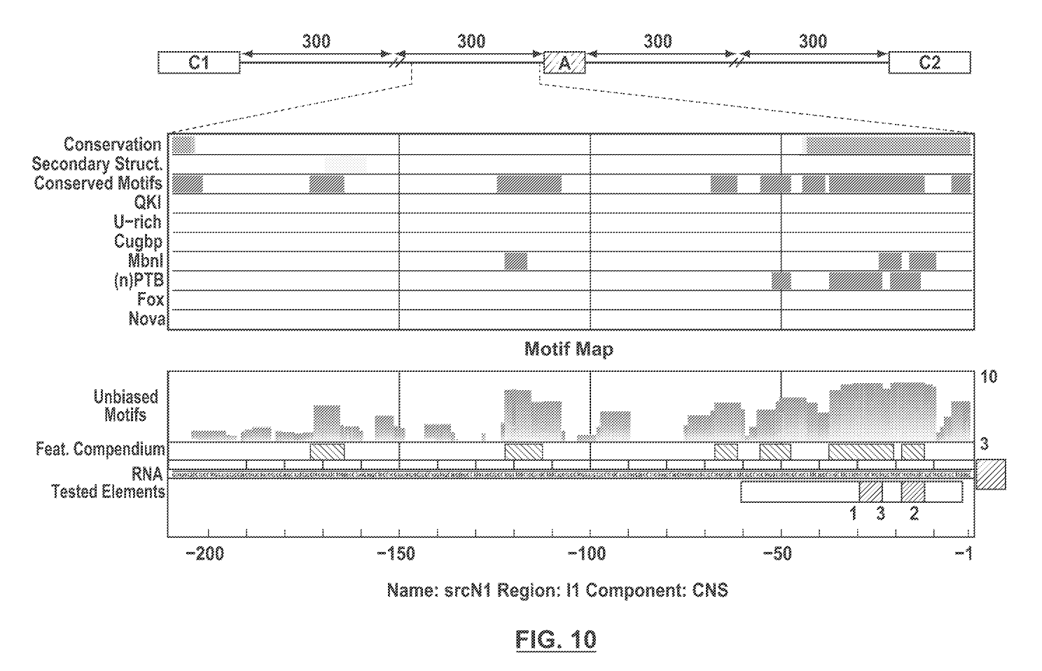

By flagging regulatory elements in RNA sequences surrounding an alternative exon, the splicing code yields a visual feature map that partially accounts for how the exon is regulated. Predicted feature maps were initially evaluated by their overlap with 376 nucleotides of RNA sequence analysed by mutagenesis in more than 60 splicing reporter constructs from Agrn (reference 33), Src (references 19, 43), Casp2 (reference 35) and the Slo K⁺ STREX exon (reference 44). Our feature maps (FIGS. 10-15 and Supplementary Information 10) achieve an overlap of 90% with a statistical significance of P<0.002 (empirical, using maps from unrelated exons). In contrast, feature maps constructed using only known motifs achieve an overlap of 38% (P=0.004) and maps derived solely from conservation information (reference 27) achieve poor specificity (P=0.27).

Code-generated feature maps can be used to guide focused mechanistic studies. We examined exon 16 of the Daam1 gene, which our code ranked among the top 0.3% for CNS-specific increased inclusion. It was recently shown (reference 39) that this exon is specifically included in CNS tissues, but the precise locations of elements that mediate neural-specific splicing of the exon were not determined. In our code, most features were found within 300 nucleotides of upstream intron sequence and the corresponding feature map (blocks 704 and 708 in FIG. 7, part A) yields the following new predictions: an unusually high density of regulatory elements (only 7.8% of other exons in our data set had as high a density); novel motifs GGAGC (215-219 nucleotides) and CUGGC (159-163 nucleotides); three well-separated regions (72-78, 106-124 and 267-280 nucleotides) that resemble nPTB binding elements, but do not score well using known motif definitions for this protein (references 19, 42, 45); and predicted inactivity of several features derived only from conservation (reference 27) (137-142, 146-150 and 284-290 nucleotides).

We tested the code-generated feature map by performing extensive mutagenesis using a Daam1 exon 16 precursor mRNA reporter (reference 39) that faithfully recapitulates endogenous splicing patterns. Fifteen mutant minigene reporters were constructed by replacing segments comprising a total of 150 nucleotides of intron sequence with random sequences pre-filtered to avoid introducing regulatory features (see FIG. 7, part A, shaded blocks 712, Supplementary Information 12 and Supplementary Table 5). Semi-quantitative RT-PCR assays were used to estimate the percentage inclusion of exon 16 in transcripts from the wild-type and mutant reporters, after their transfection into mouse neuroblastoma (N2A) cells and non-neural fibroblast (NIH-3T3) and myoblast (C2C12) cell lines (FIG. 7, part B and data not shown). Of the 15 mutants, 14 contain segments overlapping with predicted elements and indeed the percentage inclusion in N2A cells for all of these mutants was significantly different from wild type (P<0.005, normal test, s.d. of 0.8% estimated from three transfections; Supplementary Information 12). Mutant 7 was designed to test a region predicted to have no regulatory role and, indeed, its percentage inclusion is within 1 s.d. of the wild-type value. Although the code could not confidently predict the direction of percentage inclusion change, it predicted that all mutants would have higher exon inclusion in CNS tissues relative to other tissues, and this prediction was confirmed for 14 out of 15 mutants by comparison of the results from the N2A and NIH3T3 cell lines (see FIG. 7, part B and Supplementary Information 12).

Disruption of the two new motifs in mutants 3 and 6 resulted in changes in inclusion levels (P<1×10⁻¹⁰⁰, normal test). Mutants 1, 8 and 10 disrupted the three new CU-rich nPTB-like motifs and showed increased exon inclusion (P<1×10⁻¹⁰⁰). In vivo mouse whole brain CLIP and high-throughput sequencing indicates that nPTB indeed binds sequences overlapping these CU-rich elements. Mutants 2 and 5 disrupted elements that correspond to previously defined nPTB motifs (references 19, 42, 45). As expected, these mutants showed increased exon inclusion (P<1×10⁻¹⁰⁰), but to a lesser extent than for the new CU-rich elements. The code used conservation to predict and reject functional elements. Mutant 10 disrupted an element that the code identified using conservation plus CU-richness (72-78 nucleotides), and confirmed that this element is functional (see earlier). In contrast, mutant 7 disrupted a region that overlapped two conserved elements, but which the code predicted would not be functional. Indeed, no significant change in the percentage inclusion was observed.

According to the code, the number of nPTB motifs must exceed a threshold before CNS regulation occurs. To investigate interactions be tween nPTB motifs (disrupted by mutants 1, 2, 5, 8 and 10), in FIG. 7, part C we plot the percentage inclusion for these mutants, a combination mutant (segments 1, 2, 5 and 8), and wild type. Although the presence of four nPTB motifs slightly suppresses inclusion compared to only one, greater suppression occurs with five nPTB motifs, indicating a synergistic interaction. The code also predicted that CUG-rich Cugbp/Mbnl-like elements close to the nPTB element in mutant 10 would enhance inclusion. To explore combinations of these elements, we counted the number of nPTB-like CU elements and the number of Cugbp/Mbnl-like CUG elements from 55 to 90 nucleotides, and repeated this procedure for mutants 9, 10 and 11, a combination of mutants 9 and 11 (labelled 9, 11), and a mutant (labelled 9-10-11) that disrupted all elements in this region, including the CUG motif between regions 10 and 11. Consistent with the code, these elements were found to interact antagonistically (FIG. 7, part D).

### Alternative Splicing-Controlled Gene Expression

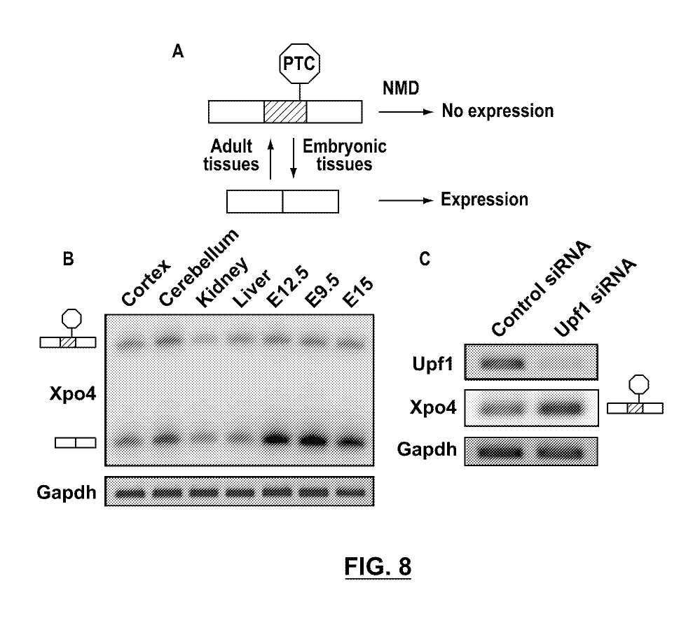

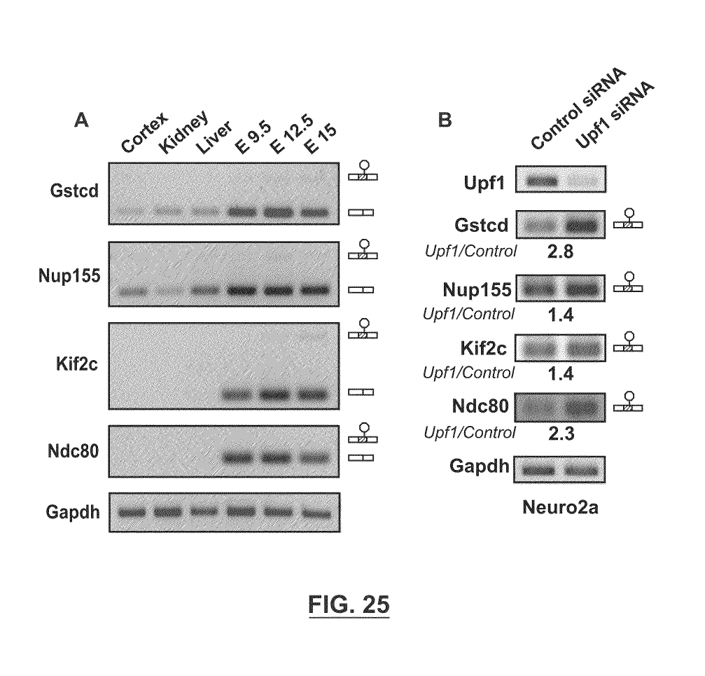

The code revealed a mechanism underlying the regulation of specific genes during development, whereby a class of alternative exons that introduce a PTC and activate nonsense-mediated mRNA decay (NMD) are included in adult tissues to suppress mRNA expression, but are skipped in embryonic tissues to activate mRNA expression (FIG. 8, part A). Supporting this predicted mechanism, microarray data indicated that 30 out of 38 genes with exons in the above class have higher (P<0.05, t-test) mRNA expression levels in embryonic tissues compared to adult tissues. Several high-scoring predictions were confirmed by RT-PCR assays as having low or non-detectable levels of PTC-containing isoforms in the profiled tissues, and relatively abundant levels of the exon-skipped isoforms in embryonic tissues (FIG. 8, part B and FIG. 25, part A). To confirm the role of NMD in mRNA regulation, a short interfering RNA (siRNA) pool capable of knocking down the essential NMD factor Upf1 was transfected into N2A cells and changes in splice isoform levels were monitored by RT-PCR assays. Knockdown of Upf1 resulted in increased levels of the PTC-containing isoforms in five out of six examples with detectable expression of these isoforms in N2A cells (FIG. 8, part C and FIG. 25, part B).

Genes containing the developmentally regulated PTC-introducing exons identified by the splicing code include those with previously described roles in development and disease. Exportin 4 (Xpo4, also known as Exp4) is a particularly interesting example (FIG. 8, parts B and C). It is a nuclear export receptor for the translation initiation factor eIF5A (reference 46), and a nuclear import receptor for SRY-related HMG-box (Sox) family transcription factors (reference 47), which have key roles in regulating embryonic development, and are required for the maintenance of stem cell pluripotency (reference 48). Notably, elF5A is amplified in certain cancers and a recent oncogenomics-based RNA interference screen further identified human Xpo4 as being required for the proliferation of Xpo4-deficient tumours (reference 49). These findings support the conclusion that Xpo4 expression must be tightly controlled such that it is active during embryogenesis but downregulated in adult tissues, to avoid possible deleterious consequences including oncogenesis.

### Discussion

The method we used to infer a splicing code produced a testable map for how RNA features work together to regulate tissue-dependent alternative splicing. The utility of the code is supported by evaluation of its ability to predict splicing patterns for previously unanalysed exons in major tissue types, including CNS, muscle, embryo and digestive tissues; recapitulation of results from previous studies of muscle- and brain-dependent splicing including targets of Nova, Fox and PTB/nPTB; evaluation of RNA segments predicted to have regulatory function; an automatically generated, interpretable, graphical depiction of the code; and discovery of a class of exons whose alternative splicing regulates gene expression differently in adult and embryonic tissues, by introducing PTCs. Unlike high-throughput sequencing and microarray profiling, our code can successfully predict tissue-regulation of exons independently of transcript expression levels (Supplementary Information 11).

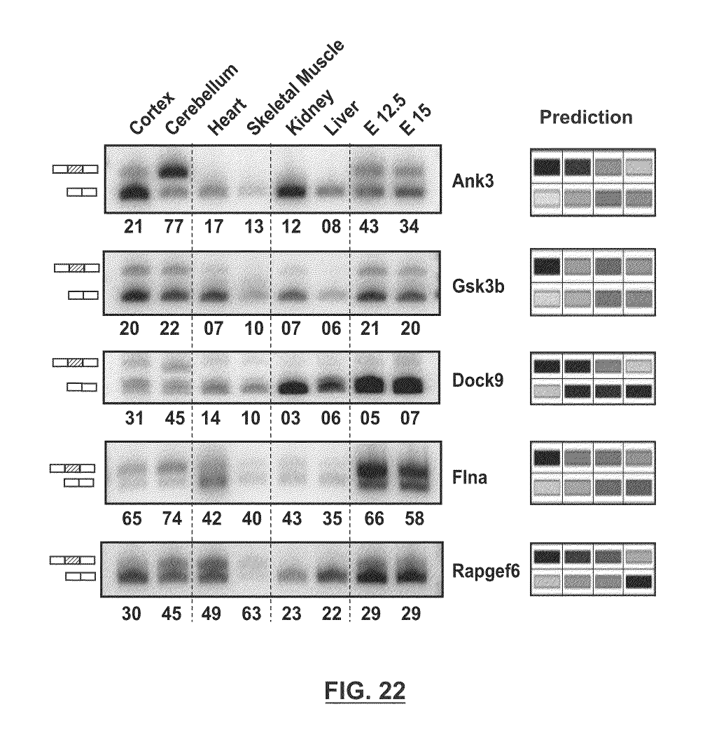

To facilitate future research, we developed a web tool (accessible at http://genes.toronto.edu/wasp), which can be used to explore new regulatory elements and how these elements work in combination to shape the transcriptional landscape. The tool can scan previously uncharacterized exons, predict tissue-dependent splicing patterns, and produce downloadable exploratory feature maps linked to the UCSC Genome Browser. Users can also download data sets comprising the feature vectors and prediction targets described earlier. As an example of the tool's utility, we wanted to explore exons that might be involved in human neurological disorders, so we used the code to predict previously uncharacterized CNS-regulated exons in widely expressed genes associated with Parkinson's disease, Alzheimer's disease, and several other disorders (Supplementary Information 11, Supplementary Table 4 and FIG. 22). In many cases, the newly identified CNS-regulated exons are predicted to affect critical protein domains and one of the exons overlaps patient genomic deletions linked to neurological disease.

A unique aspect of our approach is that it searches for a regulatory code that maximizes a quantifiable measure of code quality, so as to jointly account for many features and produce a predictive splicing code. Interesting future directions include incorporating in vivo CLIP data (reference 18), high-throughput in vitro protein-RNA binding data (reference 50), further splicing profiling (for example, RNA-Seq) data, and different learning algorithms.

It is apparent from examining the splicing code deciphered in the present study that large numbers of sequence features are generally required to achieve tissue-regulated splicing. We anticipate that the splicing code described here will be useful in future studies directed at understanding the mechanisms by which these elements and transacting factors combine to regulate tissue-dependent splicing regulation, and how these mechanisms go awry in human diseases.

### Methods Summary

Code assembly: A splicing code is inferred such that the prediction p(cᵢ,rᵢ), based on the RNA feature vector rᵢ and tissue type cᵢ (where i=1, . . . , 14,460 indexes exon-tissue type data points), is as close to the measured splicing pattern qᵢ as possible, for all data points. To achieve this, we introduce an information theoretic (reference 31) measure of ‘code quality’:

$$Code quality = {\sum }_{i ∈ data points} {\sum }_{s ∈ \{ inc , exc , nc \}} {q}_{i}^{5} log ( \frac{{p}^{5} ( {c}_{i} , {r}_{i} )}{{\overline{q}}^{5}} )$$

Where q̅⁵ is the average probability of increased inclusion (s=inc), increased exclusion (s=exc) or no change (s=nc), taken over all exons and tissue types. The code quality can also be viewed as the data set log-likelihood, up to an additive constant. In FIG. 5, part A, thresholds q^{inc}≧0.99 and q^{exc}≧0.99 were applied to obtain 28,920 binary indicators (3.4% positive) and matching code prediction probabilities were obtained using fivefold cross validation. In FIG. 5, parts B and C, cases in which the microarray- or RT-PCR-measured tissue-difference in the percentage exon inclusion exceeded one s.d. in expected error (reference 11) (5%) were selected, and microarray cases were further screened so that transcripts in both tissues were among the top 20% in expression. For every test exon and pair of tissues c and c′, the difference in predictions for the two tissues, Δp=p(c,r)−p(c′,r), was computed and high confidence cases (|Δp|>0.5) were used for testing.

Computational techniques, splicing reporter constructs, cell transfections and RT-PCR assays are described below in the section titled “Supplementary Information”.

### Supplementary Information

1 Extracting Splicing Patterns from mRNA Expression Data

We assume that the mRNA expression data has been preprocessed so that for each exon, there is an estimated percent (%) inclusion level xₜ for each of several samples or tissues, indexed by t ∈ {1, . . . , T}. We refer to this as a ‘tissue profile’. The first step in our analysis of the alternative splicing (AS) data consists of extracting ‘splicing patterns’ that account for different exons having different baseline levels of % inclusion and also variable levels of noise across exons and tissues. Each splicing pattern corresponds to a single exon in the original dataset and a specific cellular condition, which may correspond to one tissue, a subset of tissues, a weighted combination of tissues, or a more general definition of cellular condition. Each splicing pattern q consists of three probabilities corresponding to evidence for increased exon inclusion (q^{inc}), increased exon exclusion (q^{exc}), and no change (q^{nc}), all determined by comparisons to the exon-specific baseline level of % inclusion.

While a standard statistical test (e.g., a t-test) could be used to find tissues that exhibit unusually high or low % inclusion, the assumptions used in those tests are incorrect here, because tissues are not independent. For example, hindbrain and cerebellum tend to have % inclusion levels that are much more similar than those for cerebellum and liver.

We take a model-based approach that determines the above probabilities using the statistics of groups of weighted combinations of tissues along with gene expression levels. The method, developed in (reference 1), can be viewed as an adaptation of factor analysis (reference 2) and independent factor analysis (reference 3) for the task of identifying splicing patterns from high-throughput measurments. It takes as input a matrix of % inclusion values with rows corresponding to exons (3665 in our experiments) and columns corresponding to tissues (27 in our experiments) and outputs a matrix of splicing patterns with rows corresponding to exons and columns corresponding to cellular conditions (4 in our experiments). Each element of the output matrix is considered to be an example indexed by i and corresponds to an exon eᵢ and a cellular condition cᵢ.

There are two, quite different indexing systems. Indices e and c refer to rows and columns of the matrix of splicing patterns computed as described in this section. However, the method used to infer the splicing code (described later) does not require that the splicing patterns be presented as a matrix and instead enumerates the examples using the one-dimensional index i. This is useful if some of the matrix elements are missing due to low gene expression, in which case i indexes only the available elements. Alternatively, cᵢ could be a continuous variable such as the temperature or age for example i.

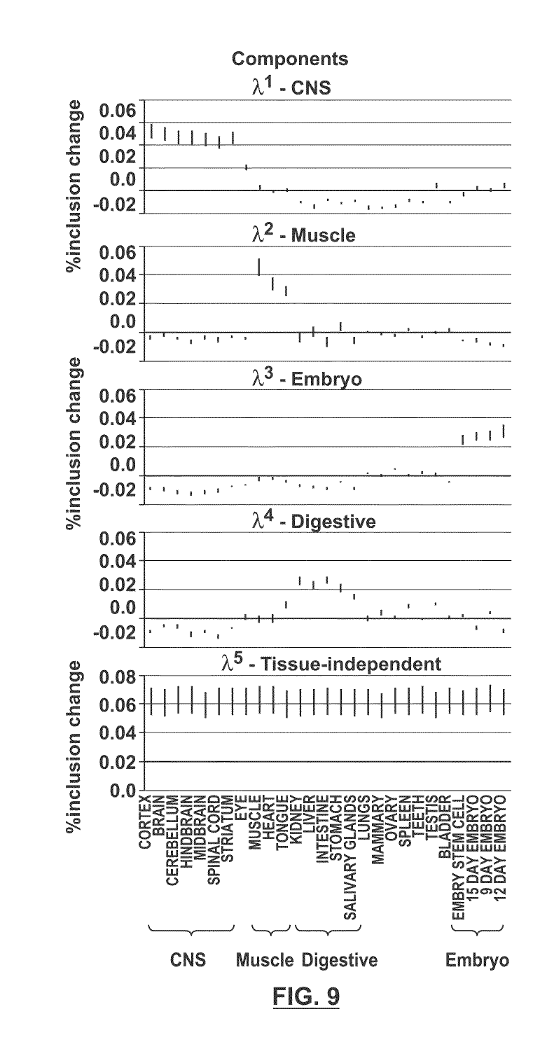

For the purposes of this section, we assume most of the variability in the tissue profile for each exon can be explained by a weighted sum of components, plus additive noise. For example, an exon with % inclusion≈0.8 in CNS tissues and % inclusion≈0.2 in all other tissues could be accounted for by a combination of 0.2 times a tissue-independent component plus 0.6 times a CNS component. An exon with % inclusion≈0.3 in CNS and muscle tissues and % inclusion≈0.6 in all other tissues could be accounted for by a combination of 0.6 times a tissue-independent component plus −0.3 times a CNS component plus −0.3 times a muscle component (see FIG. 9, which depicts the five components identified by the algorithm for the dataset of ref 23. As can be seen by the tissue labels at the bottom, the first four correspond to cellular conditions that can be labeled as central nerve system (CNS), muscle, digestive and embryo tissues, while the last component correspond to the tissue independent splicing level. The black bars denote the variance of the components over 15 random subsets of 80% of original dataset, demonstrating the robustness of the extracted components).

To construct a model, we associate a random variable with each splicing pattern. The random variable s can take on the values +1 (a relative increase in exon inclusion), −1 (a relative increase in exon exclusion) and 0 (no change) and those three states correspond to the probabilities q^{inc}, q^{exc} and q^{nc}. There will be one of these random variables for each exon e and each condition c in the output matrix and we denote it s_{c}^{e}. Below, we use standard random variable notation and will refer to the probability distribution over s_{c}^{e} by Q(s_{c}^{e}). Using this notation, qᵢ^{inc}=Q(s_{c}_{ᵢ}^{e}^{ᵢ}=+1), qᵢ^{exc}=Q(s_{c}_{ᵢ}^{e}^{ᵢ}=−1) and qᵢ^{nc}=Q(s_{c}_{ᵢ}^{e}^{ᵢ}=0). We will also refer to Q(s_{c}^{e}) as a splicing pattern.

The input data is a matrix of real numbers, where the % inclusion of exon e ∈ 1, . . . , E in tissue t ∈ 1, . . . , T is denoted xₜ^{e} ∈[0,1]. The tissue profile of exon e across the T tissues is denoted by x^{e}=└x₁^{e}, . . . , x_{T}^{e}┘. In a fashion similar to factor analysis (reference 4) and independent factor analysis (reference 3), we assume there are C underlying components or factors λ¹, . . . , λ^{C} that are vectors of length T and can be used to explain each observed tissue profile, where typically C<<T. The tth element in factor λ^{c} is λₜ^{c}. For tissue profile x^{e}, each component λ^{c} may either be present (s_{c}^{e}=+1), absent (s_{c}^{e}=0), or reversed (s_{c}^{e}=−1). An active (i.e., present or reversed) component may have different levels of effect, depending on the exon, as described above. This is modeled using a modulation variable m_{c}^{e}.

The resulting model is:

$$P ( {x}_{t}^{e} \vert {s}_{c}^{e} , {m}_{c}^{e} ) = N ( {x}_{t}^{e} ; {\sum }_{c = 1}^{C} {λ}_{c}^{t} {m}_{c}^{e} {s}_{c}^{e} , {ψ}_{t} )$$

where N denotes a Gaussian probability distribution function with variance ψₜ.

We set P(m_{c}^{e})=N(m_{c}^{e};4,1) to avoid situations where s_{c}^{e}≠0 (indicating a change in splicing), but the magnitude of the change is insignificant. For example, if s_{c}^{e}=+1, then the probability that m_{c}^{e}s_{c}^{e}<0 is 3×10⁻⁵ so the model is quite unlikely to generate values close to 0 when s_{c}^{e}=+1. To reflect the expectation that s is sparse, we set P(s_{c}^{e}=0)=0.92 and P(s_{c}^{e}=+1)=0.04, P(s_{c}^{e}=−1)=0.04 .

Some % inclusion values are expected to be outliers due to excessive noise and we often have prior knowledge about which measurements may be attributed to experimental noise (e.g., due to low gene expression). Our model therefore also has a competing outlier noise model. A hidden variable nₜ^{e}∈{0,1} denotes whether xₜ^{e} is accounted for by the components (nₜ^{e}=0) or by the outlier model (nₜ^{e}=1). So, we have:

$$P ( {x}_{t}^{e} \vert {s}_{c}^{e} , {m}_{c}^{e} , {n}_{t}^{e} ) = \{ \begin{matrix}N ( {x}_{t}^{e} ; {\sum }_{c = 1}^{C} {λ}_{t}^{c} {m}_{c}^{e} {s}_{c}^{e} , {ψ}_{t} ) & if {n}_{t}^{e} = 0 \\ N ( {x}_{t}^{e} ; {μ}_{t} , {φ}_{t} ) & if {n}_{t}^{e} = 1\end{matrix}$$

P(nₜ^{e}) is either set to a low value for nₜ^{e}=1 (indicating low outlier probability), or it is allowed to depend on gene expression level, as described below.

Before the output matrix of splicing patterns can be inferred, the model parameters Θ={λ_{c}, ψₜ, μₜ, φₜ} must be estimated. To do that, we use a variational approximation for the joint posterior distribution Q(s^{e}, m^{e}, n^{e}) given the observed splice levels x^{e}. We use the following approximation:

$$Q ( {s}^{e} , {m}^{e} , {n}^{e} ) = {\prod }_{c = 1}^{C} ( Q ( {s}_{c}^{e} ) N ( {m}_{c}^{e} ; {η}_{{s}_{c}}^{e} , {σ}_{{s}_{c}}^{e} ) ) {\prod }_{t = 1}^{T} Q ( {n}_{t}^{e} ) ,$$

where ηₛ_{_{c}}^{e}, σₛ_{_{c}}^{e} are variational parameters governing the posterior distribution over m_{c}^{e}. Given this variational approximation, learning the model amounts to minimizing the free energy (references 5, 6):

$$F = {\sum }_{e} {\sum }_{{s}^{e} , {n}^{e}} {\int }_{{m}^{e}} Q ( {s}^{e} , {m}^{e} , {n}^{e} ) log \frac{Q ( {s}^{e} , {m}^{e} , {n}^{e} )}{P ( {s}^{e} , {m}^{e} , {n}^{e} , {x}^{e} )} .$$

Because of Gaussian assumptions the integral is analytic and because Q(n^{e}) and Q(s^{e}) factorize across the tissues and the components, the sums over n and s simplify so that their computation takes time that is linear in the number of tissues and the number of components.

The free energy is minimized iteratively using a variational EM procedure (references 5, 6). Given the model parameters θ, derivatives of F with respect to the variational parameters are used to update them, and given those variational parameters, the derivatives of F with respect to the model parameters are used to update them. This is repeated until convergence is detected. To determine the number of components c, this process is repeated for each value of C an d the value of C th at has the lowest validation free energy, lowest variance in free energy on the validation data and highest reproducibility in posterior distribution over splicing patterns Q(s_{c}^{e}) is selected (data not shown). This led to setting C=5, as shown in FIG. 9.

For each run of variational EM, there are several parameters that need to be initialized properly. We initialized λ^{c} to the average tissue profile plus independent Gaussian noise with variance equal to the tissue profile variance. μ was initialized to the average tissue profile. ψ and φ were initialized to the variance of the tissue profiles. For a given training set we repeated this procedure 30 times and then selected the model with the lowest free energy.

### 1.1 Modeling Tissue Independent Splicing and Gene Expression Effects

Every exon may have a different base level of tissue-independent inclusion—some tend to be more highly included across all tissues than others, regardless of specific tissue-dependent splicing patterns. We model this by incorporating an additional component λ^{B} that is forced to be used in the positive sense in all cases: s_{B}^{e}=1∀e . (Above, the value of C=5 that was automatically selected included this tissue-independent component, as shown in FIG. 9). The variational posterior Q(m_{B}^{e}) is initialized according to the mean inclusion levels in each tissue. While the exact values of λ^{B} is updated during learning, every exon is guaranteed to have this pattern contributing through its m_{B}ⁱ variable to the base inclusion level.

High transcript levels of a gene have been shown to correlate with skipping of alternative exons. If a gene expression measurement vₜ^{e} is available for exon e and all tissues t ∈ {1, . . . , T}, we can account for it using an additional component. As described above for the tissue-independent component, we fix the hidden variable corresponding to the gene component to one: s_{V}^{e}=1. However, in this case the modulation levels may be positive or negative (corresponding to a positive or negative correlation with gene expression) and some may be relatively small (i.e., close to zero). We therefore set m_{V}^{e}=N(m_{V}^{e};0,b) and learn the variance b within the EM loop described above. Also, unlike the other components, this component is different for different exons and is determined directly from the gene expression values: λₜ=vₜ^{e},t ∈ {1, . . . , T}.

In practice, the above two modifications imply that the splicing patterns will account for changes that are not accounted for by tissue-independent % inclusion and gene expression.

### 1.2 The Output: Obtaining Splicing Patterns Used for Inferring the Regulatory Code

After inference and learning in the above model, for example index i and corresponding exon index eᵢ and condition index cᵢ, Q(s_{c}_{ᵢ}^{e}^{ᵢ}) gives the splice pattern probabilities qᵢ={qᵢ^{inc},qᵢ^{exc},qᵢ^{nc}}. The % inclusion values for a novel test exon e* can also be fed into the variational inference procedure to obtain the splice pattern q for each condition. When inferring the regulatory code as described below, these probabilities can be used directly or they can be thresholded to produce discrete targets. For example, if qᵢ^{exc}=0.0001, qᵢ^{nc}=0.0002 and qᵢ^{inc}=0.9997, then the most probable configuration is increased inclusion. Though we use a probabilistic framework, we found that the inferred probabilities tend to be extreme, thus discretizing them, for example to test if a set of exons that share a common splicing pattern are enriched with a specific motif, does not lose much information. For example, 99% of the probabilities estimated in one experiment were either greater that 0.9 or less than 0.1.

### 2 Compendium of Putative Regulatory Features

We assembled a compendium of 1014 RNA features consisting of 171 features derived from cis-elements described in literature as affecting alternative splicing or binding a known splice factor (called ‘known motifs’ or ‘PSSM’), 12 that sum counts of ESE and ESS elements previously reported, 314 potentially new cis-elements supported by conservation evidence but with no known tissue specific context (called ‘new motifs’), 460 features measuring regional counts of sequences 1-3 nt long (called ‘short motifs’) and 57 features describing transcript structure (exon lengths, splicing-induced premature termination codons, etc). Each feature may be associated with one of the seven unspliced RNA regions indicated in FIG. 4, part A, or a combination of those regions. The regions correspond to the upstream neighboring exon (E1), 300 nt at the 5′ end of the upstream intron (I1(5′)), 300 nt at the 3′ end of the upstream intron (I1(3′)), the alternative exon (A), 300 nt at the 5′ end of the downstream intron (I2(5′)), 300 nt at the 3′ end of the downstream intron (I2(3′)) and the downstream neighboring exon (E2). The complete list of features is provided in Table S1.

Usually, the number of occurrences of an element in a region was used as the actual feature value. For intronic regions, we additionally included a version of each motif feature obtained by estimating the conservation level of the intron sequence at each position containing the motif and summing together the conservation-weighted motif counts. For example, if the average conservation of two motif occurrence was 0.01 and 0.02 in two relatively non conserved regions, then the feature value for this specific exon would be 0.03, albeit having two occurrences of the motif. If selected during code inference, this type of feature could enable the code to explain the inactivity of a feature when it lacks appropriate context as indicated by lack of conservation. The conservation level for each nucleotide was derived from the phastCons tracks (reference 7) for mouse assembly mm8 in the UCSC Genome Browser (reference 8).

Known motifs were derived from a literature survey for cis elements identified as affecting alternative splicing or binding a known splice factor as well as from recent comprehensive computational analyses yielding extremely high statistical significance motifs associated with alternative splicing. These include motifs for CUG-rich, Mbnl and the CUGBP binding tracts (reference 9), PTB/nPTB binding tracts (references 10-12), Fox (reference 13), Tra2 (reference 14), Srp55, Srp40, SC35, and ASF/SF2 as represented by the ESEFinder (reference 15), UG-rich motifs (reference 16), U-rich Tia/Tiar motifs (reference 17), Quaking (reference 18) and Nova. In the case of Nova, we used both the specific regions and the Nova cluster score defined in (reference 19) as well as a simple search of YCAY elements in the regions defined above. For motifs defined using position specific scoring matrices (PSSM), like the general splice factor motifs defined by reference 15, the matching feature value was defined as the posterior probability that the given sequence is regulated given the PSSM (e.g., reference 20). We also included a few computationally-identified motifs associated with tissue-specific AS (references 21-24), These features are listed in Table S1 using the label prefix ‘Known’, or ‘KnownCons’ if the feature incorporated conservation.

We included several relatively large sets of cis elements reported as correlating with splicing regulation in general, without tissue specific effect. All splicing enhancers and silencers (repressors) reported in references 25-28 were analyzed and included in the feature compendium in the appropriate regions. Exonic elements were identified in the alternative exon, but also the neighboring constitutive exons. These counts were normalized by the matching exon's length. These features are listed in Table S1 using the label prefixes ‘Burge’ and ‘Chasin’. Also, each of the 314 4-7mer motif clusters identified by reference 29 using only conservation information in the intronic regions flanking alternative exons was included as a feature. These features are listed in Table S1 using the label prefix ‘Yeo’, or ‘YeoCons’ if the feature incorporates conservation. We note that the total number of unique motifs identified in those study is large and hence do not comprise by themselves a very specific set of regulatory elements for defining a regulatory code. For example, the ESE/ESS high scoring elements (NI score>0.8) in reference 28 include about 36% of all possible timers, while reference 29 clusters cover a total of 1260 5-7mers.

Short motifs consisted of regional counts of 1-3mers. Such regional counts have been previously shown to be helpful in differentiating between alternative and constitutive exons 30. In Table S1 these features are indicated by the label prefix ‘ShortSeq’. Many quite diverse features were used to describe what we refer to as ‘transcript structure’. This class refers to the features in Table S1 that are not described above. Transcript structure features include binary variables indicating whether (1) or not (0) a premature termination codon was identified in transcripts involving the inclusion or exclusion of the alternative exon, binary variables indicating whether or not the alternative exon introduces a frame shift, lengths (in nt) of the alternative exon and the neighboring introns and exons, ratios of length parameters, splice site strengths (measured using the PSSMs defined in reference 31), distance to the first upstream occurrence of AG (reference 32) and so on. Since the overall conservation level in the introns surrounding and exon may be an indicator of an evolutionarily stable transcript structure, we also used the net conservation level of the introns flanking the alternative exon as features, computing the average value of the phastCons tracks (reference 7) for the first 100 nt up- and down-stream of the alternative exon. RNA secondary structure likely plays an important role, so we included features that were derived by running RNAfold (reference 33) to compute the probabilities for local stem loop secondary structures, defined as PU scores (reference 34). As a pre-processing step, each intronic region was extended up to 50 nt up- or down-stream. RNAfold was then used to compute for each sequence bⁱ=b₁, . . . , b_{L} the PU score for a stem loop of length l starting at position i denoted as S_{PU}(bᵢ). The features derived from these scores were the average and maximal PU score in the 20 nt region around the splice site, and in the proximal intronic region 1-70 nt, 71-140 nt and 141-210 nt up- and down-stream of the splice site. The above features can identified by appropriate labels in Table S1.

As a final note, we stress that all the features described above were not discretized or normalized in a preprocessing step, but instead the learning algorithm determines the most appropriate set of thresholds. In practice, this means there is no prior definition of thresholds involved (e.g., junction score>v, for some v, to define a “strong” splice junction) and the range of possible feature values may vary considerably between different features. Instead, thresholds that lead to feature combinations that result in maximum code quality are selected, as described in Supplementary Information 4.1. Additional details about the various features used and their actual values for the data analyzed is accessible via the accompanying website www.psi.toronto.edu/wasp.

### 3 De Novo Search: The Unbiased Motif Set

To address the question of what kinds of motifs could be identified if previous literature were ignored, we also performed a search for enriched motifs without biasing the search using previous literature. The aim of this search was to estimate which positions in a given sequence, like the upstream intron of exon 16 in Daam1 portrayed in FIG. 7, part A, are likely to be a part of a feature involved in regulation. To do this, we used the SeedSearcher algorithm as previously described in (reference 23) with similar settings. This algorithm takes as input two sets of sequences: a ‘positive’ set that is expected to be enriched in putative motifs, and a ‘negative’ or ‘background’ set, against which the enrichment of putative motifs is measured. For each cellular condition c and each direction of splicing change s ∈ {inc, exc}, corresponding sets of exons were identified by thresholding the splicing pattern probabilities q as follows:

G¹(s, c)={e:eᵢ=e,cᵢ=c,qᵢ^{s}≧W₁}

G⁰(s, c)={e:eᵢ=e,cᵢ=c,qᵢ^{s}≧W₀},

where we took W₀=0.1 and W₁=0.9. Intronic and exonic sequences corresponding to the regions shown in FIG. 4, part A were then extracted for each exon, resulting in a positive and a negative set of sequences for each region.

For each combination of cellular condition, direction of splicing change and sequence region, we ran SeedSearcher and collected all motifs that had a false discovery rate-corrected p-value score better than 0.01 in any of 125 randomly sampled data subsets containing 80% of the data each. We then mapped the detected motifs back to their positions in the unspliced RNA sequence and computed, for each position in the RNA sequence, the distribution of overlapping motif scores and the fraction of the 125 random subsets in which identified motifs overlapped that position (providing an indication of detection robustness). In an exon's feature map, like the one in FIG. 7, part A, only positions with ≧20% reproducibility are plotted (in grey blocks 700) and the distribution of the −log₁₀ p-value ranging from 2 to a cap of 10 is shown using shades of grey.

### 4 Inferring the Regulatory Code

The feature information index described in the previous section aims to answer the question “How informative is each feature on its own with respect to a specific splice pattern (e.g., differential inclusion in CNS)?”. This is also the type of question addressed, using various computational approaches, in all previous studies of condition specific alternative splicing with respect to known or novel sequence motifs (e.g., references 21-24, 35). A somewhat different question is “Which set of features, when combined together, defines a robust and predictive regulatory code for a given splice pattern?”. While the two questions are related, they are quite different and their corresponding answers may yield different feature sets of interest. For example, a certain feature may be highly useful for predicting a specific splice pattern while only appearing in a relatively small subset of the events who share it. Thus, it can be found as a highly robust feature for the regulatory code, while the amount of information it carries for the entire group of exons who share this pattern would be moderate. The Nova cis elements are a good example of that, being selected as robust features for the regulatory code for increased inclusion in CNS tissues, while estimated to regulate only about 7% of the exons that share this pattern. On the other hand, a specific cis element may be very common in the regulatory code for a specific pattern but may be highly redundant to other cis elements in terms of its predictive power since they tend to co-appear. In such a case this feature may score high in terms of information content, but may be, in the extreme case, totally ignored by the algorithm learning the regulatory code for that pattern.

We now turn to describe how the second question regarding a set of features, which together define a robust and predictive regulatory code for a specific splice pattern, was addressed.

### 4.1 Regulatory Code Learning

The goal of this step of the procedure is to identify RNA features (motifs, nucleotide biases and transcript structure features) and how they can be combined so as to be predictive of the N splicing patterns q₁, . . . , q_{N} extracted as described above. The measure of code quality that we use is:

$$H = \frac{1}{N} {\sum }_{i = 1}^{N} {\sum }_{s ∈ \{ inc , exc , nc \}} {q}_{i}^{s} log ( \frac{{p}^{s} ( {c}_{i} , {r}_{i} )}{{\overline{q}}^{s}} ) ,$$

where qᵢ^{s} is the probability of splicing change s ∈ {inc, exc, nc} in example i, p^{s}(cᵢ, rᵢ) is the predicted probability of splicing change s given cellular condition cᵢ and RNA feature vector rᵢ, and q̅^{s} is the average probability of splicing change

$$s , {\overline{q}}^{s} = \frac{1}{N} {\sum }_{i = 1}^{N} {q}_{i}^{s} .$$

H measures the average number of bits of information in condition-dependent splicing changes that are accounted for by the splicing code. To see this, we rewrite H as follows:

$$\begin{matrix}H = ( \frac{1}{N} {\sum }_{i = 1}^{N} {\sum }_{s ∈ \{ inc , exc , nc \}} {q}_{i}^{s} log ( \frac{{p}^{s} ( {c}_{i} , {r}_{i} )}{{\overline{q}}_{i}^{s}} ) ) - \\ ( \frac{1}{N} {\sum }_{i = 1}^{N} {\sum }_{s ∈ \{ inc , exc , nc \}} {q}_{i}^{s} log ( \frac{{\overline{q}}^{s}}{{q}_{i}^{s}} ) ) \\ = ( \frac{1}{N} {\sum }_{i = 1}^{N} KL ( {q}_{i} , \overline{q} ) ) - ( \frac{1}{N} {\sum }_{i = 1}^{N} KL ( {q}_{i} , p ( {c}_{i} , {r}_{i} ) ) )\end{matrix}$$

where KL is the Kullback-Leibler divergence or relative entropy measure (reference 36). The first term is the average information lost when making predictions without taking into account the condition or RNA feature vector. The second term is the average information lost when making predictions using the splicing code. The difference is the average gain in information achieved by the splicing code.

Inferring the regulatory code entails finding a predictor p(c,r) that maximizes H. We assume that p(c,r) is parametrized by Θ, so inferring the code entails maximizing H with respect to Θ. This is equivalent to maximizing the net cross entropy L betw een the splicing pattern probability distribution and the predicted distribution,

$$\begin{matrix}{Θ}^{Code} = {argmax}_{Θ} H \\ = {argmax}_{Θ} L\end{matrix}$$

$$where$$

$$L = {\sum }_{i = 1}^{N} {\sum }_{s ∈ \{ inc , exc , nc \}} {q}_{i}^{s} log {p}^{s} ( {c}_{i} , {r}_{i} ) .$$

The remainder of this section describes how the splicing code is inferred by maximizing L while ensuring the resulting code is robust to perturbations in the data and experimental conditions.

Diversity in the types of RNA features requires a method that can handle binary-valued, integer-valued, non-ordinal, and real-valued features. Also, because of the large number of potential features, a technique that avoids over-fitting while performing feature selection is needed. Many different approaches can be used to specify the functional form of the predictor p(c,r) and to search over the space of solutions, including maximum-likelihood methods, boosting-based methods and Bayesian techniques, which account for uncertainty in a principled manner.

We use a technique that treats each cellular condition separately and for each one learns simple decision boundaries for selected input features and uses weighted combinations of corresponding indicator variables as input to a softmax (multi-valued logisitic) function. Our model can be viewed as a single-layer logistic Bayesian network or neural network where the inputs are indicator variables that tell when an input feature is in a learnt region. Alternatively, it can be viewed as a weighted combination of single-layer decision trees. For condition c and RNA feature vector r, the output of the splicing code is:

$${p}^{s} ( c , r ) = \frac{exp ( {f}_{c}^{s} ( r ) )}{{\sum }_{{s}^{′}} exp ( {f}_{c}^{{s}^{′}} ( r ) )} , where {f}_{c}^{s} ( r ) = {\sum }_{m = 0}^{M} {γ}_{c , m}^{s} I ( r ∈ {R}_{c , m}^{s} ) .$$

Here, the number of selected input features for condition c is M_{c} and R_{c,m}^{s} is a learnt region for the mth selected feature for condition c and splicing change s. The function l(·) evaluates to 1 if its argument is true and 0 otherwise, so I(r ∈ R_{c,m}^{s})=1 if the RNA feature vector is within the learnt region for the mth selected feature for condition c and splicing change s. γ_{c,m}^{s} is a parameter that accounts for the direction and magnitude of the effect that indicator variable has on the predicted probability.

The case m=0 in the above expression is a special case for which we define I(r ∈ R_{c,m}^{s})=1 regardless of r. This accounts for a condition-dependent bias γ_{c,0}^{s} in the predicted probability that is independent of the RNA feature vector.

Learning consists of estimating Θ={M_{c}, R_{c,m}^{s}, γ_{c,m}^{s}}. To simplify the space of decision boundaries, we restricted R_{c,m}^{s} to be axis-aligned, i.e., each indicator variable tests whether an individual RNA feature is within a region (e.g., “is the length of the exon longer than 30?” or “does this exon introduce a PTC?”). Note, however, that because multiple features are combined together in the above softmax function and because the same feature can be used more than once, the resulting predictor is nonlinear and can account for some degree of competition and cooperation among features.

### 4.1.1 Recursive Feature Selection Algorithm

Because feature selection is expected to be critical (beforehand, we expected only around 10% of the features would be relevant to alternative splicing), we paid careful attention to the choice of learning algorithm. We considered various methods, but the results described here are based on an entropy-based variant of the likelihood-based step-wise boosting procedure described in (reference 37). The algorithm starts with M_{c}=0 for all conditions, in which case the prediction is based solely on the bias parameters described above. Then, the algorithm recursively adds regions so as to maximize code quality. As in other step-wise boosting procedures, at the mth stage of feature selection, the region and weights associated with the previous m−1 steps are fixed and examples that are least well-accounted for by the current model are ‘boosted’ so that they count more when selecting the next feature.

A concern given the limited amount of data and the large number of features is that the algorithm would over-fit the training data by adding too many features, while generalization performance over unseen test data actually deteriorates. As illustrated in FIG. 4, part B, this over-fitting did not occur for the settings we used.

### 4.2 Extracting the Robust Regulatory Code

Identifying a robust set of features that is not sensitive to data perturbations and experimental conditions is difficult, because of the large number of potential features, their redundancy, the relatively small number of examples that are not in the ‘no change’ group, and the inherent noise in the data. For example, a feature selected by the algorithm described above could be selected because of over-fitting, i.e., the feature accounts for only a statistically insignificant number of examples. As another example, if two features are quite similar, one or the other may be selected, depending on small changes in the data or the experimental conditions.

To overcome these problems we used the following approach. First, we constructed 125 datasets of tissue profiles by randomly sampling 80% of the exons from the original dataset, without replacement (see Supplementary Information 5). For each of these datasets, we extracted the splicing patterns as described in the previous section and estimated a splicing code (parameters Θ) as described above. For each cellular condition and direction of splicing change (inc, exc, nc), we then examined each potential feature and computed the fraction of the 125 splicing codes that included that feature. We refer to this percentage as the feature robustness R. To overcome feature redundancy, whenever the presence of one feature implied the presence of another feature for the cellular condition and direction of splicing change under consideration, only the second feature was retained. Also, motif features that were quite similar (e.g., slightly different variants of PTB binding motifs) were counted as one in the above process. Each feature was labeled as being ‘robustly detected’ if it was detected in at least 25 splicing codes, i.e., satisfied R≧20%.

Table S2 lists the resulting set of robust features constituting the regulatory code. This table was also used to create the schematic representations of the regulatory codes reported in the paper (e.g., FIGS. 6-6A and FIG. 7).

### 5 Prediction Performance Evaluation

As described in other sections, the splicing code provides an interpretable map of how splicing is regulated and can also be used to generate exon-specific regulatory feature maps, but the validity of the code also relies on its prediction capability. Here, we describe how tests were carried out to evaluate the code's prediction accuracy on non-homologous test exons.

The composition of the examples used to infer the code and the cases used to test the code can significantly influence prediction performance. For example, the code described here was inferred using exons for which there was EST evidence of alternative splicing, so testing it using constitutive exons or pseudo exons would produce ambiguous results. While the question of accurately distinguishing between alternative, constitutive, or pseudo exons has been addressed in the past (e.g., reference 30), the ability to predict tissue specific splicing directly from sequence has never before been demonstrated nor quantified to the best of our knowledge. To avoid biasing the results of our evaluation, we thus focus only on exons that are known to be alternatively spliced. However, in order test how our computational approach scales up for genomic wide scans where many constitutive exons are expected, and estimate the false positive rate in this setting, we also performed genome wide data base mining for putative constitutive exons based on transcripts evidence and evaluated the ability of our algorithm, using the same feature set defined in Supplementary Information 2, to discriminate between tissue specific AS and constitutive exons.

To address concerns about the code being highly tailored to an overly-specific prediction task, we chose five different ways of measuring test accuracy. First, we examined the theoretical code quality (Supplementary Information 1) on unseen test cases quantified using the same microarray and preprocessing procedure that was used to generate the training data. Second, for every combination of exon, tissue type and direction of splicing change (increased inclusion or increased exclusion) in that dataset, we created a binary label indicating whether or not the exon exhibited the corresponding change in the corresponding tissue and then measured prediction accuracy for those labels. Third, to ensure that our preprocessing procedure was not introducing too much bias, we computed the difference in % inclusion for every pair of tissues and every exon in that dataset and assessed the code's ability to predict the direction of change between pairs of tissues (positive or negative). Note that the reason we examined predictions for changes in splicing between tissues is that the code is meant to predict tissue-dependent splicing changes. Fourth, we acquired RT-PCR data for 14 tissues and 14 exons that the code predicted would exhibit tissue-specific regulation, computed the difference in % inclusion for every pair of tissues and every one of the 14 exons, and assessed the code's ability to predict the direction of change between pairs of tissues. Fifth, we identified 97 exons that were previously studied in detail and shown to be regulated in brain and/or muscle tissues by Nova, (n)PTB and Fox-1/2 and examined whether, at a low false positive rate, the code was able to identify these exons as CNS and/or muscle regulated exons.

### 5.1 Using Multiple Codes to Make Robust Splice Pattern Predictions

We used 5-fold cross-validation to obtain an unbiased low-variance estimate of prediction accuracy. We randomly partitioned the original data set D of 3665 exons from reference 23 into K=5 equal-size subsets {Dₖ}, k ∈ {1, . . . , 5} each of which contained 20% of the data. For k=1, . . . , 5, we set aside Dₖ as test data and used the remaining 80% of the data, D\Dₖ, for training. For each training subset D\Dₖ, we extracted the tissue groups as described in Supplementary Information 1 and computed the splice pattern qᵢ for each training example i ∈ D\Dₖ. Then, we inferred a splicing code as described in Supplementary Information 4.1 and used it to make predictions p(cᵢ, rᵢ) for each test case i ∈ Dₖ and also to assess the code quality on test data.

To increase the robustness of predictions to random perturbations of the data used to infer the code, we did not assess prediction accuracy using the above predictions, but instead repeated the above procedure N times and made a prediction for each case by averaging the predictions from N splicing codes:

$${p}^{s} ( {c}_{i} , {r}_{i} ) = \frac{1}{N} {\sum }_{n = 1}^{N} {p}_{n}^{s} ( {c}_{i} , {r}_{i} ) ,$$

where s ∈ {inc, exc, nc} and pₙ is the prediction from the nth splicing code. We used N=5 for the results reported in this paper.

Note that in the above description, there are two quite different data partitionings: one is used to produce an unbiased, low-variance estimate of prediction accuracy, and the other is used to make more accurate predictions. While the above method is more complicated than standard 5-fold cross-validation, it nonetheless produces unbiased estimates of prediction accuracy.

Finally, we obtained estimates of variance on prediction accuracy and code quality by repeating the above procedure M times. We used M=5 for results reported in this paper. So, overall, we created K·N·M=5.5.5=125 subsets of the original dataset and combined them as described above to obtain robust predictions and measures of code quality, obtain unbiased estimates of test performance and obtain estimates of variance. Note that because the preprocessing stage (estimate of tissue groups) was included within the cross-validation loop, the estimates of variance include variability introduced by estimating the tissue groups.

The overall set of 125 regulatory codes were also used to derive the robust code described in Supplementary Information 4.2, the robust feature maps described in Supplementary Information 10, and to identify robustly selected features shown in the graphical depiction of the code Supplementary Information 8. Similarly, when a test exon was not in the original data set of reference 23 the entire set of 125 codes was used to derive predictions for it, by setting N=125 in the above equation.

### 5.2 Evaluation Using Microarray-Assayed Alternative Exons

The above train/test method enabled us to perform extensive evaluation of prediction accuracy over 3665 exons, including in silico testing of the contribution of various types of features, like conservation information or known motifs, to the overall prediction accuracy.

Given the inherent noise in microarray measurements, care must be taken in defining the reference used to test predictions. The following procedure was therefore used: For each of the 125 training sets described above, the estimated tissue groups were used to compute the splice patterns (qᵢ^{inc}, qᵢ^{exc}, qᵢ^{nc}) for the test cases. Test cases for which the splice pattern assignment (qᵢ) to compare against did not have high confidence across the N repetitions were removed. Specifically, we kept only the examples for which q^{s}<0.1 or q^{s}>0.9 where s ∈ {inc, exc, nc}. This step typically removed between 8% of the CNS examples and 28% for the digestive examples.

FIG. 4, part D gives the theoretical code quality as measured by the decrease in relative entropy between the splice pattern assignments (q) and their predictions from sequence p^{s}(cᵢ, rᵢ) where s ∈ {inc, exc, nc} (Supplementary Information 4). The different codes listed were derived using subsets of the features detailed in Supplementary Information 2, matching their name (code with no conservation information, code with no structural features etc.).

FIG. 5, part A compares the same set of derived regulatory codes plotting their precision (relative to the code derived from the entire feature compendium) on the y-axis, as a function of the false detection rate (the x-axis), which in turn are both determined by a variable threshold on the confidence of the predictions.

FIG. 5, part B compares the splice pattern predictions directly to inclusion changes between pairs of brain, muscle, digestive or embryo tissues. For this, the prediction for a splice pattern of condition cᵢ in test exon eᵢ given by p^{s}(cᵢ, rᵢ) where s ∈ {inc, exc}, was compared against the prediction for a splice pattern for a different condition in the same test exon p^{s}(cᵢ*, rᵢ). The prediction difference was defined accordingly as:

Δp=p^{s}(cᵢ,rᵢ)−p^{s}(cᵢ*,rᵢ)

Only cases where the prediction difference had high confidence (|Δp|>0.25) were included in subsequent analysis. Similarly to the evaluation when comparing to splice pattern assignments derived from microarray, care must be taken to compare Ap only against cases where there is actually strong microarray evidence for a change in splicing. FIG. 5, part B therefore only contains test cases where the difference in % inclusion as measured between the two tissues exceeded one standard deviation in expected noise (5% per tissue) (reference 38) and where both tissues were among the top 20% in gene expression measurements in the original data set of reference 23. For completeness, FIG. 20 gives the same measure of prediction accuracy as in FIG. 5, part B for different screening thresholds over the gene expression level.

### 5.3 Evaluation of RT-PCR-Assayed Test Exons

We mined a set of cassette alternative exons using EST/cDNA data (this set includes the 3665 exons from the microarray study, but many additional ones—see Supplementary Information 12.1 for details). BLAST was used to compare these against the exons that were used for training and matching exons were removed to form an independent pool of potential test exons. The splicing code was applied to these exons and the predictions were used to score the exons for the 4 tissue types and 2 directions of change (increased inclusion and exclusion). We randomly selected 20 exons from among the 50 exons with highest score equally taken from the four tissue types.

For each of the 20 selected exons, we performed RT-PCR quantification (Supplementary Information 12) across 14 different tissues, corresponding to the 4 different cellular conditions identified by the algorithm. These included brain, cortex, cerebellum, hind-brain, skeletal muscle, heart, tongue, stomach, salivary glands, kidney, liver, 9.5-day embryo, 12.5-day embryo, 15-day embryo. In six cases, either the reaction did not succeed or the gel contained an ambiguous number of bands (one or more than two) and these were removed from subsequent analysis, since they may represent non-cassette exons mistakenly included in the initial set derived from EST/cDNA data.

FIG. 5, part D shows gels for four exons with dominant differential inclusion patterns in different tissue types, along with the predictions made by the code. To visualize the code predictions in grey scale we first normalized predictions for each of the tissue types (CNS, muscle, digestive and embryo) using the entire set of exons from the genome wide scan, and then scaled the set of 8 predictions for each of the exons so their relative change is visually clear when plotted as grey scale images.

5.4 Evaluation Using Nova-, Fox- and (n)PTB-Regulated Human and Mouse Exons

To ascertain whether or not the code could predict splicing changes for exons whose regulatory mechanisms have been studied in detail, we collected 97 exons regulated in human and/or mouse brain and/or muscle by Nova (65 cases), Fox (20 cases) and (n)PTB (12 cases). Reference 39 studied targets of Fox-1/2, a splice factor known to contribute to differential splicing in brain and muscle tissues. Using RT-PCR, some of those exons were found to exhibit differential splicing across multiple tissues, including brain and muscle, while a larger set of exons was found to be affected by Fox-1 using flag-tagged Fox-1 protein in HeLa cells. These experiments were carried out for human genes, so we mined their supporting database (reference 40) for exons that are conserved in mouse, with both isoforms reported.

Nova was recently shown to regulate splicing in neuronal tissues by way of clusters of YCAY binding sites (reference 19) and cross-linking immunoprecipitation was used to identify over one hundred exons targeted by Nova (reference 41).

PTB and nPTB (neuronal PTB) are well-known splicing factor. In a recent study of a regulatory factor called nSR100 that operates in conjunction with (n)PTB42 verified (n)PTB affect 11 mouse exons that exhibit differential splicing in CNS tissues.

The experimental techniques employed in the above studies vary substantially, so care is needed when using them to define ground truth for prediction. All of the studies examine differential splicing in muscle and/or CNS tissues, but in most cases the direction of change was not clear (e.g., if all that is reported is a target of a trans-factor) and in some cases only one tissue was compared against a wild type (e.g., CNS or muscle, but not both). To compile a single set of examples that could be used for evaluation of the splicing code, we compared all the exons from the above studies (listed in Supplementary Table S3) to all cassette exons we previously mined and then removed all exons that were found to be similar (using BLAST similarity, see Supplementary Information 12.1) to exons used to infer the splicing code. This resulted in a set of 97 test exons for evaluation.

For each test exon, we extracted proximal RNA sequence, applied the splicing code, and applied a threshold that matches, in terms of the number of exons that pass it, a threshold of 0.9 over the predicted probability of a splicing change (either increased inclusion or increased exclusion) in either CNS or muscle tissues. The results of these tests are summarized in Supplementary Table S3.

Because of the diverse sources of data employed we computed statistics for the prediction accuracy over all the test exons, but also for subsets of test exons depending on the source of the trans element involved. Overall, our algorithm achieved a sensitivity of 75% (p<10⁻⁴¹): 65% of the 65 Nova targets (p<10⁻²⁰), 92% of the 11 (n)PTB targets (p<10⁻⁸) and 95% of the 20 Fox targets (p<10⁻¹⁵), where p-values were computed using a binomial distribution, assuming a null hypothesis where the predictions are random, based only on the relative abundance of exons with CNS or muscle related splice patterns exceeding the above score threshold.

### 6 Evaluating Genome Wide Prediction Using Putative Constitutive Exons

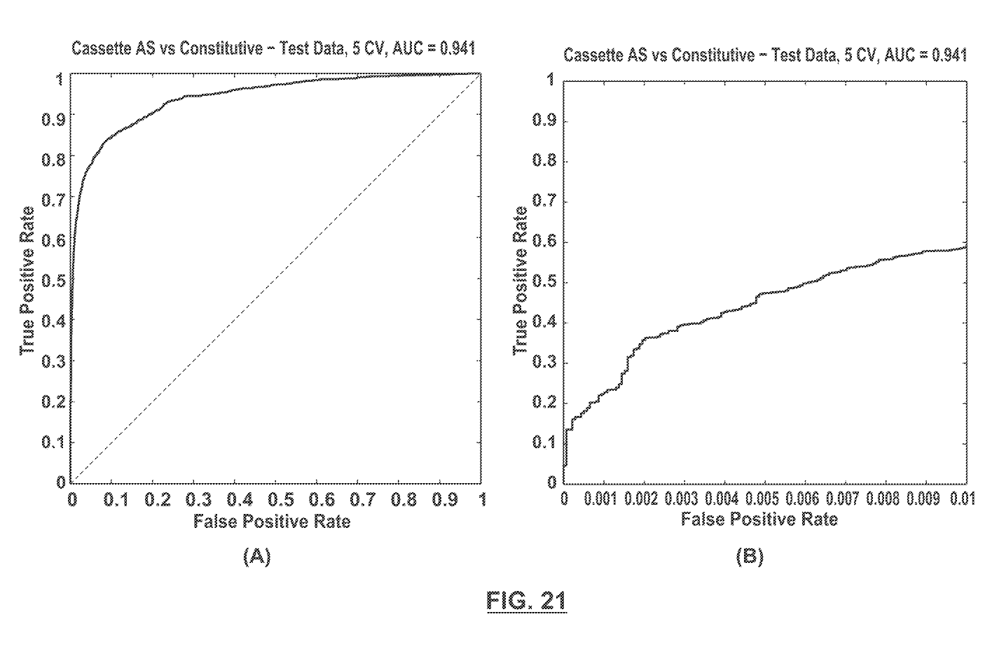

The above procedures concentrated on evaluating how accurately the splice code can account for tissue-regulated splicing. In order to evaluate how our computational approach scales up when performing genome-wide scans for tissue specific alternatively spliced exons, we wanted to extend our code to be able to distinguish between alternatively spliced exons and constitutive exons. For this purpose, we mined a set of putative constitutive exons using EST/cDNA data (see Supplementary Information 12.1 for details). Since exons may be alternatively spliced in specific contexts and not in others, we defined the set of putative constitutive exons as those that had at least 20 different supporting EST/cDNA sequences with no evidence of that the exons are alternatively spliced. As described before, BLAST was used to remove any redundancy within this set, resulting in a set of about 14,000 exons. We then tested our algorithms ability to discriminate between these exons and those identified as being tissue regulated from the microarray data (Supplementary Information 1), using a standard 5-fold cross validation train and test procedure. We achieved an ROC with an area under the curve (AUC)>0.94 and sensitivity of 60% for a false positive rate (FF′R) of 1% (see FIG. 21). While not being the main focus of this work, these results compare favourably with the best previously published results for discriminating constitutive and alternative exons (eg. AUC=0.93, sensitivity=50% for 1% FPR, as reported in reference 30). We note our result probably constitutes a lower bound on achievable accuracy, since both the algorithms meta-parameters and the feature set used were not optimized for the purpose of distinguishing constitutive and alternative exons.

### 7 Feature Information Index

The feature information index aims to answer how informative is each of the putative regulatory features we defined with respect to a specific splice pattern. For this, every feature ri in our dataset was scored for how well it correlated with a specific pattern assignment (s_{c}) where s ∈ {inc, exc, nc} and the amount of information it conveyed for this pattern. This was done using the following procedure: First, pattern assignment (s_{c}) were discretised using confidence thresholds:

$$D ( {q}_{i}^{s} ) = \{ \begin{matrix}- 1 & if {q}_{i}^{s} < {W}_{0} \\ 1 & if {q}_{i}^{s} > {W}_{1} \\ 0 & otherwise\end{matrix}$$

In the results reported we used confidence thresholds W₁=0.9 and W₀=0.1, but results remained stable on a wide range of values (data not shown). Second, for any given set of feature assignment {rᵢⁱ}ₑ₌₁ⁱ and discretised pattern assignments {D(qᵢ^{s})}ₑ₌₁ⁱ we optimized a threshold value zᵢ*:

zᵢ*=arg max S({D(rᵢ|zᵢ)}, {D(qᵢ^{s})}),

where {D(rᵢ|zᵢ)} is a discretising function over feature values defined as:

$$D ( {r}_{i}^{i} ) = \{ \begin{matrix}- 1 & if {r}_{i}^{i} \leq {z}_{i} \\ 1 & if {r}_{i}^{i} > {z}_{i}\end{matrix}$$

and S is the function we maximize. Supplementary Table S1 summarizes the enrichment of every feature in the compendium we created (see Supplementary Sec. 2) for each of the splicing pattern s identified by our algorithm. The function S used to score for enrichment in Supplementary Table S1 as well as in FIG. 6 is the two sided Fisher exact test (reference 43), after −log₁₀ transformation. We also used a second definition of S based on mutual information (reference 36) which gave similar results (data not shown).

### 8 Graphical Depiction of the Regulatory Code

To create the graphical depiction of the regulatory code shown in FIG. 6, we used the robust code identified as described in Supplementary Sec. 4.2 and reported in detail in Supplementary Table S2. In FIG. 6, whenever a feature is based on a motif matching that of a previously-described trans-factor, we denote it with the commonly known motif for that trans-factor with the name of the trans-factor in parentheses. We note though that the feature identified is the cis element and while it may be known to be associated with a certain trans-factor this does not imply this trans-factor is the actual regulator (e.g., a different protein may bind to the same motif in a different tissue). Other cis elements, are denoted ‘Mot[]’, with a consensus sequence provided within the brackets. Otherwise, the feature is assigned some other unique identifier (See Supplementary Sec. 2 for more information). Columns 2-8 in FIG. 6 correspond to different regions of unspliced RNA. Within each cell (corresponding to a feature and an RNA region), there are five sets of bars corresponding to tissue-independent splicing (denoted I) and tissue-dependent splicing in CNS, muscle, embryo and digestive tissues (denoted C, M, E and D respectively). White bars 600 correspond to features that were selected for increased inclusion, whereas shaded bars 604 correspond to features that were selected for increased exclusion. In each case, the feature can act positively (enrichment mode) or negatively (depletion mode) and the mode is indicated in the key in the upper-left of FIG. 6, particularly by the presence or absence of black hats 608. For example, enrichment of exonic splicing enhancers (ESEs) in the alternative exon (A) were found to increase tissue-independent exon inclusion, but additionally, depletion of ESEs in the alternative exon were found to increase tissue-independent exon exclusion.

For each cellular condition, direction of splicing change, and unspliced RNA region in FIG. 6, the size of bars 600 and 604 corresponds to the enrichment of the feature as measured by the ‘feature information index’ (see Supplementary Sec. 7). If several features match the label-region combination (e.g., variants of PTB elements), then the highest feature information index was used. If a feature was selected for s=0 (no change), that means the feature is predictive of a change either way (increased inclusion or exclusion), so both types of bar were plotted.

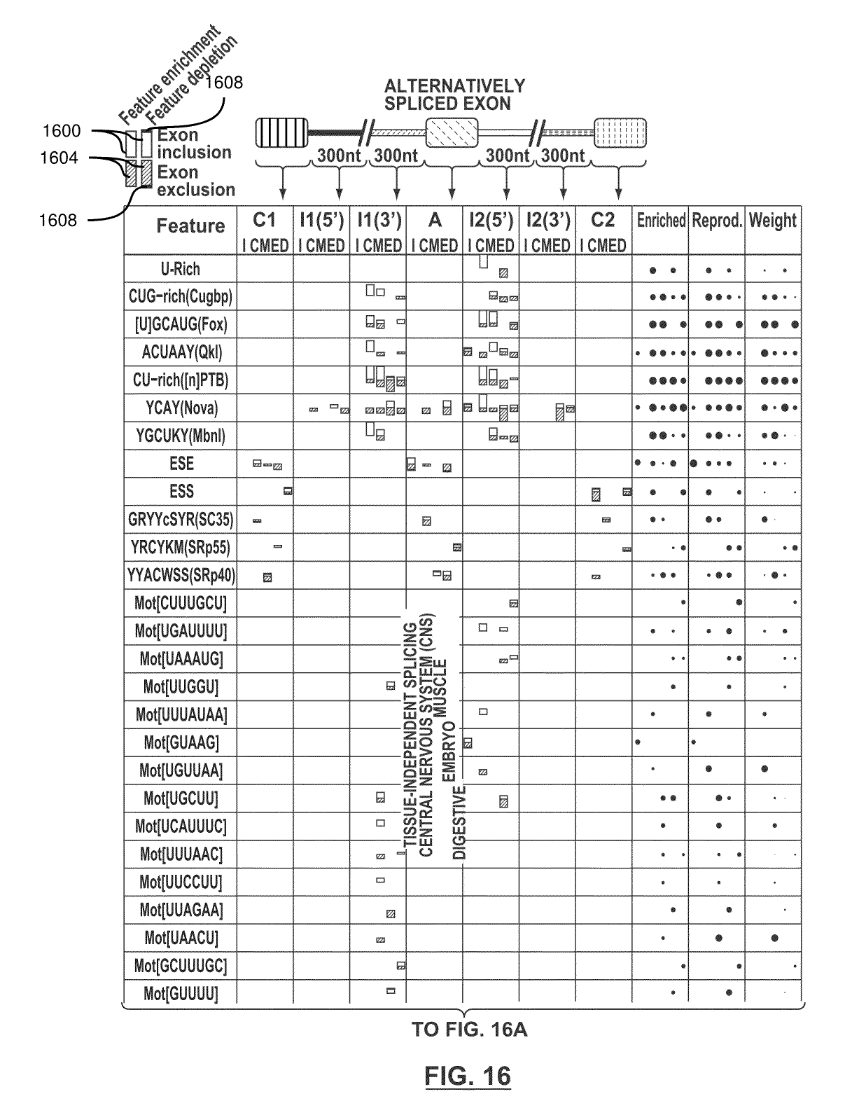

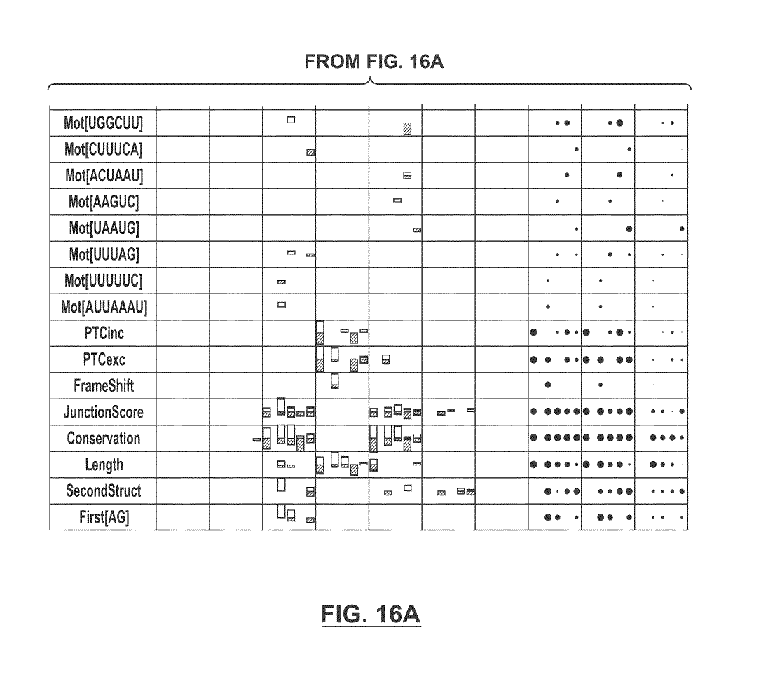

An important question is “How trustworthy is each feature in the splicing code?” To address this, we computed three different measures for each cellular condition and plotted them in the three columns on the far right, omitted in FIG. 6 but shown in FIGS. 16-16A and 17-17A. The 3rd column from the right (Enriched') shows the sum of the feature enrichment scores (feature information indices) across all regions. The 2nd column from the right (‘Reprod’) shows the reproducibility of the feature, i.e., the maximum robustness R across all regions. The far right column (‘Weight’) shows the sum of the absolute weight (γₛ in the above formula) associated with the feature in the learnt regulatory code, scaled by the sum of all absolute weights.

In FIG. 6, only those features where the maximum enrichment score (across all regions, conditions and directions of splicing change) was greater than −log₁₀(0.005) are shown. Also, to save space, FIG. 6 excludes the short motif features; see FIGS. 17-17A for a graphical depiction of those. FIGS. 16-16A and 17-17A show graphical depictions of the inferred splicing code. With regards to FIGS. 16-16A: for each feature identified by the code (first column) and each of the seven regions that were analyzed (next seven columns), the activity of the feature in tissue-independent, CNS tissue, muscle tissue, embryo tissue and digestive tissue regulation is shown by the five sets of white bars 1600 and shaded bars 1604 (labeled I, C, M, E and D). A white bar 1600 indicates the feature was associated with increased inclusion of exons in the corresponding tissue, whereas a shaded bar 1604 indicates the feature was associated with increased exclusion. A similar legend is used in FIGS. 17-17A, with white bars 1700 representing inclusion, shaded bars 1704 representing exclusion, and the presence of black hats 1708 indicating feature depletion rather than enrichment. The size of the block conveys statistical significance and only cases where p<0.005 (hypergeometric test) are plotted. Each feature can operate in enrichment mode (high feature value is associated with regulation) and/or depletion mode (low feature value is associated with regulation), as indicated by the key in the upper-left corner, in particular by the presence of black hats 1608. For each feature, the last three columns show three different measures of confidence: enrichment (frequency with which the feature was associated with regulation), reproducibility (how often the feature was identified among 125 different randomly-selected datasets), and weight (the amount of change in splicing pattern that was associated with the feature).

### 8.1 Graphical Depiction of the Feature Overlap Network

To create the graphical depiction of the feature overlap network in FIG. 6, we used the same set of robust features described above. To create the network, we first discretized each of these features into a binary variable representing the absence or presence of the feature, based on the threshold that maximized the feature's information index with respect to the group it was identified in (e.g., short exons in exons highly included in CNS). The features, along with the matching thresholds used to discretize them, are listed in Supplementary Table S2. In FIG. 6A, parts B-D, features are represented as nodes. Similar to FIG. 6, the size of the node corresponds to the enrichment of the feature in the group of exons. Only features with an enrichment score greater than −log₁₀(0.001) were considered in the analysis, with the maximal node size in the figure matching an enrichment score of 15. In order to maintain consistency with FIG. 6 we also represented the depletion mode of the feature (e.g., exon length is short, or ESE count is under-represented) with a thicker black edge around the matching node. In addition, nodes are shaded to represent the regions from which the feature was derived—the shading of the nodes in FIG. 6A matches the shading of the neighbouring introns and exons at the top of FIG. 6. Nodes are also s haped to represent whether the feature is a cis element or a structural element (e.g., exon length).

Next, for each pair of such binary variables, we computed the significance of their respective co-occurrences using Fisher's exact test. The edges in areas 612 of FIG. 6A correspond to overlap between features that were selected for increased exclusion (similar to shaded bars 604 of FIG. 6), while the remaining edges correspond to overlap between features that were selected for increased inclusion (similar to white bars 600 of FIG. 6). Only pairs of features for which the significance of their overlap exceeded an FDR corrected p-value of 0.05 were reported. Each such pair was represented by an edge between the nodes representing the two features. The thickness of the edge corresponds to the significance of the overlap, ranging from an uncorrected p-value of around 0.01 to 10⁻⁸. In a few cases the features tended to not overlap rather than overlap. These were represented using a dashed line. Many features had significant overlap with features representing conservation in the flanking regions. To avoid cluttering the figure, conservation features along with all corresponding edges were removed from this analysis.

Finally, we note that only features that had at least a single significant edge are represented in FIG. 6A, parts B-D. Consequently, no features from the regulatory code for digestive tissues are represented, and many of the other features depicted in FIG. 6 are not included.

### 9 Additional Analysis of Features

This section includes additional details and matching plots about features selected by the code. FIG. 18 shows histograms of the number of features identified per exon, for the four tissue types (CNS, muscle, embryo, digestive). Histograms for different types of feature are shown, including (part A) only the known and new motifs with the short (1-3 nt) motif count excluded, (part B) the known and new motifs combined with transcript structure features, but still excluding the short motifs, and (part C) features derived from the short motifs. Combined, these indicate that the composition of the regulatory code for muscle and brain tissues is similar in terms of the type and number of features used, with a median of 12-15 features without including short motifs, and additional 10-11 features derived from short motifs. The regulatory code for embryonic tissue regulation involve a similar number of features derived from short motifs, a slightly larger number of known and new motifs (median is 11 compared to 8 in CNS and muscle), with the difference increasing when transcript structure features are included (median is 19). Compared to CNS and muscle, the code for digestive tissue regulation includes a similar number of known and new motifs, but a larger number of features derived from short motifs (median is 17 compared to 10 for CNS and muscle). A potential partial explanation for these differences is that alternative splicing in embryonic and digestive tissues has not been studied as comprehensively as in CNS and muscle tissues.

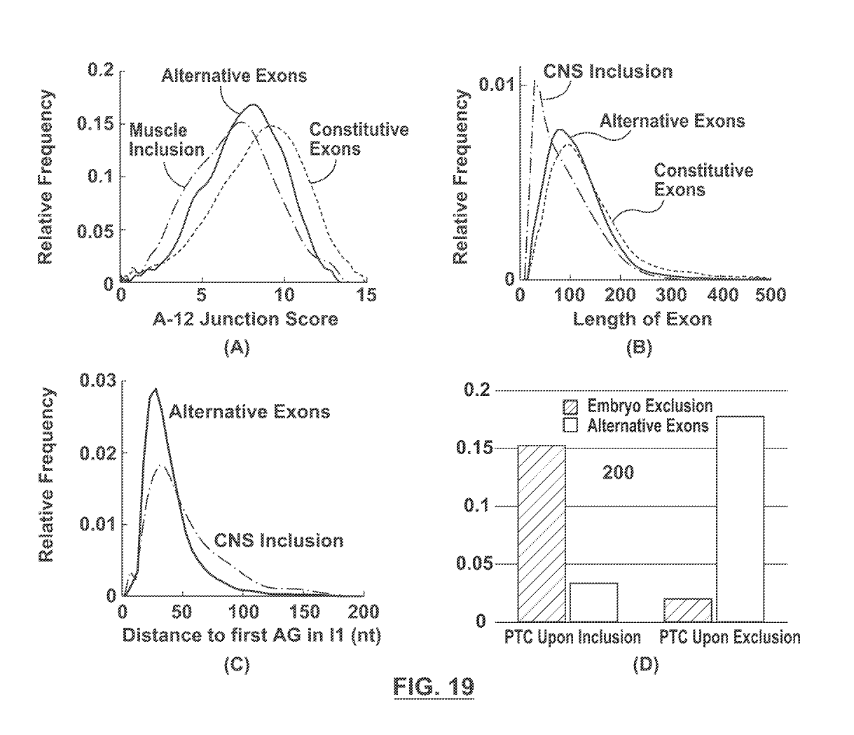

FIG. 19 illustrates the enrichment of several features in different tissue-regulated exons. In each plot, the distribution of a feature is shown for a specific subgroup of tissue-regulated exons (e.g., exons with increased inclusion in CNS tissues) as well as for a reference group (either all 3665 exons in the dataset, or all exons except the ones used in the subgroup). In some cases, the distribution of the feature for exons for which there is no evidence of alternative splicing (constitutive exons) is also shown. FIG. 19, parts A and B show histograms for exon length and the strength of the alternative exon 5′ splice site (denoted A-I2) which are two of the features that make up the exclusion by default mechanism described above. FIG. 19, part C shows the histogram of the distance to the first AG in the upstream intron and this result is consistent with the ‘AG exclusion zone’ described by reference 32). The difference of the distance to the first AG in exons highly included in CNS could be a consequence of secondary structure or branch site definition in those exons, but may be an indirect result of C/U richness in introns flanking those exons. FIG. 19, part D shows the relative enrichment of splicing events that introduce premature termination codons (PTCs). The enrichment of PTC upon inclusion in exons excluded in embryonic tissues may correspond to a nonsense-mediated decay (NMD) shutdown mechanism for those genes, many of which exhibit correlation of exclusion of the alternative exon with high expression in embryo tissues, as described above.

In FIG. 19, parts A and B we also plot the histograms for constitutive exons. The differences between constitutive exons and alternative exons has been described previously, unlike the tissue-specific differences noted here. These results are also consistent with the code derived for higher tissue-independent inclusion shown in FIG. 6. The tissue independent code, while not being the main focus of this work, is consistent with our current understanding of how ESE/ESS counts, splice sites strength and longer exons influence the baseline inclusion level. For example, increased length of the alternative exon and higher ESE counts in it are associated with increased inclusion levels. Introduction of a PTC upon exon inclusion is associated with a decrease in overall inclusion, which is consistent with NMD.

### 10 Exon-Specific Feature Maps

The splicing code can be used to answer the question “Which of the RNA segments proximal to a given alternative exon are utilized by the code to explain splicing changes in a particular tissue and may thus be functional regulatory elements in that tissue type?”. Our answer to this is an automatically-generated feature map (or motif map) like the one depicted in FIG. 7, part A for CNS regulation of exon 16 of Daaml. As labelled in FIG. 16, the alternative exon (A) is shown, along with neighbouring introns (11 and 12) and exons (C1 and C2). Returning to FIG. 7, blocks 704 and 708 denote segments that match any of the feature compendium motifs used in the code for the given tissue type (see Supplementary Information 4.2). Grey scaled bars 700 are used to flag positions that were found to overlap motifs identified by the unbiased motif search in exons associated with the selected tissue type (see Supplementary Information 3). For reference, the feature map also shows a small selection of previously-identified motifs from the feature compendium (e.g., Nova and Fox motifs), which may or may not have been utilized by the code, plus conservation levels and possible regions of secondary structure.

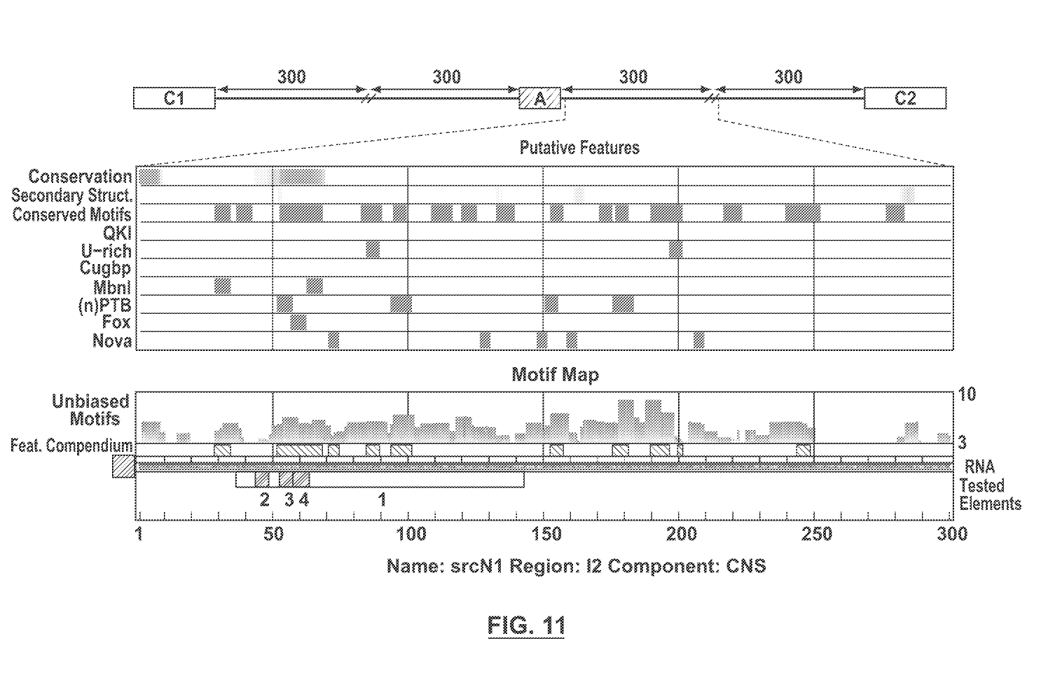

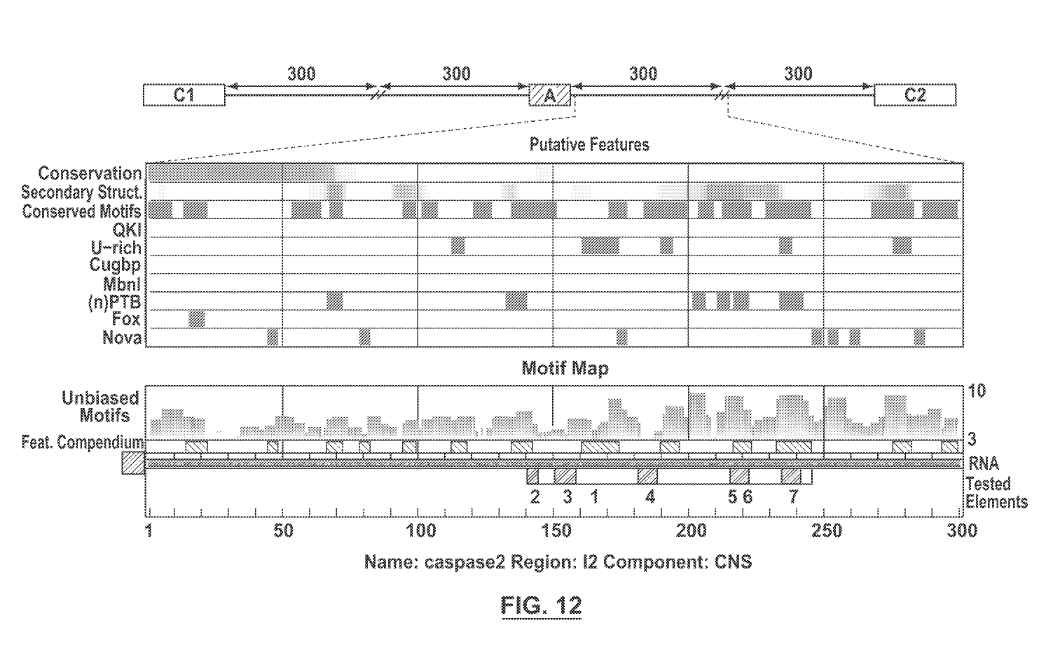

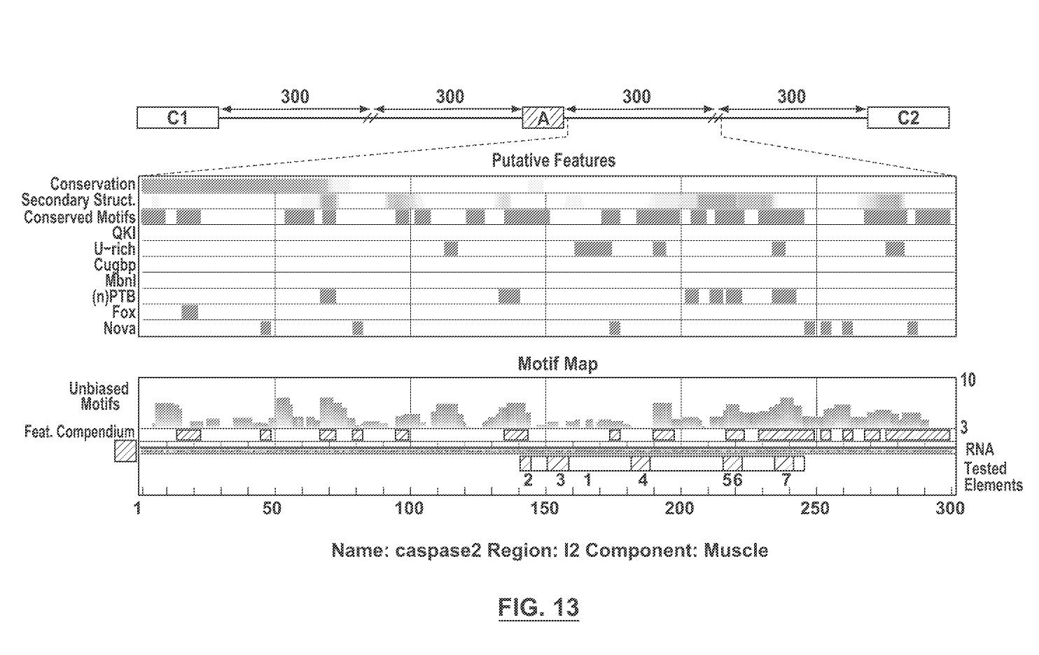

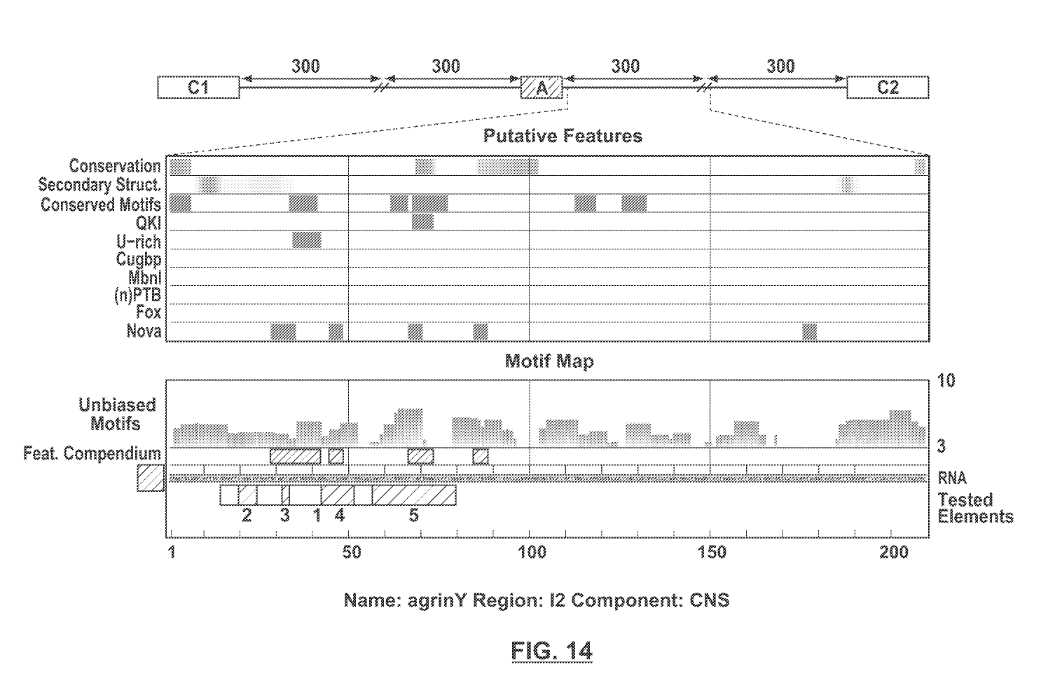

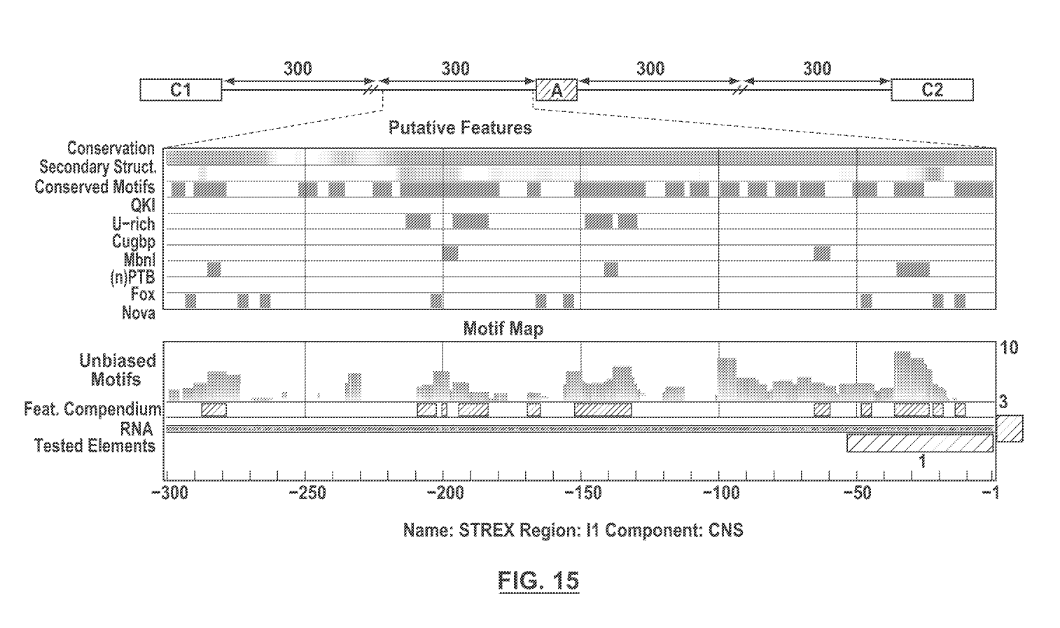

When information was available about regions that were experimentally verified to contribute to splicing regulation, these regions were marked below the feature map in the region labelled “tested elements”. Areas 716 flag sequences previously shown to be important for element function but that have not yet been demonstrated to bind to specific trans-acting factors, whereas shaded rectangles 712 flag sequences with more specific additional information about mechanism, such as confirmation of a trans element that binds to them. Exons for which we collected this information include the Agrin Y exon (exon 28 in Mouse) (reference 44), Src N1 exon (references 45-47), Caspase-2 exon 9 (references 48, 49) and Slo K+channel STREX exon (reference 50). All of those exons were correctly predicted by the algorithm to exhibit CNS and muscle (in the case of Caspase-2) specific regulation. The feature maps for those are given in FIG. 10, FIG. 11, FIG. 12, FIG. 13, FIG. 14, and FIG. 15 (in which blocks, areas and rectangles similar to those of FIG. 7 are used), for the up- and down-stream introns where the regions verified as active were found. For Caspase-2, which exhibits splicing regulation in both CNS and muscle tissues, feature maps for both tissue types are given.

As is clearly evident in the above mentioned figures, many elements predicted to be functional in those exons appear in regions that have not be experimentally verified in past studies. While predictions of elements in those regions can obviously not be assessed by these studies, we are still able to assess whether the observed overlap between predicted elements and regions that were tested is significant. Intuitively, if the algorithm achieves high coverage of the verified regions simply by outputting a lot of predicted elements in general, then testing the overlap between predicted elements and the same regions in random exons should yield similar results in many cases. To assess this, we computed an empirical p-value for how well the predicted feature map overlap with the experimentally verified regulatory regions using the following procedure: from a data set containing over 11,000 cassette exons (Supplementary Information 12.1) we randomly sampled a set of 4 exons, each of which corresponded to a specific exon from the original independent studies of regulatory elements (e.g., Src N1). Next, for each of the random exons, we computed how many of the positions in a the corresponding original exon (e.g., 37-142 upstream of the alternative exon in the Src N1 case) overlap with the feature map predicted for this randomly selected exon. We repeated this procedure 10000 times, using the combined feature map, only known motifs, and only motifs based on general conservation analysis (reference 29) achieving p-values of <0.002, 0.004 and 0.27 respectively, while coverage of the original 376 nt verified in the original studies as regulatory active ranged between 90% for the feature map, to only 38% for the known motifs.

### 11 Identification and Analysis of CNS-specific Exons in Neurological Disease Genes

In addition to facilitating detailed analyses of specific exons of interest, the code can be used to scan all alternatively spliced exons to produce explorable maps of tissue-specific regulation. Since many genes with critical and specific functions in the nervous system are widely expressed across mammalian tissues, we conjectured that the identification of novel CNS-regulated exons could potentially provide a useful basis for understanding these functions and potentially also mechanisms of relevance to neurological disease. To this end, we first derived a genome-wide regulatory map for mouse, composed of over 11,000 cassette exons mined from EST/cDNA data. Any exon that may be homologous to the ones used to derive the regulatory code were removed (see Supplementary Information 12.1 for details). We then examined exons where the corresponding gene is conserved in human and has been associated with a neurological disease. Then, we selected exons that score highest for CNS-regulated splicing using our splicing code. Twelve predicted exons were analyzed by RT-PCR assays and nine of these (75%) were verified as having a neural-specific inclusion pattern, though some of the identified CNS specific patterns involved more than a single exon (data not shown). Five cases, involving a single exon and implicated causally in neurological diseases are shown in FIG. 22. Detailed literature searches and sequence analyses were performed to assess the degree of prior knowledge related to these cases, as well as potential functional consequences. The results of this analysis are summarized in Supplementary Table S4 and described below.

Several of the neural-regulated exons are located in genes linked to bipolar disorder or schizophrenia, including Ank3, Dock9, Gsk3beta and Rapgef6. The neural-regulated exon in Gsk3beta has been independently identified (Supplementary Table S4), whereas the other examples of neural-regulated exons are novel. Gsk3beta is a Ser/Thr kinase that is implicated in Parkinsons and Alzheimers diseases, and bipolar disorder, and is known to phosphorylate tau, the main component of neurofibrillary tangles in Alzheimers Disease when abnormally hyperphosphorylated. In each case the neural-regulated exons identified in Ank3, Dock9 and Rapgef6 are predicted to affect critical protein domains or expression. For example, the location of the neural-regulated exon in Gsk3beta suggests that it could function to modulate the activity of the adjacent kinase domain. The domain-altering splicing event in Filamin A (Flna) is predicted to remove the beginning of the 15th filamin repeat domain. Mutations in the filamin repeat domain of this gene have several clinical outcomes, including periventricular nodular heterotopia, an X-linked dominant neuronal migration disorder that is implicated in cortical malformations and epilepsy. Finally, one of the cases verified by RT-PCR assays that involve more than a single exon was found in Cask, a gene implicated in X-linked brain malformation and mental retardation. Interestingly, while this splicing event is not predicted to alter any functionally defined protein domain, genomic deletions identified in two individuals with brain malformation encompass the CNS-regulated alternative exon in the Cask gene (references 51, 52).

Our results also demonstrate the usefulness of code in identifying regulated alternatively spliced exons ivolving transcripts expressed at levels that are too low for them to be detected using currently available RNA-Seq datasets. In order to reliably predict differences in percent exon inclusion levels that are >10-20% using read data, it is necessary to have a read coverage level of least 15-20 reads per set of three splice junctions (C1-A, A-C2 and C1-C2) representing a cassette alternative exon, and/or for the corresponding exons (C1, A and C2). Available datasets comprising 30-40 million reads at 30-50 nt reads (references 35, 53) afford sufficient coverage to quantify levels of splicing for only the top 20%-30% most highly expressed transcripts, and obtaining sufficient read coverage to quantify splicing levels for >90% of expressed transcripts would be prohibitively expensive since >400 million reads would be required (reference 54).

We asked which of the neural-specific alternative splicing events successfully predicted by the code and validated by RT-PCR assays in the present study could be independently predicted using the available brain and non-neural tissue RNA-Seq datasets. Surprisingly, none of the events validated in our manuscript that we examined had sufficient read coverage to make a reliable prediction. This observation reveals that our splicing code can be used to identify regulated exons in genes regardless of whether they are expressed at levels that are sufficient for independent detection using available RNA-Seq data.

### 12 Experimental Procedures and Data Acquisition

### 12.1 Sequence and Microarray Data for Cassette Exons

The main dataset for this work was obtained from reference 23, which is publicly available. The sequence data for the exons in this study was derived from mouse assembly mm8 in the UCSC Genome Browser (reference 8). Mining of additional cassette exons and identification of PTC for different transcripts was performed using the procedure previously described in references 38, 55. Sequence for additional cassette exons was derived from mouse assembly mm9 in the UCSC Genome Browser. To avoid including redundant cassette exons, exons were compared against each other using BLAST and exons with p 5_{—} 0.001 were removed. Because the p-value for comparing similar yet very short exons may not appear significant, we also tested if exons were shorter than 30 nt, and used a p-value threshold of only 0.1 in such cases. We note that this procedure is conservative: while it may remove exons that are actually not redundant, it ensures that test exons are not similar to training exons.

### 12.2 Growth and Maintenance of Cell Lines

Neuro2A and NIH-3T3 cell lines were obtained from ATCC. Neuro2A cells were grown in DMEM supplemented with 10% FBS, Sodium pyruvate, MEM non-essential amino acids, and antibiotics. NIH-3T3 cells were grown in Dulbecco's Modified Eagles Medium (DMEM) supplemented with 10% FBS and antibiotics. All cell lines were cultured at 37° C. with 5% CO₂.

### 12.3 Generation of Minigene Reporters, Transfection and RNA Sample Preparation

The parental Daam1 minigene reporter was generated by amplifying a Daam1 genomic DNA fragment from a BAC clone using the primers:

5′-CGGCTCGAGCAAATGTCAACACACCCACAC-3′ and

5′-CGGGCGGCCGCCCTCGAATCTCAGCAAACA-3′. This PCR product was subsequently cloned into the PET01 exon trap vector (Mobitec) using Xhol and Notl restriction sites to create PET01-Daam1. This vector placed the Daam1 exon and flanking intronic sequences in between two heterologous exons. All other mutant derivatives were created from this construct by standard molecular cloning approaches. Primers for these constructs are available upon request. Detailed information corresponding to which residues were substituted in the mutant constructs can be found in Supplementary Table S5. Minigene reporter constructs were transfected into Neuro2a and NIH-3T3 cell lines using Lipofectamine 2000 transfection reagent (Invitrogen) according to the recommendations of the manufacturer. Total RNA was harvested from transfected cells 48 hours post-transfection using RNeasy mini columns (Qiagen). All minigene reporter constructs were transfected in triplicate. For purification of mRNA from mouse tissues used in this study, total RNA was extracted from 1-2g of each mouse tissue sample using Trizol reagent (Invitrogen) as per the manufacturer recommendations. PolyA+mRNA was purified as described previously in reference 38.

12.4 Generation of Code Preditcions for Mutated sequences

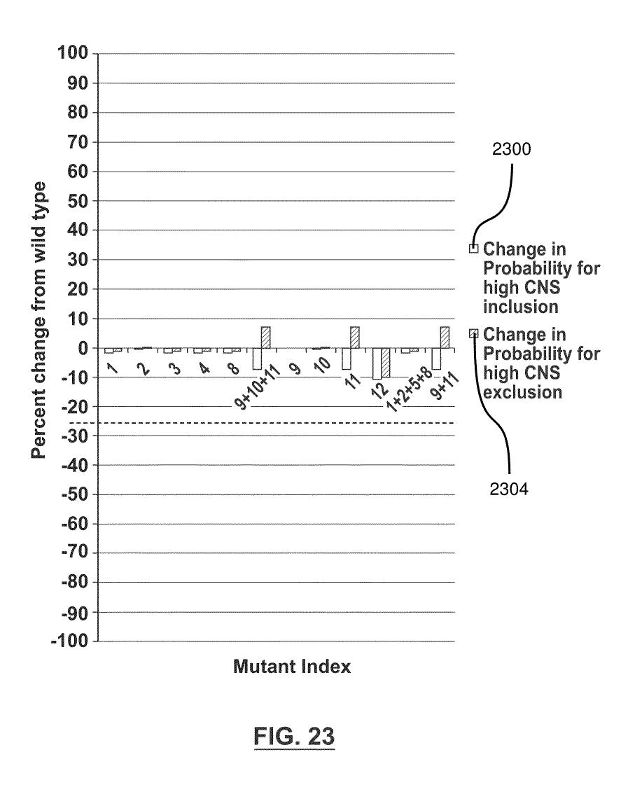

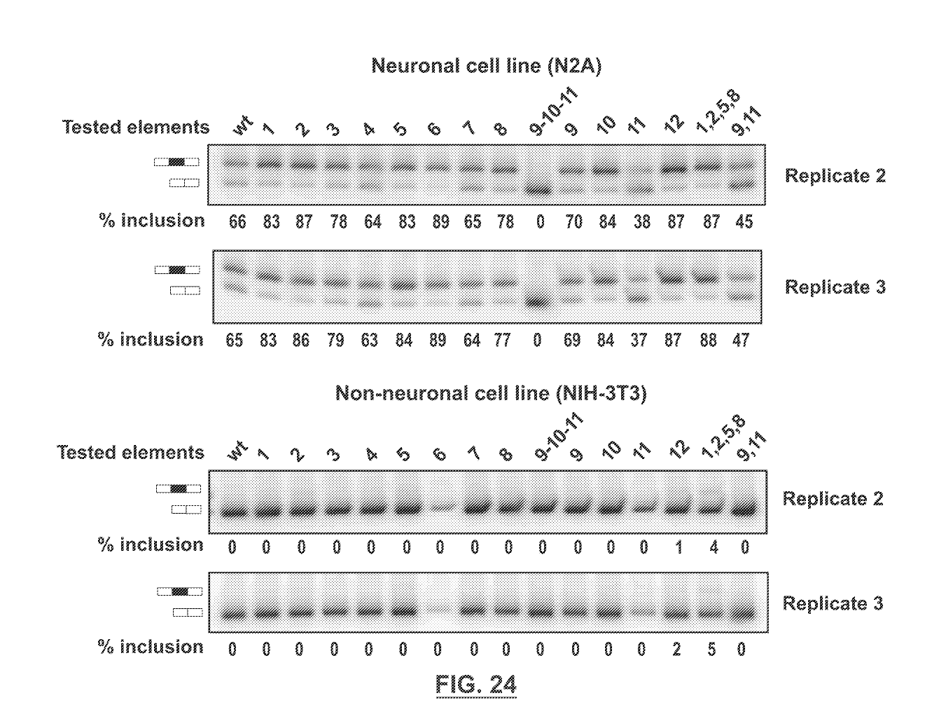

For each of the mutated sequences of the intron upstream of Daam1 exon 16 we used the code to predict whether we would observe higher percent inclusion in CNS tissues. Towards this, we first recomputed the entire set of features for each mutation, then fed the resulting feature values to the code and observed the probability for either higher inclusion or higher exclusion levels in CNS tissues, given by the matching p^{s}(cᵢ, rᵢ) (see Supplementary Information 4). The results are shown in FIG. 23 where the x axis corresponds to the different mutants as indexed in FIG. 7, part A and the y axis represents the relative change, compared to the wild type predictions, in the probabilities for higher inclusion (white bars 2300) or exclusion (shaded bars 2304) levels in CNS tissues. Mutants 3,6,7 are not shown as those do not overlap the sequence segments in the upstream region used to derive the predictions. Mutants 3 and 6 both overlap other sequence segments identified by the unbiased motif search and were verified to effect splicing levels, while mutant 7 was designed as a negative control as it is 5 nt away from the nearest element predicted to be important in the feature map (see the section Deciphering the Splicing Code, above, for details). As described above, the high confidence prediction in the case of Daam1 exon 16 was for higher inclusion in CNS. The dashed line in the FIG. 23 corresponds to the threshold used to define such high confidence predictions. As is clearly shown, the code retains high confidence predictions for increased inclusion in CNS for all mutants, predictions verified for all but one of the mutants (mutant combination 9-10-11, see above and FIG. 24). Although all predictions changes were relatively low (less then 11%), we noticed that predictions involving several CUG repeats (mutants 11 and combinations of it with mutants 9,10) involved a distinct increase in the probability for higher exclusion in CNS tissues, a result confirmed by the RT-PCR described below.

### 12.5 Reverse Transcription-Polymerase Chain Reaction (RT-PCR) Assays and Quantification

RT-PCR reactions contained 30 ng of total RNA for minigene reporter assays or 0.6 ng of polyA+ RNA for mouse tissue assays. cDNA synthesis and amplification was performed using the One Step RT-PCR kit (Qiagen), as per manufacturers recommendations or with the addition of 0.3 μCi of α-³²P-dCTP per 10 μL reaction. The number of amplification cycles was 22 for detection of minigene reporter transcripts and 29 for detection of predicted tissue-specific alternative splicing events. Reaction products were separated using 6% denaturing polyacrylamide gels, placed on phosphor screens and detected by autoradiography. Quantification of isoform abundance was performed using ImageQuant software (GE healthcare).

FIG. 24 shows the additional two replicates done for the experiments shown in FIG. 7, part B.

### 12.6 RNAi Knockdown of Upf1

Additional examples of developmentally regulated genes with transcript isoforms targeted by NMD pathway are shown in FIG. 25. To test these, Neuro2a cells were transfected with an siGenome pool control or Upf1-specific siRNAs (Dharmacon) using the Dharmafect 1 transfection reagent, as recommended by the manufacturer. Cells were harvested 72 hours post transfection, and total RNA was extracted using RNeasy mini columns (Qiagen). RT-PCR assays were performed as described above and quantified using either ImageQuant (GE Healthcare) or ImageJ software. To selectively detect the PTC-containing isoform in transcript populations, primers were used to selectively amplify cDNAs corresponding to each exon-included isoform.

Further discussion of the generation of splicing patterns according to exemplary non-limiting embodiments, as discussed earlier in connection with FIG. 3 as well as the sections Isoform quantification and RNA features, and Supplementary Information 1 (Extracting Splicing Patterns from mRNA Expression Data), will now be provided.

### Model-based Detection of Alternative Splicing Signals

### Introduction

As discussed above, a computationally derived regulatory code has been developed that includes combinations of motifs and non-motif features such as transcript structure characteristics to directly predict splicing changes from genomic sequence. The focus of the work presented here is to facilitate such downstream analysis by accurately identifying biologically informative condition-specific splicing changes, or AS signals, underlying high-throughput measurements.

High-throughput AS measurements are typically acquired using microarrays or high-throughput sequencing technologies. Accurate quantification of every isoform still poses computational and experimental challenges. Consequently, much of the research involving AS and derived datasets focuses on the simpler task of quantifying splicing changes at the single exon level. Such data can be quantified as the fraction of gene isoforms including an exon, with additional information conveying the overall gene expression level in each condition (Pan et al., 2004; Shai et al., 2006). This representation is not only easier to derive, but also corresponds well to the hypotheses accounting for regulated AS. The regulatory mechanisms involved include various structural features and cis elements in the proximity of the alternative exon, with splicing and transcription forming two distinct networks of regulation (Hartmann and Valcarcel, 2009; Wang and Burge, 2008).

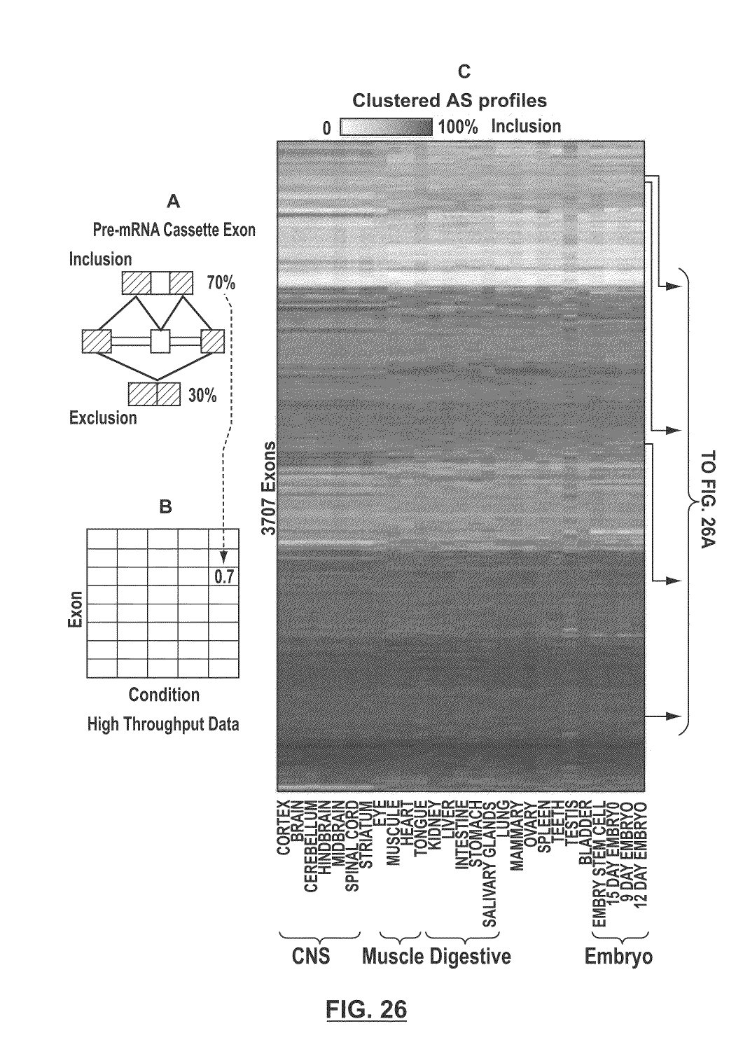

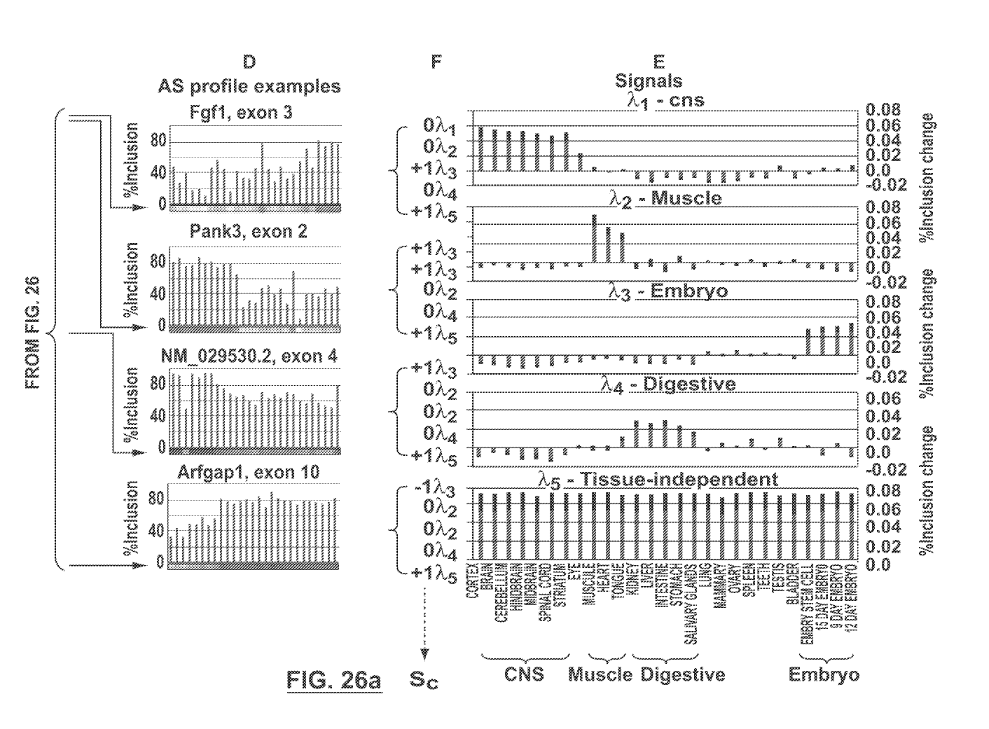

Formally, the measurements from high-throughput AS studies can be represented as a matrix whose entries convey the fraction of inclusion and exclusion isoforms for each of the exons and each of the conditions monitored in the study (FIG. 26, part B). Similarly, the overall expression levels of the genes containing each exon can be represented by a corresponding matrix. A widely used approach for identifying common patterns in such data is clustering (Eisen et al., 1998; Segal et al., 2004). Clustering the columns of the matrix derived from Fagnani et al. (2007), containing about 3700 cassette exons profiled across 27 mouse tissues, easily identifies a cluster of all central nervous system (CNS) tissues, evident on the left side of the clustergram in FIG. 26, part C. Similarly, clustering rows of the matrix, which represent AS profiles of exons, identifies groups of exons that share a similar AS profile across conditions.

While readily available and easy to apply to AS datasets, standard clustering methods such as hierarchical agglomerative clustering and K-means clustering, suffer from several drawbacks. First, many splicing changes occur in functionally related conditions, such as CNS or muscle tissues. Standard clustering is not easily modified so as to incorporate such prior knowledge. Second, a splicing change in a subset of conditions may involve two types of effects, one being a relative increase of exon inclusion levels and the second being a relative decrease. Common distance measures used for clustering either distinguish between these two effect types or ignore the difference between the two (e.g. correlation and absolute correlation coefficients). In practice, however, it is desirable to be able to distinguish between these two types of effects, but still associate them since they may share common regulatory elements. For instance, splice factors such as Nova, Fox and (n)PTB have been linked to both effects in the same tissues (Ashiya and Grabowski, 1997; Boutz et al., 2007; Minovitsky et al., 2005; Ule et al., 2006). Third, another characteristic of AS datasets not easily incorporated into standard clustering methods, is that exons may exhibit a combination of splicing changes in several functionally related tissue groups, such as muscle and CNS (Zhang et al., 2008), but occurrence of regulated splicing changes across cellular conditions is expected to generally be sparse. This expected sparsity is related to the experimental setup, where thousands of exons are monitored but most of these do not exhibit condition-specific profiles. Fourth, previous work has shown that while some exons exhibit a type of on/off splicing profile, others exhibit continuous splicing changes across tissues, and may have different tissue-independent baseline inclusion levels. A closer look at the clustering results (FIG. 26A, part D), illustrates the problems that arise from the inability to easily incorporate these domain characteristics into standard clustering. Exon 2 of Pank3 and exon 10 of Arfgapl are an example of two exons positioned on opposite ends of the clustergram, despite both exhibiting a profile containing a splicing change in CNS tissues. Exon 2 of Pank3 and exon 3 of NM_{—}029530.2 are positioned far apart since their baseline levels of inclusion are distinctly different, but both exhibit a similar pattern of increased inclusion in CNS. The Pank3 exon also exhibits increased inclusion in muscle tissues, yet it is positioned adjacent to exon 3 of Fgf1, which exhibits an unrelated splicing profile. Switching to different similarity measures [e.g. from the default L1 norm used here to Pearson's correlation, or mean squared error (MSE)] or between clustering algorithms, may help address some of these problems, but does not offer an overall solution to the issues raised.

Matrix factorization algorithms, such as principal component analysis (PCA), factor analysis (FA) and singular value decomposition (SVD), offer an alternative approach for analyzing high-throughput AS measurements. Following the terminology of SVD previously used for this task (Wang et al., 2008), these algorithms are able to identify a set of C≦T underlying ‘eigen-exons’ (termed ‘components’ in PCA and ‘factors’ in FA), and assign to each exon in the dataset a matching set of values that represent how much each of these eigen-exons contributes to a given exon AS profile. This approach is thus more naturally suited for modeling AS measurements as continuous combination of components, where each component can have either a positive (increased inclusion) or negative (increased exclusion) effect, and with different magnitude. However, these algorithms still lack some basic elements needed to properly model AS. For example, it is not obvious how to incorporate prior knowledge about the domain (e.g. groups of related experiments) or possible noise in the measurements. Specifically, some measurements are more likely to be noisy because a gene is insignificantly transcribed in a certain tissue, or suffers from low read coverage. In addition, since sparsity is not enforced in many of these algorithms, they can account for an AS profile using small amounts of many eigen-exons, and such contributions are usually meaningless in terms of underlying condition-specific regulation.

We propose a probabilistic model for high-throughput AS measurements that stems from signal processing and FA (Rubin and Thayer, 1982). In this framework, given a dataset, our objective is to identify what are the underlying AS signals that together explain the observed data, and what combination of those make up each of the observed exon AS profiles. Our generative model treats the observed AS profile of an exon as a vector of random variables which is the result of a combination of underlying (hidden) condition- specific AS signals. Each AS signal, just as the eigen-exons in SVD, is a vector across the experimental conditions. However, unlike in standard matrix factorization, the multiplicative factor modulating the contribution of each AS signal to each exon is modeled by an assignment to a random variable that can come from three different distributions: the first distribution corresponds to the signal being ‘off (i.e. contributes nothing to the AS profile), while the other two distributions represent the signal being ‘on’ or ‘reversed’, corresponding to the signal contributing to differential inclusion or exclusion, respectively. We include a sparse prior favoring the ‘off’ state to reflect the fact that most exons monitored in high-throughput experiments are not expected to exhibit condition-specific splicing changes. In addition to the AS signals, our generative model also includes a competing background model. Whether an observed measurement was generated by the signal or the background model is determined by the assignment of a matching binary noise variable, which is generally unknown (i.e. hidden). However, when additional information is available, such as the overall expression level of the exon's gene in that condition, we incorporate it into the model to increase or decrease the posterior belief that specific measurements came from the background model.

We derive an algorithm to efficiently learn the proposed model given a high-throughput AS dataset. Performing inference in the learned model, one can identify which combination of signals make up the AS profile of each exon monitored, or test exons not included in the original study. The result of such analysis is illustrated in FIG. 26A, parts E and F. Three of the identified signals in FIG. 26A, part E correspond to previously known splicing changes in CNS, muscle and embryo tissues, while the last signal corresponds to a tissue-independent signal that captures the (hidden) baseline inclusion level. One tissue-specific signal is a novel signal representing splicing changes in digestive tissues identified by the algorithm. As we discuss later, this signal was not discovered by alternative methods but was supported by a predictive model derived from putative regulatory features followed by experimental testing of the model's predictions (Barash et al., 2010). The combinations of these five AS signals used to account for the AS profiles of the four exon examples of FIG. 26A, part D are shown in FIG. 26A, part F. We see that exon 3 of Fgf1 was correctly identified as including the signal for a change in embryo tissues set to ‘on’, the three other exons correctly identified to include the CNS tissues signal set to either ‘on’ or ‘reverse’, and exon 2 of Pank3 was also found to include the signal for muscle.

In the following section, we provide more indepth details of the model and the algorithm used to learn it. In the results section, we discuss the AS signals identified and experimental verifications of exons exhibiting those signals. Then, we demonstrate the advantages of our model, both quantitatively and qualitatively, over the related SVD method and over manually defined AS signals, two approaches previously used for this task (Castle et al., 2008; Fagnani et al., 2007; Wang et al., 2008). We finish the results section relating the AS signals identified to a compendium of known regulatory features we compiled, briefly reviewing some of the mechanistic insights suggested by our analysis before concluding with a discussion of related work and future directions.

Methods

The input data includes two matrices, one for AS measurements {xₜ^{e}}∈[0,1], giving for each exon e ∈ {1, . . . , E} and condition t ∈ {1, . . . , T} the estimated fraction of isoforms that include the cassette exon, and the second matrix, {vₜ^{e}}∈R representing the estimated log-abundance of each exon's corresponding gene in each condition. We term the vector x^{e}=x₁^{e}, . . . , x_{T}^{e} the AS profile of exon e. In our probabilistic framework, the AS profile is a vector of random variables x=x₁, . . . , x_{T}, and an observed AS profile of an exon (x^{e}) is an instantiation of it. According to our generative model, an observed AS profile is a result of an unknown combination of a set of unknown components, or AS signals {λ_{c}}_{c=1}^{C} where λ_{c} is a vector over the measured conditions λ_{c,1}, . . . , λ_{c,T}, where λ_{c,t}∈ R. We know from previous studies (Castle et al., 2008; Wang et al., 2008) that splicing changes across conditions may occur at different levels of magnitudes. Accordingly, the contribution of each signal λ_{c} depends on a multiplicative factor, modeled by a matching random variable m_{c} ∈ R. To reflect the fact that each AS signal (e.g. inclusion change in CNS tissues) may contribute to an observed AS profile either positively (increase inclusion) or negatively (increase exclusion), and that most exons surveyed in such high-throughput datasets are not expected to exhibit a condition-specific splicing profile, we use a mixture distribution for the magnitude modulation variable m_{c}. The class of this mixture distribution is represented by a ternary random variable s_{c}, and corresponds to three components: s_{c}=0 which means the signal is absent (m_{c}=0), s_{c}=+1 and s_{c}=−1 which imply positive (m_{c}>0) or negative (m_{c}<0) contributions of the matching signal λ_{c}. To summarize, we have:

$$P ( {x}_{t}^{e} , {s}^{e} , {m}^{e} ) = P ( {s}^{e} ) P ( {m}^{e} \vert {s}^{e} ) N ( {x}_{t}^{e} ; {\sum }_{c = 1}^{C} {λ}_{c , t} {m}_{c}^{e} , {ψ}_{t} ) ,$$

where N denotes a Gaussian with variance ψₜ. To eflect the fact that most exons are not expected to exhibit condition-specific AS profiles, we use a sparse prior where ∀ c P(s_{c}=0)>>P(s_{c}=±1). When an AS signal is absent (s_{c}=0) we have mc set to zero. For cases where an AS signal is present (s_{c}=±1) we use P(m_{c}|s_{c})=N(m_{c}; v_{c}, y_{c}) and initialize it with v_{c}=±4, y_{c}=1, (In FA, changing either v_{c} or y_{c} of mc prior distribution have the same effect on the model's likelihood as the magnitude of the signal multiplied by m_{c} is absorbed by the values of the matching λ_{c}) to avoid situations where s_{c}^{e}≠0 (indicating a change in splicing), but the magnitude of the change is close to zero. We note that while the Gaussian assumption carries the benefits of mathematical tractability for the derivations that follow, it is not ideal for modeling a distribution over a random variable confined to a finite range. However, we stress that the marginal distribution P(xₜ^{e}) as defined above is actually a mixture distribution, with the assignment s_{c} determining the mixture component.

The assignments to those mixture variables in turn determine which exon exhibits each of the inferred AS signal.

Exons surveyed in high-throughput experiments tend to have varying baseline inclusion levels. Indeed, when performing SVD analysis of AS data the first and most prominent signal identified is a tissue-independent signal (see Results, below). To model this we incorporate into the model a signal λ_{B} that is forced to be used in the positive sense in all cases (i.e. s_{B}^{e}=+1, ∀e with with m_{B}˜N(v_{B}, y_{B}), initialized using v_{B}=4, y_{B}=1). This is the fifth AS signal depicted at the bottom of FIG. 26A, part E. While the exact value of λ_{B} is updated during learning, the m_{B} variable guarantees varying magnitudes of this baseline signal to appear in the AS profile of each exon.

Next, we incorporate into the model gene expression levels and possibly other knowledge about the experiments. Intuitively, if a gene is not expressed in a specific cellular condition t then a corresponding entry xₜ^{e} for one of its exons should be ignored. In practice, either biological factors (e.g. low gene expression) or technical ones (e.g. non-specific hybridization or fluctuations in read coverage) usually lead us to ascertain higher or lower confidence to measurements. We assume additional measurement information such as gene expression levels is given as a matrix {vₜ^{e}} and generally vₜ^{e} ∈ R. To utilize this information, our generative framework contains alongside the signal model a competing background or outlier model. A hidden binary variable nₜ indicates whether each observation xₜ^{e} was generated from the signal model (nₜ^{e}=0) or from the background model nₜ^{e}=1. Formally:

$$P ( {x}^{e} , {m}^{e} , {s}^{e} , {v}^{e} ) = {\prod }_{c} P ( {s}_{c}^{e} ) P ( {m}_{c}^{e} \vert {s}_{c}^{e} ) \cdot {\prod }_{t} [ \begin{matrix}P ( {n}_{t}^{e} = 1 ) P ( {v}_{t}^{e} \vert {n}_{t}^{e} = 1 ) N ( {x}_{t}^{e} ; {μ}_{t} , {φ}_{t} ) + \\ P ( {n}_{t}^{e} = 0 ) P ( {v}_{t}^{e} \vert {n}_{t}^{e} = 0 ) N ( {x}_{t}^{e} ; {\sum }_{c = 1}^{C} {λ}_{c , t} {m}_{c}^{e} , {ψ}_{t} )\end{matrix} ]$$

(referred to herein as Equation A). If prior knowledge about the quality of the AS measurements, given by P(vₜ^{e}|nₜ^{e}), is not available, we simply set P(nₜ=1) to a low value, indicating low outlier probability. More details on how setting P(vₜ^{e}|nₜ^{e}) using gene expression information are given in Supplementary Material.

Gene expression levels have an additional role, besides guiding the model to assign higher or lower confidence in the AS measurements. Specifically, high gene transcript levels correlate with skipping of alternative exons, possibly because of ‘kinetic coupling’ (Kornblihtt, 2007) where changes in the rate of transcriptional elongation in turn affect the timing in which splice sites are presented to the splicing machinery. To account for this phenomena we include an additional signal in our model, based on the expression measurements. Unlike other signals in the model (or in standard matrix factorization), this signal is not learned but determined directly from the expression values of each exon's corresponding gene. We therefore denote it λ_{V}^{e}, where λ_{V,t}^{e}=vₜ^{e}, t ∈{1, . . . T}. Since in this case the modulation levels may be positive or negative (corresponding to a positive or negative correlation with gene expression) and some may be relatively small, we set the distribution over it to be P(mᵥ)=N(mᵥ; vᵥ=0, yᵥ) and learn the variance yᵥ.

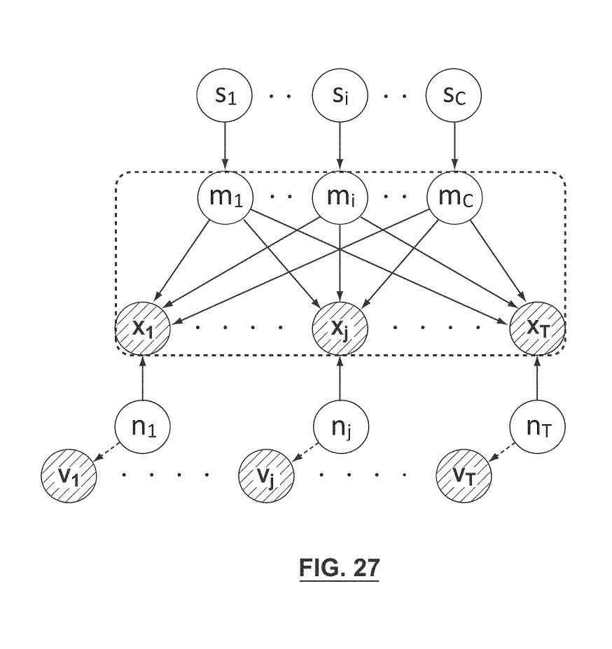

To summarize, the addition of a baseline and expression signals via the m_{b} and m_{y} modulation variables imply that the condition-specific AS signals identified by the model and their assignments to the various exons are inferred after tissue-independent inclusion level and gene expression effects are accounted for. The resulting model can be represented as a Bayesian network (FIG. 27, in which observed variables are shaded and dependencies are denoted with directed edges. The dashed frame denotes elements shared with standard FA.), with the model elements that are shared with standard FA denoted by a dashed line. Compared with FA, the model includes four major changes outlined above: the addition of a separate baseline and expression signal; the introduction of a mixture distribution over the factor modulation variable m_{c} via a matching s_{c} variable to enforce sparse signal activation with either positive or negative effects; and the addition of a competing outlier model with gene expression or other experimental information serving as noisy sensors for it, via the {nₜ} variable set.

Learning the Model

Given input data {xₜ^{e}} and {vₜ^{e}}, the objective of our probabilistic generative framework is to learn the model parameters Θ={λ_{c}, ψₜ, y_{c}, v_{B}, Yᵥ, μₜ, φₜ} that maximize the likelihood of the data. We develop an efficient learning algorithm, based on generalized expectation maximization (EM), to optimize a bound on the likelihood termed free energy (Neal and Hinton, 1998). Similar to standard FA and independent factor analysis (IFA) (Attias, 1999) (and unlike SVD/PCA that are optimized analytically), convergence to the global optimum is not guaranteed We therefore follow the learning algorithm description with a review of how it can be effectively initialized and directed to find good solutions. Finally, we review how the free parameters that control the number of AS signals C and the sparsity of those P(s_{c}) can be set.

The structure of the graphical model in FIG. 27 illustrates the computational complexity of running standard parameter learning and inference methods given the data, since the dependency between s=s₁, . . . , s_{c} and n=n₁, . . . , n_{T} makes such inference intractable for moderate values of T and C. We therefore use a variational approximation (Neal and Hinton, 1998) for the joint posterior distribution Q(s^{e}, m^{e}, n^{e}) given the observed inclusion levels x^{e} and additional data v^{e}:

$$P ( {s}^{e} , {m}^{e} , {n}^{e} \vert {x}^{e} , {v}^{e} ) \approx Q ( {s}^{e} , {m}^{e} , {n}^{e} ) = {\prod }_{c = 1}^{C} ( Q ( {s}_{c}^{e} ) N ( {m}_{c}^{e} ; {η}_{{s}_{c}}^{e} , {σ}_{{s}_{c}}^{e} ) ) {\prod }_{t = 1}^{T} Q ( {n}_{t}^{e} ) ,$$

(referred to herein as Equation B) where ηₛ_{_{c}}^{e}, σₛ_{_{c}}^{e} are the variational parameters governing the posterior distribution over the modulation assignments. Given this variational approximation, learning a maximum likelihood model is done using an EM-like iterative procedure. We defer additional technical details to the Supplementary Material, and only note that for the results presented in the following sections, the learning procedure converges to a set of parameters that define the AS signals (given by {λ_{c}}) and that the posterior belief that a given exon's AS profile x^{e} includes a specific signal as either ‘off’, ‘on’ or ‘reversed’, is given by Q(s_{c}^{e}) with s_{c} ∈{0, +1, −1} in the above equation.

As is usually the case with EM-based learning algorithms, it is imperative to initialize the model parameters properly. When there is no prior knowledge, we create a random initialization point by setting λ_{c} to the average AS profile plus independent Gaussian noise with variance equal to the AS profile variance. Similarly, μ is initialized to the average tissue profile, while ψ and Φ are initialized to the variance of the AS profiles. In addition, to avoid poor local minima for a given training set, we repeat this procedure N times and select the model with the highest likelihood (N=50 in the experiments described below).

Finally, we describe how the model's free parameters can be set. We employed a standard approach of cross-validation to test how well different model settings do on train and test data. The most crucial parameter to set is C, the number of underlying AS signal assumed to comprise a given dataset. We evaluate different values for C in the following section. For the signal sparsity prior P(s_{c}), we wanted the model to avoid assigning AS signal with low values and therefore used the following preprocessing. Initial SVD analysis identified the well-known AS signals for CNS, muscle and embryo tissues (see Results), with the cumulative distribution over the singular values associated with these signals typically shaped like a sigmoid. Consequently, we set the prior P(s_{c}=±1) at 0.08 to reflect the probability mass of both edges of this sigmoid. The AS signals identified and their assignments to exons were not sensitive to changes (±0.05) to these settings as long as sparsity was maintained (data not shown).

### Setting Signals Using Biological Knowledge

An additional benefit of the model-based approach described here is that specific initialization points and model constraints can be easily incorporated. These initialization points or model constraints can be used to reflect prior biological knowledge about the underlying AS signals in the data. While the uninformed initialization scheme described above works generally well (see Results), several reasons may lead researchers to prefer biologically directed solutions. First, learning such solutions may be computationally efficient, leading to quick convergence and avoiding excessive numbers of random restarts. Perhaps more importantly, our generative model ultimately serves as an approximation for the physical process that yielded the observed measurements. As such, there may be several solutions the model can converge to, with some that are biologically plausible yet quite different. For these reasons, as we demonstrate in the Results section, it is beneficial to have the ability to use different biologically directed and undirected settings, exploring the space of possible solutions.

To direct the learning algorithm toward a certain solution for the AS signals, we use the following procedure: for any subgroup of conditions T′⊂{1, . . . , T} corresponding to a known signal we initialize a matching signal λ_{c} so that sign(λ_{c,t})=sign(λ_{c,t′}) ∀t,t′∉T′, while λ_{c,t}=0 ∀t∉T′. If this is a good solution in terms of the likelihood surface, the learning algorithm can quickly converge to a similar solution in the neighborhood of this starting point. As we later show, we can also initialize a subset of the signals in such a way, and learn the rest of the signals using random initializations. Alternatively, we can constrain the model so that λ_{c,t}=0 ∀t∉T′ and learn only the subset of the parameters {λ_{c,t}}, ∀t∉T′. If we use only such constrained signals, this is equivalent to inferring the contribution of AS signals from predefined condition groups, along with the baseline inclusion level. We note, however, that unlike many clustering and bi-clustering algorithms, even in such a constrained scenario, each condition t may be included in more than a single AS signal, and for a specific signal c, the contribution of the conditions T′ that define it need not be the same. The advantage of this modeling ability is nicely illustrated in the AS signals depicted in FIG. 26A, part E, derived using unconstrained learning with a biologically derived initialization point. While the eye tissue is obviously rich with nerve cells, it is not exclusively part of the CNS. Consequently, it appears in the inferred CNS signal (λ₁), but has a lower value associated with it.

### Results

We used the dataset of Fagnani et al. (2007), comprising 3707 cassette exons measured across 27 mouse tissues to evaluate our computational method. The condition-specific AS signals, corresponding to splicing changes in CNS, muscle, embryo and digestive tissues, are shown in FIG. 26A. The error bars for the signals were derived by randomly sampling subsets containing 80% of the original data. The four tissue-specific AS signals identified were also supported by a recent work where splicing changes corresponding to these four signals where predicted directly from genomic sequence and verified experimentally using RT-PCR experiments (Barash et al., 2010).

### Comparison to Alternative Approaches

The comparison to alternative computational approaches for signal extraction includes two main parts: the AS signals identified, and their assignment to exons. Computational alternatives can be broadly divided into two subgroups: supervised and unsupervised. The supervised approach is based on prior knowledge of condition groups (e.g. CNS tissues) and is executed by computing a statistic for each exon such as the difference between its mean inclusion level in a predefined group of conditions compared with all the others. The set of exons for which the inclusion levels in these groups deviates the most are subsequently assigned the AS signal matching these groups (Castle et al., 2008; Fagnani et al., 2007). The second, unsupervised, computational alternative includes clustering algorithms discussed in the Introduction, and variants of matrix factorization.

We start by comparing the identified AS signals. For the supervised approach, comparing the three major AS signals corresponding to splicing changes in CNS, muscle and embryo tissues is not particularly informative as the signals are both known and highly robust (see below). However, it is important to note that the supervised approach can only be applied to signals that are already known. Unless additional exploratory analysis is performed, this approach cannot detect unknown signals such as those corresponding to splicing changes in digestive tissues or in two subgroups of CNS tissues described below.

Matrix factorization algorithms, such as SVD, PCA and FA, are implemented in various software packages and represent the second alternative approach for AS signal extraction. We term this approach ‘unsupervised’ since, unlike the first approach described, the underlying signals are not set in advance. For comparison, we focused on SVD, which was recently applied to this task (Wang et al., 2008). In SVD, the input matrix of observed inclusion levels X is decomposed so that X=USV^{T}. The diagonal matrix S contains the singular values, ordered by magnitude, while the rows Vₖ represent ‘eigen-exons’. SVD guarantees that for any C≦rank [X] using only the first C components of the matrices U, S, V^{T} produces a matrix X^{C} that is the closest, by MSE, to X from all rank C matrices. This can be given a probabilistic interpretation when assuming a fixed Gaussian noise model for the observations.

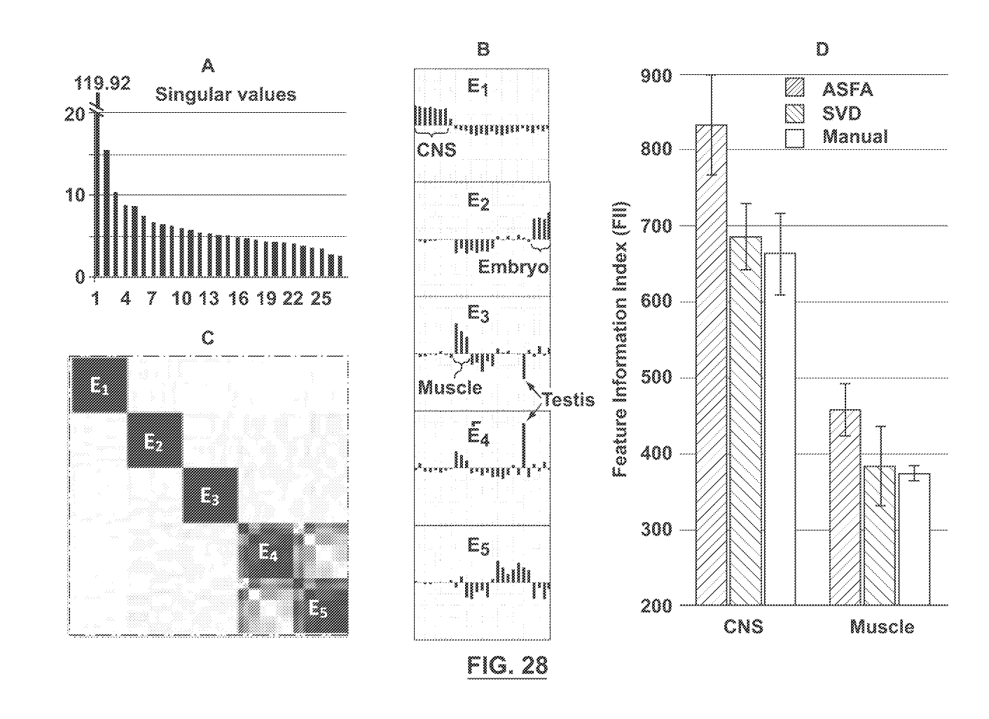

FIG. 28 shows the results of SVD analysis. Based on the magnitude of the singular values (part A), we included in subsequent analysis the first six eigen-exons. The first and by far most dominant singular value (119.2), corresponds to a tissue-independent eigen-exon, while the following five eigen-exons, denoted E1, . . . , E5, are shown in part B. SVD clearly retrieves CNS, muscle and embryo AS signals represented by the first three eigen-exons. To test how robust the signals identified by SVD are, we performed the following procedure: we created ten subsets containing 80% of the data, then computed the pairwise correlation between the signals identified for each of the 10 data subsets. The pairwise correlations between the five eigen-exons derived for each of these data subsets are plotted as a heat-map in FIG. 28, part C. The first three eigen-exons, matching splicing changes in CNS, muscle and embryo tissues, were highly robust but the fourth and fifth signals were less clear (FIG. 28, part B). Over the 10 data subsets, the fourth and fifth eigen-exons contained various combinations of tissues with at least one always having a strong peak in testis. The testis tissue, which is a clear outlier in this dataset, also appeared in other eigen-exons, such as the muscle one (E3) depicted in FIG. 28, part B. This result is probably due to the fact that SVD analysis, based on a uniform Gaussian noise model and no additional modulation, is more sensitive to outliers.

Next, we evaluated the quality of the signal assignments to exons. When analyzing real-life high-throughput data, the correct assignment of signals to exons is generally not known. We therefore defined an independent measure for the quality of the signal assignment, termed the feature information index (FII). In short, the Eli measures the enrichment of previously reported regulatory elements in groups of exons assigned a specific AS signal (e.g. splicing changes in CNS tissues). See Supplementary Material for more details. The rational behind the Ell measure is that a better definition of a set of exons as those that exhibit splicing changes in certain conditions should consequently lead to finding higher enrichment levels within this exon set of elements known to regulate splicing in these conditions. We note that the algorithms only had access to AS and expression measurements; thus, the Eli can serve as an independent quality measure. Moreover, the FII may also be indicative of the quality of further downstream analysis of high-throughput AS datasets, as many of the works producing these datasets subsequently try to identify the regulatory elements and underlying mechanisms that govern condition-specific AS.

Our model allows the assignment of signals to exons by setting a threshold that represents high confidence according to the signal posterior Q(s_{c}^{e}) defined above in the Methods section. In the case of SVD, each column vector U^{c} defines an ordering over the amount each eigen-exon c contributes to each exon. Similarly, for the supervised approach the magnitude of the difference between the mean inclusion level in a predefined condition group (e.g. CNS tissues) and the rest also defines an ordering over the exons. However, both of these computational alternatives have no built-in method to set a threshold for signal assignments. In order to avoid biasing the FII measure due to differences in group sizes, we therefore used the orderings of these methods defined over exons for each AS signal to create groups of the same size as our model defined. Specifically, in the experiments described we used a confidence threshold of Q(s_{c}^{e})≧0.9 to define both the exons that had a signal (s_{c}=±1) or did not have it (s_{c}=0). Changing the threshold to 0.99 yielded similar results (data not shown).

The results of the Ell evaluation are summarized in FIG. 28, part D. Only CNS and muscle tissue groups are shown as these are the only tissues for which a substantial knowledge of condition-specific cis regulatory elements is currently available (see Supplementary Material for details). SVD and the supervised method gave similar results, while our method scored significantly higher for both signals. The similar performance of SVD to the manually constructed tissue groups is to be expected in this case as both matching eigen-exons are dominated by these tissue groups, and SVD uses a fixed MSE model to assign those to exons. In contrast, our modeling approach identified the same two AS signals but is able to reject noisy measurements and assign signals to exons with varying degrees of splicing changes due to the modulation factor.

Evaluation of Model Settings

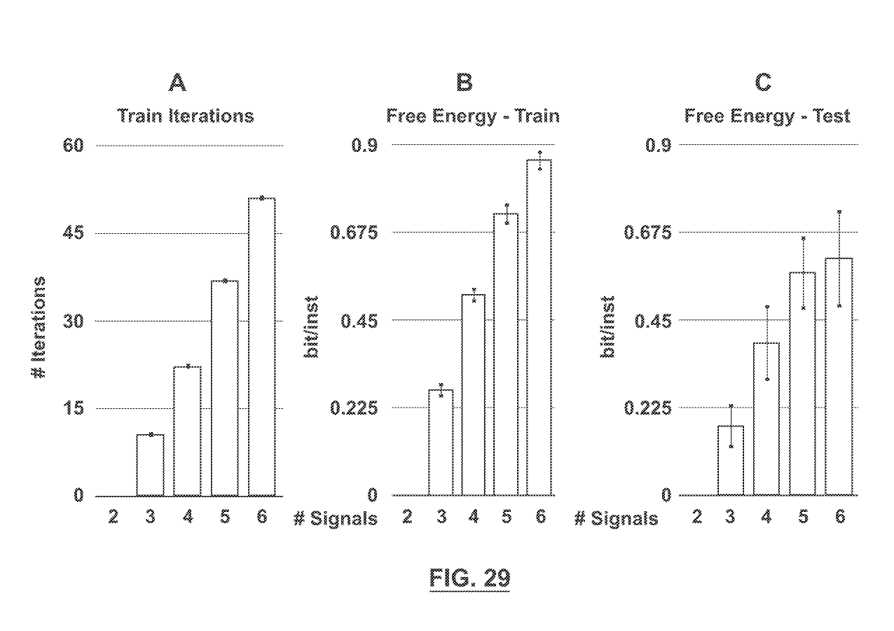

We start the evaluation of the model settings by addressing the most prominent question of how many AS signals are we able to identify in the data. We employed a train and test procedure, randomly choosing 80% of the exons for training, and keeping the other 20% for testing. FIG. 29 shows the effect of increasing the number of underlying AS signals C in our model, where the baseline is a simple model containing only two tissue-specific AS signals, a tissue-independent signal (λ_{B}) and the expression-dependent signal (λ_{V}). Error bars were derived by repeating the above procedure 10 times. As expected, when the number of signals increases, so does the time it takes for the algorithm to explore the search space and converge (FIG. 29, part A). While the free energy keeps dropping for the training set, for test data we see a clear saturation effect after reaching five signals.

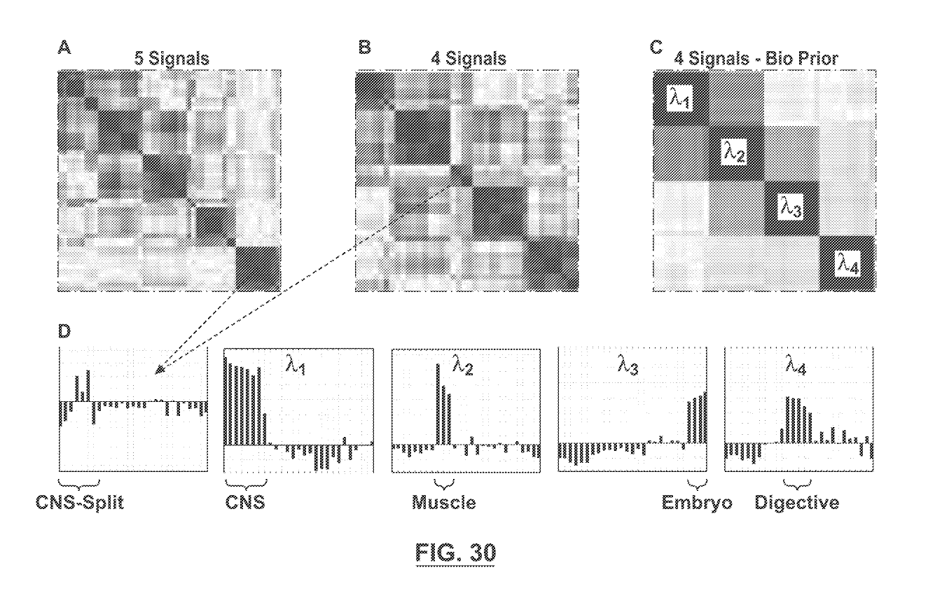

Since the algorithm converges during learning to a specific set of signals that represent a local optimum in the search space, a highly related question is how robust are these signals. In one extreme, convergence to very different solutions under slight data perturbation that make no biological sense would indicate a problem in the modeling approach or with the ability to overcome local minima, while, on the other hand, consistent convergence to a single solution would suggest a distinct global optimum under the modeling assumptions. To test the robustness of the identified signals, we repeated the same procedure that we used for evaluating SVD, using the same 10 randomly chosen subsets containing 80% of the original data. For each subset we learned the AS signals, then computed the pairwise correlation between the signals. FIG. 30 shows a heat-map for the pairwise correlations between all AS signals learned under different settings of the algorithm. The tested settings include either four or five tissue-specific signals, using random initialization and initializing the model to include three known AS signals corresponding to splicing changes in CNS, muscle and embryo tissues. In general, we found that randomly initialized runs always converged to solutions that included CNS, muscle and embryo signals, sometimes slightly combined. The best scoring solutions had distinct CNS, muscle and embryo signals, with a split between the CNS tissues sometimes occurring when learning either four or five signals (FIG. 30, part D, left panel). This split may represent a novel distinction, in terms of AS signals, between two subgroups of CNS tissues: one that is dominated by spinal cord and hindbrain and another that is dominated by striatum and cortex.

When the model was initialized with three AS signals corresponding to known splicing changes in CNS, muscle and embryo tissues, the algorithm convergence was highly robust for all 10 data subsets (FIG. 30, part C). We note that in this setting the first three signals were only initialized to these tissue groups but not held fixed. Moreover, the initialization for the fourth signal was kept random as we had no prior knowledge for additional signals, yet the algorithm consistently converged to it given the other settings. The four tissue-specific signals the algorithm converged to are shown in FIG. 30, part D. These signals match with those shown in FIG. 26A, where we also included the variance of the signals. We noticed that adding additional random restarts to several data subsets that originally converged to a different set of signals, eventually yielded this set of AS signals, implying this may be a slightly better solution and possibly a global optimum for these data subsets too. Taken together with the other results, we conclude that while the search space of the algorithm contains many local optima, all of these include a combination of CNS, muscle and embryo signals. The ability to switch between directed and undirected exploration of the search space was beneficial for the analysis of the data, with the undirected search identifying one local optimum that includes a distinction between two groups of CNS tissues and the directed search leading to a more stable solution that includes a novel splice pattern in digestive tissues verified by direct experiments.

Next, we tested the effect of modeling each measurement as generated from either the AS signals or a competing background model, with a posterior belief derived from the observed gene expression levels. Compared with an uninformative sparse noise prior, the derived AS signals remained similar but convergence time was reduced by 30%. This moderate effect was probably due to the fact that only about 11% of the measurements in the data of Fagnani et al. (2007) were suspected as noise based on expression values; thus, using this prior allowed the algorithm to converge more quickly but had little effect on the actual resuft. We suspect the noise prior may play a more critical role in cases where a larger portion of the data is expected to be noise (see Supplementary Material for an example). We also tried varying the sparsity of the signal prior (P(s_{c}=±1)), within a ±5% range, with no substantial effect in terms of the signals identified or their assignment to exons. Standard FA, where sparsity of the signals is not enforced, gave similar results to the SVD analysis described before (data not shown).

Regulatory Features Associated with AS Signals

While not being the main focus of this work, we conclude this section with a review of the correspondence between the AS signals we identified and known regulatory elements included in the FII. In general, we found excellent agreement between our results and previously reported ones. Nova YCAY motifs were found to be enriched mostly in the downstream introns of exons associated with increased inclusion in CNS and mostly downstream of exons downregulated in those tissues. Some of the more distant regions enriched in Nova motifs were also identified (Ule et al., 2006). Fox motif variants ([U]GCAUG) were associated with inclusion in muscle and to lesser extent brain tissues when appearing in the downstream intron, and mostly with exclusion in those tissues when in the upstream intron. However, this motif was correlated with a general change in exon inclusion in those tissues, indicating a reversed effect too, a result in accordance with a recent study (Zhang et al., 2008). CU-rich motifs known to bind (n)PTB were found to be highly enriched both up-and downstream of exons exhibiting splicing changes in several tissue groups, most prominently CNS. This result is inline with (n)PTB known role as a derepressor in CNS tissues and its ability to loop across relatively short exons, as in the well-studied case of src N1 (Chan and Black, 1997). An interesting result involved the Quaking-like motif ACUAAY, which was previously reported enriched downstream of exons exhibiting increased inclusion in muscle (Das et al., 2007; Wang et al., 2008). We not only identified this enrichment, but also an enrichment upstream of exons exhibiting splicing changes in CNS, which is in line with known roles of this class of splicing factors in neuronal disease mutations.

### Additional Discussion

In this work we presented a model-based approach to identifying condition-specific AS signals from high-throughput data. Unlike other approaches, our generative model is specifically tailored for this task. It incorporates prior knowledge about AS, including known correlation to expression levels, modeling of a tissue-independent signal, the expected sparsity of the AS signals and the fact that AS signals may have either a positive or negative effect. The model is also able to incorporate specific knowledge about a given dataset, including information about the quality of the measurements, related gene expression levels and knowledge of specific AS signals in the data. We compared our approach with commonly used alternatives and showed that on real data it was able to produce superior results in terms of the signals identified, their robustness and their assignments to biologically important groups of exons. For the latter, we defined an independent measure of quality, the FII, performed a literature search for tissue-specific splicing regulatory cis elements, and showed that the assignment of AS signals by our method correlated significantly better with those elements. Our method was able to detect a novel split of the signal for splicing changes in CNS tissues into two separate subgroups of tissues, and a previously unreported AS signal associated with digestive tissues. The four main tissue-specific AS signals identified by our model are supported by a predictive model derived from putative regulaotry features, including experimental testing of the model's predictions (Barash et al., 2010).

Previous work developing related models include IFA and another form of a mixture of factor analyzers (Attias, 1999; Ghahramani and Hinton, 1996). Both of these models, developed for different applications, differ from ours in the mixture model used and do not include domain-specific elements, such as the background model, the gene expression levels and the AS baseline signals. More recent work involving general matrix factorization algorithms include the work by (Dueck et al., 2005), which was applied to gene expression data and Robust PCA (Candes et al., 2009), which involves sparse signal assignments and noisy data. In general, the computational alternatives currently available can be broadly divided into two: supervised and unsupervised methods. The first mostly consists of computing statistics such as the mean inclusion level for a predefined group of conditions, while the other includes clustering methods such as hierarchical agglomerative clustering, as well as SVD, PCA and other variants of matrix factorization algorithms. Compared with those, our modeling approach can range between supervised and unsupervised signal identification, depending on the amount of additional information incorporated into the model. We were able to demonstrate the usefulness of this trade-off between search space exploration and prior knowledge exploitation for the identification of AS signals in the data.

There are several direct computational extensions to the model presented here. One extension involves defining the number of components in the model as a random variable and marginalizing over it. A recent work by (Paisley and Garin, 2009) implemented such a model for factor mixtures using a beta process prior. We note though that in our context we are not simply interested in marginalizing out the component number, since the identity of the AS signals and the exons associated with them are biologically meaningful. Another possible direction for future work is to replace the Gaussian mixture components used in our model with alternative distributions that would fit the data better. This change would be of practical use if the better fit to the data would also lead to more accurate signal assignments to exons.

We briefly reviewed some of the regulatory elements we identified as enriched in groups of exons associated with the AS signal reported. Many of these are in excellent agreement with previously published results, including the role and positional bias of cis element known to bind Nova, PTB and Fox. Some identified features, such as the Quaking motif upstream of exons highly included in CNS, offer possible insights to additional regulatory mechanisms.

The correlation between signals identified by our model and regulatory elements points to possible extensions and applicative potential of the modeling approach we propose. Our probabilistic framework can naturally be extended to a unified framework where combinations of regulatory features are used to explain identified AS signals and the assignment of these signals to exons is subsequently used to refine the regulatory programs learned. Such a unified approach for modeling regulatory programs has been applied successfully in other domains (Bar-Joseph et al., 2003; Beer and Tavazoie, 2004; Segal et al., 2002, 2003). In our recent work (Barash et al., 2010), the model described here was utilized to construct a regulatory code that predicts tissue-specific splicing changes directly from genomic sequence. Our framework can be extended to incorporate additional information such as secondary structure elements, nucleosome positions and splice factor binding measurements (Licatalosi et al., 2008), to gain further insights into the underlying regulatory mechanisms associated with each AS signal.

Based on the analysis of AS signals we report and the comparison of our method to standard computational alternatives, we believe this work will facilitate the study of future high-throughput AS datasets, extending our understanding of the transcriptome complexity.

### Supplementary Material

### Variational EM for Model Learning

The variational approximation for the joint posterior distribution Q(s^{e}, m^{e}, n^{e}) given the observed splice levels x^{e} is given by:

$$Q ( {s}^{e} , {m}^{e} , {n}^{e} ) = {\prod }_{c = 1}^{C} ( Q ( {s}_{c}^{e} ) N ( {m}_{c}^{e} ; {η}_{{s}_{c}}^{e} , {σ}_{{s}_{c}}^{e} ) ) {\prod }_{t = 1}^{T} Q ( {n}_{t}^{e} ) = {\prod }_{c = 1}^{C} ( {q}_{{s}_{c}}^{e} N ( {m}_{c}^{e} ; {η}_{{s}_{c}}^{e} , {σ}_{{s}_{c}}^{e} ) ) {\prod }_{t = 1}^{T} {q}_{{n}_{t}}^{e} ,$$

where ηₛ_{_{c}}^{e} , σₛ_{_{c}}^{e} are variational parameters governing the posterior distribution over m_{c}^{e} , the probability Q(s_{c}^{e})=qₛ_{_{c}}^{e} is the posterior for signal assignment s_{c}, and Q(nₜ^{e})=qₙ_{_{c}}^{e} gives the posterior for the measurement xₜ^{e} to come from the noise (nₜ=1) or signal (nₜ=0) model. Given this variational approximation, learning the model amounts to minimizing the free energy (references 7, 5):

$$F = {\sum }_{e} {\sum }_{{s}^{e} , {n}^{e}} {\int }_{{m}^{e}} Q ( {s}^{e} , {m}^{e} , {n}^{e} ) log \frac{Q ( {s}^{e} , {m}^{e} , {n}^{e} )}{P ( {s}^{e} , {m}^{e} , {n}^{e} , {x}^{e} )}$$

This can be rearranged to the more intuitive form:

$$F = {\sum }_{e} {D}_{KL} ( Q ( {s}^{e} , {m}^{e} , {n}^{e} ) \vert \vert P ( S , M , N , {x}^{e} ) )$$

$${\sum }_{e} [ \begin{matrix}{\sum }_{c} {D}_{KL} ( Q ( {s}_{c}^{e} ) \vert \vert P ( {s}_{c} ) ) + {\sum }_{t = 1}^{T} {D}_{DK} ( Q ( {n}_{t}^{e} ) \vert \vert P ( {n}_{t} ) ) + \\ {D}_{KL} ( Q ( {m}^{e} \vert {s}^{e} , {n}^{e} ) \vert \vert P ( m , x , \vert s , n ) )\end{matrix} ] ,$$

where D_{KL} denotes the Kullback-Leibler divergence. Because of the Gaussian assumptions the integral is an alytic and because Q(n^{e}) and Q(s^{e}) factorize across the T conditions and the C signals, the sums over n and s simplify so that their computation takes time that is linear in the number of conditions and the number of signals. Combining Equations A and B with the form of the prior distributions and the above equations, we get after further mathematical manipulation:

$$F = {\sum }_{c} {D}_{KL} ( Q ( {s}_{c} ) \vert \vert P ( {s}_{c} ) ) + {\sum }_{t = 1}^{T} {D}_{KL} ( Q ( {n}_{t} ) \vert \vert P ( {n}_{t} ) ) ++ {\sum }_{t = 1}^{T} [ \begin{matrix}\begin{matrix}\frac{1}{2} log 2 π + \frac{1}{2} {q}_{{n}_{t} = 0} ( log {ψ}_{t}^{2} + {ψ}_{t}^{- 2} {x}_{t}^{2} ) + \\ \frac{1}{2} {q}_{{n}_{t} = 1} ( log {φ}_{t}^{2} + {φ}_{t}^{- 2} {x}_{t}^{2} - 2 {φ}_{t}^{- 2} {x}_{t} {μ}_{t} + {φ}^{- 2} {μ}_{t}^{2} ) ++\end{matrix} \\ {\sum }_{k} {\sum }_{{s}_{c} \neq 0} \frac{1}{2} {q}_{{s}_{c}} ( \begin{matrix}\begin{matrix}- 1 - log {σ}_{{s}_{c}}^{2} + {σ}_{{s}_{c}}^{2} + {η}_{{s}_{c}}^{2} - \\ 2 {η}_{{s}_{c}} {v}_{c} + {v}_{c}^{2} - 2 {q}_{{n}_{t} = 0} {ψ}_{t}^{- 2} {x}_{t} {λ}_{t , c} {η}_{{s}_{c}} ++\end{matrix} \\ \begin{matrix}[ \begin{matrix}{q}_{{n}_{t} = 0} {ψ}_{t}^{- 2} {λ}_{t , c} {η}_{{s}_{c}} {\sum }_{{k}^{′} \neq k} \\ {λ}_{i , {k}^{′}} {\sum }_{{s}_{c}^{′} \neq 0} Q ( {s}_{c}^{′} ) {η}_{{s}_{c}^{′}}\end{matrix} ] + \\ [ {q}_{{n}_{t} = 0} {ψ}_{t}^{- 2} {λ}_{t , c}^{2} ( {η}_{{s}_{c}}^{2} + {σ}_{{s}_{c}}^{2} ) ]\end{matrix}\end{matrix} )\end{matrix} ] ,$$

where, with a slight abuse of notation, we removed the explicit dependency on e and the sum over it for compactness. During learning, the free energy defined above is minimized iteratively using a variational EM procedure (references 7, 5). In short, at every maximization (M) step, the derivative of the above Equation with respect to the model's parameters is computed, while the expectation (E) step involves a short series of point estimates for the expected assignment or sufficient statistic Q(nₜ), Q(s_{c}), ηₛ_{_{c}}, σₛ_{_{c}} with the model's parameters held fixed. As usual with EM based algorithm, this iteration continues until convergence to a local minimum is reached. In the experiments described, we used 10⁻⁵ fold change as the stopping criteria. Finally, given the learned model we can infer the desired signal assignments to each exon by performing inference and computing {q_{e,c}^{s}}∀c,e. Using the above equation we solve for

$$\frac{\partial F}{\partial {q}_{{s}_{c}}} = 0$$

to get:

$$log {q}_{{s}_{c}} = log P ( {s}_{c} ) - 1 + \frac{N}{2} ( 1 + log {σ}_{{s}_{c}}^{2} - {σ}_{{s}_{c}}^{2} - {η}_{{s}_{c}}^{2} + 2 {η}_{{s}_{c}} {v}_{c} - {v}_{c}^{2} ) ++ {\sum }_{i = 1}^{T} {q}_{{n}_{t} = 0} {ψ}_{t}^{- 2} {λ}_{t , c} [ \begin{matrix}{x}_{t} {η}_{{s}_{c}} - {η}_{{s}_{c}} [ {\sum }_{{c}^{′} \neq c} {λ}_{t , {c}^{′}} {\sum }_{{s}_{{c}^{′}} \neq 0} {q}_{{s}_{{c}^{′}}} {η}_{{s}_{{c}^{′}}} ] - \\ \frac{1}{2} {λ}_{t , c} ( {η}_{{s}_{c}}^{2} + {σ}_{{s}_{c}}^{2} )\end{matrix} ]$$

### Using Gene Expression to Update Signal Model Posterior

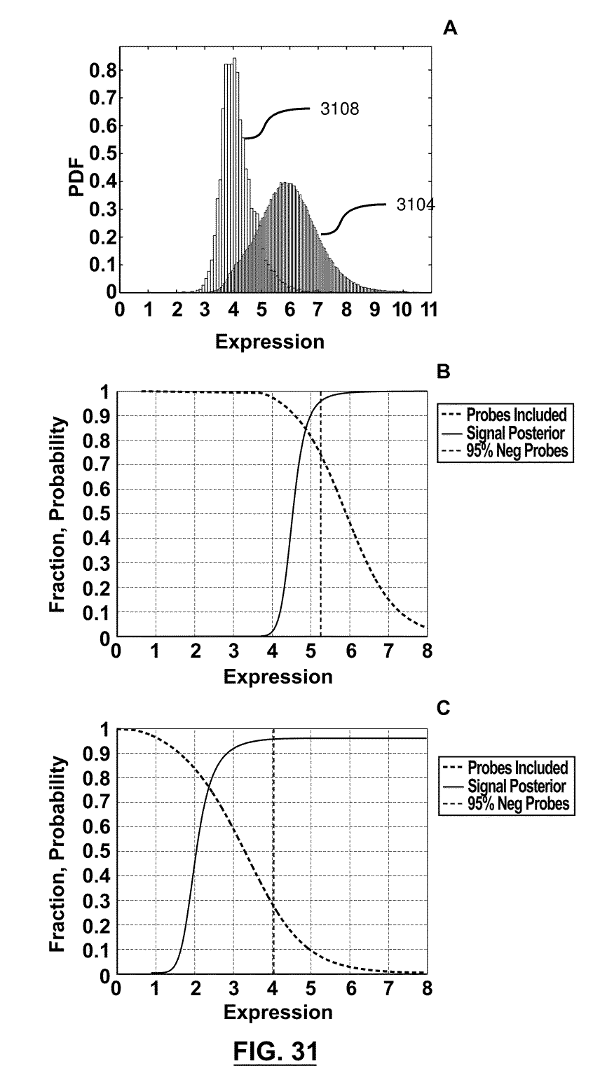

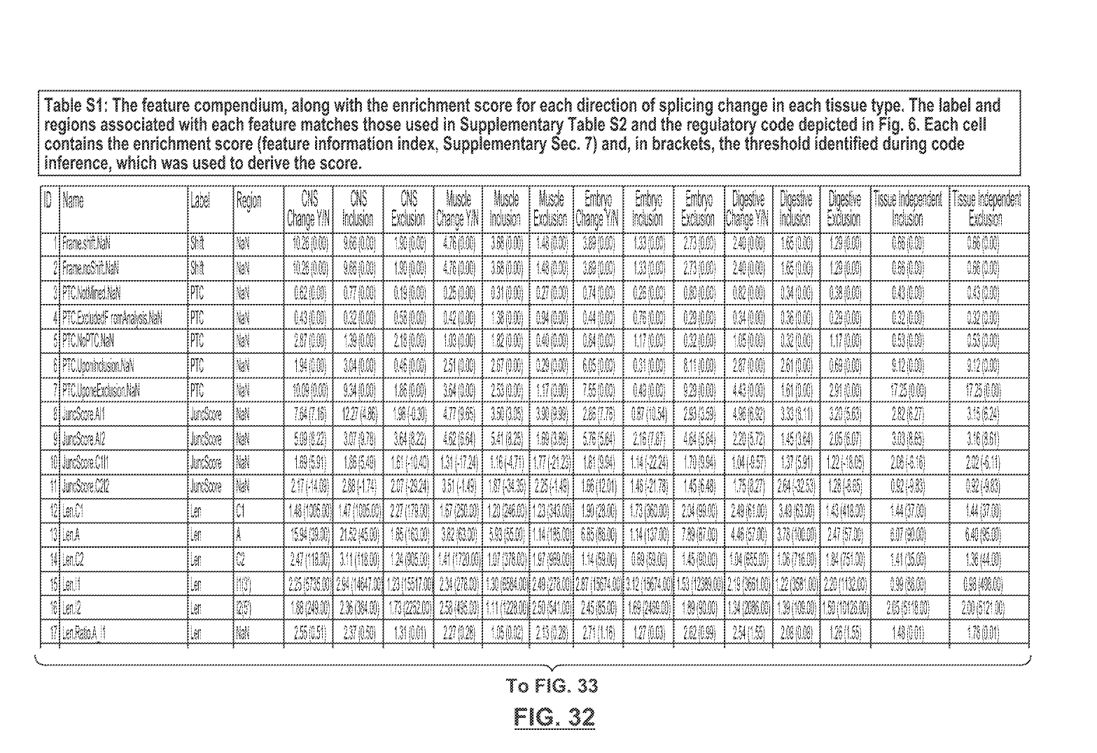

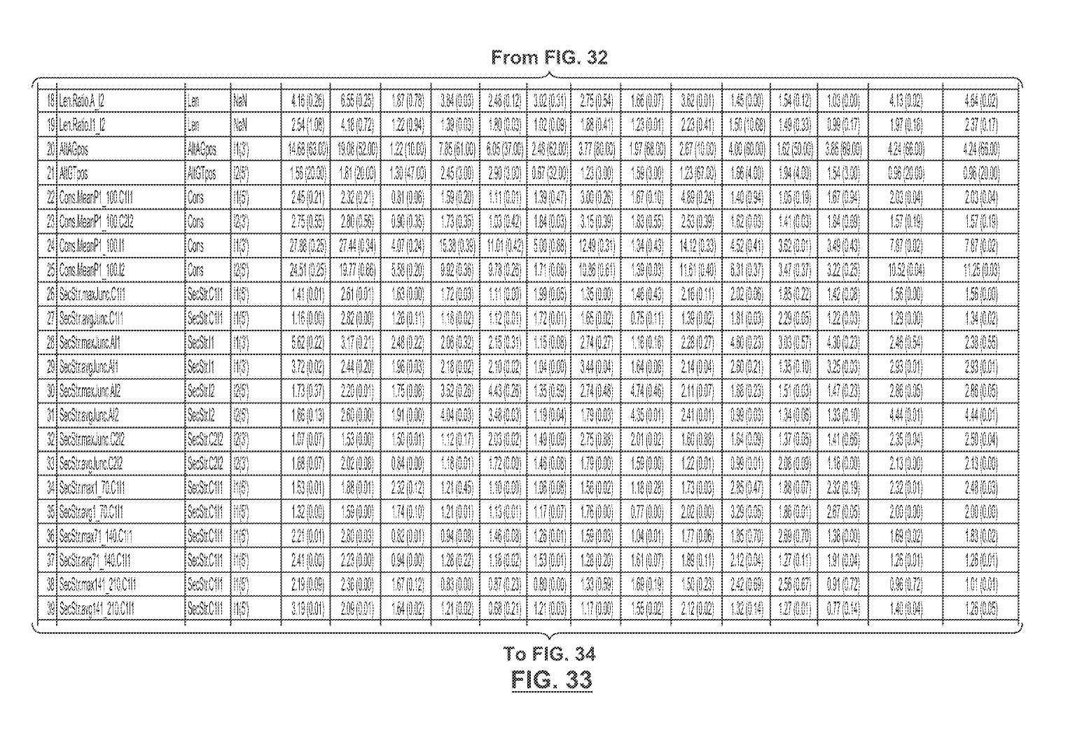

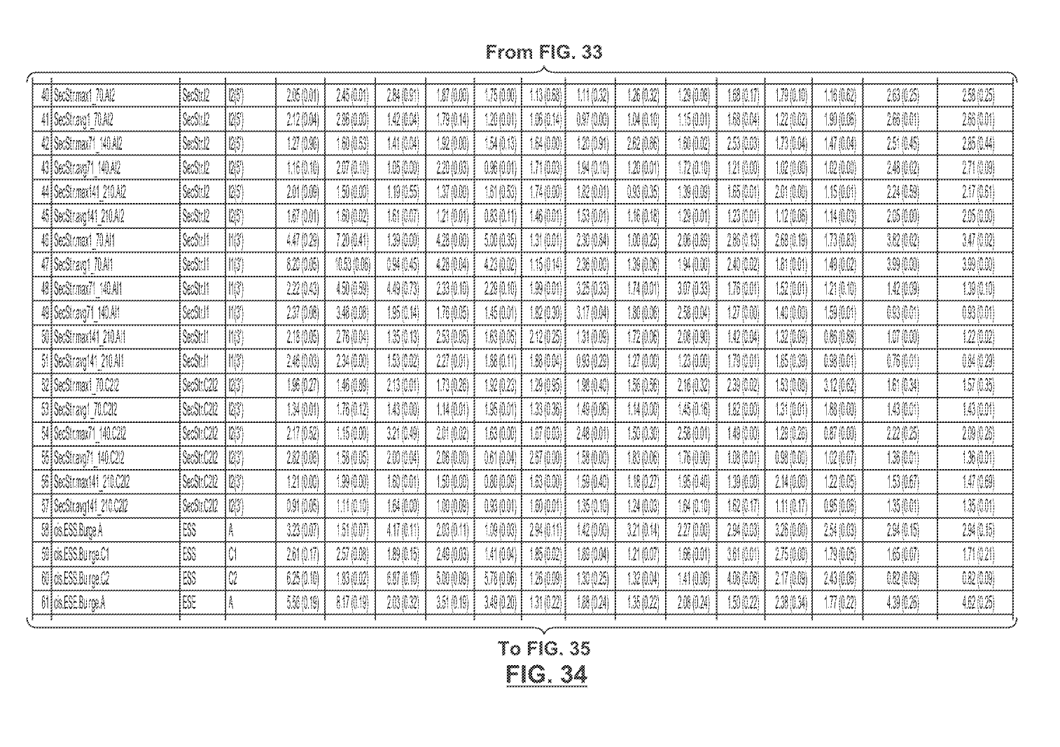

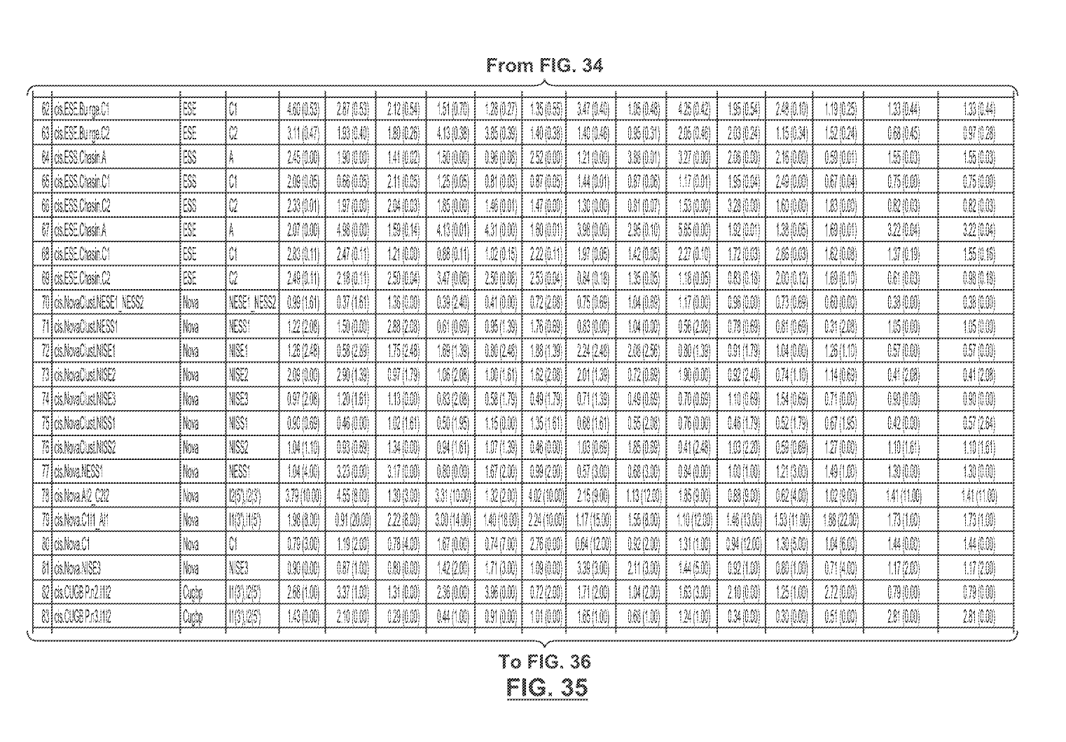

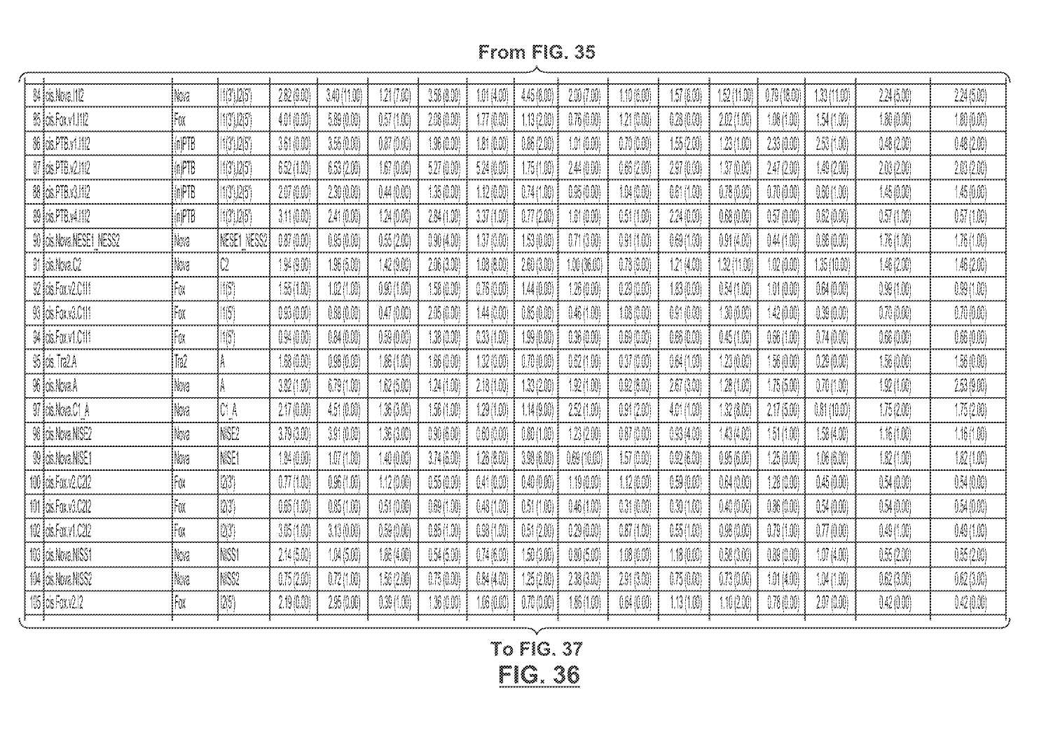

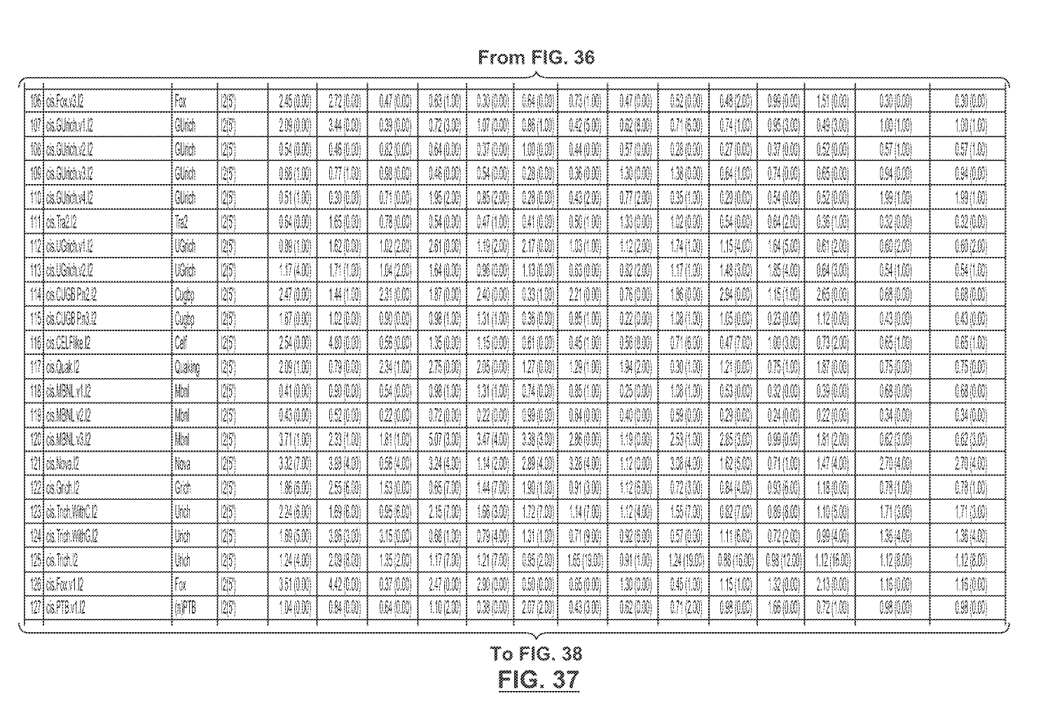

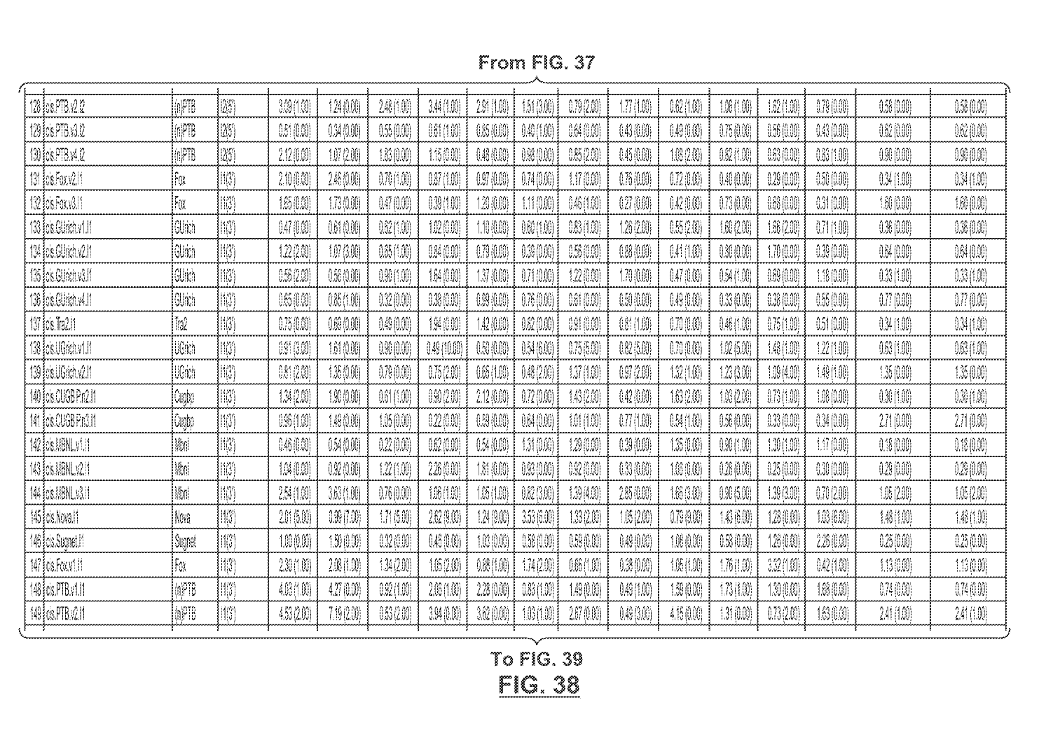

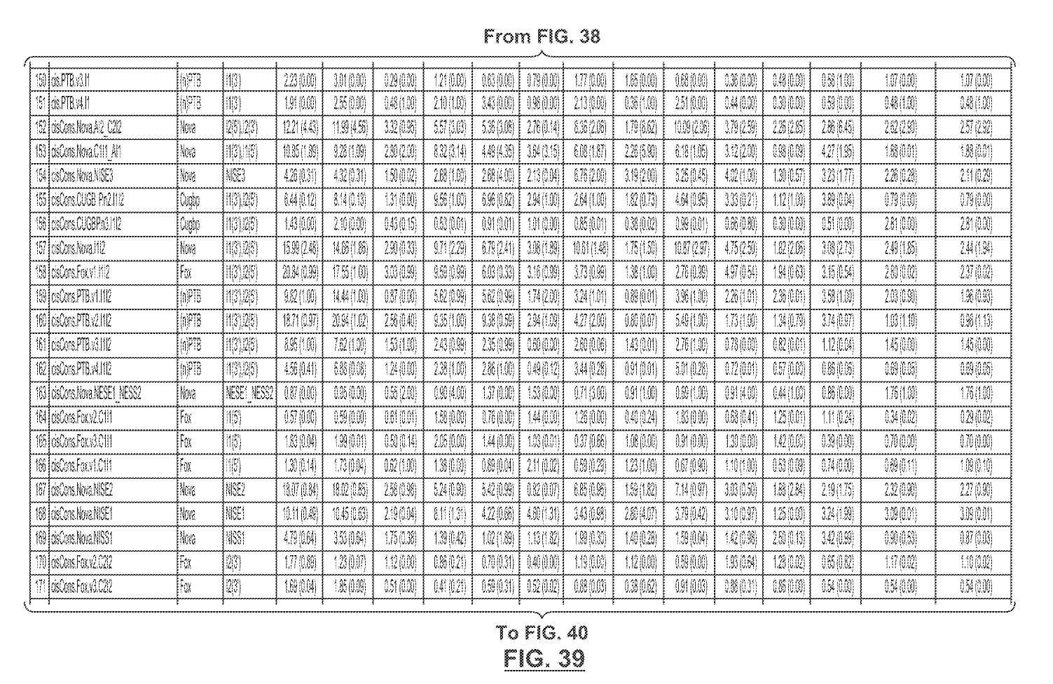

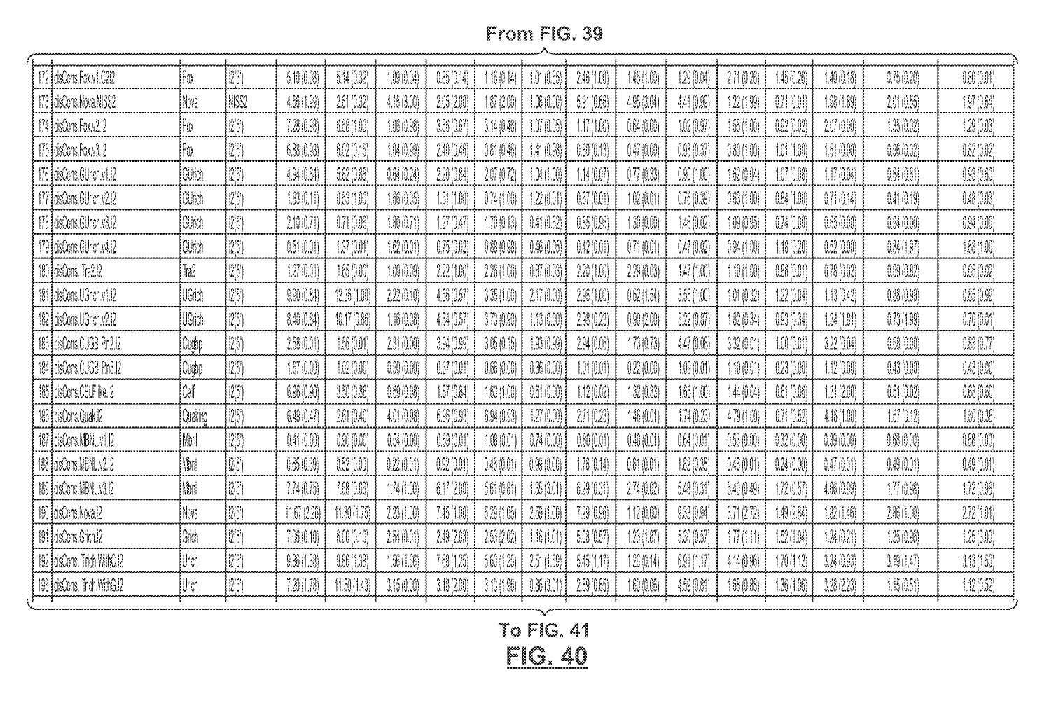

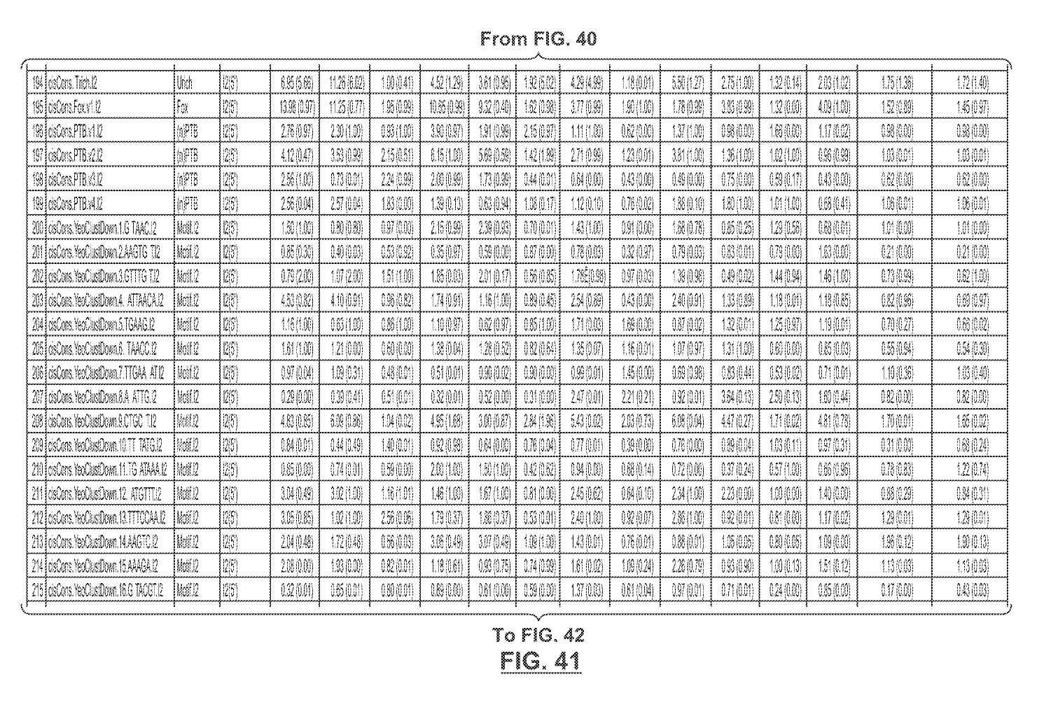

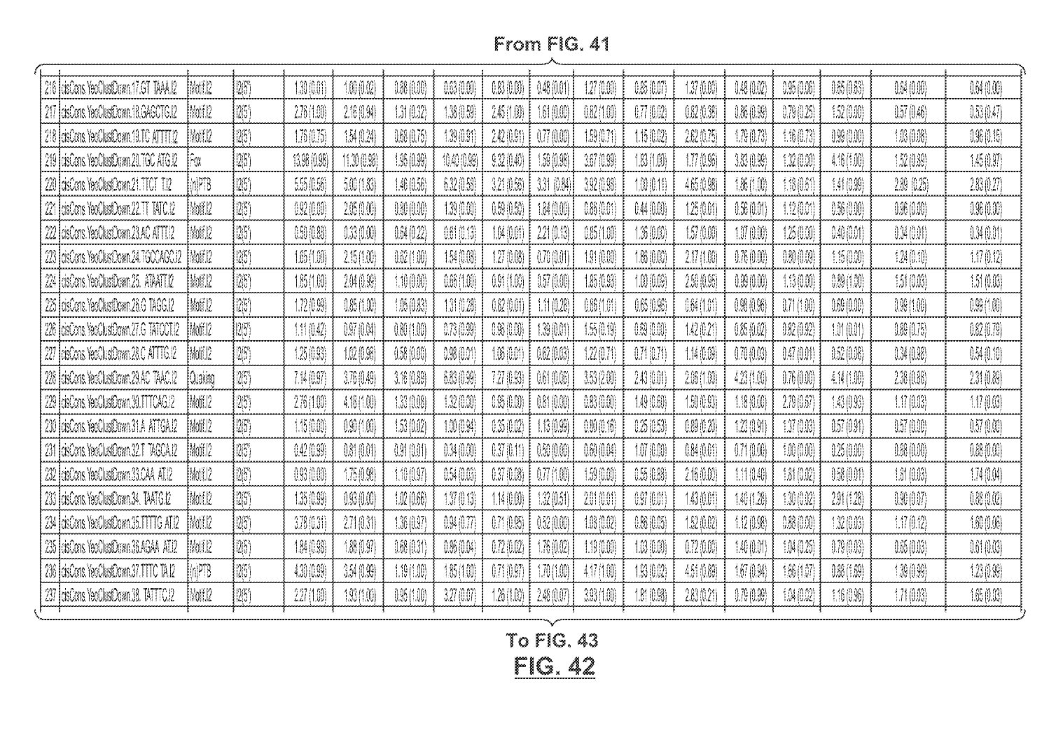

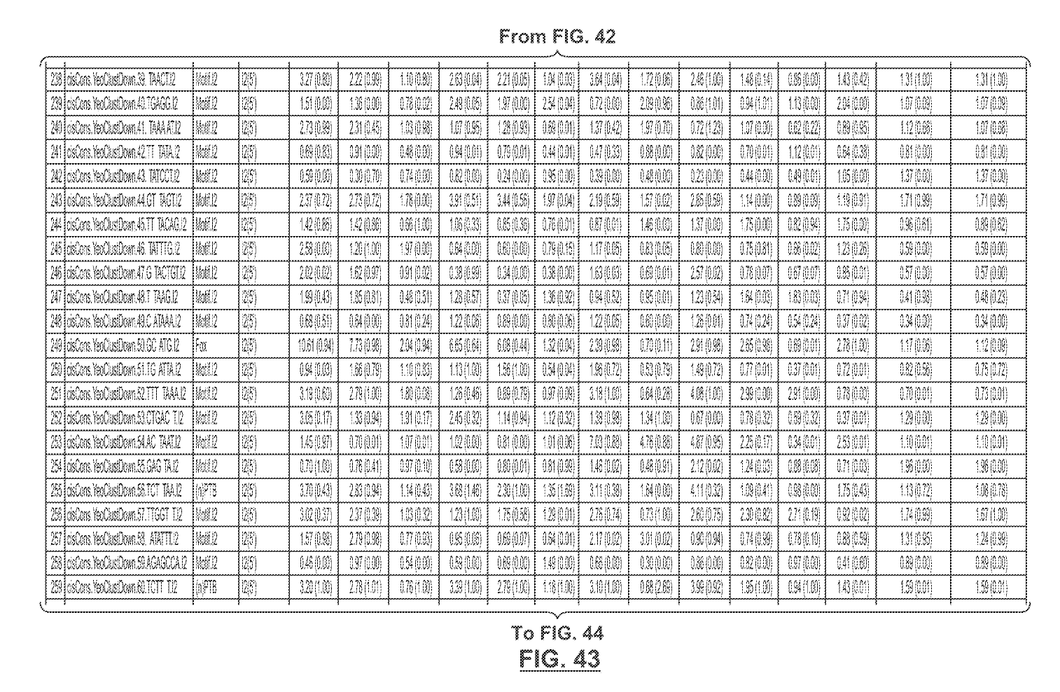

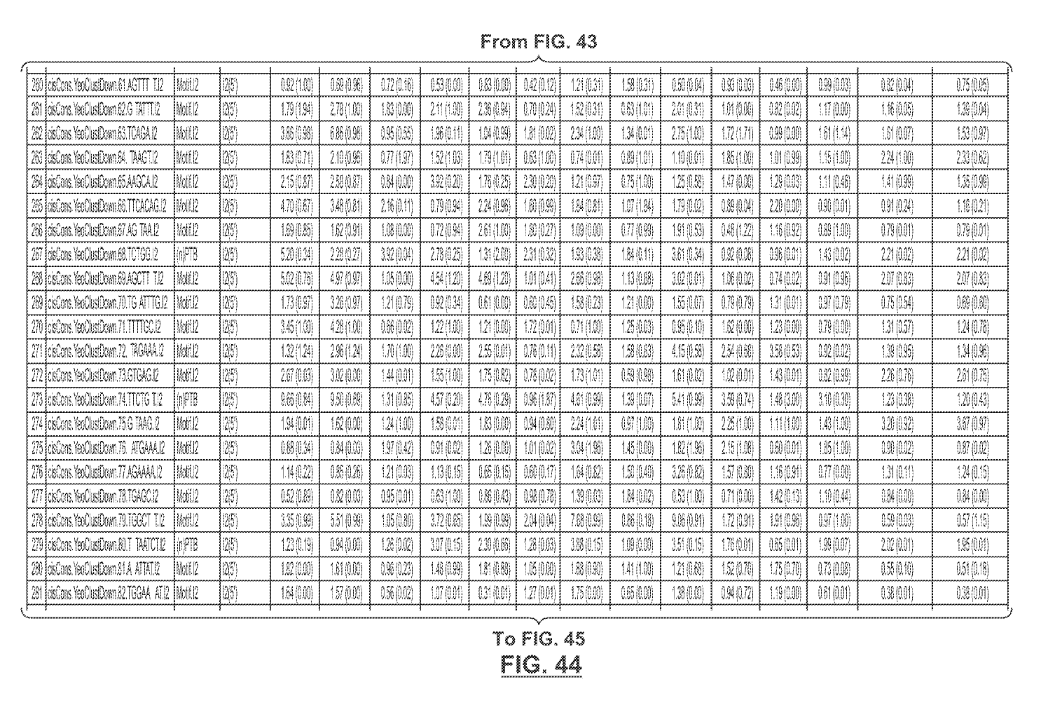

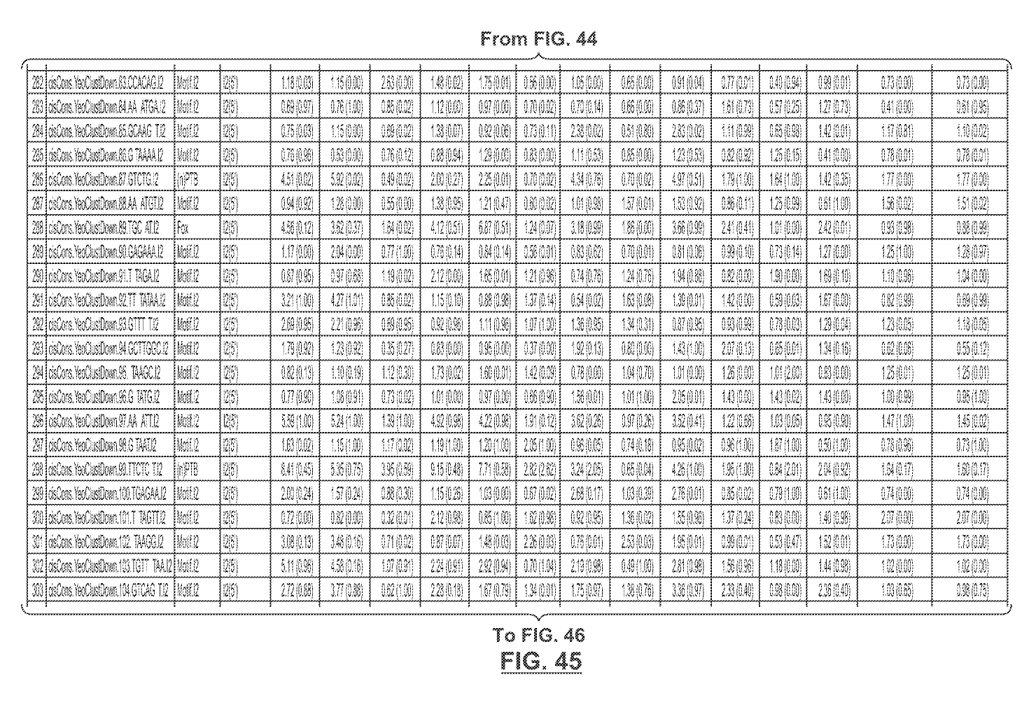

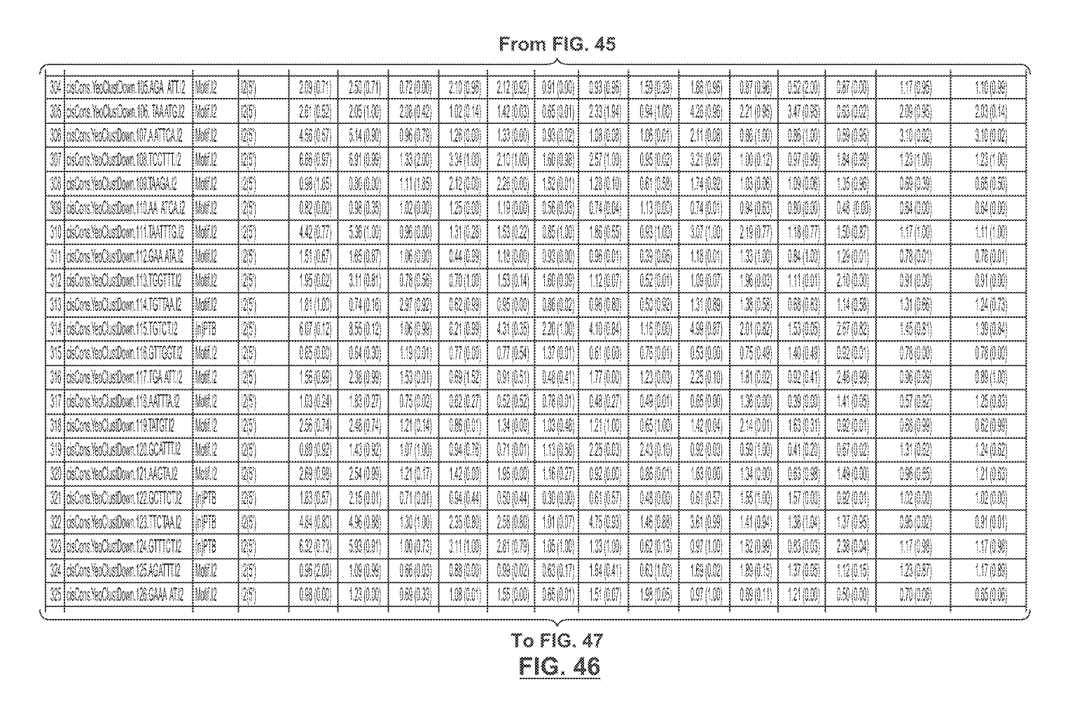

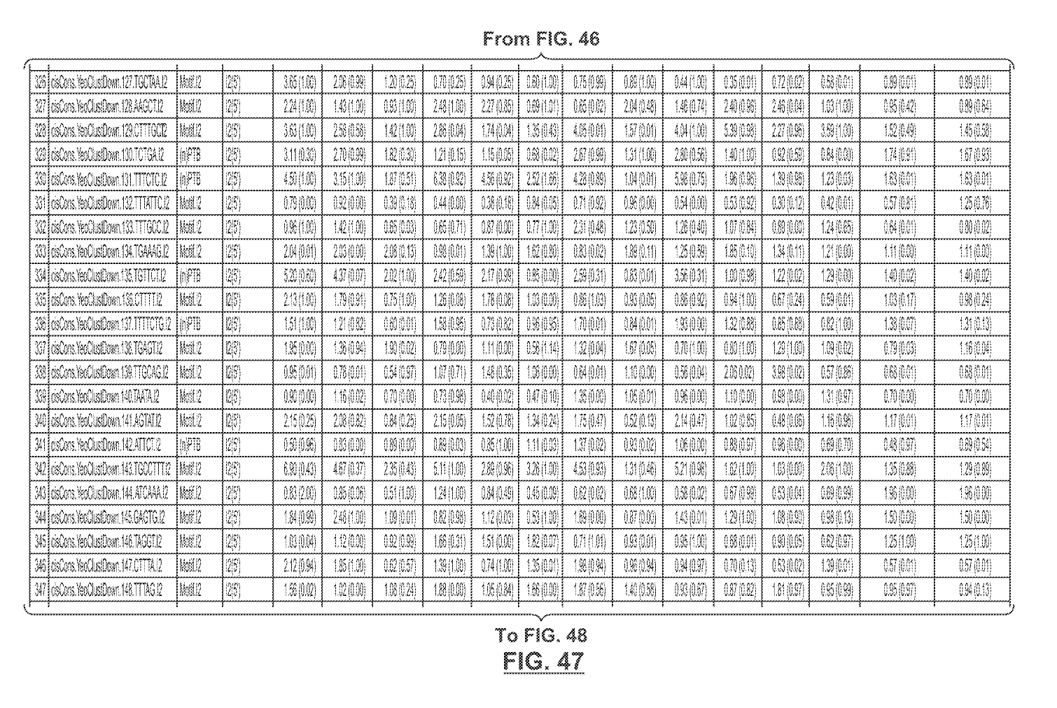

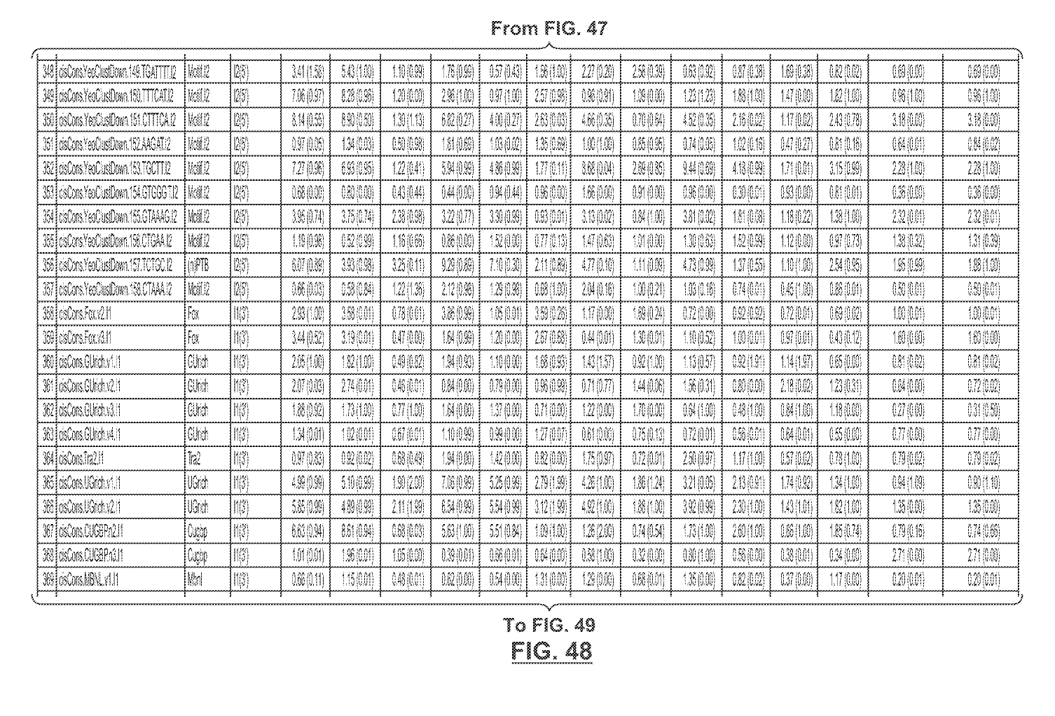

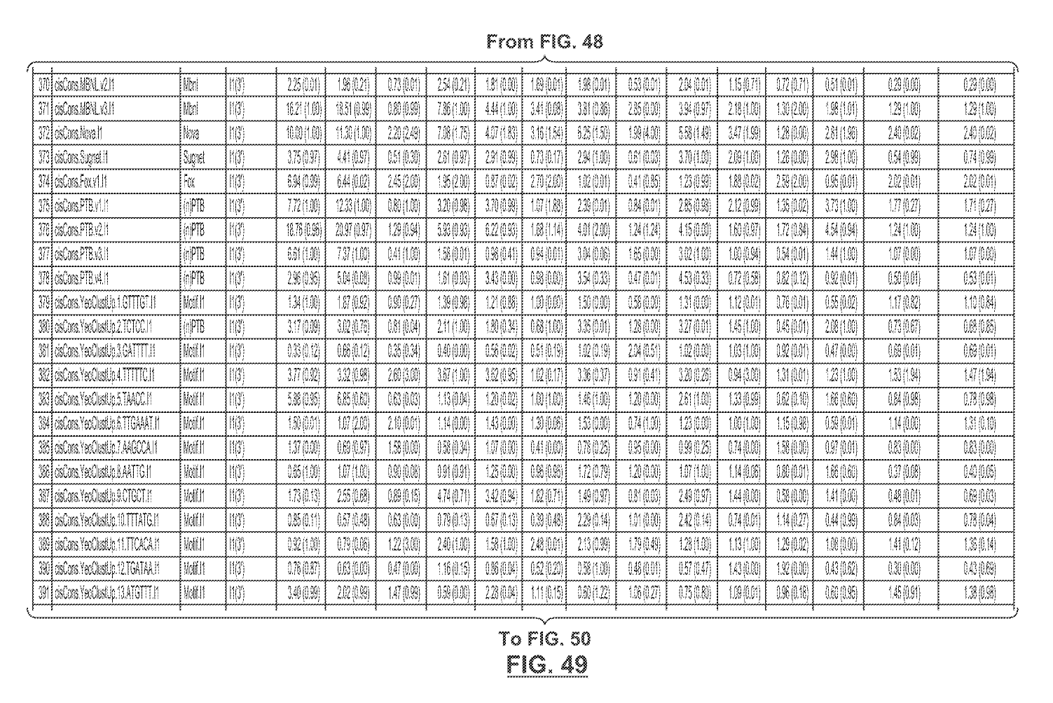

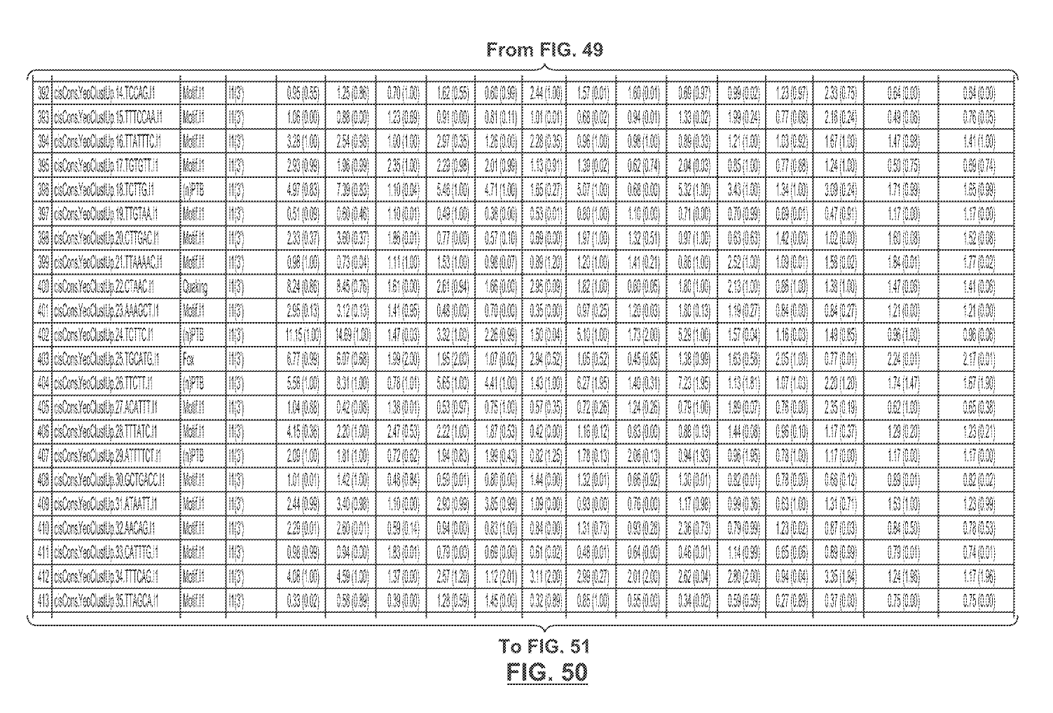

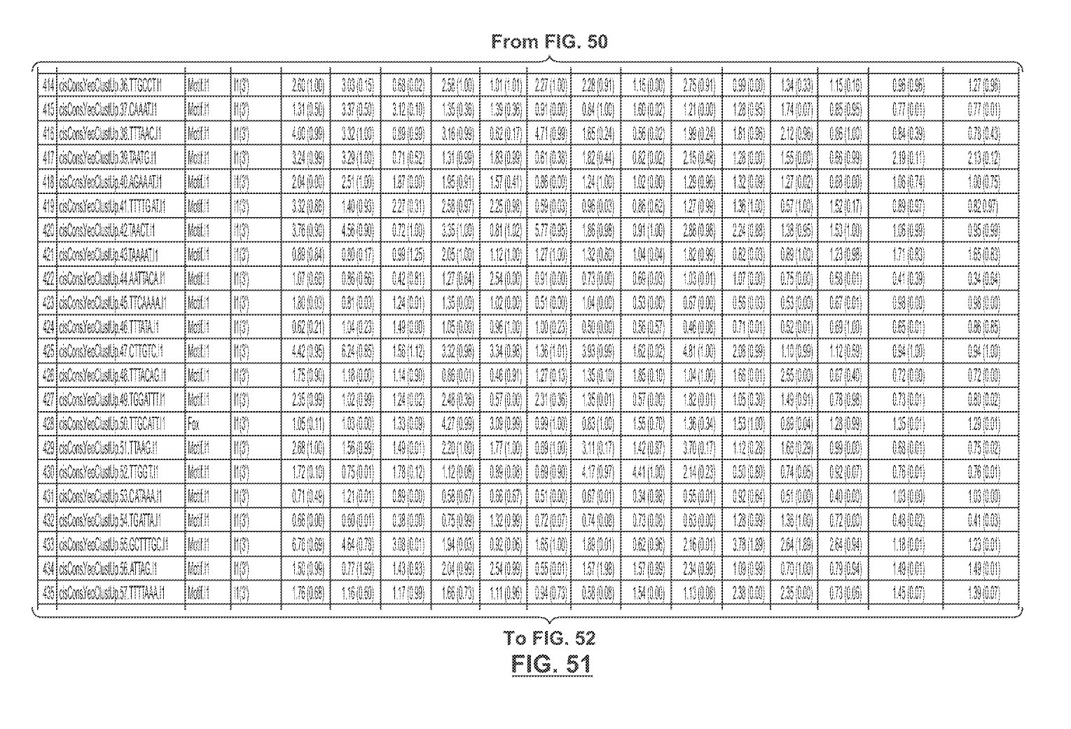

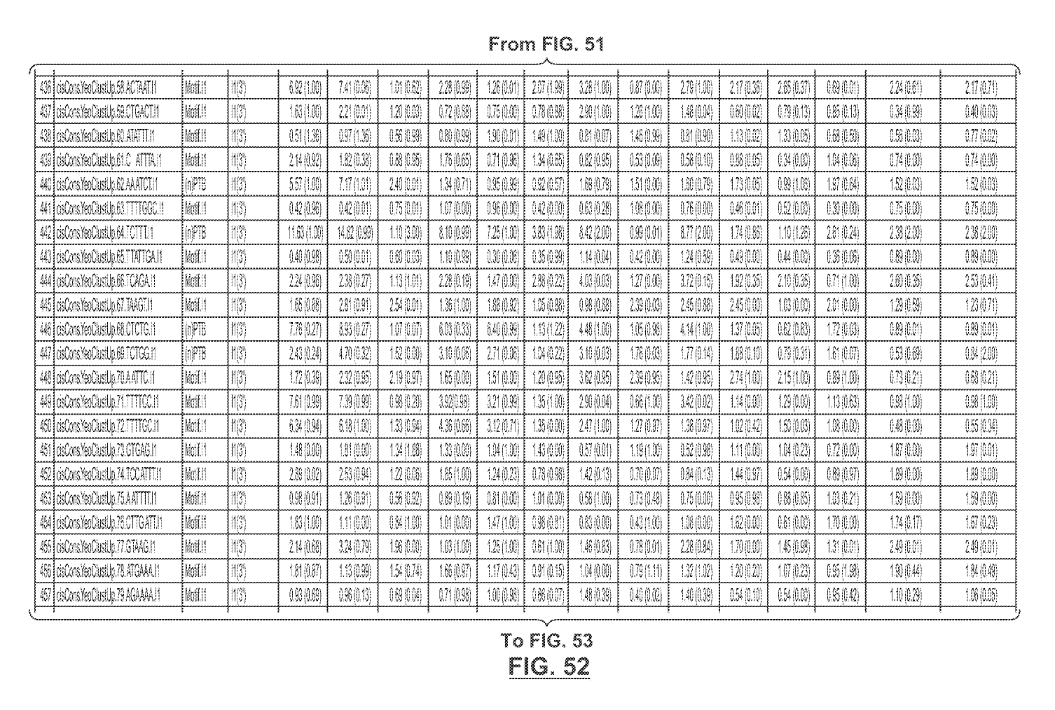

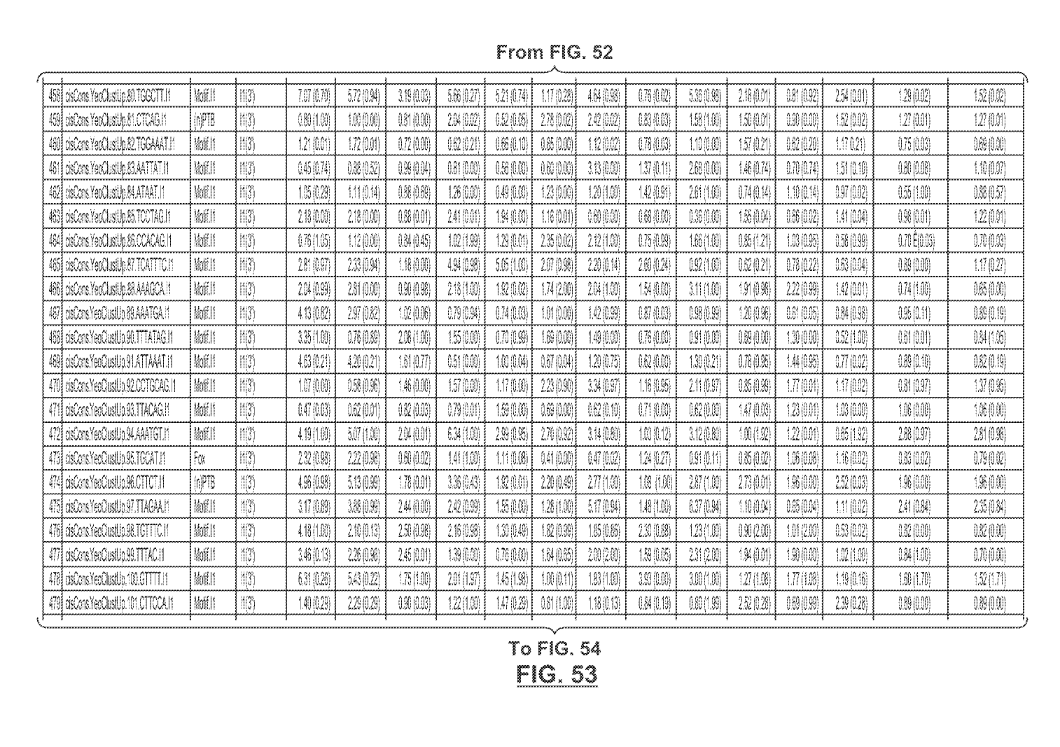

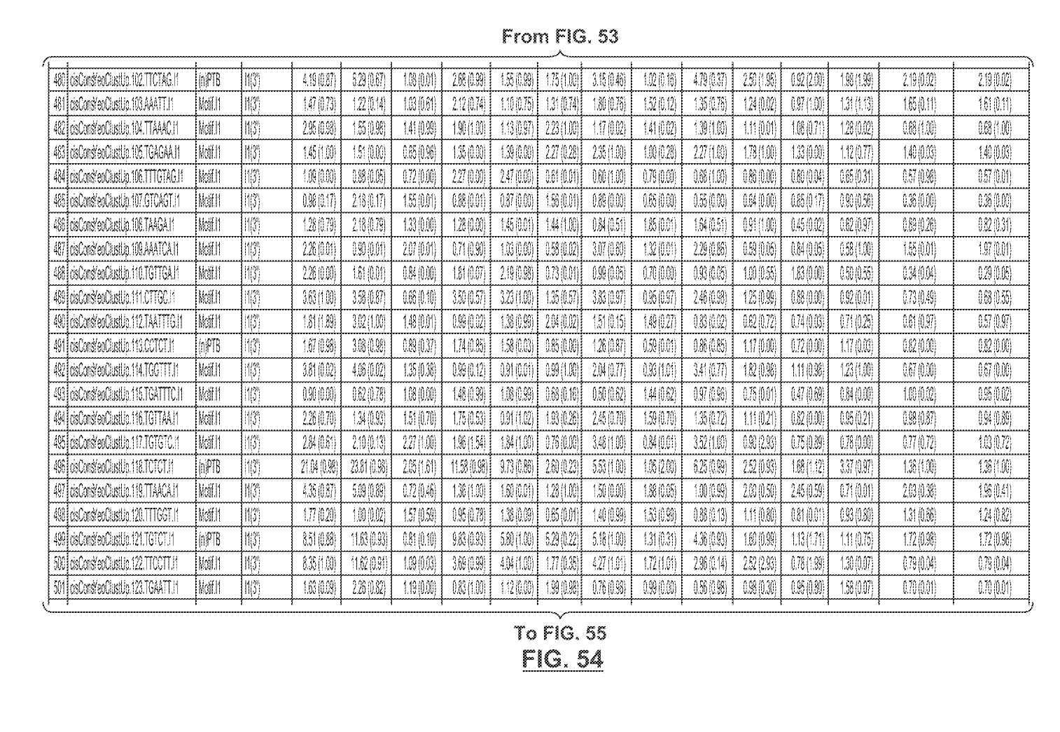

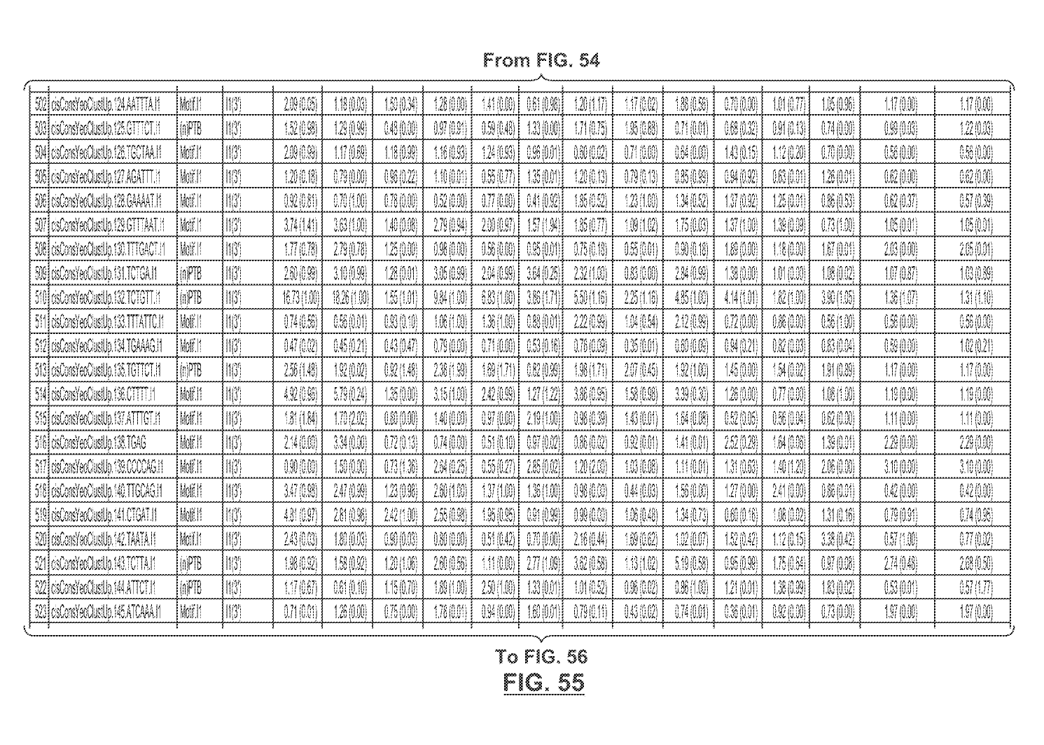

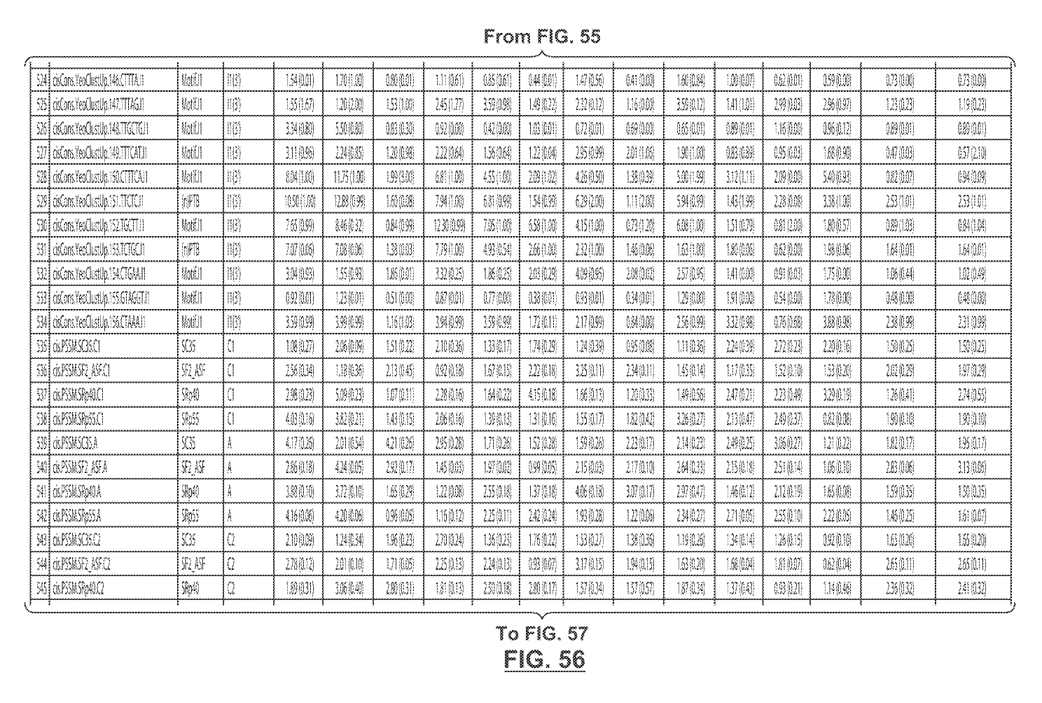

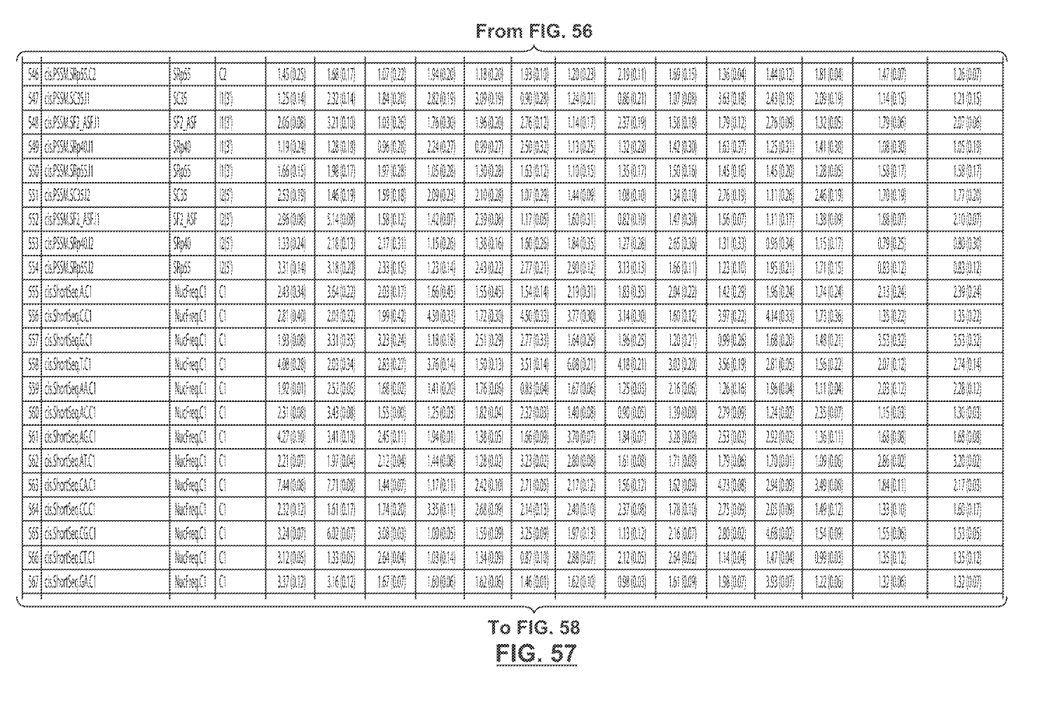

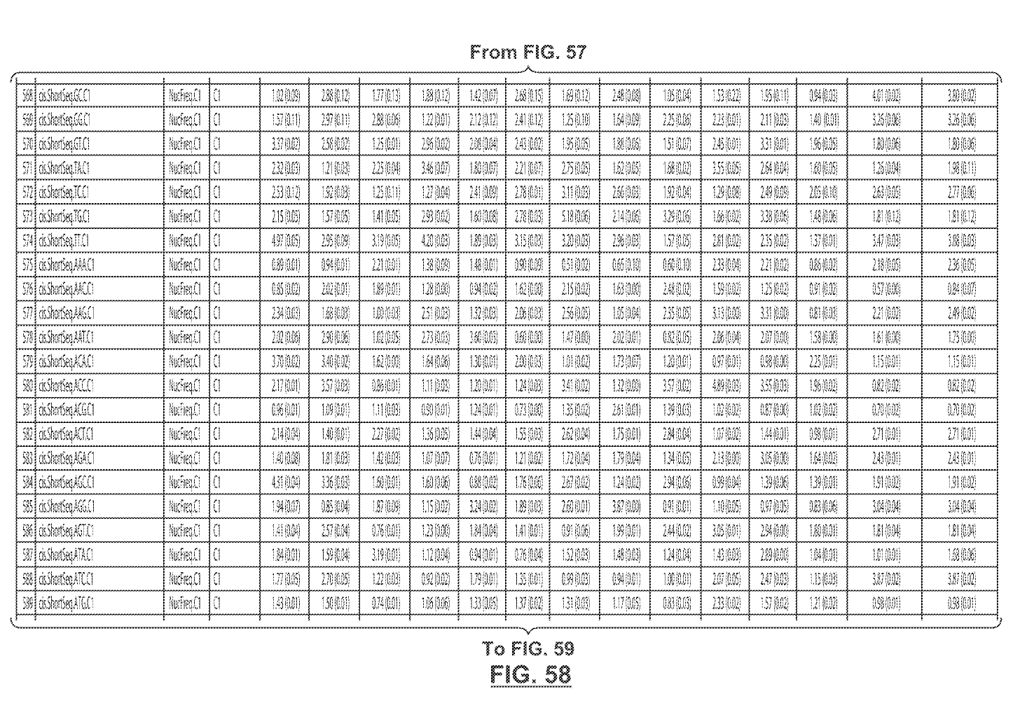

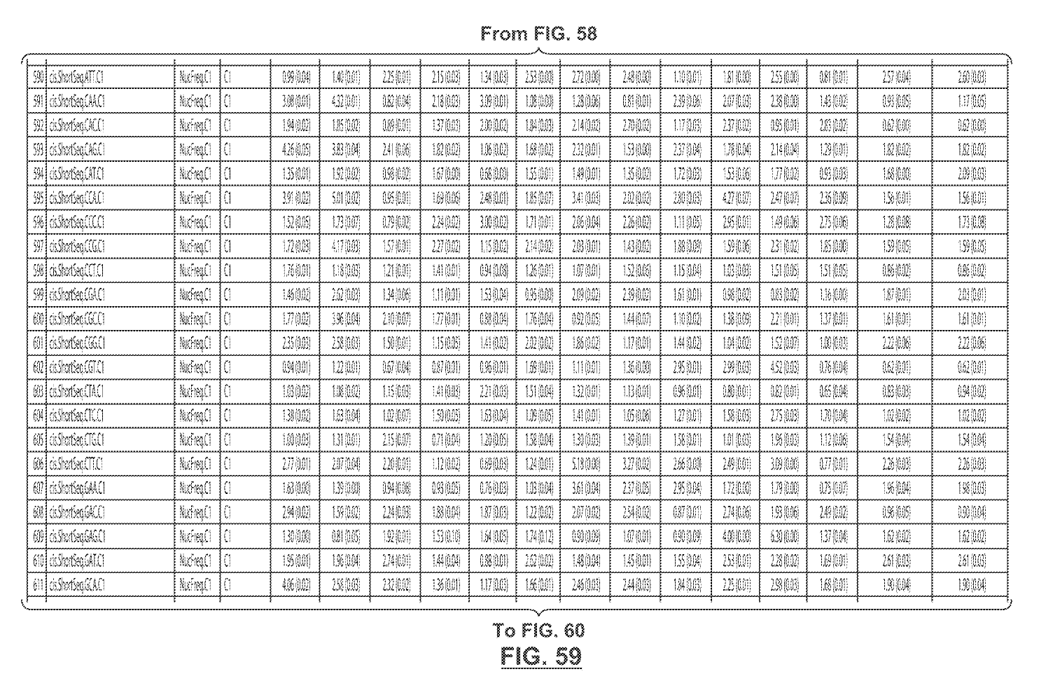

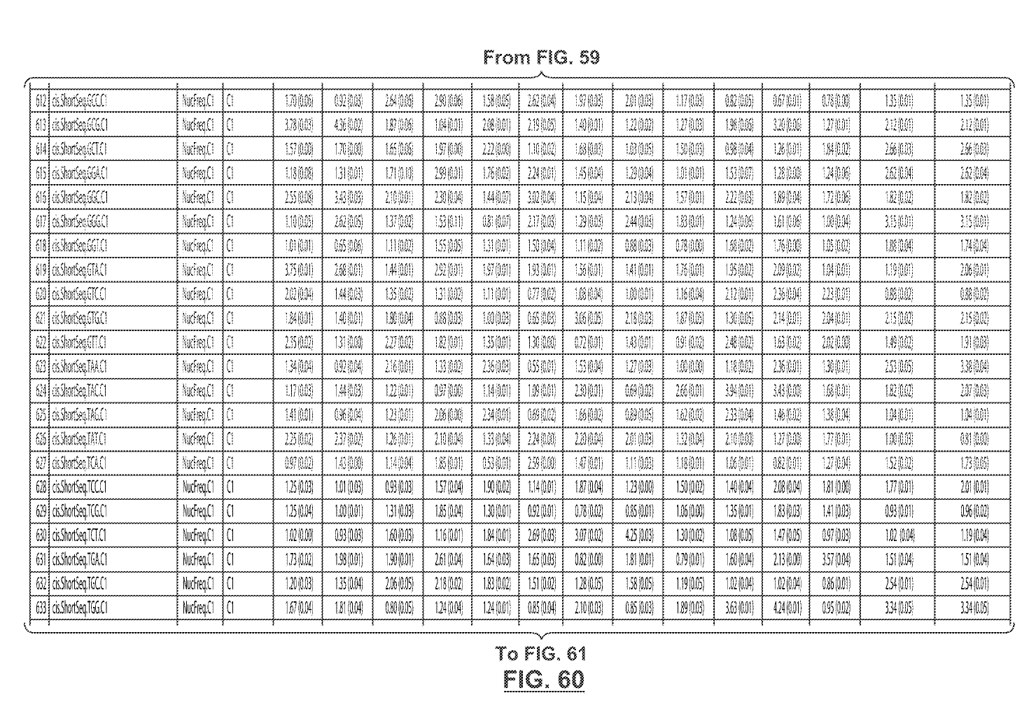

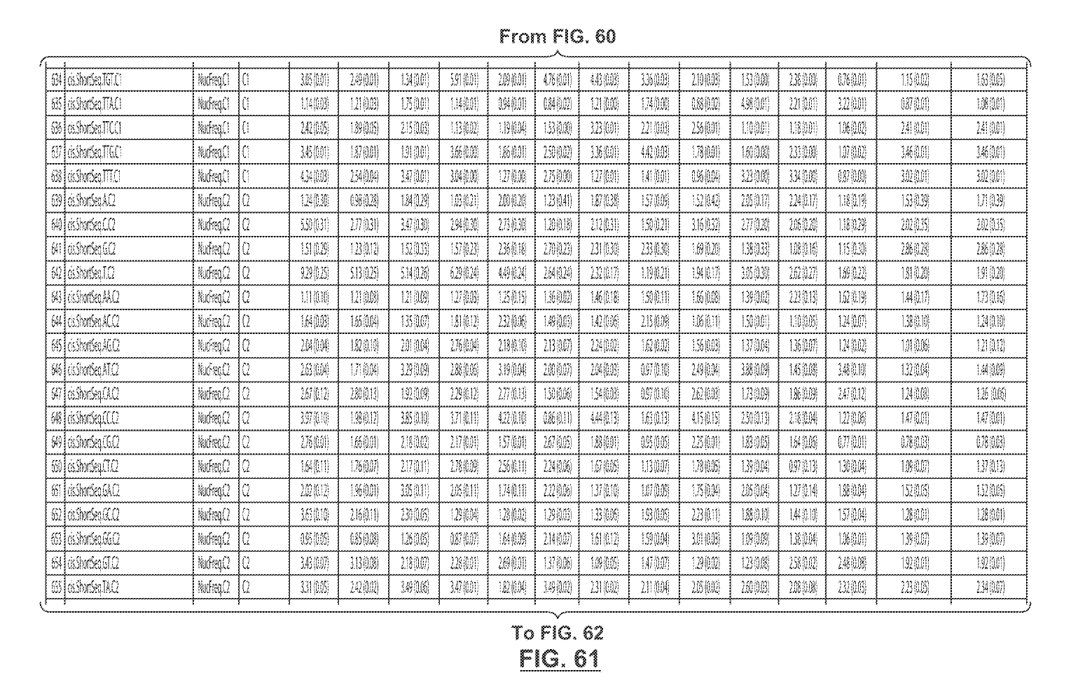

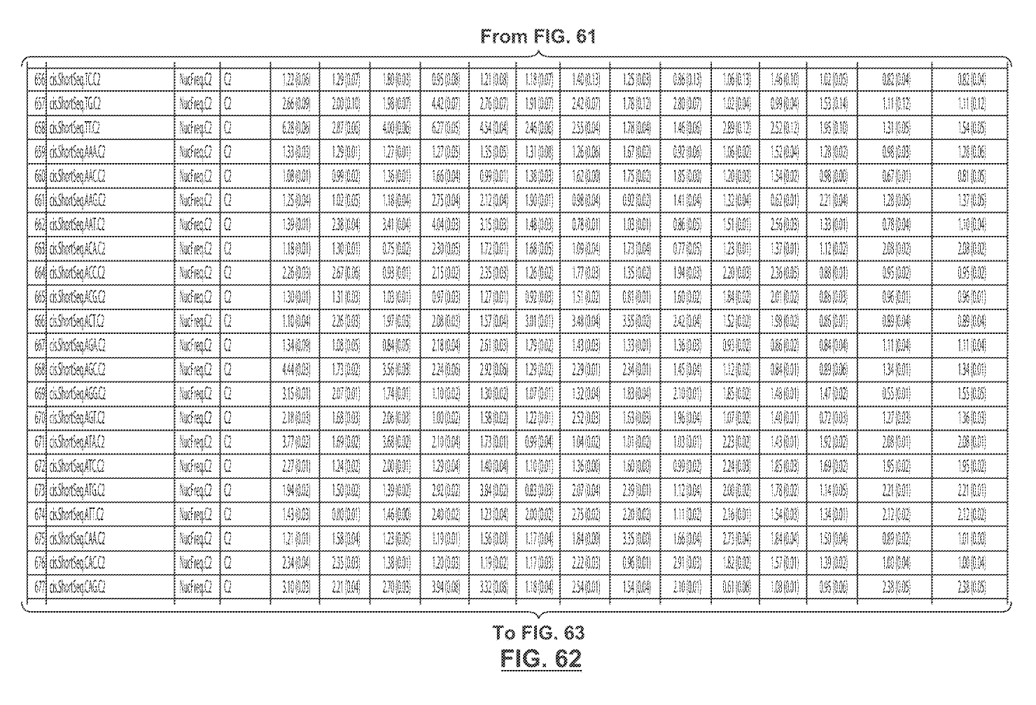

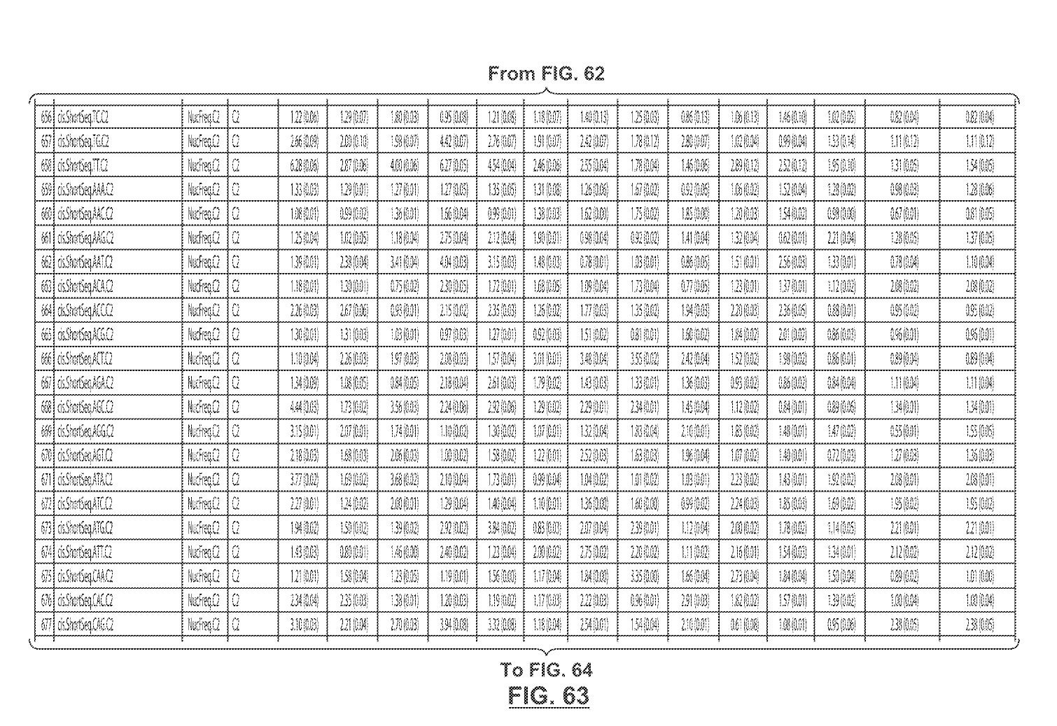

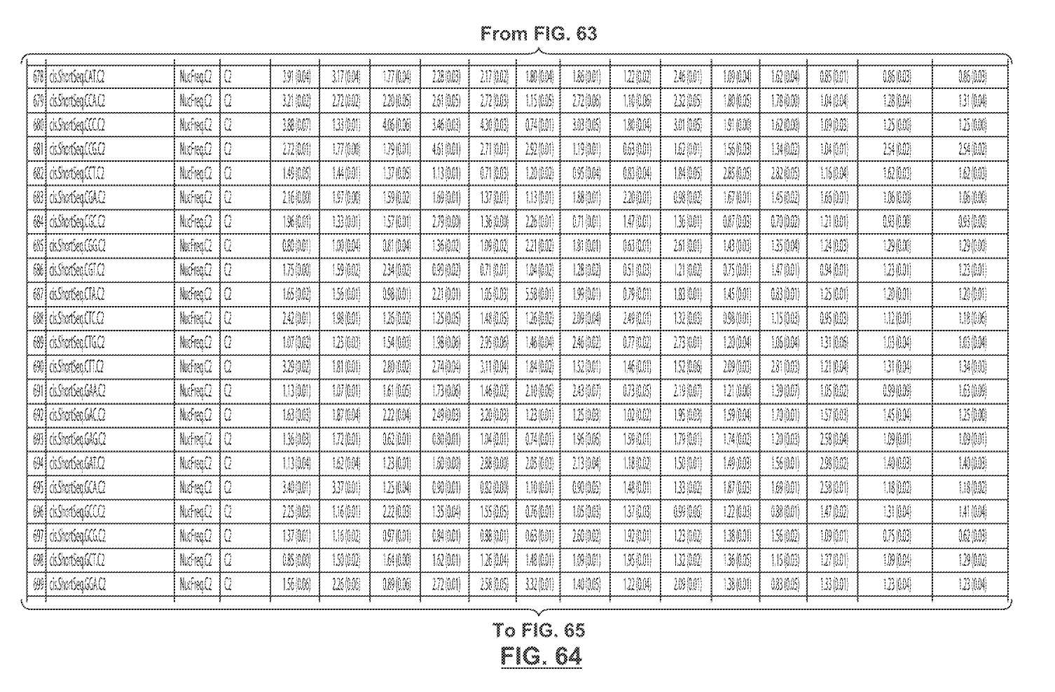

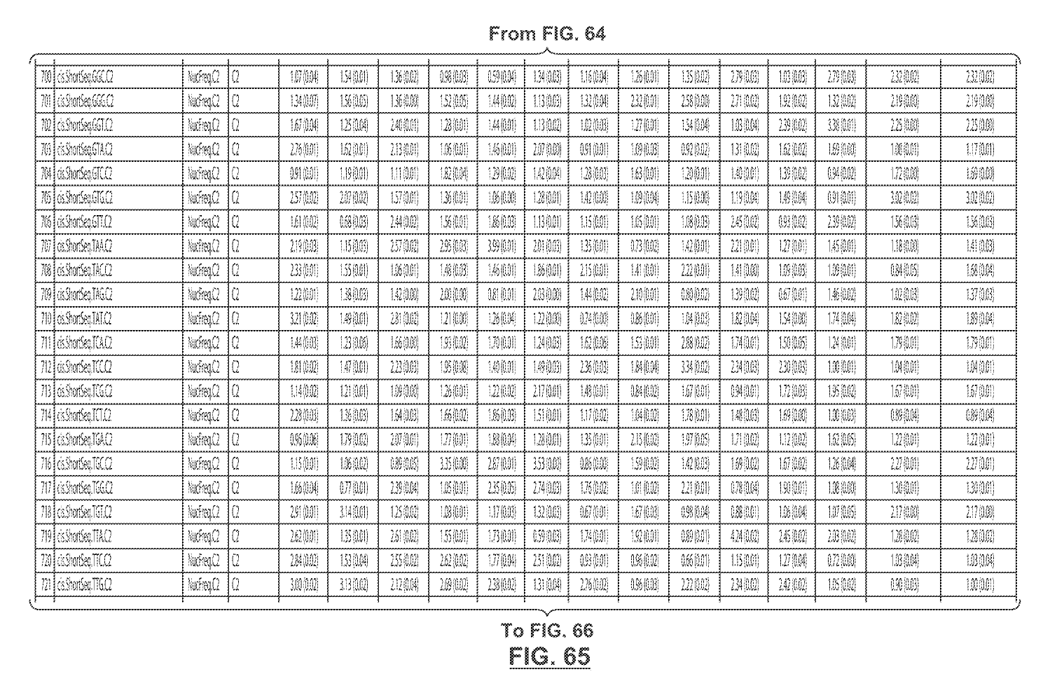

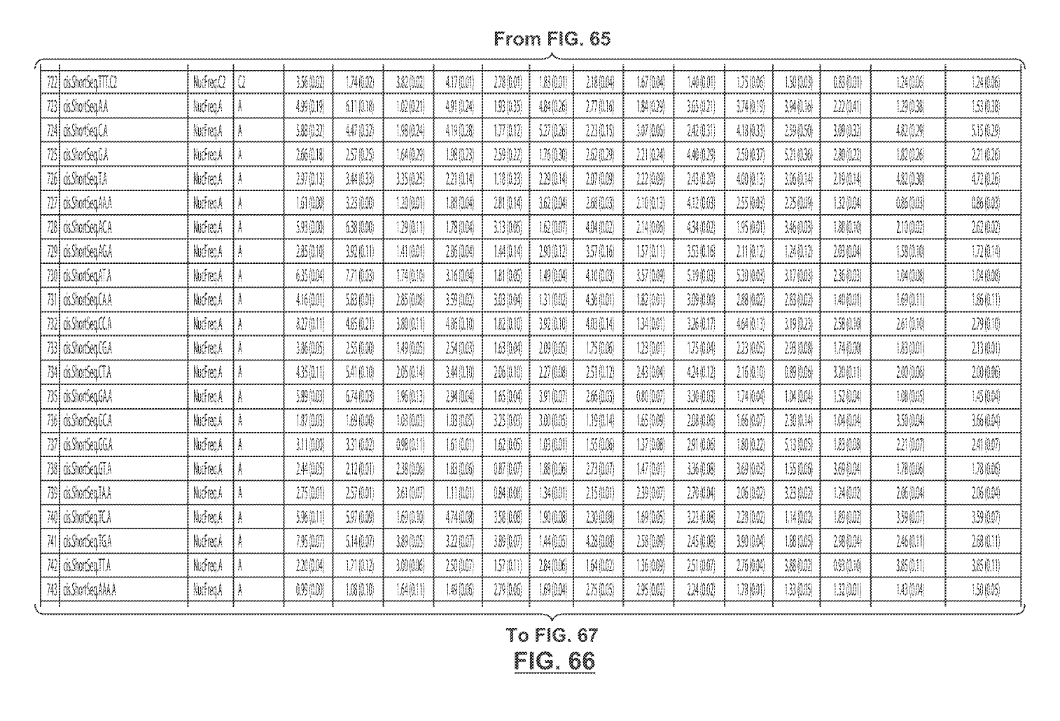

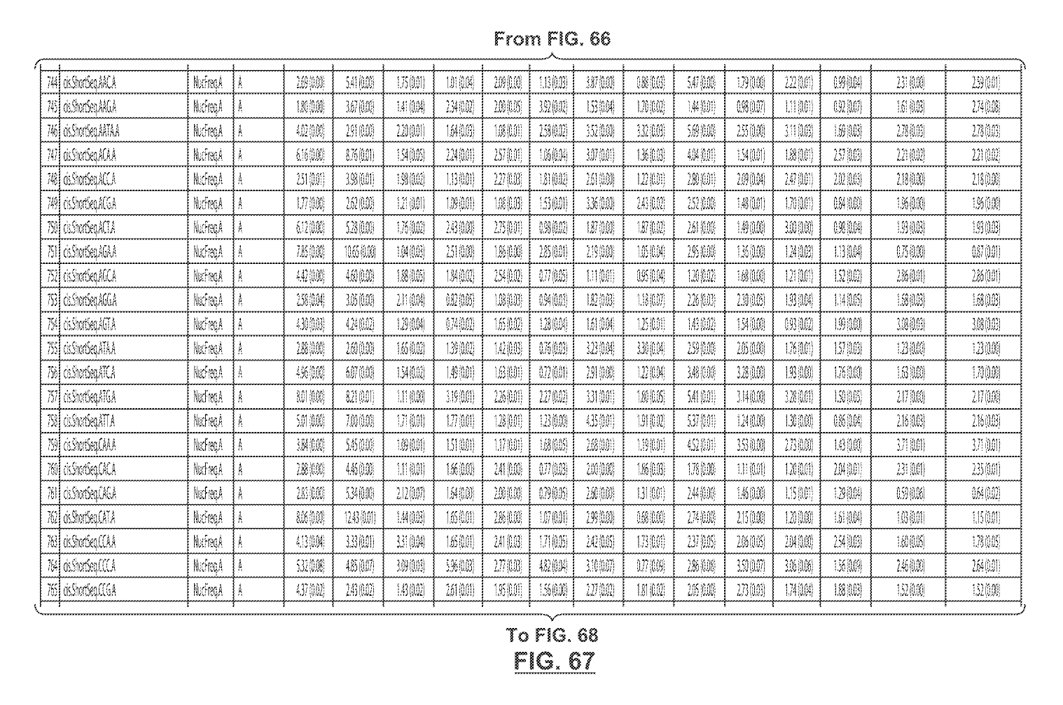

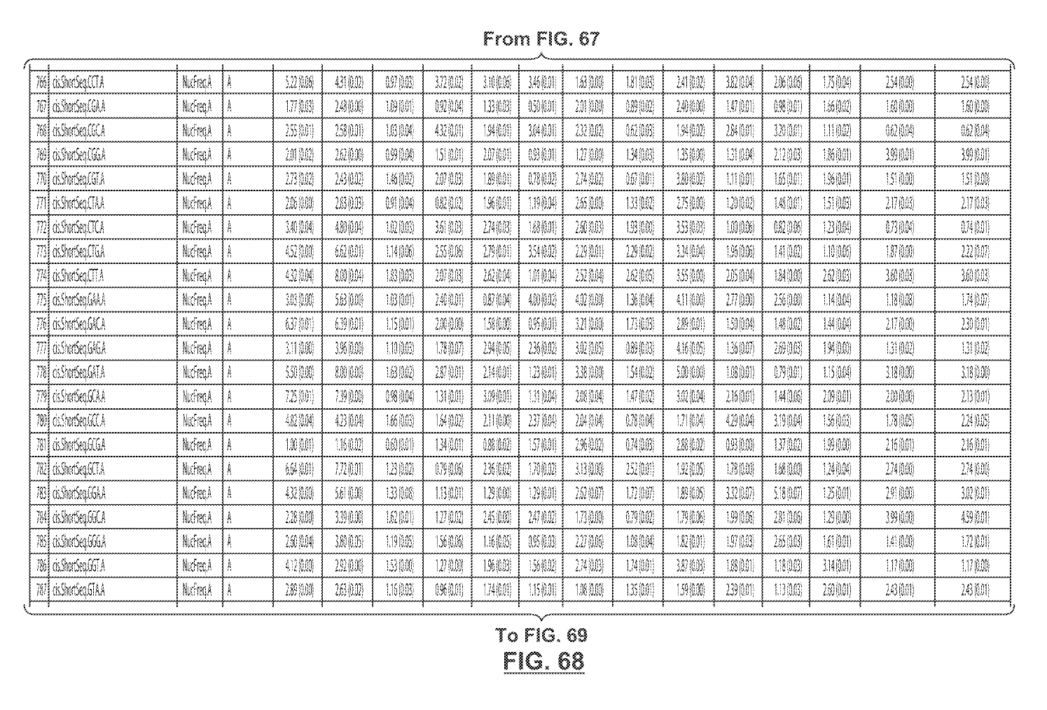

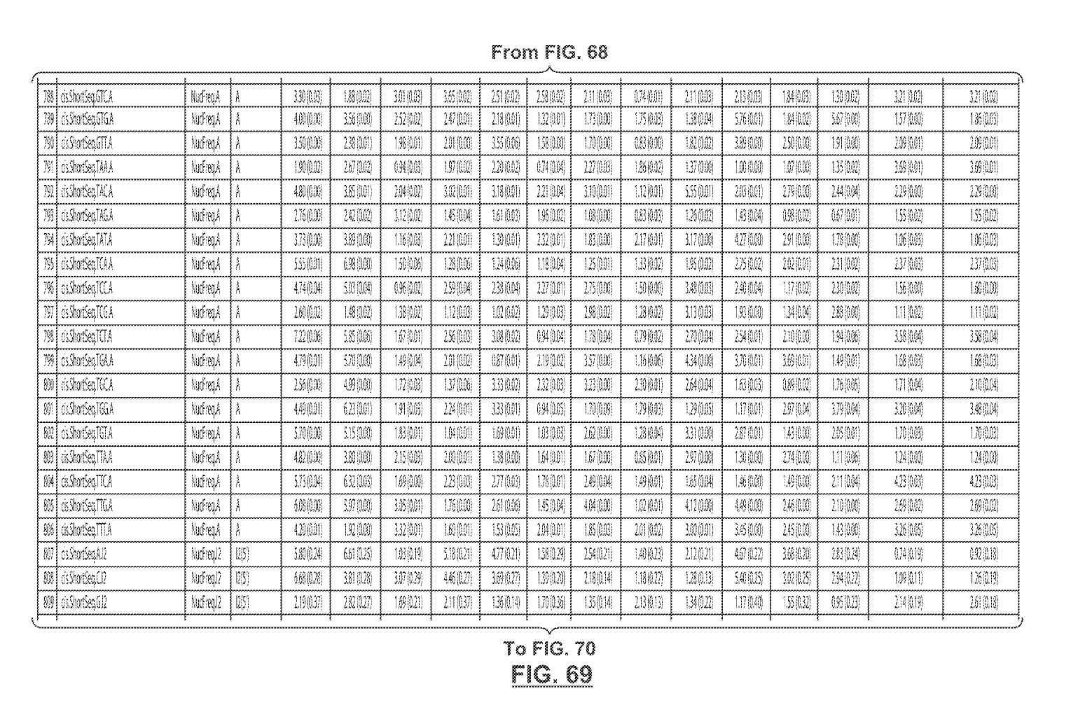

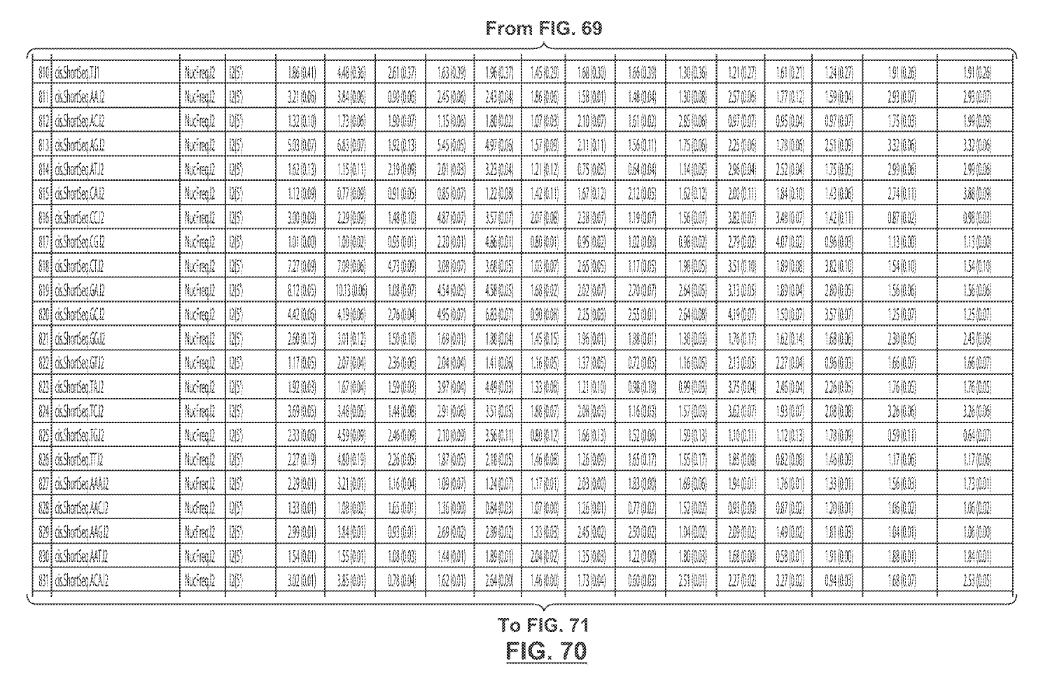

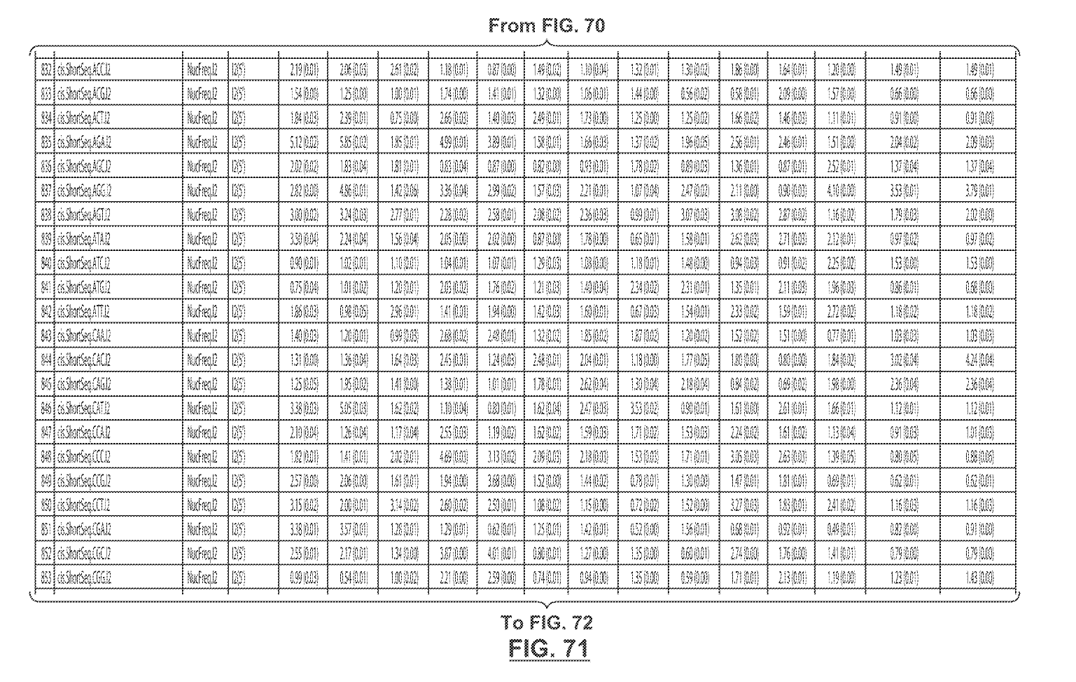

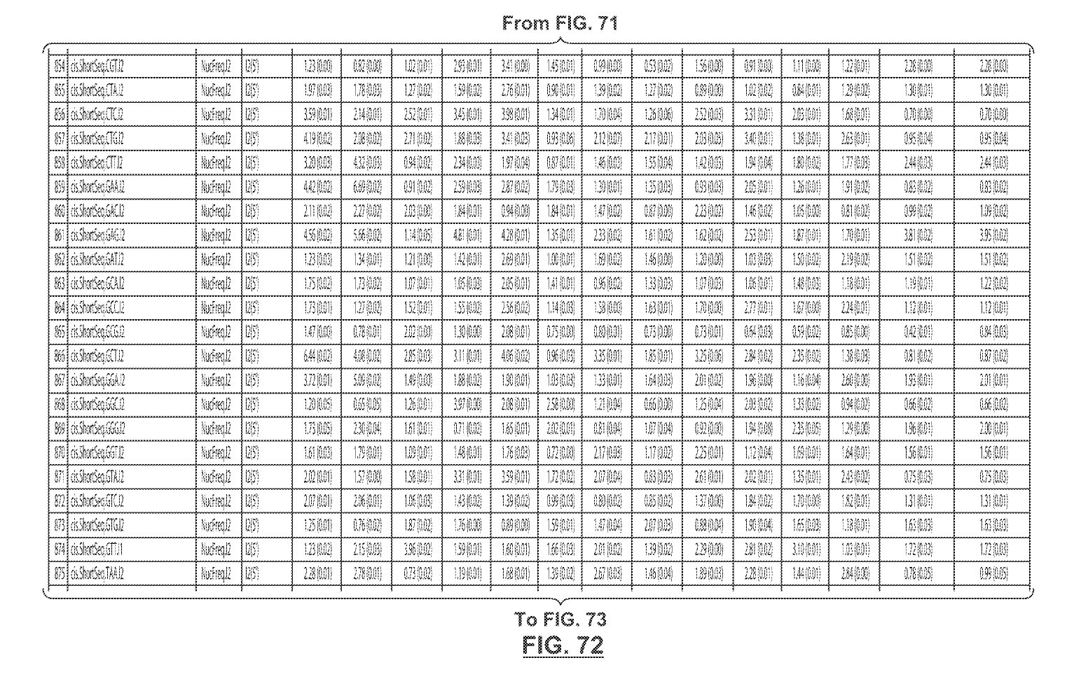

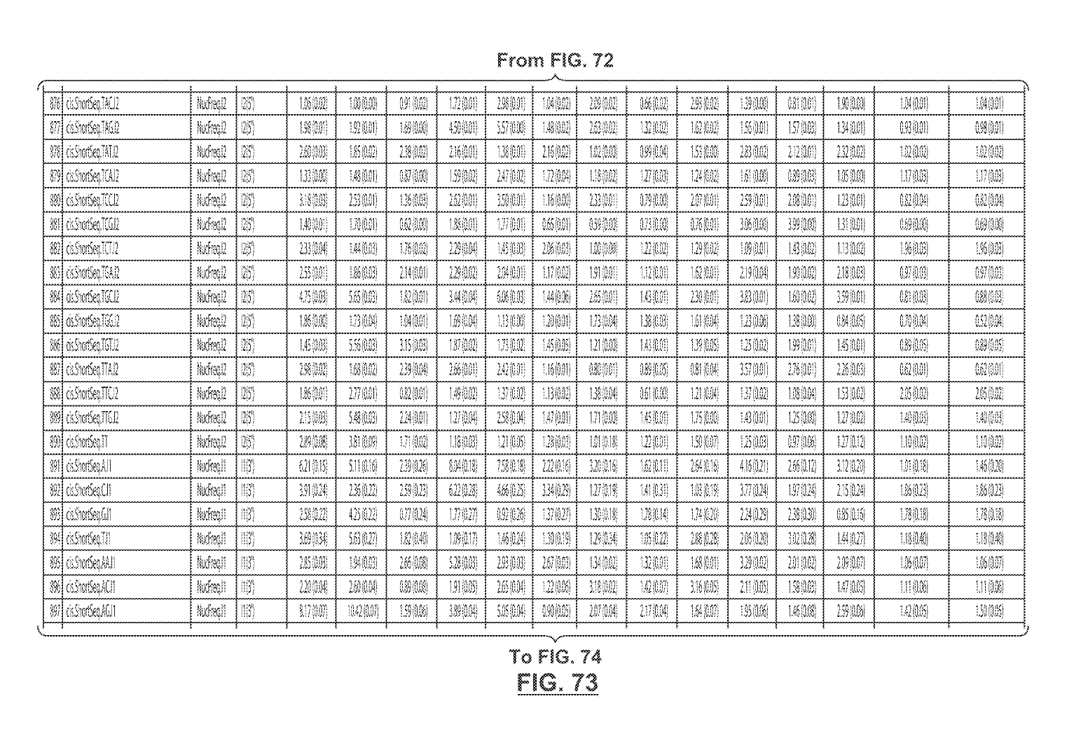

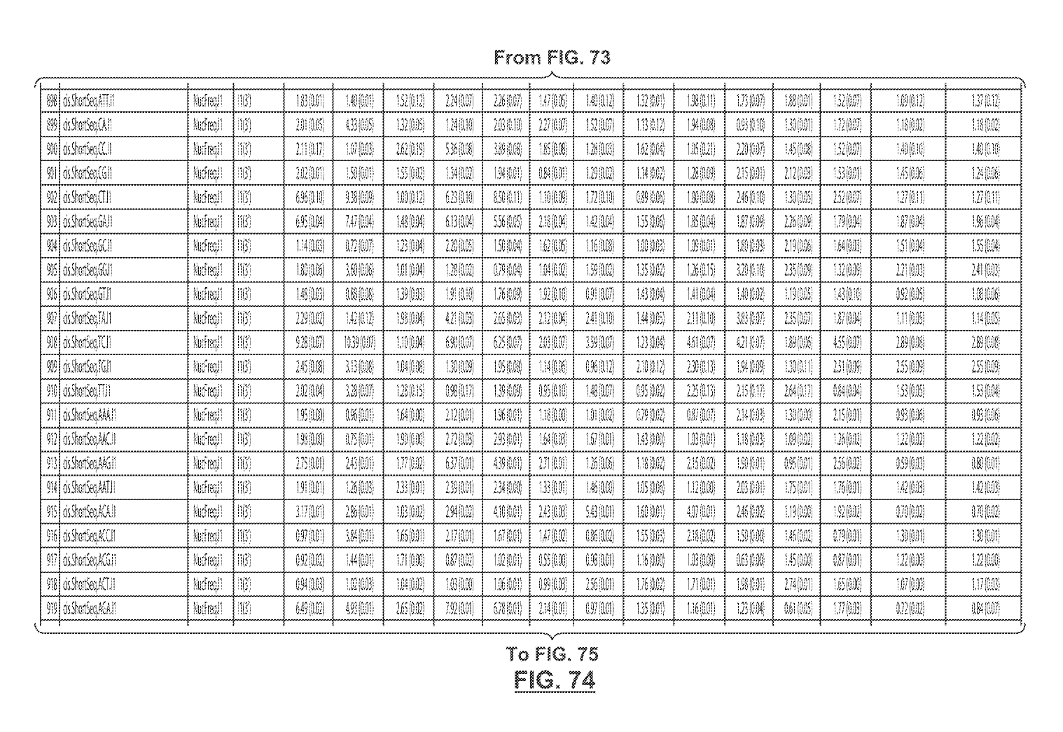

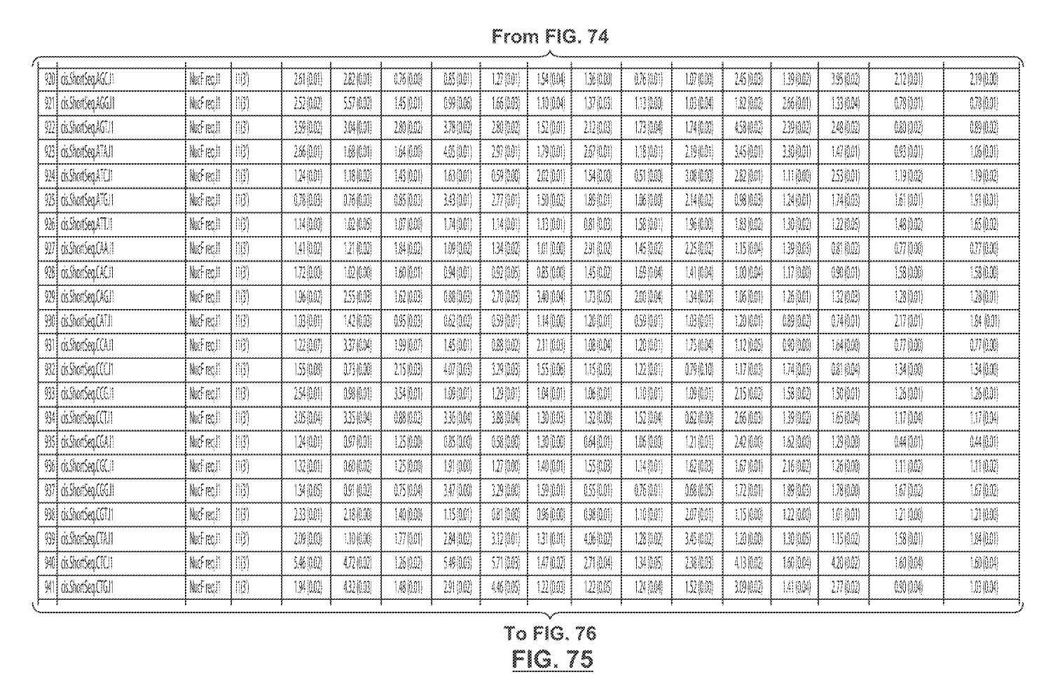

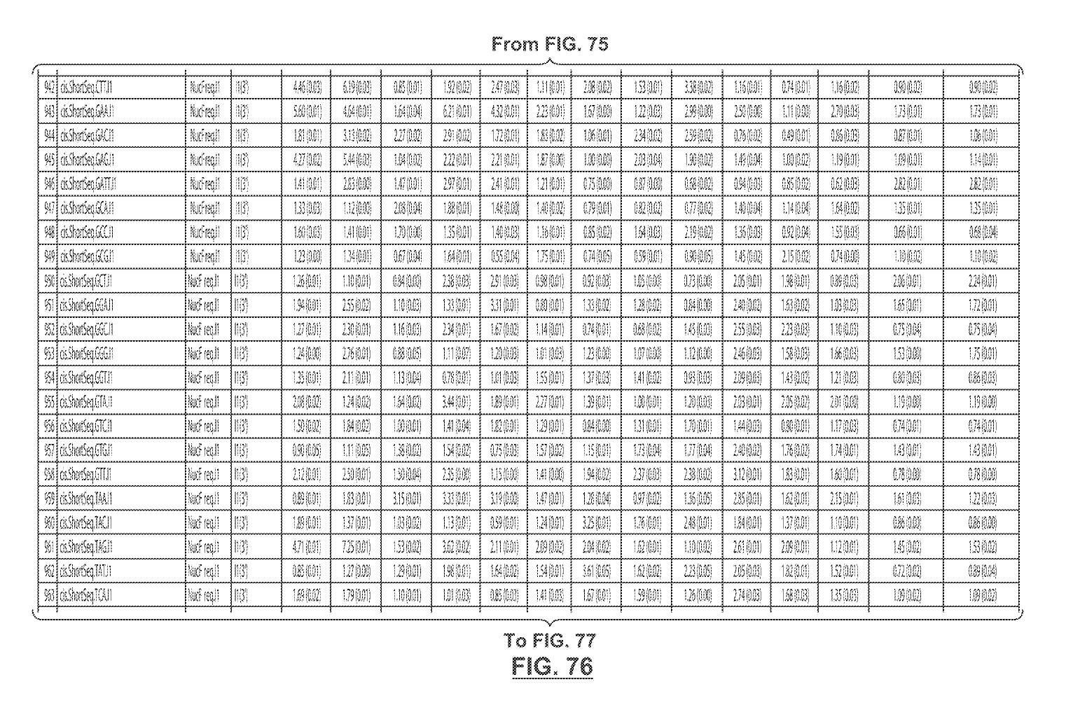

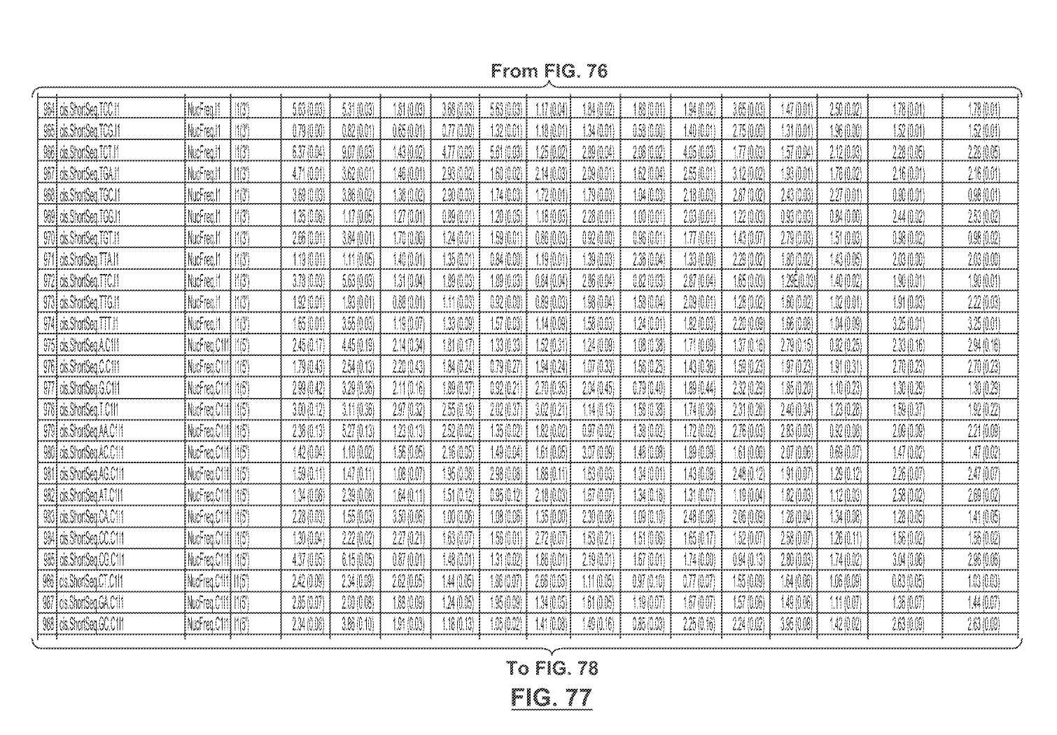

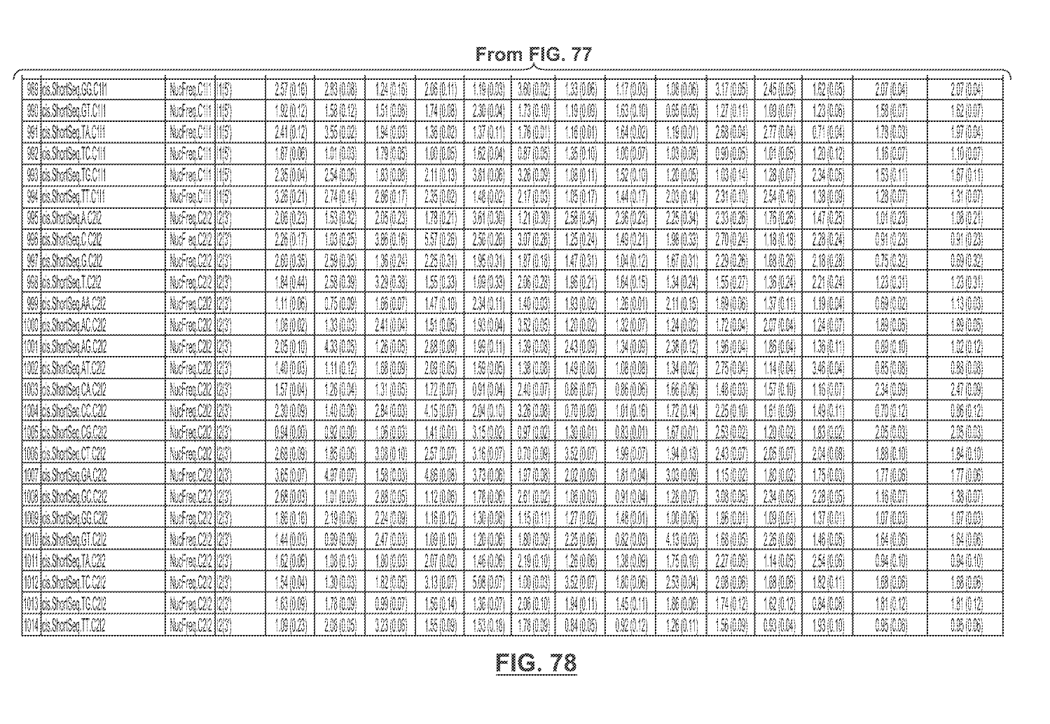

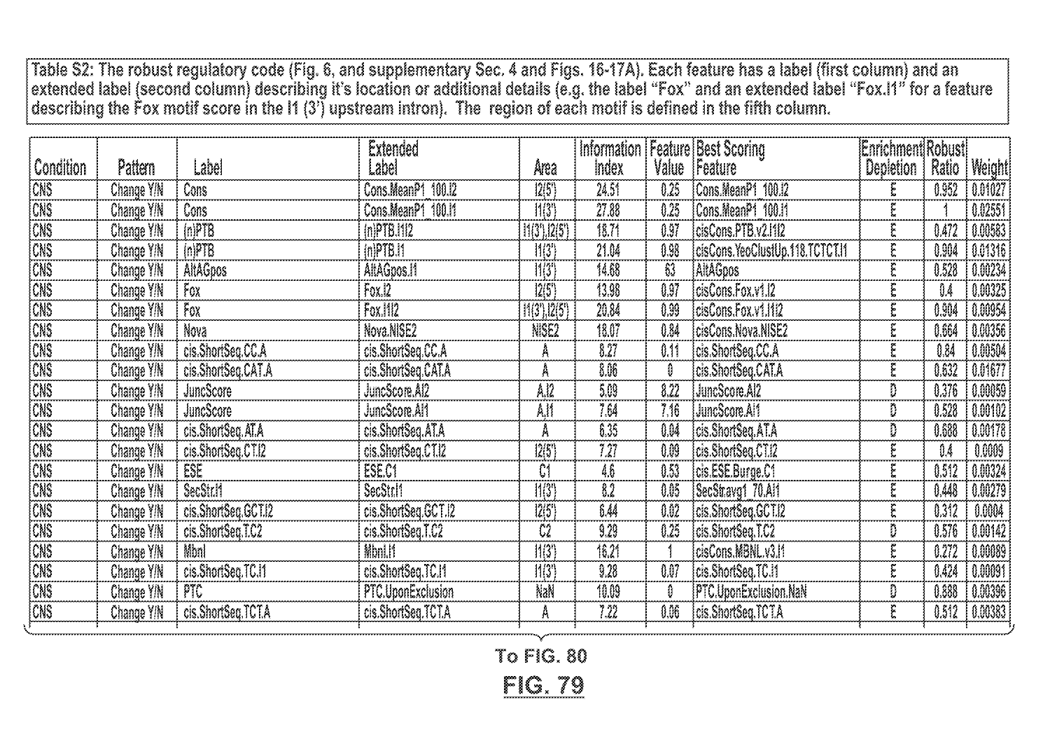

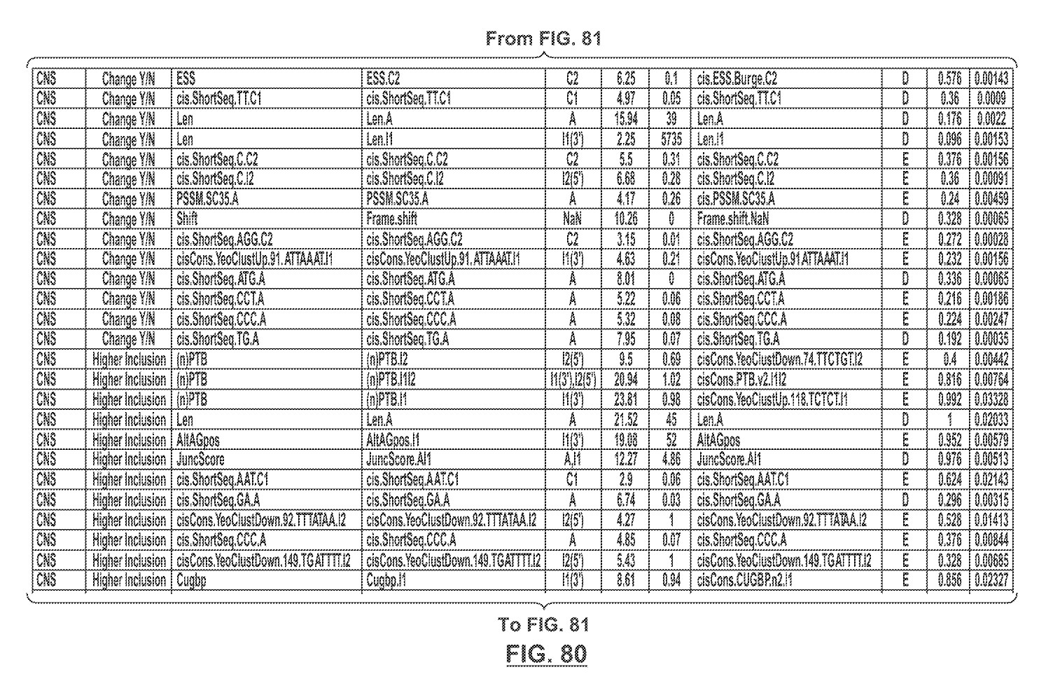

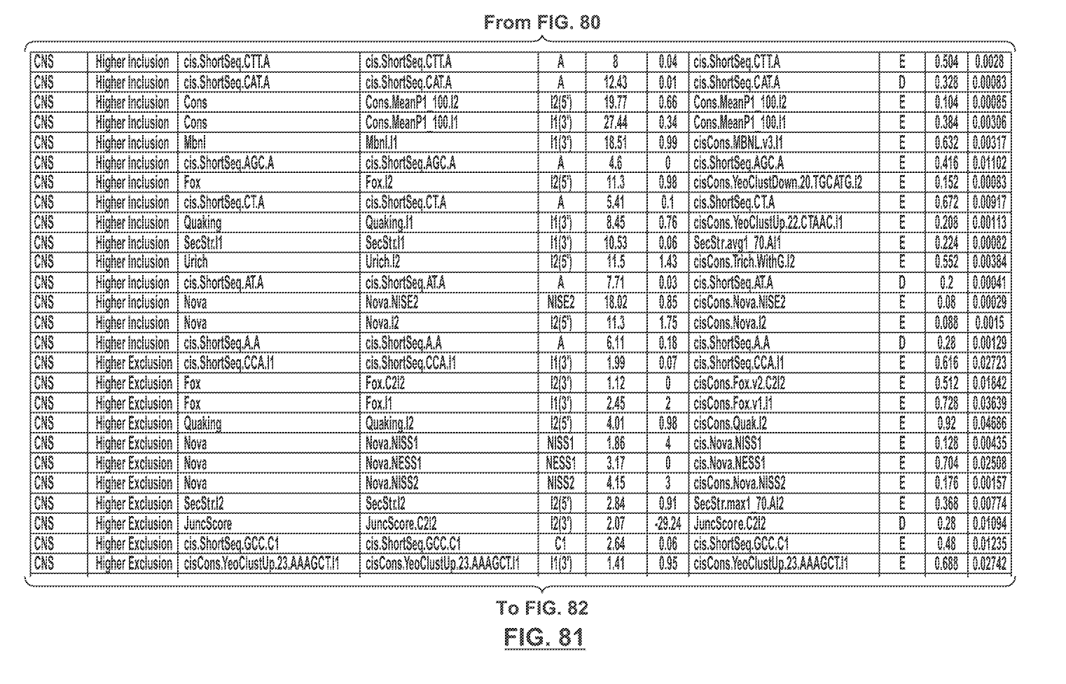

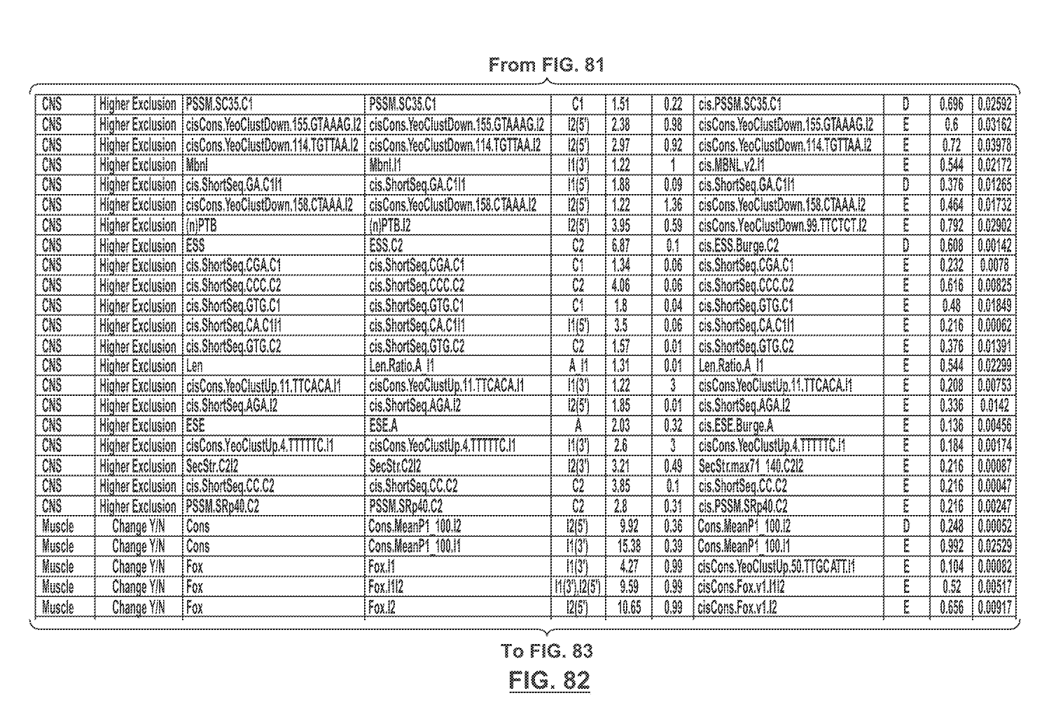

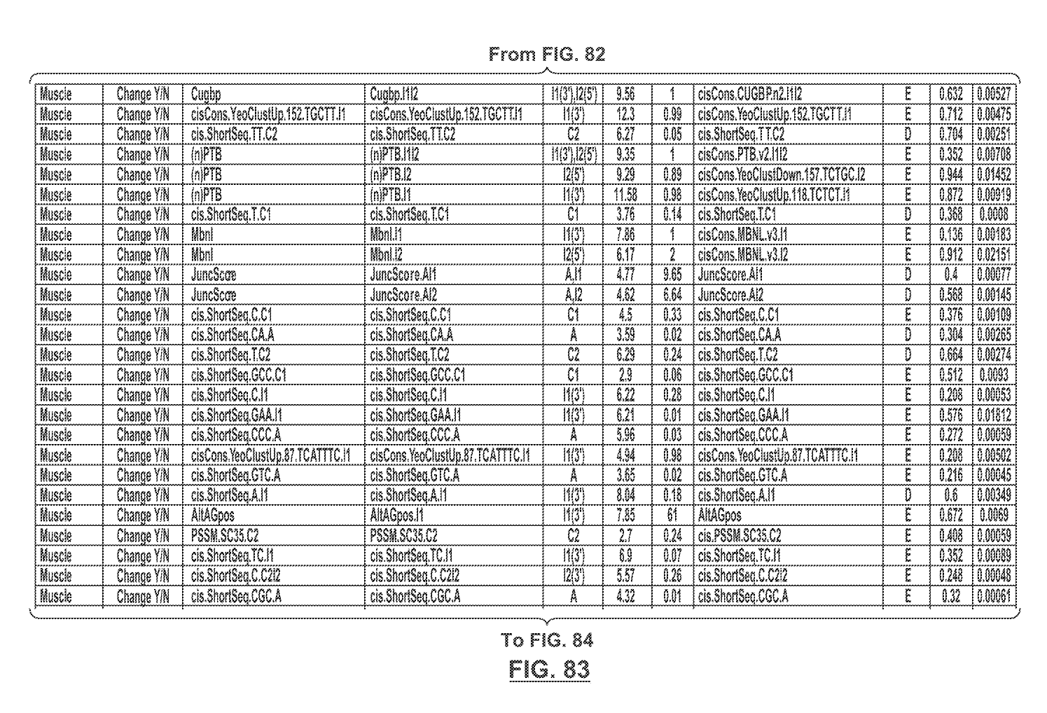

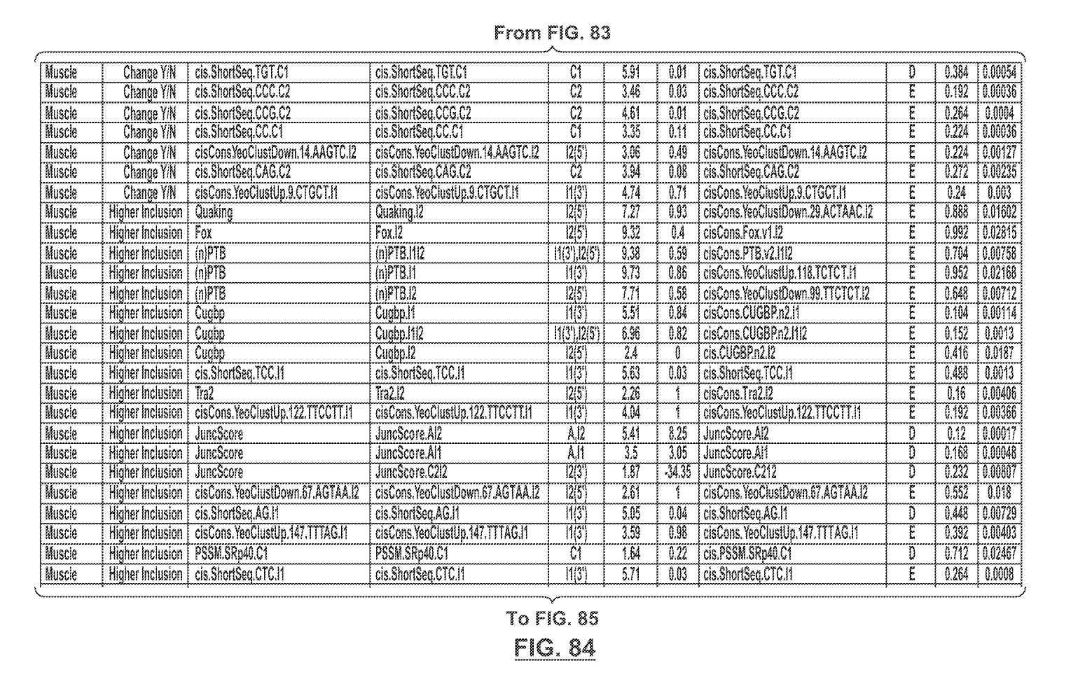

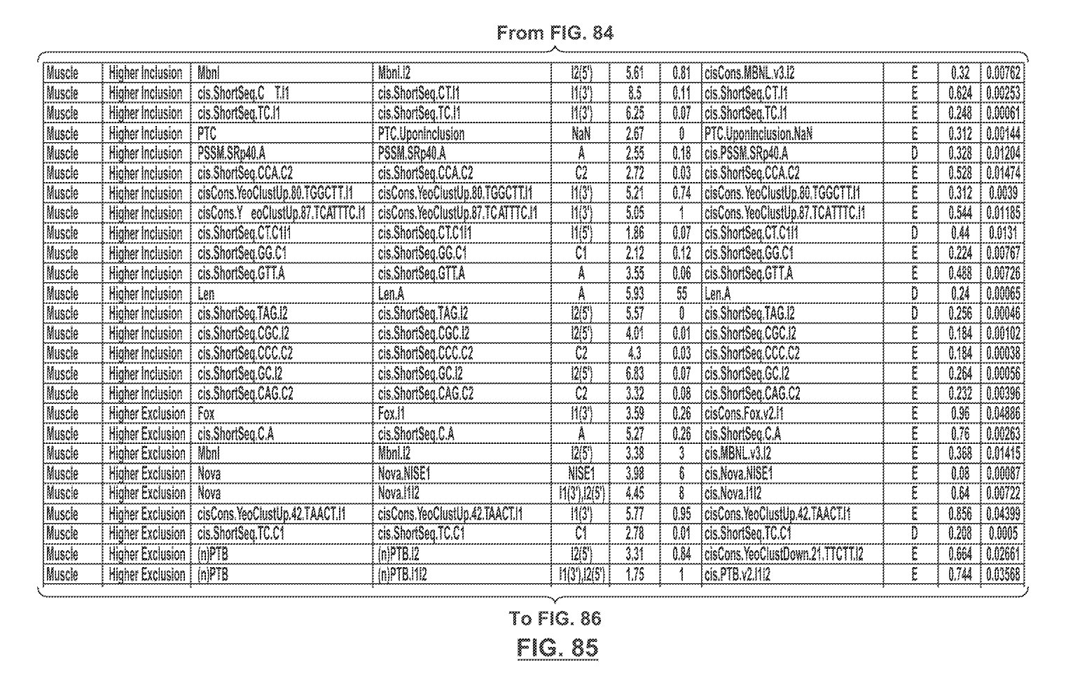

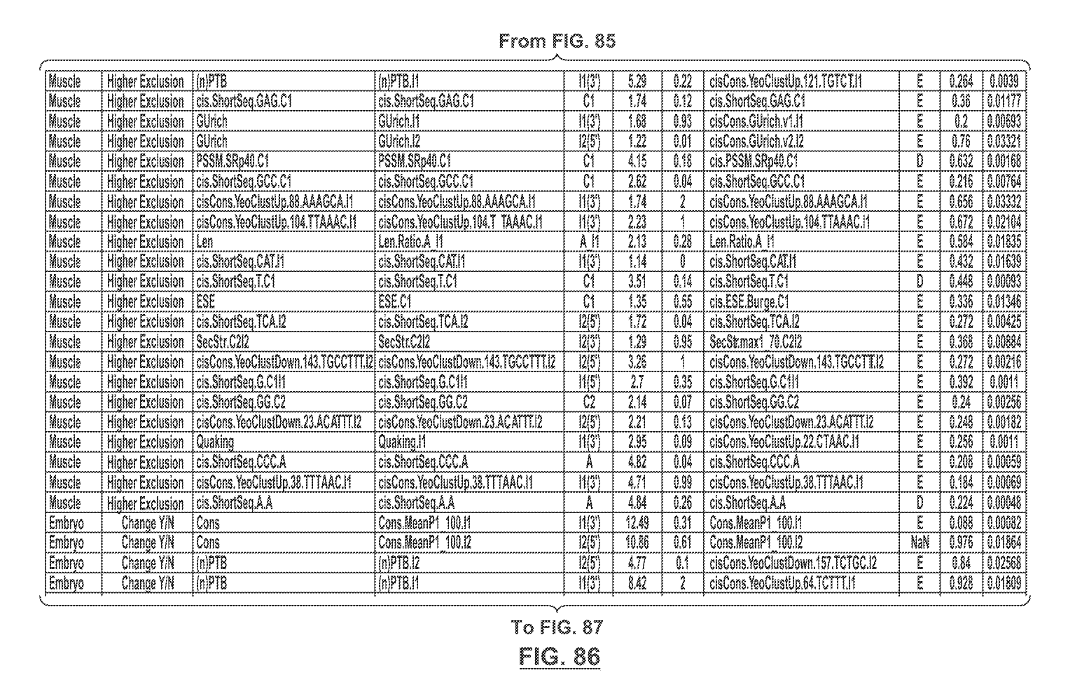

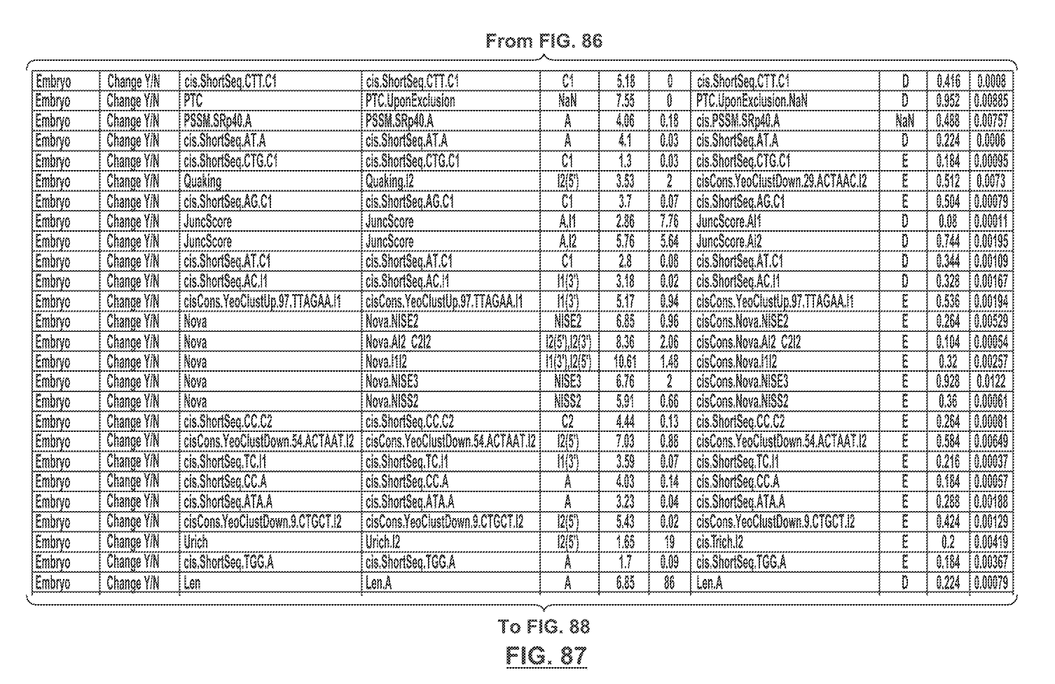

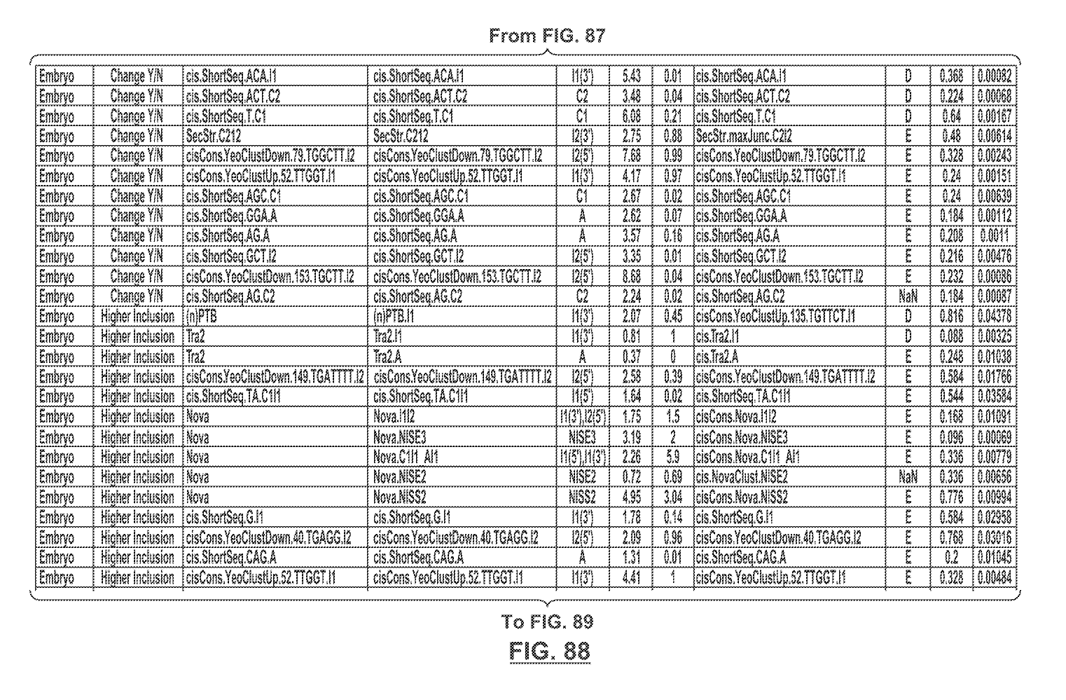

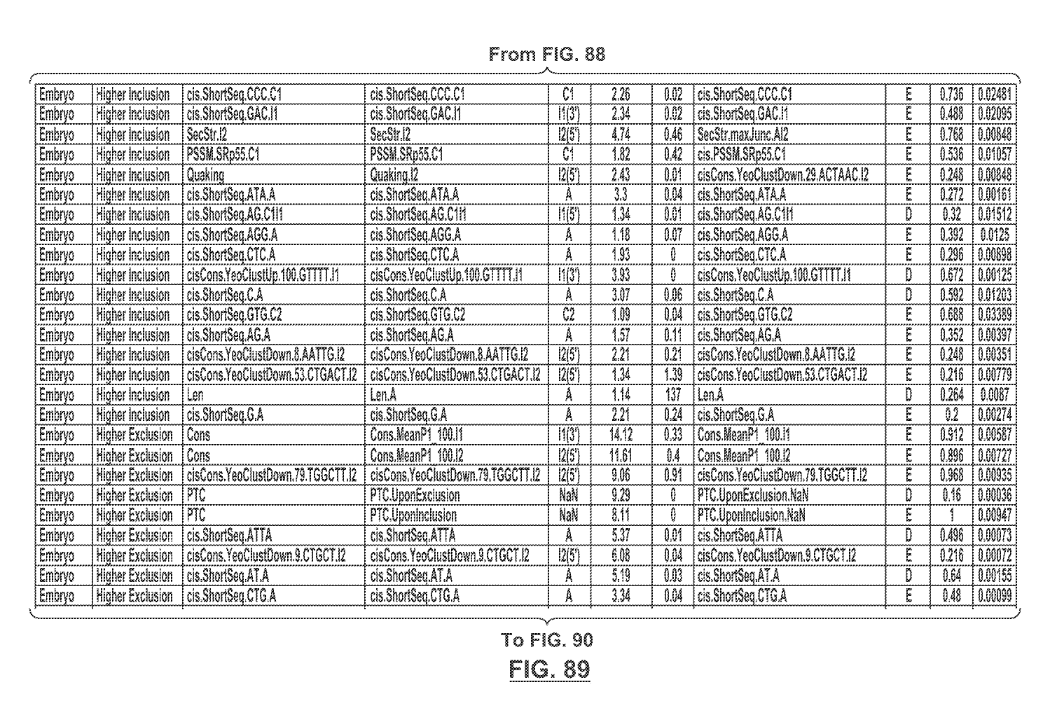

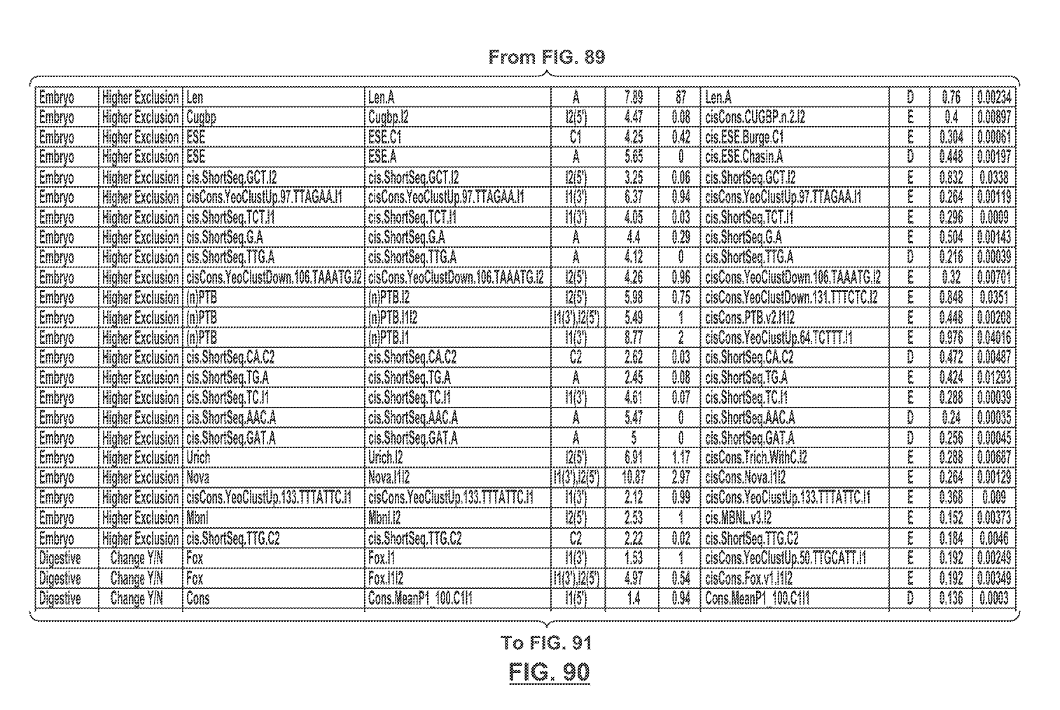

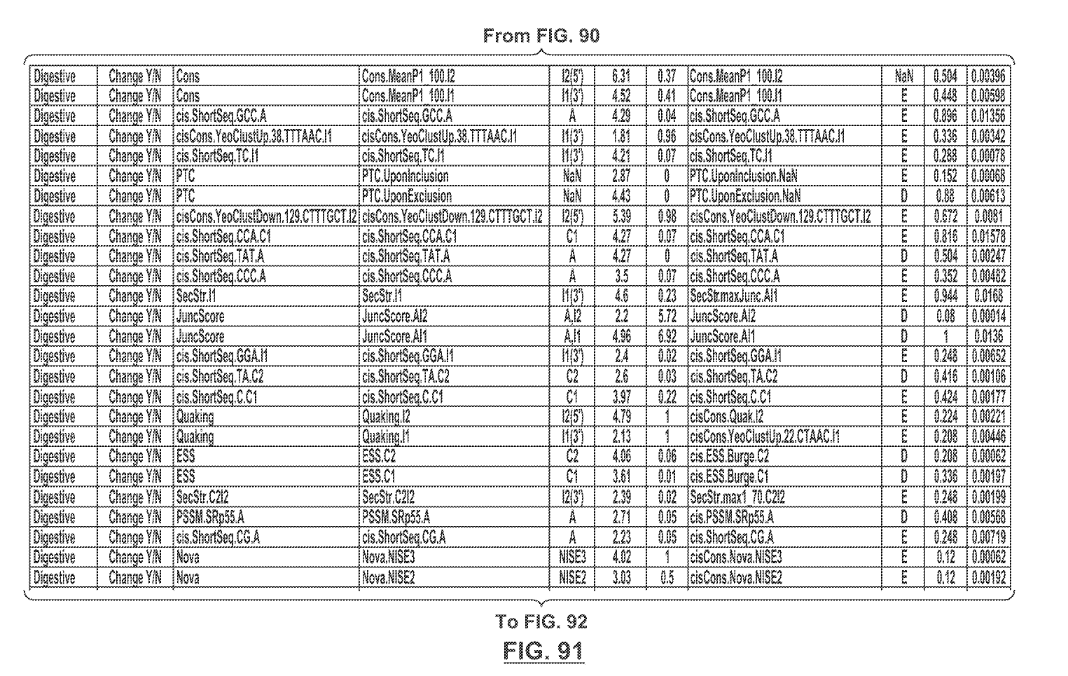

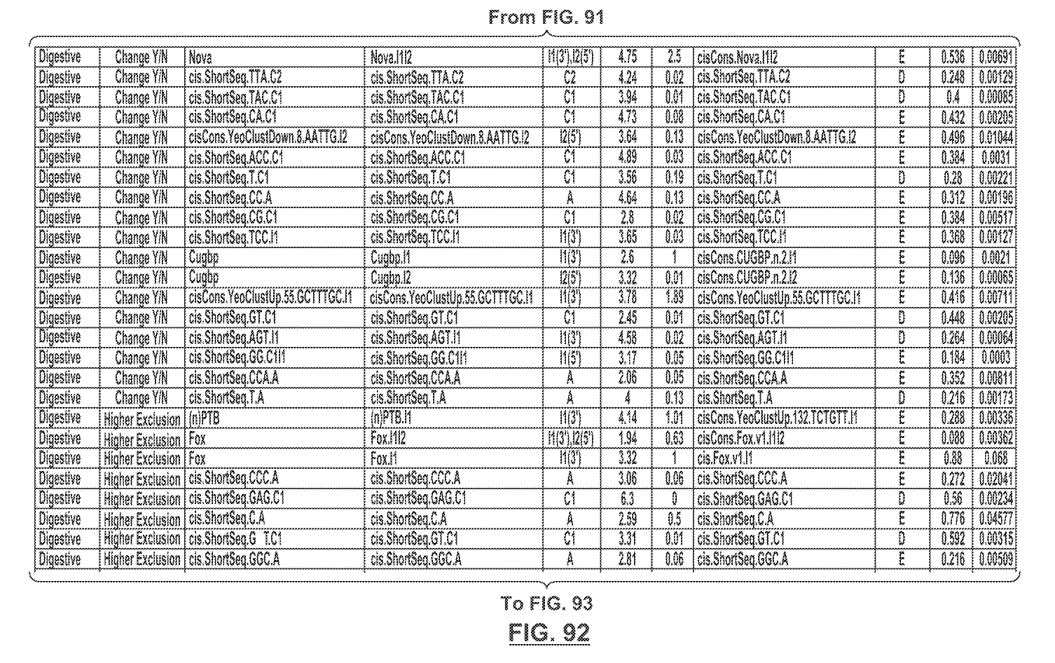

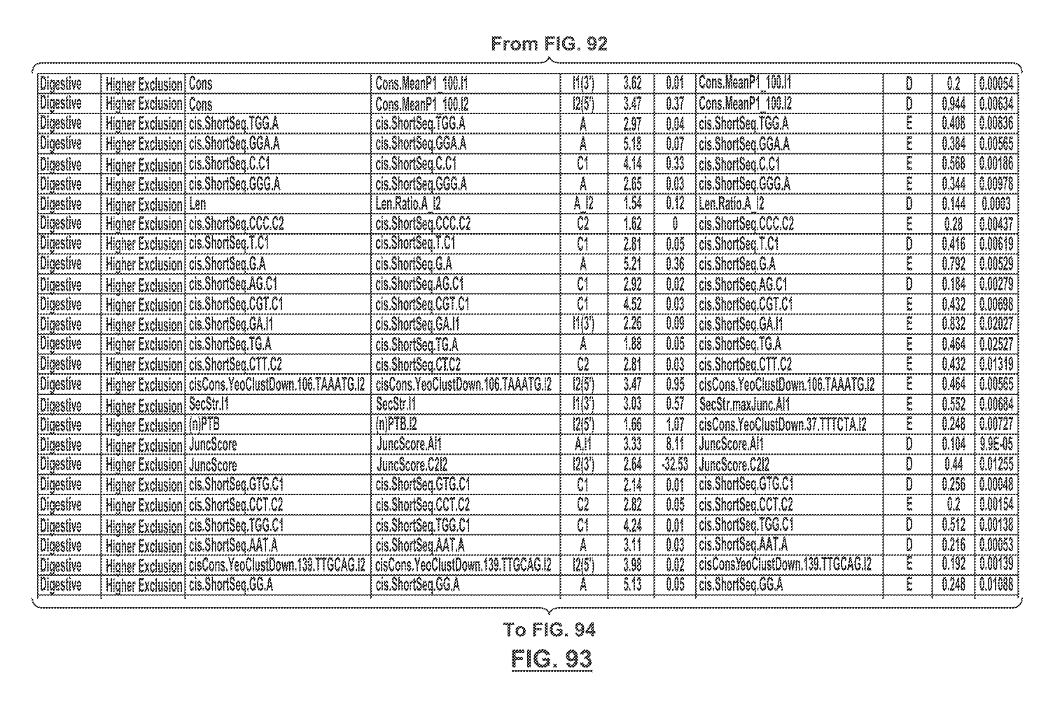

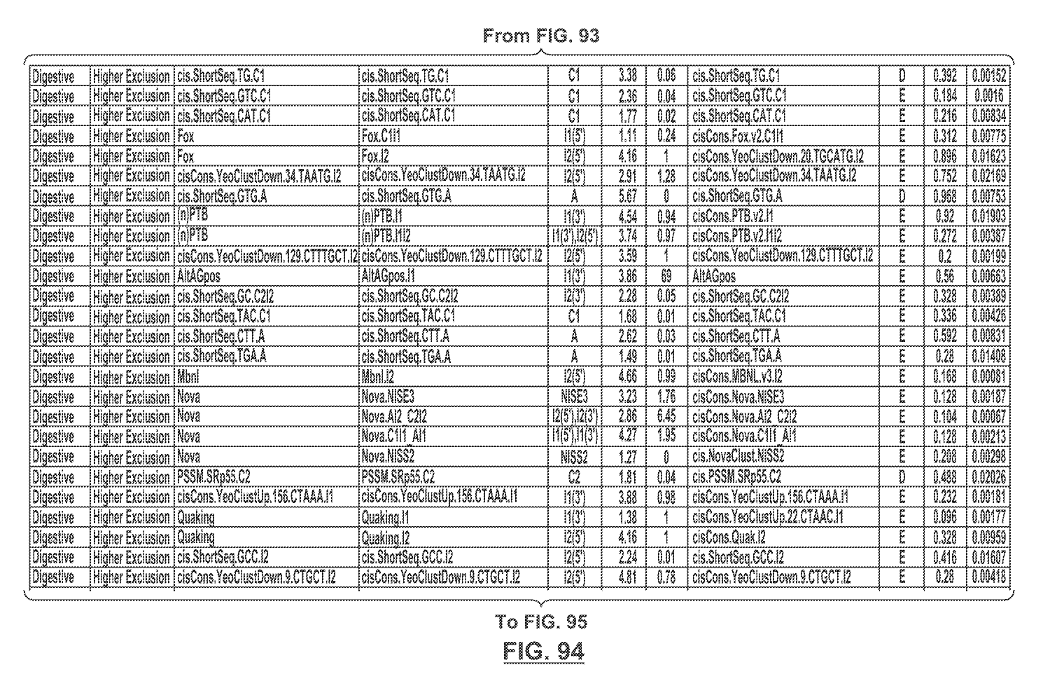

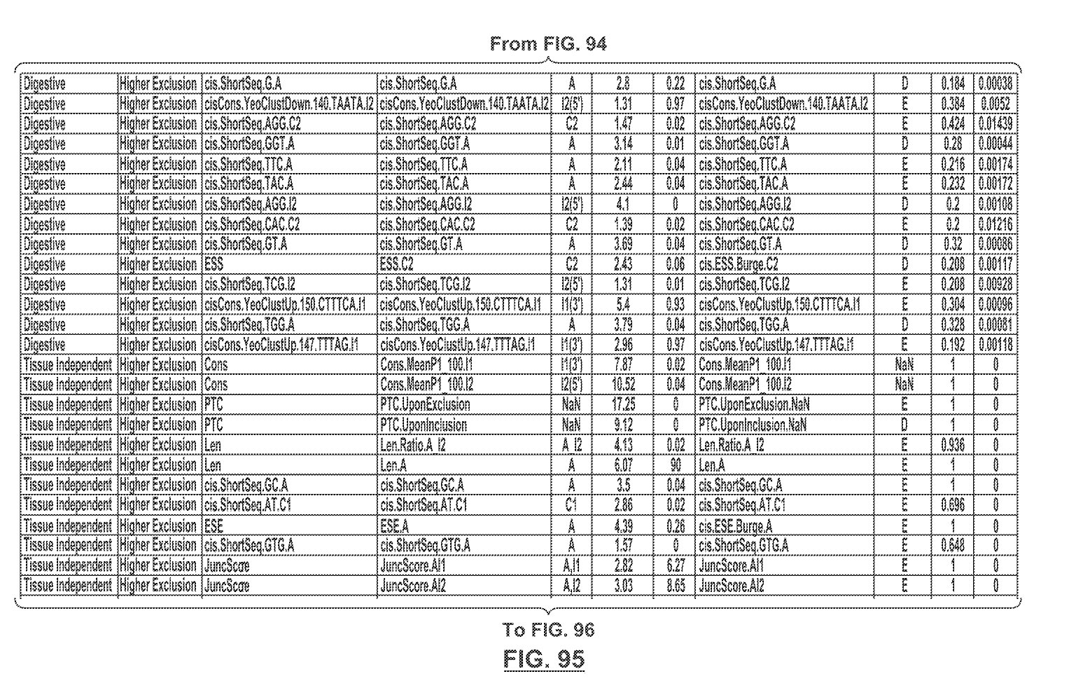

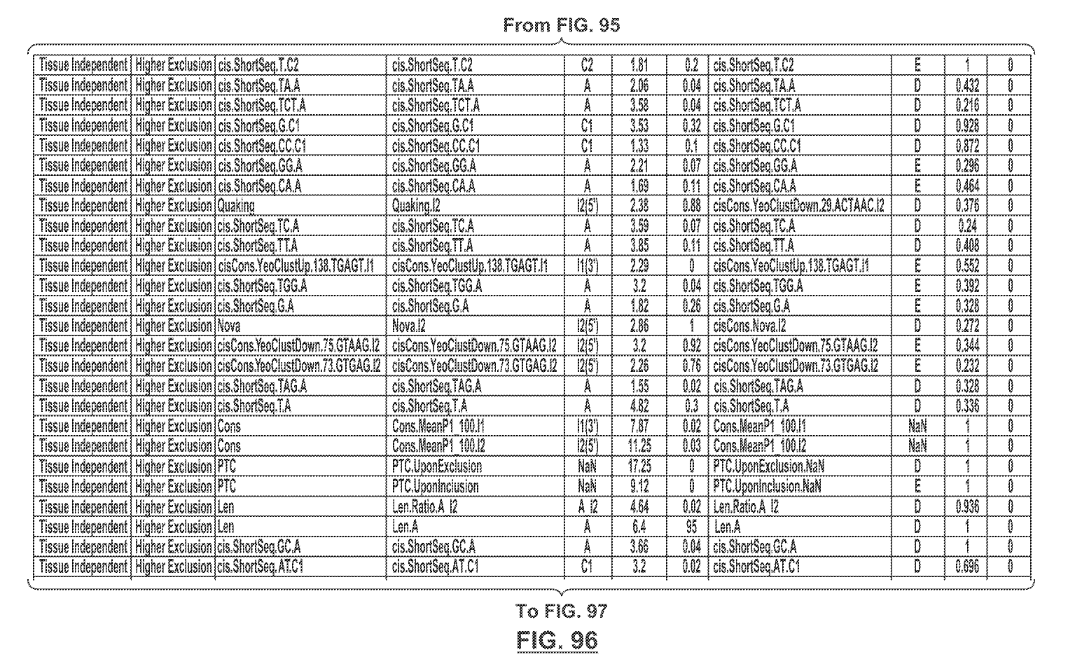

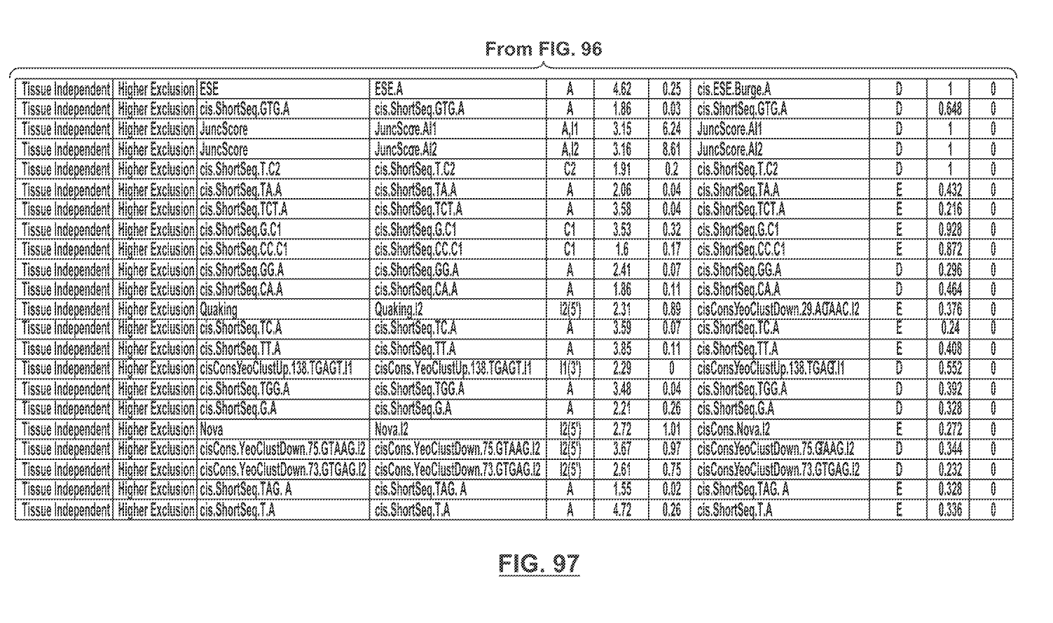

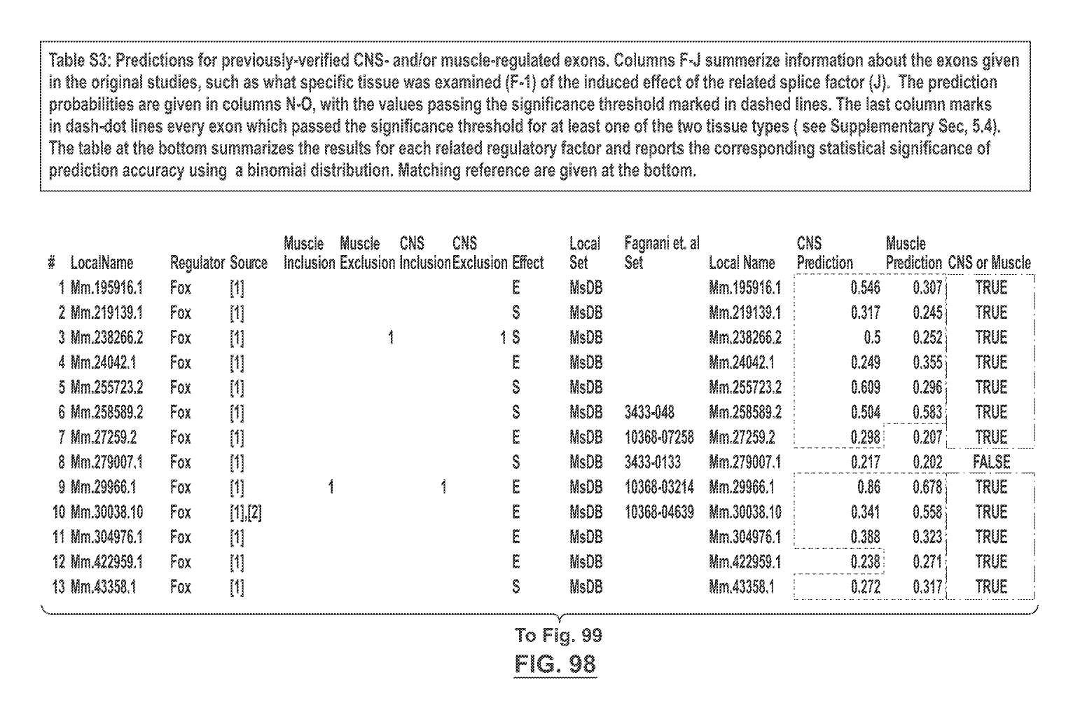

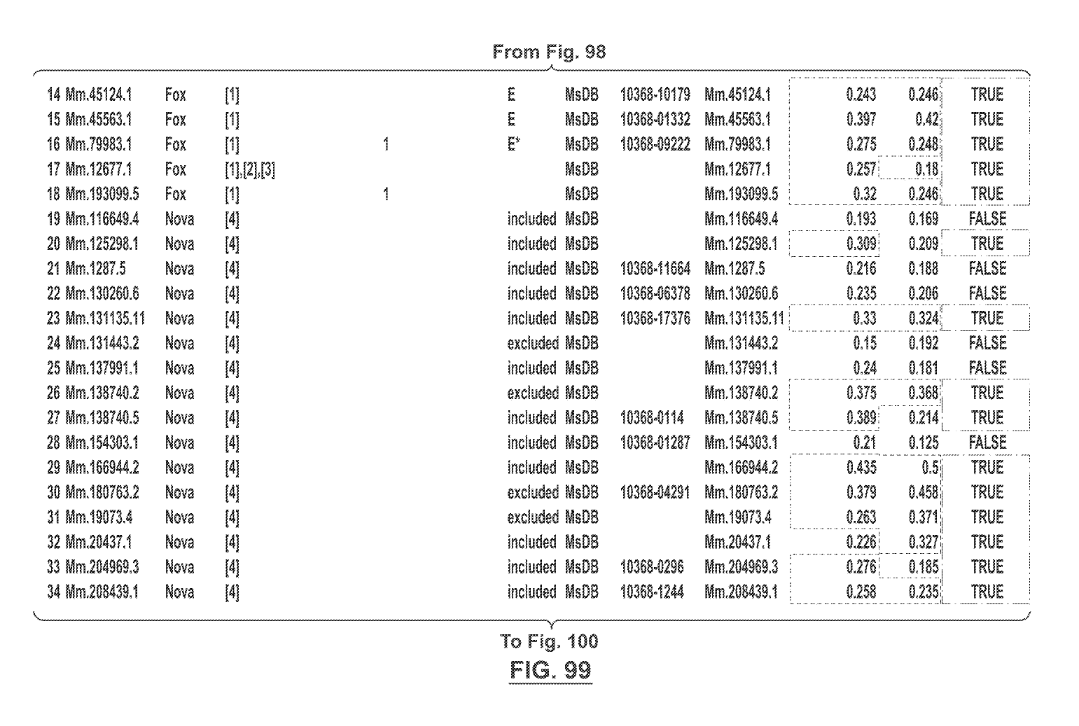

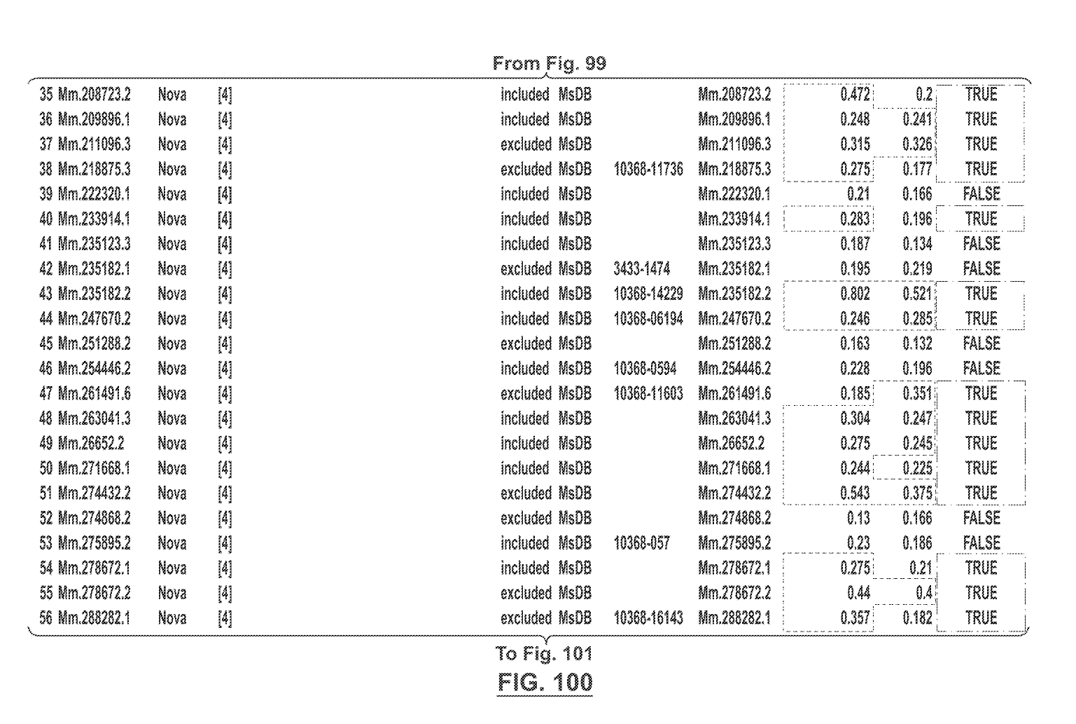

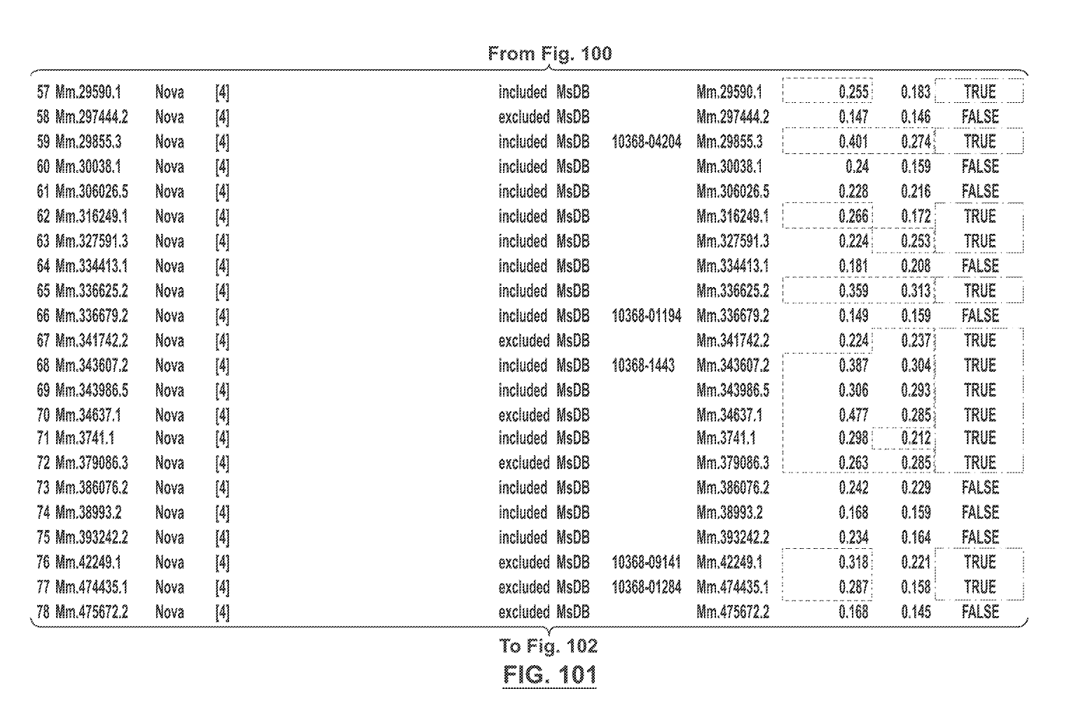

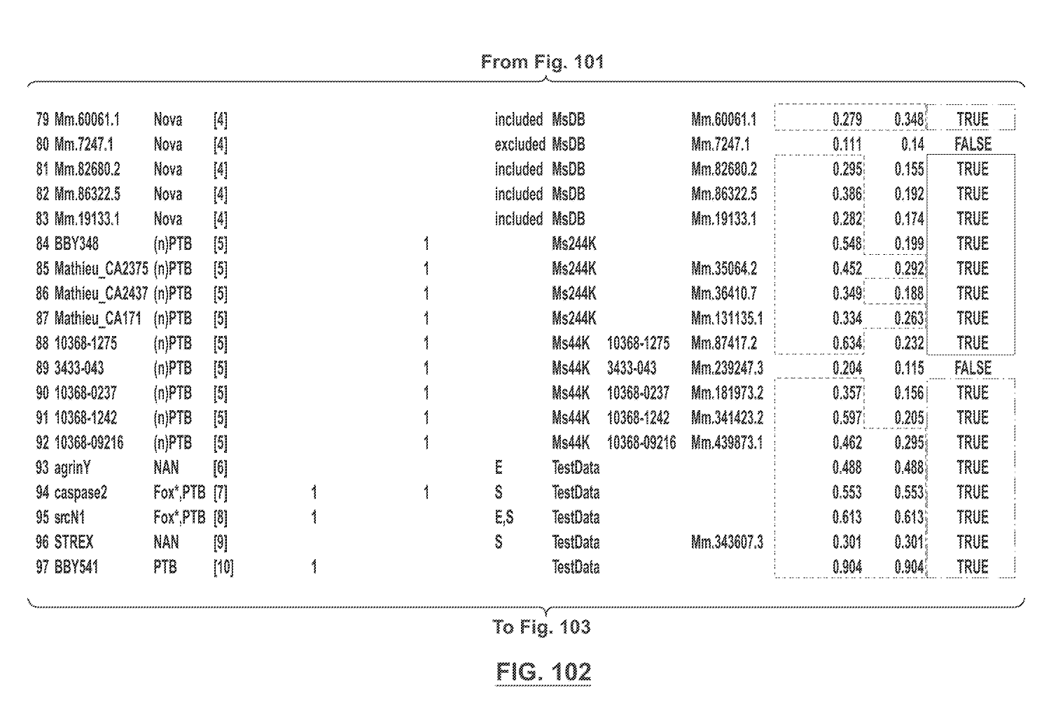

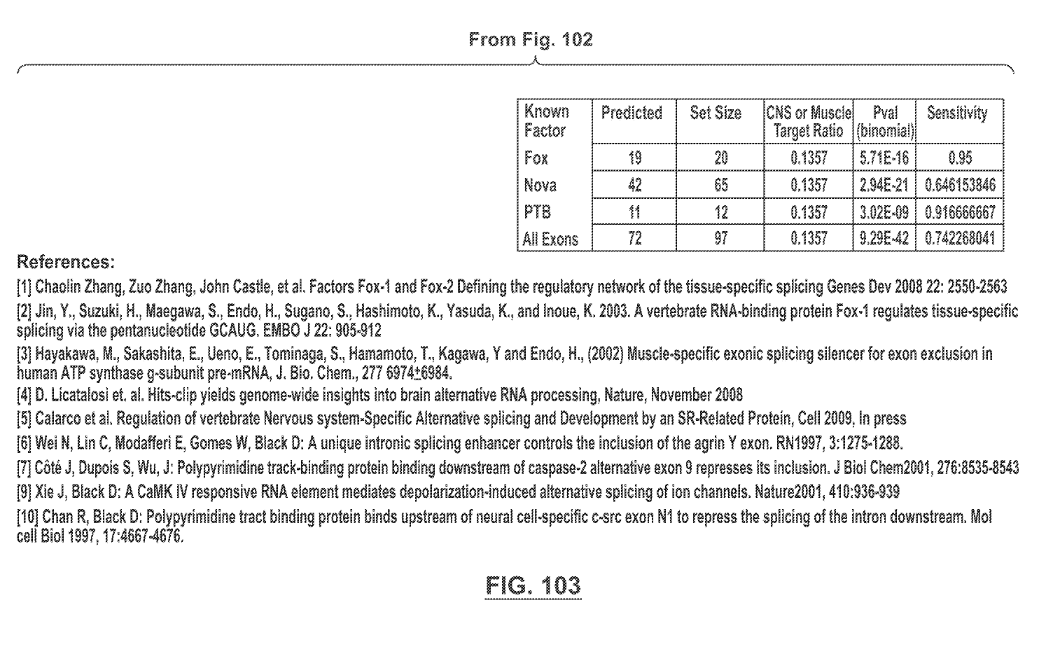

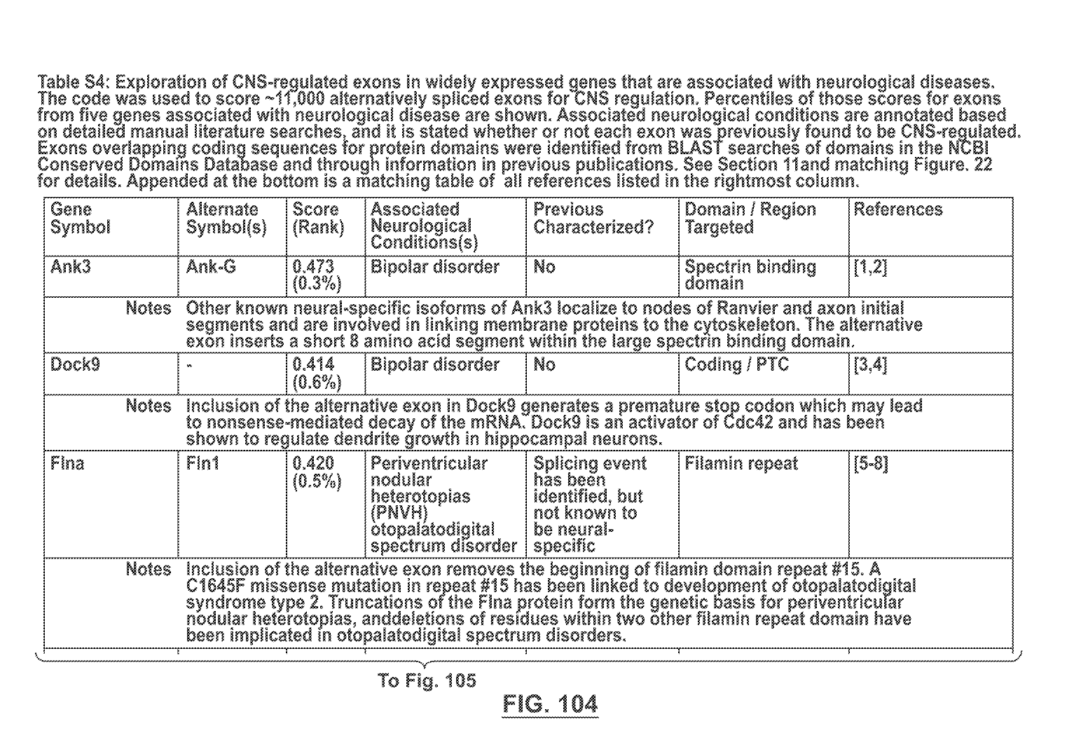

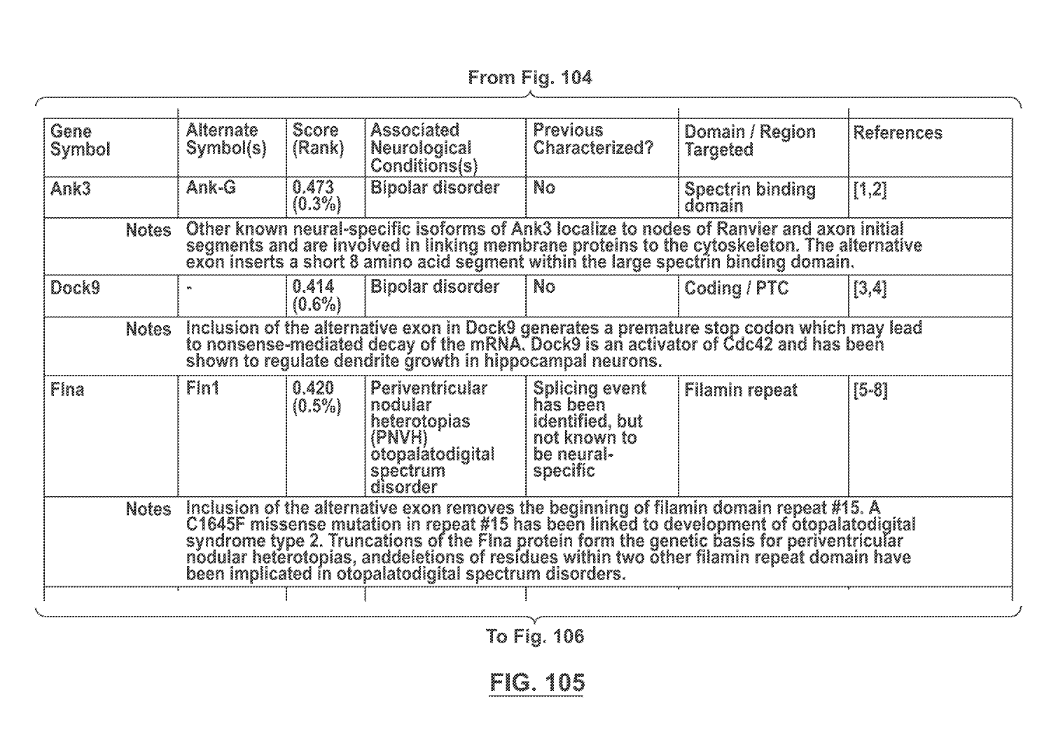

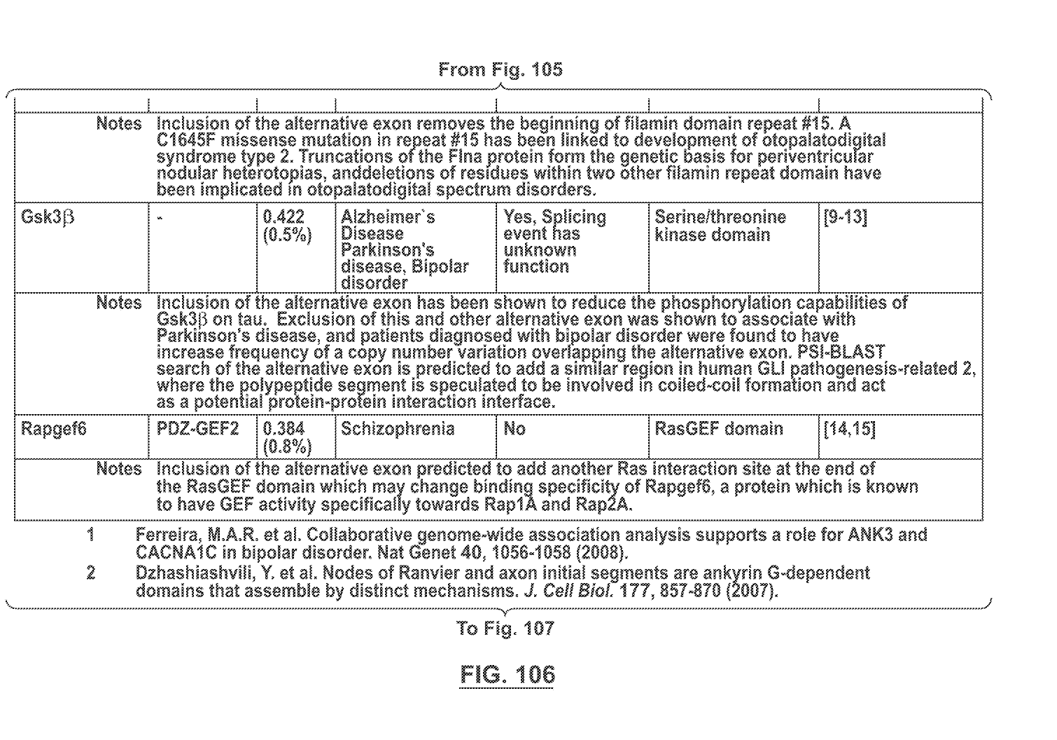

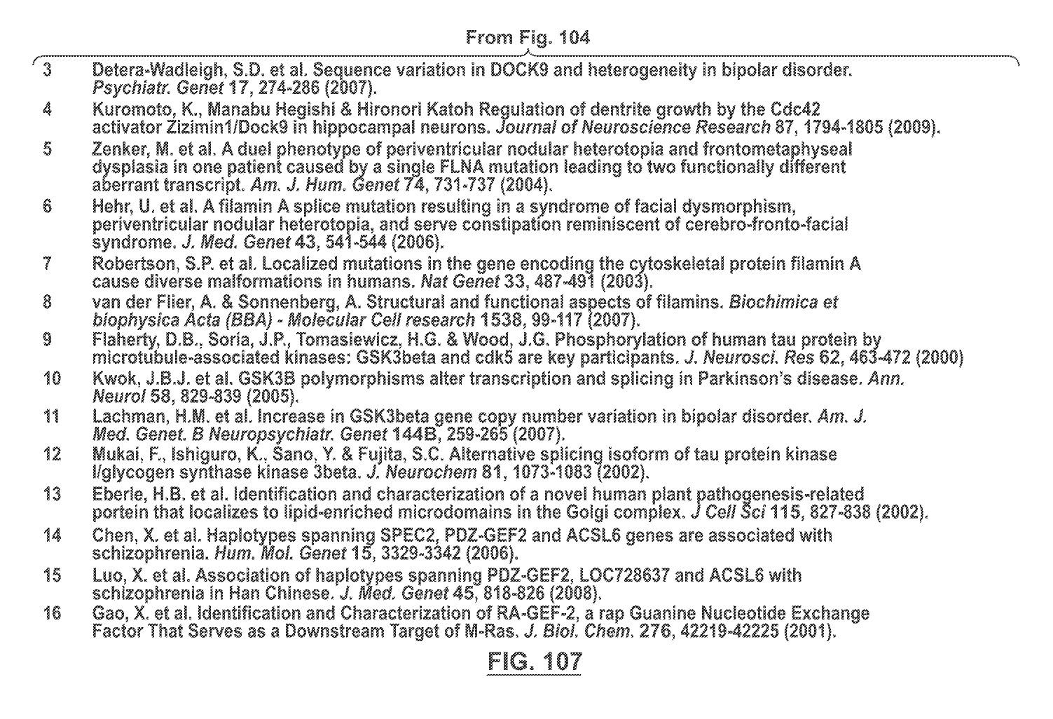

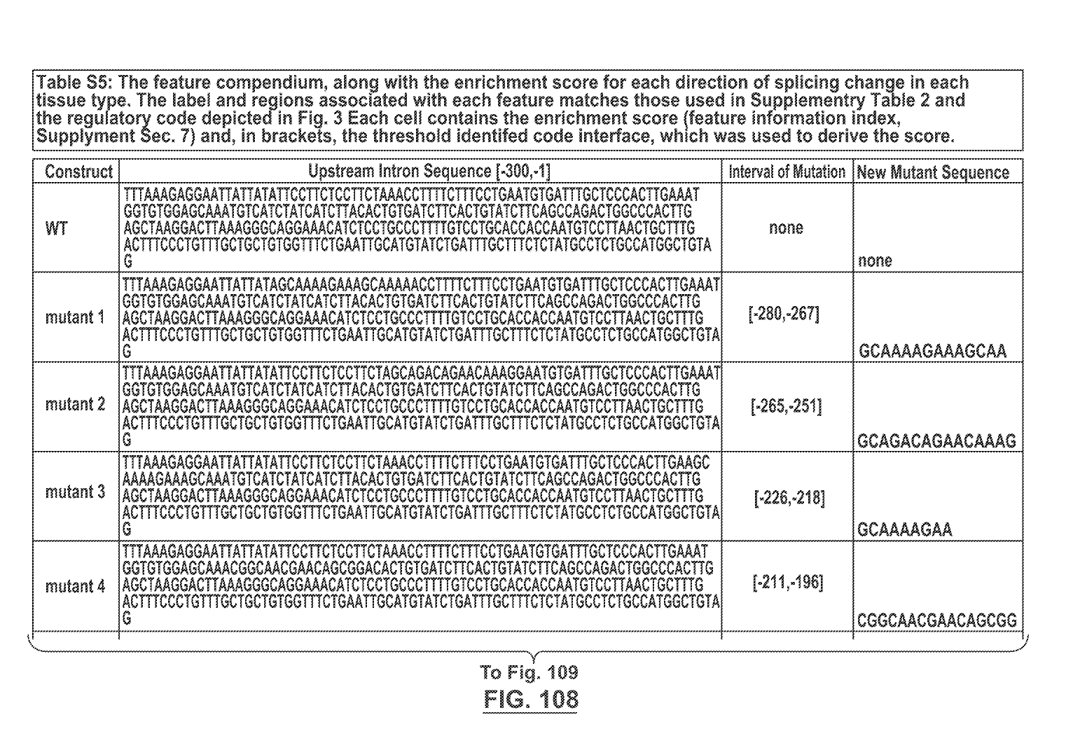

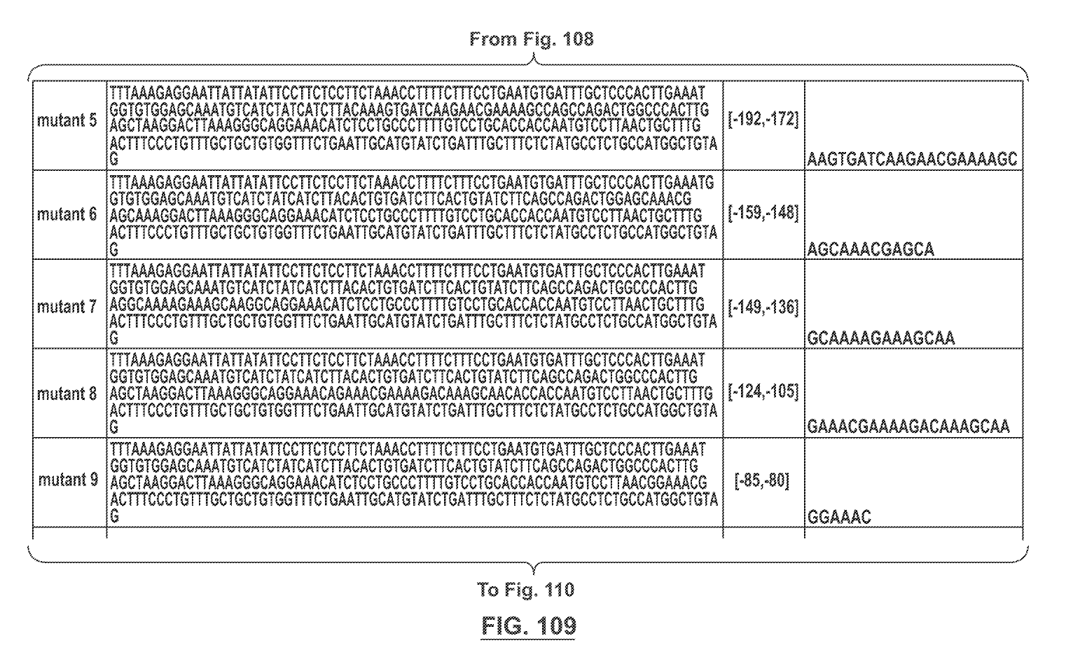

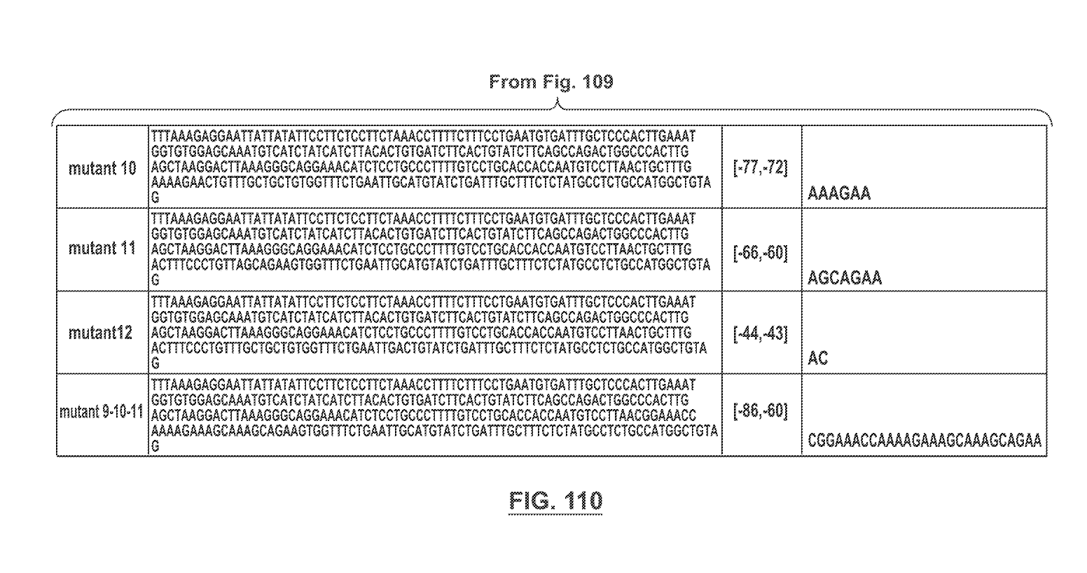

High-throughput AS measurements typically include estimation for the overall gene expression for the genes corresponding to each exon monitored in the experiments. For the data set of reference 2, two sets of expression measurements were available: log abundance estimates for the genes corresponding to each exon monitored in the experiment, denoted {vₜ^{e}}∈ R, and a set of measurements from negative probes {v*}∈ R, for genes presumably not expressed. The distribution over the two sets is shown in FIG. 31, part A. A common approach to utilize such information is to set a threshold over expression values, to make sure at least a predefined percentage of the negative probes are excluded. The result of applying this approach is shown in FIG. 31, part B. The vertical dashed line corresponds to a threshold that removes 95% of the negative probes, while the dashed line indicates that using that threshold would retain about 75% of the original measurements and remove about a quarter. FIG. 31, part C shows the result of applying this approach to a noisier data set, derived from a higher density micro array and various human tissue. In this case, using such a threshold would result in removing over 70% of the original data.

Instead of using a hard threshold to include or reject data in subsequent analysis, our probabilistic framework allows us to incorporate the gene expression measurement vₜ^{e} into the model in order to update the posterior belief that an AS measurements xₜ^{e} comes from the signal or the noise model. For the expression measurements we assume a generative mixture distribution model where the observed expression level can be generated from two distinct distributions: The first is the distribution over noise measurements, which is the distribution that the measurements for the negative probes {v*} were sampled from. The second distribution is an unknown distribution over expression values corresponding to the signal model. According to our model, the observed expression values vₜ^{e} are a set sampled from a mixture of these two distributions, with some unknown mixing proportions. The probability of an observed expression value under this mixture model can be written as:

P(vₜ^{e})=P(n=1)P(vₜ^{e}|Θₙ₌₁+P(n=0)P(vₜ^{e})|Θₙ₌₀),

Where P(n=1)=1−P(n=0) give the mixing proportions, while Θₙ₌₀ and Θₙ₌₁ are the parameters that govern the signal and noise expression level distributions. According to this model, given the observed data {vₜ^{e}} and {v*}, our task is to find the model parameters P(n=1), Θₙ₌₀, and Θₙ₌₁ that maximize the likelihood of the data. We do this by first estimating Θₙ₌₀ from {v*}, then we fix these parameters and run EM for mixture model learning to fit P(n=1), and Θₙ₌₁.

As usual with EM based learning, a good initialization point is important. To achieve this, we used Matlab's built in package for parametrized distributions fitting to derive the initial parameters. After the model's parameters have been learned we compute for each AS measurement xₜ^{e} the posterior it came from the signal model based on the observed expression value:

$$P ( n = 0 \vert {v}_{t}^{e} ) = P ( n = 0 ) \frac{P ( {v}_{t}^{e} \vert {θ}_{n = 0} )}{P ( {v}_{t}^{e} )} .$$

This posterior as a function of the expression value is plotted in FIG. 31, parts B and C as a solid black line. The value P(n=0|vₜ^{e}), is plugged into the AS model presented above in the section Model-Based Detection of Alternative Splicing Signals, to update the belief each AS measurement comes from the signal rather than the noise model. Overall, for the data set of reference 2, the noise model marginal probability we inferred was P(n=0)˜11%, while for the second data set shown in FIG. 31, part C, the noise model marginal was more than doubled (P(n=0)˜23%).

### The Feature Information Index

In order to have a more quantitative measure of how identified AS signals correspond to known regulatory features, we did extensive literature survey for cis elements associated with splice factors that are known to have tissue-specific regulatory effect. These include motifs for CUG-rich, Mbnl and the CUGBP binding tracts (reference 4), PTB/nPTB binding tracts (references 1, 8, 9), Fox (reference, 6), Quaking (reference 3) and Nova (reference 10). We note that since current available regulatory information involves almost exclusively CNS and muscle tissues, our analysis concentrated only on AS signals reflecting splicing changes in those tissues. For each of the cis element in our set, we scored its enrichment, using the hyper-geometric p-value (-log scaled), in a group of exons. These motifs were searched in the alternative exon, the constitutive exons flanking it, and the intronic regions flanking those exons. The feature information index (FII) for a splicing signal in a given data set (e.g., splicing changes in CNS), was computed by summing over all the features enrichment scores for this group. When different motifs were available for the same SF, we only included the higher scoring one.

Those skilled in the art will appreciate that in some embodiments, the functionality of application 144 may be implemented using pre-programmed hardware or firmware elements (e.g., application specific integrated circuits (ASICs), electrically erasable programmable read-only memories (EEPROMs), etc.), or other related components.

A portion of the disclosure of this patent document contains material which is subject to copyright protection. The copyright owner has no objection to the facsimile reproduction by any one the patent document or patent disclosure, as it appears in the Patent and Trademark Office patent file or records, but otherwise reserves all copyrights whatsoever.

Persons skilled in the art will appreciate that there are yet more alternative implementations and modifications possible for implementing the embodiments, and that the above implementations and examples are only illustrations of one or more embodiments. The scope, therefore, is only to be limited by the claims appended hereto.

REFERENCES CITED UNDER THE HEADING “DECIPHERING THE SPLICING CODE”

1. Wang, E. T. et al. Alternative isoform regulation in human tissue transcriptomes. Nature 456, 470-476 (2008).

2. Pan, Q., Shai, O., Lee, L. J., Frey, B. J. & Blencowe, B. J. Deep surveying of alternative splicing complexity in the human transcriptome by high-throughput sequencing. Nature Genet. 40, 1413-1415 (2008).

3. Wang, G.-S. & Cooper, T. A. Splicing in disease: disruption of the splicing code and the decoding machinery. Nature Rev. Genet. 8, 749-761 (2007).

4. Wang, Z. & Burge, C. B. Splicing regulation: from a parts list of regulatory elements to an integrated splicing code. RNA 14, 802-813 (2008).

5. Hartmann, B. & Valcarcel, J. Decrypting the genome's alternative messages. Curr. Opin. Cell Biol. 21, 377-386 (2009).

6. Hallegger, M., Llorian, M. & Smith, C. W. Alternative splicing: global insights. FEBS J. 277, 856-866 (2010).

7. Nilsen, T. W. & Graveley, B. R. Expansion of the eukaryotic proteome by alternative splicing. Nature 463, 457-463 (2010).

8. Blencowe, B. J. Alternative splicing: new insights from global analyses. Cell 126, 7-47 (2006).

9. Black, D. L. Mechanisms of alternative pre-messenger RNA splicing. Annu. Rev. Biochem. 72, 291-336 (2003).

10. Fagnani, M. et al. Functional coordination of alternative splicing in the mammalian central nervous system. Genome Biol. 8, R108 (2007).

11. Shai, O., Morris, Q. D., Blencowe, B. J. & Frey, B. J. Inferring global levels of alternative splicing isoforms using a generative model of microarray data. Bioinformatics 22, 606-613 (2006).

12. Sugnet, C. W. et al. Unusual intron conservation near tissue-regulated exons found by splicing microarrays. PLoS Comput. Biol. 2, e4 (2006).

13. Das, D. et al. A correlation with exon expression approach to identify cis-regulatory elements for tissue-specific alternative splicing. Nucleic Acids Res. 35, 4845-4857 (2007).

14. Castle, J. C. et al. Expression of 24,426 human alternative splicing events and predicted cis regulation in 48 tissues and cell lines. Nature Genet. 40, 1416-1425 (2008).

15. Minovitsky, S., Gee, S. L., Schokrpur, S., Dubchak, I. & Conboy, J. G. The splicing regulatory element, UGCAUG, is phylogenetically and spatially conserved in introns that flank tissue-specific alternative exons. Nucleic Acids Res. 33, 714-724 (2005).

16.Kawamoto, S. Neuron-specific alternative splicing of nonmuscle myosin II heavy chain-B pre-mRNA requires a cis-acting intron sequence. J. Biol. Chem. 271, 17613-17616 (1996).

17. Ule, J. et al. An RNA map predicting Nova-dependent splicing regulation. Nature 444, 580-586 (2006).

18. Licatalosi, D. D. et al. HITS-CLIP yields genome-wide insights into brain alternative RNA processing. Nature 456, 464-469 (2008).

19. Chan, R. C. & Black, D. L. The polypyrimidine tract binding protein binds upstream of neural cell-specific c-src exon N1 to repress the splicing of the intron downstream. Mol. Cell. Biol. 17, 4667-4676 (1997).

20. Ashiya, M. & Grabowski, P. J. A neuron-specific splicing switch mediated by an array of pre-mRNA repressor sites: evidence of a regulatory role for the polypyrimidine tract binding protein and a brain-specific PTB counterpart. RNA 3, 996-1015 (1997).

21. Faustino, N. A. & Cooper, T. A. Identification of putative new splicing targets for ETR-3 using sequences identified by systematic evolution of ligands by exponential enrichment. Mol. Cell. Biol. 25, 879-887 (2005).

22. Galarneau, A. & Richard, S. Target RNA motif and target mRNAs of the Quaking STAR protein. Nature Struct. Mol. Biol. 12, 691-698 (2005).

23. Sorek, R. & Ast, G. Intronic sequences flanking alternatively spliced exons are conserved between human and mouse. Genome Res. 13, 1631-1637 (2003).

24. Fairbrother, W. G., Yeh, R. F., Sharp, P. A. & Burge, C. B. Predictive identification of exonic splicing enhancers in human genes. Science 297, 1007-1013 (2002).

25. Zhang, X. H. & Chasin, L. A. Computational definition of sequence motifs governing constitutive exon splicing. Genes Dev. 18, 1241-1250 (2004).

26. Stadler, M. B. et al. Inference of splicing regulatory activities by sequence neighborhood analysis. PLoS Genet. 2, e191 (2006).

27. Yeo, G. W., Nostrand, E. L. & Liang, T. Y. Discovery and analysis of evolutionarily conserved intronic splicing regulatory elements. PLoS Genet. 3, e85 (2007).

28. Xiao, X., Wang, Z., Jang, M. & Burge, C. B. Coevolutionary networks of splicing cis-regulatory elements. Proc. Natl Acad. Sci. USA 104, 18583-18588 (2007).

29. Shepard, P. J. & Hertel, K. J. Conserved RNA secondary structures promote alternative splicing. RNA 14, 1463-1469 (2008).

30. Bishop, C. M. Pattern Recognition and Machine Learning. (Springer, 2006).

31. Shannon, C. E. A mathematical theory of communication. Bell Syst. Tech. J. 27, 379-423 (1948).

32. WoMerton, M. C., Gooding, C., Wagner, E. J., Garcia-Blanco, M. A. & Smith, C. W. Autoregulation of polypyrimidine tract binding protein by alternative splicing leading to nonsense-mediated decay. Mol. Cell 13, 91-100 (2004).

33. Wei, N., Lin, C. Q., Modafferi, E. F., Gomes, W. A. & Black, D. L. A unique intronic splicing enhancer controls the inclusion of the agrin Y exon. RNA 3, 1275-1288 (1997).

34. Lim, L. P. & Sharp, P. A. Alternative splicing of the fibronectin EIIIB exon depends on specific TGCATG repeats. Mol. Cell. Biol. 18, 3900-3906 (1998).

35. Cote, J., Dupuis, S., Jiang, Z. & Wu, J. Y. Caspase-2 pre-mRNA alternative splicing: identification of an intronic element containing a decoy 39 acceptor site. Proc. Natl Acad. Sci. USA 98, 938-943 (2001).

36. Hayakawa, M. et al. Muscle-specific exonic splicing silencer for exon exclusion in human ATP synthase c-subunit pre-mRNA. J. Biol. Chem. 277, 6974-6984 (2002).

37. Jin, Y. et al. A vertebrate RNA-binding protein Fox-1 regulates tissue-specific splicing via the pentanucleotide GCAUG. EMBO J. 22, 905-912 (2003).

38. Zhang, C. et al. Defining the regulatory network of the tissue-specific splicing factors Fox-1 and Fox-2. Genes Dev. 22, 2550-2563 (2008).

39. Calarco, J. A. et al. Regulation of vertebrate nervous system alternative splicing and development by an SR-related protein. Cell 138, 898-910 (2009).

40. Gooding, C. et al. A class of human exons with predicted distant branch points revealed by analysis of AG dinucleotide exclusion zones. Genome Biol. 7, R1 (2006).

41. Wu, J. I., Reed, R. B., Grabowski, P. J. & Artzt, K. Function of quaking in myelination: regulation of alternative splicing. Proc. Natl Acad. Sci. USA 99, 4233-4238 (2002).

42. Oberstrass, F. C. et al. Structure of PTB bound to RNA: specific binding and implications for splicing regulation. Science 309, 2054-2057 (2005).

43. Markovtsov, V. et al. Cooperative assembly of an hnRNP complex induced by a tissue-specific homolog of polypyrimidine tract binding protein. Mol. Cell. Biol. 20, 7463-7479 (2000).

44. Xie, J., Jan, C., Stoilov, P., Park, J. & Black, D. L. A consensus CaMK IV-responsive RNA sequence mediates regulation of alternative exons in neurons. RNA 11, 1825-1834 (2005).

45. Perez, I., Lin, C. H., McAfee, J. G. & Patton, J. G. Mutation of PTB binding sites causes misregulation of alternative 39 splice site selection in vivo. RNA 3, 764-778 (1997).

46. Lipowsky, G. et al. Exportin 4: a mediator of a novel nuclear export pathway in higher eukaryotes. EMBO J. 19, 4362-4371 (2000).

47. Gontan, C. et al. Exportin 4 mediates a novel nuclear import pathway for Sox family transcription factors. J. Cell Biol. 185, 27-34 (2009).

48. Lefebvre, V., Dumitriu, B., Penzo-Me'ndez, A., Han, Y. & Pallavi, B. Control of cell fate and differentiation by Sry-related high-mobility-group box (Sox) transcription factors. Int. J. Biochem. Cell Biol. 39, 2195-2214 (2007).

49. Zender, L. et al. An oncogenomics-based in vivo RNAi screen identifies tumor suppressors in liver cancer. Cell 135, 852-864 (2008).

50. Ray, D. et al. RNACompete: Rapid and systematic analysis of the RNA recognition specificities of RNA-binding proteins. Nature Biotechnol. 27, 667-670 (2009).

### REFERENCES CITED UNDER THE HEADING “SUPPLEMENTAL INFORMATION”

1. Barash, Y., Blencowe, B. & Frey, B. Model-Based Detection of Alternative Splicing Signals. In ISMB'10 (ISMB, 2010).

2. Rubin, D. & Thayer, D. EM algorithms for ML factor analysis. Psychometrika 47, 69-76 (1982).

3. Attias, H. Independent Factor Analysis. Neural Computation 11, 803-851 (1999).

4. Rubin, D. B. & Thayer, D. T. EM algorithms for ML factor analysis. Psychometrika 417, 69-76 (1982).

5. Neal, R. & Hinton, G. A View of the EM Algorithm that Justifies Incremental, Sparse, and other Variants. In Jordan, M. I. (ed.) Learning in Graphical Models (Kluwer, 1998).

6. Jordan, M. I., Ghahramani, Z., Jaakkola, T. & Saul, L. K. An Introduction to Variational Methods for Graphical Models. Machine Learning 37, 183-233 (1999).

7. Siepel, A. et al. Evolutionarily conserved elements in vertebrate, insect, worm, and yeast genomes. Genome Res 15, 1034-1050 (2005).

8. Kuhn, R. M. et al. The UCSC genome browser database: update 2007. Nucleic Acids Res 35 (2007).

9. H. Ho, T. et al. Muscleblind proteins regulate alternative splicing. EMBO 23, 3103.-3112 (2004).

10. Ashiya, M. & Grabowski, P. J. A neuron-specific splicing switch mediated by an array of pre-mRNA repressor sites: evidence of a regulatory role for the polypyrimidine tract binding protein and a brain-specific PTB counterpart. RNA 3, 996-1015 (1997).

11. Oberstrass, F. C. et al. Structure of PTB bound to RNA: specific binding and implications for splicing regulation. Science 309, 2054-2057 (2005).

12. Perez, I., Lin, C. H., McAfee, J. G. & Patton, J. G. Mutation of PTB binding sites causes misregulation of alternative 39 splice site selection in vivo. RNA 3, 764-778 (1997).

13. Minovitsky, S., Gee, S. L., Schokrpur, S., Dubchak, I. & Conboy, J. G. The splicing regulatory element, UGCAUG, is phylogenetically and spatially conserved in introns that flank tissue-specific alternative exons, Nucleic Acids Res. 33, 714-724 (2005).

14. Hofmann, Y., Lorson, C. L., Stamm, S., Androphy, E. J. & Wirth, B. Htra2-beta 1 stimulates an exonic splicing enhancer and can restore full-length SMN expression to survival motor neuron 2 (SMN2). Proceedings of the National Academy of Sciences of the United States of America 97, 9618-9623 (2000).

15. Cartegni, L., Wang, J., Zhu, Z., Zhang, M. Q. & Krainer, A. R. ESEfinder: a web resource to identify exonic splicing enhancers. Nucl. Acids Res. 31, 3568-3571 (2003).

16. Faustino, N. A. & Cooper, T. A. Identification of putative new splicing targets for ETR-3 using sequences identified by systematic evolution of ligands by exponential enrichment. Mol. Cell. Biol. 25, 879-887 (2005).

17. Aznarez, I. et al. A systematic analysis of intronic sequences downstream of 5′ splice sites reveals a widespread role for U-rich motifs and TIA1/TIAL1 proteins in alternative splicing regulation. Genome Research 1247-1258 (2008).

18. Galarneau, A. & Richard, S. Target RNA motif and target mRNAs of the Quaking STAR protein. Nature Struct. Mol. Biol. 12, 691-698 (2005).

19. Ule, J. et al. An RNA map predicting Nova-dependent splicing regulation. Nature 444, 580-586 (2006).

20.Segal, E., Barash, Y., Simon, I., Friedman, N. & Koller, D. From Promoter Sequence to Expression:A Probabilistic Framework. In RECOMB'02 (RECOMB, 2002).

21. Das, D. et al. A correlation with exon expression approach to identify cis-regulatory elements for tissue-specific alternative splicing. Nucleic Acids Res. 35, 4845-4857 (2007).

22. Sugnet, C. W. et al. Unusual intron conservation near tissue-regulated exons found by splicing microarrays. PLoS Comput. Biol. 2, e4 (2006).

23. Fagnani, M. et al. Functional coordination of alternative splicing in the mammalian central nervous system. Genome Biol. 8, R108 (2007).

24. Castle, J. C. et al. Expression of 24,426 human alternative splicing events and predicted cis regulation in 48 tissues and cell lines. Nature Genet. 40, 1416-1425 (2008).

25. Fairbrother, W. G., Yeh, R. F., Sharp, P. A. & Burge, C. B. Predictive identification of exonic splicing enhancers in human genes. Science 297, 1007-1013 (2002).

26. Wang, Z. et al. Systematic identification and analysis of exonic splicing silencers. Cell 119, 831-845 (2004).

27. Zhang, X. H. & Chasin, L. A. Computational definition of sequence motifs governing constitutive exon splicing. Genes Dev. 18, 1241-1250 (2004).

28. Stadler, M. B. et al. Inference of splicing regulatory activities by sequence neighborhood analysis. PLoS Genet. 2, e191 (2006).

29. Yeo, G. W., Nostrand, E. L. & Liang, T. Y. Discovery and analysis of evolutionarily conserved intronic splicing regulatory elements. PLoS Genet. 3, e85 (2007).

30. Dror, G., Sorek, R. & Shamir, R. Accurate identification of alternatively spliced exons using support vector machine. Bioinformatics 21, 897-901 (2005).

31. ltoh, H., Washio, T. & Tomita, M. Computational comparative analyses of alternative splicing regulation using full-length cDNA of various eukaryotes. RNA 10, 1005-1018 (2004).

32. Gooding, C. et al. A class of human exons with predicted distant branch points revealed by analysis of AG dinucleotide exclusion zones. Genome Biol. 7, R1 (2006).

33. Hofacker, I. L. Vienna RNA secondary structure server. Nucleic Acids Res 31, 3429-3431 (2003).

34. Hiller, M., Pudimat, R., Busch, A. & Backofen, R. Using RNA secondary structures to guide sequence motif finding towards single-stranded regions. Nucleic Acids Research 34, e117 (2006).

35. (duplicate of 1 from paper 1)

36. Cover, T. M. & Thomas, J. A. Elements of Information Theory (John Wiley & Sons, New York, 1991).

37. Friedman, J. H. Greedy function approximation: A gradient boosting machine. Annals of Statistics 29, 1189-1232 (2001).

38. Pan, Q. et al. Revealing global regulatory features of mammalian alternative splicing using a quantitative microarray platform. Mol Cell 16, 929-941 (2004).

39. Zhang, C. et al. Defining the regulatory network of the tissue-specific splicing factors Fox-1 and Fox-2. Genes Dev. 22, 2550-2563 (2008).

40. Zhang, C., Hastings, M. L., Krainer, A. R. & Zhang, M. Q. Dual-specificity splice sites function alternatively as 5′ and 3′ splice sites. Proceedings of the National Academy of Sciences 104, 15028-15033 (2007).

41. Licatalosi, D. D. et al. HITS-CLIP yields genome-wide insights into brain alternative RNA processing. Nature 456, 464-469 (2008).

42. Calarco, J. A. et al. Regulation of vertebrate nervous system alternative splicing and development by an SR-related protein. Cell 138, 898-910 (2009).

43. DeGroot, M. H. Probability and Statistics (Addison Wesley, Reading, Mass., 1989).

44. Wei, N., Lin, C. Q., Modafferi, E. F., Gomes, W. A. & Black, D. L. A unique intronic splicing enhancer controls the inclusion of the agrin Y exon. RNA 3, 1275-1288 (1997).

45. Markovtsov, V. et al. Activation of c-src neuron-specific splicing by an unusual RNA element in vivo and in vitro. Cell 69, 795-807 (1992).

46. Chan, R. C. & Black, D. L. The polypyrimidine tract binding protein binds upstream of neural cell-specific c-src exon N1 to repress the splicing of the intron downstream. Mol. Cell. Biol. 17, 4667-4676 (1997).

47. Markovtsov, V. et al. Cooperative assembly of an hnRNP complex induced by a tissue-specific homolog of polypyrimidine tract binding protein. Mol. Cell. Biol. 20, 7463-7479 (2000).

48. Cote, N., Dupuis, S. & Wu, J. Polypyrimidine track-binding protein binding downstream of caspase-2 alter-native exon 9 represses its inclusion. J Biol Chem 276, 8535-8543 (2001).

49. Cote, J., Dupuis, S., Jiang, Z. & Wu, J. Y. Caspase-2 pre-mRNA alternative splicing: identification of an intronic element containing a decoy 39 acceptor site. Proc. Natl Acad. Sci. USA 98, 938-943 (2001).

50. Xie, J. & Black, D. A CaMK IV responsive RNA element mediates depolarization-induced alternative splicing of ion channels. Nature 410, 936-939 (2001).

51. Najm, J. et al. Mutations of CASK cause a novel X-linked brain malformation phenotype with microcephaly and hypoplasia of the brainstem and cerebellum. Nature Genetics 40, 1065-1067 (2008).

52. Hata, Y., Butz, S. & Sudhof, T. CASK: a novel dlg/PSD95 homolog with an N-terminal calmodulin-dependent protein kinase domain identified by interaction with neurexins. J. Neurosci 16, 2488-2494 (1996).

53. Pan, Q., Shai, O., Lee, L. J., Frey, B. J. & Blencowe, B. J. Deep surveying of alternative splicing complexity in the human transcriptome by high-throughput sequencing. Nature Genet. 40, 1413-1415 (2008).

54. Blencowe, B. J., Ahmad, S. & Lee, L. J. Current-generation high-throughput sequencing: deepening insights into mammalian transcriptomes. Genes and Development 23, 1379-1386 (2009).

55. Pan, Q. et al. Quantitative microarray profiling provides evidence against widespread coupling of alternative splicing with nonsense-mediated mRNA decay to control gene expression. Genes Dev. 20, 153-158 (2006).

### REFERENCES CITED UNDER THE HEADING “MODEL-BASED DETECTION OF ALTERNATIVE SPLICING SIGNALS”

Ashiya, M., and Grabowski, P J. (1997) A neuron-specific splicing switch mediated by an array of pre-mRNA repressor sites: evidence of a regulatory role for the polypyrimidine tract binding protein and a brain-specific PTB counterpart, RNA, 3 996-1015.

Attias, H. (1999) Independent factor analysis. Neural Comput., 11, 803-851.

Barash, Y. et al. (2010) Deciphering the splicing code. Nature, 464, 7294.

Bar-Joeph, Z. et al. (2003) Computational discovery of gene modules and regulatory networks, Nat. Biotechnol., 21, 1337-1342.

Beer, M. A. and Tavazoie, S. (2004) Predicting gene expression from sequence, Cell, 117, 185-198.

Boutz, P. et al. (2007) MicroRNAs regulate the expression of the alternative splicing factor nPTB during muscle development, Gen. Dev., 21, 71-84.

Candes, E. et al. (2009) Robust principal component analysis? Stanford Technical Report. Available at http://www-stat.stanford.edu/˜candes/publications.html.

Castle, J. C. et al. (2008) Expression of 24,426 human alternative splicing events and predicted cis regulation in 48 tissues and cell lines, Nat. Gen., 40, 1416-1425.

Chan,R. and Black, D. (1997) The polypyrimidine tract binding protein binds upstream of neural cell-specific c-src exon N1 to repress the splicing of the intron downstream, Mol. Cell Biol., 17 4667-4676.

Das, D. et al. (2007) A correlation with exon expression approach to identify cis-regulatory elements for tissue-specific alternative splicing, Nucleic Acids Res., 35, 4845-4857.

Dueck, D. et al. (2005) Probabilistic sparse matrix factorization with an application to discovering gene functions in mouse mRNA expression data. Bioinformatics, 21 (Suppl. 1), i144-i151.

Eisen, B. M. et al. (1998) Cluster analysis and display of genome-wide expression patterns, Proc. Natl Acad. Sci. USA, 95, 14863-14868.

Fagnani, M. et al. (2007) Functional coordination of alternative splicing in the mammalian central nervous system, Genome. Biol., 8, R108.

Ghahramani, Z. and Hinton, G. E. (1996) The EM algorithm for mixtures of factor analyzers, University of Toronto Technical Report, CRG-TR-96-1. Available at http://www.cs.toronto.edu/˜hinton/absps/tr-96-1.pdf.

Hartmann, B. and Valcarcel, J. (2009) Decrypting the genome's alternative messages, Curr. Opin. Cell Biol., 21, 377-386.

Kornblihtt, A. R. (2007) Coupling transcription and alternative splicing, Adv. Exp. Med. Biol., 623, 175-189.

Licatalosi, D. et al. (2008) HITS-CLIP yields genome-wide insights into brain alternative RNA processing, Nature, 456, 464-469.

Minovitsky, S. et al. (2005) The splicing regulatory element, UGCAUG, is phylogenetically and spatially conserved in introns that flank tissue-specific alternative exons, Nucleic Acids Res., 33, 714-724.

Neal, R. and Hinton, G. (1998) A view of the Em algorithm that justifies incremental, sparse, and other variants. In Jordan, M. I. (ed.), Learning in Graphical Models. Kluwer Academic Publishers, Norwell, Mass., USA, pp. 355-368.

Paisley, J. and Carin, L. (2009) Nonparametric factor analysis with beta process priors, In International Conference on Machine Learning (ICML) 2009. Vol. 382, Montreal, Canada, pp. 777-784.

Pan, Q. et al. (2004) Revealing global regulatory features of mammalian alternative splicing using a quantitative microarray platform, Mol. Cell, 16, 929-941.

Pan, Q. et al. (2008) Deep surveying of alternative splicing complexity in the human transcriptome by high-throughput sequencing, Nat. Genet., 40, 1413-1415.

Rubin, D. and Thayer, D. (1982) EM algorithms for ML factor analysis. Psychometrika, 47, 69-76.

Scheper, W. et al. (2004) Alternative splicing in the N-terminus of Alzheimer's presenilin 1. Neurogenetics, 5, 223-227.

Segal, E. et al. (2002) From promoter sequence to expression:a probabilistic framework. In RECOMB. ACM Press, Washington, D.C., USA, pp. 263-272.

Segal, E. et al. (2003) Modules networks: identifying regulatory modules and their condition-specific regulators from gene expression data. Nat. Genet., 34, 166-176.

Segal, E. et al. (2004) GeneXPress: a visualization and statistical analysis tool for gene expression and sequence data. In Proceedings of the 11th International Conference on Intelligent Systems for Molecular Biology (ISMB).

Shai, O. et al. (2006) Inferring global levels of alternative splicing isoforms using a generative model of microarray data, Bioinformatics, 22, 606-613.

Ule, J. et al. (2006) An RNA map predicting Nova-dependent splicing regulation, Nature, 444, 580-586.

Wang, G. S. and Cooper, T. (2007) Splicing in disease: disruption of the splicing code and the decoding machinery. Nat. Rev. Genet., 8, 749-761.

Wang, Z. and Burge, CB (2008) Splicing regulation: from a parts list of regulatory elements to an integrated splicing code, RNA, 14, 802-813.

Wang, E. T. et al. (2008) Alternative isoform regulation in human tissue transcriptomes, Nature, 456, 470-476.

Zhang, C. et al. (2008) Defining the regulatory network of the tissue-specific splicing factors Fox-1 and Fox-2. Gen. Dev., 22, 2550-2563.

### REFERENCES CITED UNDER THE HEADING “SUPPLEMENTARY MATERIAL”

1. M. Ashiya and P J. Grabowski. A neuron-specific splicing switch mediated by an array of pre-mRNA repressor sites: evidence of a regulatory role for the polypyrimidine tract binding protein and a brain-specific PTB counterpart. RNA, 3:996-1015, September 1997.

2. M. Fagnani, Y. Barash, J. Ip, C. Misquitta, Q. Pan, A. L. Saltzman, O. Shai, L. Lee, A. Rozenhek, N. Mohammad, S. Willaime-Morawek, T. Babak, W. Zhang, T. R. Hughes, D. van der Kooy, B. J. Frey, and B. J. Blencowe. Functional coordination of alternative splicing in the mammalian central nervous system. Genome Biology, 8:R108+, June 2007.

3. A. Galarneau and S. Richard. Target RNA motif and target mRNAs of the Quaking STAR protein. Nature Structural & Molecular Biology, 12(8):691-698, July 2005.

4. Thai H. Ho, N. Charlet-B, M. G. Poulos, G. Singh, M. S Swanson, and T. A. Cooper. M uscleblind proteins r egulate alternative splicing. EMBO, 23:3103-3112, 2004.

5. M. I. Jordan, Z. Ghahramani, T. Jaakkola, and L. K. Saul. An Introduction to Variational Methods for Graphical Mo dels. Machine Learning, 37(2):183-233, 1999.

6. S. Minovitsky, S. L. Gee, S. Schokrpur, I. Dubchak, and J. G. Conboy. The splicing regulatory element, UGCAUG, is phylogenetically and spatially conserved in introns that flank tissue-specific alternative exons. NAR, 33:714-724, 2005.

7. R. Neal and G. Hinton. A View of the EM Algorithm that Justifies Incremental, Sparse, and other Variants. In M. I. Jordan, editor, Learning in Graphical Models. Kluwer, 1998.

8. F. C. Oberstrass, S. D. Auweter, M. Erat, Y. Hargous, A. Henning, P. Wenter, L. Reymond, B. Amir-Ahmady, S. Pitsch, D. L. Black, and F. H.-T. Allain. Structure of PTB Bound to RNA: Specific Binding and Implications for Splicing Regulation. Science, 309(5743):2054-2057, 2005.

9. I. Perez, C. H. Lin, J. G. McAfee, and J. G. Patton. Mutation of PTB binding sites causes misregulation of alternative 3′ splice site selection in vivo. RNA, 3:764-768, 1997.

10. J. Ule, G. Stefani, A. Mele, M. Ruggiu, X. Wang, B. Taneri, T. Gaasterland, B. J. Blencowe, and R. B. Darnell. An RNA map predicting Nova-dependent splicing regulation. Nature, October 2006.

1. A method of processing requests, comprising:
storing, in a memory, splicing code data comprising a plurality of features, the splicing codle data further comprising, in association with each feature, at least one parameter defining the activity of the feature in splicing regulation;
receiving a request at a processor, the request identifying at least a first portion of a genomic sequence;
receiving, at the processor, at least a second portion of the genomic sequence that is relevant to the first portion;
receiving, at the processor, a feature set comprising at least one feature from the second portion of the genomic sequence;
generating, based on the splicing code data and the feature set, a response to the request, the response comprising at least one of a numerical value and a graphical depiction for at least one condition; and
transmitting the response.

2. The method of claim 1, wherein receiving the request comprises receiving the request from a computing device via a network interface controller.

3. The method of claim 1, wherein the request comprises at least one of the first portion and the second portion of the genomic sequence.

4. The method of claim 1, wherein the request comprises genomic coordinates and wherein receiving the second portion of the genomic sequence comprises retrieving the second portion from the memory based on the genomic coordinates.

5. The method of claim 1, wherein the first portion of the genomic sequence comprises any one of a portion of an exon, an intron, a combination of one or more exons and one or more introns, and an untranslated region.

6. The method of claim 5, wherein the first portion of the genomic sequence comprises an exon.

7. The method of claim 6, wherein the request includes at least a recognizable portion of the exon.

8. The method of claim 6, wherein storing the splicing code data comprises:
storing, in the memory, expression data relating to a plurality of exons and a plurality of samples, the expression data comprising an inclusion level for each pair of one exon and one sample, each inclusion level indicating a fraction of transcripts from the one sample in which the one exon is included;
generating at the processor, for each exon, at least one splicing pattern comprising a probability for each of increased exon inclusion, increased exon exclusion, and no change in exon transcription in connection with at least one cellular condition.

9. The method of claim 8, further comprising generating a plurality of splicing patterns for each exon, each splicing pattern corresponding to a different one of a plurality of cellular conditions.

10. The method of claim 9, wherein the cellular conditions are tissue types.

11. The method of claim 10, wherein the tissue types comprise CNS, muscle, embryo and digestive tissue types.

12. The method of claim 8, wherein storing the splicing code data further comprises:
performing at least one of the selection of at least one feature and the adjustment of at least one parameter;
determining a code quality;
repeating the performing and determining until a determination to cease optimizing code quality is made; and
storing the selected features and adjusted parameters as the splicing code data.

13. The method of claim 12, further comprising:
repeating the generation of splicing patterns, the selection of features and the adjustment of parameters for a plurality of subsets of the expression data;
determining, for each selected feature, the fraction of the resulting sets of splicing code data in which the selected feature is present;
retaining the selected feature if the fraction exceeds a predetermined threshold; and
storing the retained features and associated parameters as a robust splicing code.

14. The method of claim 1, wherein the second portion is the second portion, and wherein receiving the request and receiving the second portion are simultaneous.

15. The method of claim 1, wherein the numerical value is a predicted change in inclusion level, and wherein the graphical depiction is a predicted feature map.

16. The method of claim 1, wherein receiving the feature set comprises generating the feature set at the processor.

17. A server for processing requests, comprising:
a memory for storing splicing code data comprising a plurality of features, the splicing codle data further comprising, in association with each feature, at least one parameter defining the activity of the feature in splicing regulation;
processor configured to receive a request, the request identifying at least a first portion of a genomic sequence;
the processor further configured to receive at least a second portion of the genomic sequence that is relevant to the first portion;
the processor further configured to receive a feature set comprising at least one feature from the second portion of the genomic sequence;
the processor further configured to generate, based on the splicing code data and the feature set, a response to the request, the response comprising at least one of at least one of a numerical value and a graphical depiction for at least one condition; and
the processor further configured to transmit the response.

18. A non-transitory computer readable medium for storing computer-readable instructions executable by a processor for configuring the processor to implement a method, comprising:
storing, in a memory, splicing code data comprising a plurality of features, the splicing code data further comprising, in association with each feature, at least one parameter defining the activity of the feature in splicing regulation;
receiving a request at a processor, the request identifying at least a first portion of a genomic sequence;
receiving at the processor, at least a second portion of the genomic sequence that is relevant to the first portion;
receiving, at the processor, a feature set comprising at least one feature from the second portion of the genomic sequence;
generating, based on the splicing code data and the feature set, a response to the request, the response comprising at least one of a numerical value and a graphical depiction for at least one condition; and
transmitting the response.
